(19) United States
(12) Patent Application Publication
(10) Pub. No.: US 2026/0131939 A1
(43) Pub. Date: May 14, 2026

(54) TRANSPORTABLE CONTAINER SYSTEM

(71) Applicant: THE STANLEY WORKS ISRAEL LTD., Rosh Ha'Ayin (IL)

(72) Inventors: Adar OMRY, Hertzeliya (IL); Noam TWIG, Petach Tikva (IL); Ilan BURLO, Ramat Gan (IL); Shir LEVY, Hadera (IL)

(21) Appl. No.: 19/397,401

(22) Filed: Nov. 21, 2025

Related U.S. Application Data
(63) Continuation of application No. 19/389,660, filed on Nov. 14, 2025.
(60) Provisional application No. 63/720,735, filed on Nov. 14, 2024.
(60) Provisional application No. 63/735,056, filed on Dec. 17, 2024.
(60) Provisional application No. 63/770,391, filed on Mar. 12, 2025.
(60) Provisional application No. 63/848,898, filed on Jul. 22, 2025.

(51) Int. Cl. B65D 21/02

(52) U.S. Cl. CPC B65D 21/0223

(57) ABSTRACT

Portable structures are disclosed that include a housing having top, bottom, first side, and second side walls; a first mating element having a cleat and positioned on a first region between the bottom wall and the first sidewall, the cleat extending laterally outward from the first region; and a second mating element having an actuator and a cleat and positioned in a second region between the bottom wall and the second sidewall, the second mating element pivotally movable about a pivot axis extending longitudinally along the second region, and the second mating element biased to a first position in which the actuator is positioned against the second region and the cleat extends laterally outward from the second region, and movable to a second position in which the actuator is spaced laterally outward from the second region and the cleat is retracted laterally inward relative to the second region.

### CROSS REFERENCE TO RELATED APPLICATIONS

This application is a continuation of U.S. application Ser. No. 19/389,660, filed Nov. 14, 2025 and entitled “TRANSPORTABLE CONTAINER SYSTEM,” which claims priority under 35 U.S.C. §119(e) to U.S. Provisional Application No. 63/720,735 filed Nov. 14, 2024, U.S. Provisional Application No. 63/735,056 filed Dec. 17, 2024, U.S. Provisional Application No. 63/770,391 filed Mar. 12, 2025, and U.S. Provisional Application No. 63/848,898 filed Jul. 22, 2025, the entire contents of which are hereby expressly incorporated by reference herein.

### FIELD

This patent application relates, in general, to the field of container systems. In particular, this patent application relates to a stackable container system that may be configured for transporting articles between working locations and that includes a plurality of stackable containers that may be configured to be latched to one another.

### BACKGROUND

Carpenters, handy persons, other tradesmen (electricians, plumbers, internal design, etc.) often need to carry multiple containers/stackable bodies to a jobsite. These containers/stackable bodies are often latched to one another. Typical latches are manual connectors that include a swinging portion having a hook on a first body and a protruding portion suitable for engaging the hook on the second body. These manual connectors require an operator to actively move the swinging portion into engagement with the protruding portion, requiring two hands to connect and disconnect the containers.

### SUMMARY

In one aspect, a portable structure is provided that includes a housing having a top wall, a bottom wall, a first sidewall, and a second sidewall opposite the first sidewall. The portable structure can include a first mating element having a cleat portion, the first mating element being positioned on a first region between the bottom wall and the first sidewall, and the cleat portion extending laterally outward from the first region. The portable structure can include a second mating element having an actuator portion and a cleat portion, the second mating element being positioned in a second region between the bottom wall and the second sidewall, the second mating element being pivotally movable about a pivot axis extending longitudinally along the second region, and the second mating element being biased to a first position in which the actuator can be positioned against the second region and the cleat extends laterally outward from the second region, and being movable to a second position in which the actuator can be spaced laterally outward from the second region and the cleat can be retracted laterally inward relative to the second region.

In some aspects, the first mating element can be immovably positioned in the first region.

In some aspects, the cleat portion of the first mating element can be movable between a first position in which the cleat extends laterally outward from the first region and a second position in which the cleat can be retracted laterally inward relative to the first region.

In some aspects, the cleat portion of the first mating element can include a tapered surface.

In some aspects, the cleat portion of the first mating element can include a plurality of cleats spaced longitudinally along the first region and the cleat portion of the second mating element can include a plurality of cleats spaced longitudinally along the second region.

In some aspects, the plurality of cleats can move simultaneously with movement of the actuator portion of the second mating element.

In some aspects, the second mating element can be biased via a spring positioned within the second region.

In some aspects, the plurality of cleats can extend parallel to the bottom wall.

In another aspect, a system is provided that includes a first structure including a top wall, a bottom wall opposite the top wall, a first sidewall, and a second sidewall opposite the first sidewall, a first plurality of pockets positioned on the top wall adjacent the first sidewall, a second plurality of pockets positioned on the top wall adjacent the second sidewall, a first mating element positioned on a first region between the bottom wall and the first sidewall, the mating element having one or more cleats extending laterally outward from the first region, and a second mating element positioned on a second region between the bottom wall and the second sidewall, the second mating element having one or more cleats extending laterally outward from the second region and being pivotally movable relative to the bottom wall. The system can include a second structure including a top surface including a first edge, a second edge opposite the first edge, a third plurality of pockets positioned on the top surface adjacent the first edge, and a fourth plurality of pockets positioned on the top surface adjacent the second edge. The first structure can be arranged to be mated to the second structure by angularly inserting the one or more cleats of the first mating element on the first structure into one or more of the third plurality of pockets in the second structure and rotating the first structure from a first position in which the bottom wall of the first structure extends at an acute angle relative to the top surface of the second structure, to a second position in which the bottom wall of the first structure can be substantially parallel to the top surface of the second structure, and the second mating element can be arranged to pivot when the first structure can be moved from the first position to the second position, and the one or more cleats on the second mating element can be arranged to engage one or more of the fourth plurality of pockets when the first structure can be in the second position to attach the first structure to the second structure.

In some aspects, the first plurality of pockets and second plurality of pockets can be positioned above the top wall.

In some aspects, the one or more cleats of the first mating element can be immovable and can include a tapered surface.

In some aspects, the one or more cleats of the first mating element can be movable between a first position in which the cleat extends laterally outward from the first region and a second position in which the cleat can be retracted laterally inward relative to the first region, and the first structure can be arranged to be mated to the second structure by vertically placing the first structure on top of the second structure such that the one or more cleats of the first mating element contact a top surface of one or more of the third plurality of pockets and the one or more cleats of the second mating element contact a top surface of one or more of the fourth plurality of pockets and pivot inward toward the first and second regions, respectively, and subsequently pivot outward from the first and second regions to engage with one or more of the third plurality of pockets and one or more of the fourth plurality of pockets, respectively, to attach the first structure to the second structure.

In some aspects, each of the first plurality of pockets can include an opening, and each of the second plurality of pockets can include an opening, and the openings of the first plurality of pockets can face the openings of the second plurality of pockets.

In some aspects, the openings of the first plurality of pockets can be perpendicular to the top wall.

In some aspects, each of the first plurality of pockets can be separated by a rib extending upward from the top wall.

In some aspects, the first structure can be a container and the second structure can be any one of a container, a wall mount, or floor mount.

In another aspect, a structure is provided that includes a top surface, a first plurality of pockets positioned proximate to a first edge of the top surface, a second plurality of pockets positioned proximate to a second edge of the top surface, and a third plurality of pockets positioned on the top surface at a location between the first plurality of pockets and the second plurality of pockets, the third plurality of pockets including a first set of pockets each having an opening facing the first plurality of pockets, and a second set of pockets each having an opening facing the second plurality of pockets.

In some aspects, each of openings of the first set of pockets and the second set of pockets can be perpendicular to the top surface.

In some aspects, the first, second, and third plurality of pockets can each have the same shape and size.

In some aspects, each of the first plurality of pockets can be separated by a rib extending upward from the top surface.

In some aspects, the shape of the first, second, and third plurality of pockets can be trapezoidal.

In some aspects, the top surface can be arranged to receive and releasably secure one or more containers thereto in a plurality of arrangements, and each arrangement of the plurality can include releasably secure connections of each of the one or more containers between one or more of the first plurality of pockets and one or more of the second plurality of pockets, between one or more of the first plurality of pockets and one or more of the third plurality of pockets, or between one or more of the second plurality of pockets and one or more of the third plurality of pockets.

In some aspects, the structure can further include a housing having a plurality of walls including top wall, a bottom wall, a first sidewall, and a second sidewall, and the top surface can be provided on the top wall.

In some aspects, the structure can be a wall or floor mount.

In another aspect, a system is provided that includes a first structure having a top surface including a first plurality of pockets positioned on the top surface adjacent a first edge of the top surface, and a second plurality of pockets positioned on the top surface adjacent a second edge of the top surface, opposite the first edge. The system can include a second structure having a top wall, a bottom wall, a first sidewall, a second sidewall opposite the first sidewall, a first cleat positioned on a first region between the bottom wall and the first sidewall, and a second cleat positioned on a second region between the bottom wall and the second sidewall, at least one of the first and second cleats being pivotally movable relative to the second structure. The second structure can be matable to the first structure in a first orientation in which the first cleat can be positioned in one of the first plurality of pockets and the second cleat can be positioned in one of the second plurality of pockets, and a second orientation in which the first cleat can be positioned in one of the second plurality of pockets and the second cleat can be positioned in one of the first plurality of pockets.

In some aspects, each of the first plurality of pockets can include an opening positioned perpendicular to the top surface of the first structure.

In some aspects, each of the second plurality of pockets can include an opening positioned perpendicular to the top surface of the first structure.

In some aspects, the openings of the first plurality of pockets can face the openings of the second plurality of pockets.

In some aspects, at least one of the first and second cleats can be rigidly connected to the second structure.

In some aspects, the first cleat can extend laterally outward from the first region.

In some aspects, each of the first cleat and the second cleat can include a tapered surface.

In some aspects, the first cleat can include a plurality of cleats positioned adjacent one another along the first region.

In some aspects, the first structure can further include a housing having a top wall, a bottom wall, a first sidewall, and a second sidewall, and the top surface can be provided on the top wall.

In some aspects, the first structure and the second structure can be containers.

In some aspects, the first structure can be a wall mount or a floor mount.

In another aspect, a system is provided that includes a first structure having a top surface including a first plurality of pockets positioned on the top surface adjacent a first edge of the top surface, and a second plurality of pockets positioned on the top surface adjacent a second edge of the top surface, opposite the first edge. The system can include a second structure having a plurality of walls including a top wall, a bottom wall, a first sidewall, and a second sidewall opposite the first sidewall, the second structure having a first cleat positioned on a first region between the bottom wall and the first sidewall and a second cleat positioned on a second region between the bottom wall and the second sidewall, at least one of the first and second cleats being pivotally movable relative to the second structure. The first cleat can be arranged to be received in any one of the first plurality of pockets with the second cleat being received in a corresponding pocket of the second plurality of pockets such that the second structure can be selectively mated to the first structure at a plurality of longitudinal positions.

In some aspects, the second structure can include a portion arranged to overhang off an edge of the first structure when the second structure can be connected to the first structure.

In some aspects, the system can further include a third structure having a top surface including a third plurality of pockets positioned on the top surface adjacent a first edge of the top surface, and a fourth plurality of pockets positioned on the top surface adjacent a second edge of the top surface, opposite the first edge. The second structure can further include a third cleat positioned on the first region and a fourth cleat positioned on the second region, at least one of the third and fourth cleats being pivotally movable relative to the second structure. The third and fourth cleats can be provided on the portion of the second structure that overhangs off the edge of the first structure. The third cleat can be arranged to be received in any one of the third plurality of pockets with the fourth cleat being received in a corresponding pocket of the fourth plurality of pockets of the third structure such that the second structure can be selectively mated to across both the first structure and the third structure.

In some aspects, the first structure can further include a housing having a top wall, a bottom wall, a first sidewall, and a second sidewall, and the top surface can be provided on the top wall, and the first structure and the second structure can be containers.

In some aspects, the first structure can be a wall mount or a floor mount.

In some aspects, the plurality of longitudinal positions can include multiple mounting locations along a width and a depth of the top surface of the first structure for at least one of the first cleat and second cleat to engage with.

In some aspects, at least one of the first and second cleats can be rigidly connected to the second structure.

In some aspects, each of the first cleat and the second cleat can include a tapered surface.

In some aspects, the first cleat can include a plurality of cleats positioned adjacent one another along the first region.

In another aspect, a system is provided that includes a first structure having a top surface including a first plurality of pockets positioned on the top surface adjacent a first edge of the top surface, a second plurality of pockets positioned on the top surface adjacent a second edge of the top surface, opposite the first edge, and a third plurality of pockets positioned on the top surface between the first edge and the second edge. The system can include a second structure having a plurality of walls including a bottom wall, a first sidewall, and a second sidewall opposite the first sidewall, the second structure including a first cleat positioned along a first region between the bottom wall and first sidewall, and a second cleat positioned along a second region between the bottom wall and the second sidewall, the first cleat being arranged to engage with any one of the third plurality of pockets and the second cleat being moveable relative to the bottom wall and arranged to engage with the a corresponding pocket of either the first plurality of pockets or the second plurality of pockets to connect the second structure to the top surface of the first structure between the third plurality of pockets and either the first plurality of pockets or the second plurality of pockets.

In some aspects, the third plurality of pockets can include a first set of pockets each having an opening facing the first plurality of pockets.

In some aspects, each of openings of the first set of pockets can be perpendicular to the top wall of the first structure.

In some aspects, the third plurality of pockets can include a second set of pockets each having an opening facing the second plurality of pockets.

In some aspects, each of openings of the second set of pockets can be perpendicular to the top wall of the first structure.

In some aspects, the first set of pockets and the second set of pockets can be separated by a wall positioned therebetween.

In some aspects, the first structure can further include a housing having a top wall, a bottom wall, a first sidewall, and a second sidewall, and the top surface can be provided on the top wall, and the first structure and the second structure can be containers.

In some aspects, the first structure can be a wall mount or a floor mount.

In another aspect, a system is provided that includes a first structure having a latch with an actuator and a cleat, the latch being pivotally movable relative to the first structure, and the latch including a slug movable between extended and recessed positions. The system can include a second structure having a recess arranged to receive the cleat on the first structure to mate the first and second structures. The actuator can be movable from a locked position in which the cleat can be received in the recess, to a released position in which the cleat can be withdrawn from the recess, such that movement of the actuator from the locked position to the released position, when the first structure can be mated to the second structure, causes the slug to move from the recessed position to the extended position to maintain the actuator in the released position, allowing the first structure to be detached from the second structure any time thereafter, without having to continuously engage the actuator.

In some aspects, the slug can contact the second structure when in the extended position.

In some aspects, the slug can include a tab extending laterally outward from the first structure.

In some aspects, the slug can be biased to the extended position by a spring positioned between the slug and the latch.

In some aspects, the slug can be positioned within an internal hole of the latch.

In some aspects, a bottom surface of the slug can rest on the second structure when the first structure can be mated to the second structure to maintain the slug in the recessed position when the actuator can be in the locked position.

In some aspects, the slug can further include a first slug and a second slug positioned on opposite sides of the actuator.

In some aspects, the slug can be positioned at least partially below the actuator of the latch.

In another aspect, a system is provided that includes a first structure including a latch body pivotally disposed on the first structure and arranged to rotate between first and second positions, the latch body having a actuator and a cleat, and a slug at least partially disposed within the latch body and arranged move relative to the latch body between a recessed position and an extended position. The system can include a second structure having a recess arranged to receive the cleat to mate the first structure to the second structure. The latch can have a first arrangement in which the actuator can be biased to the first position and the slug biased to the extended position when the first structure can be detached from the second structure. The latch can have a second arrangement in which the actuator can be in the first position and the slug can be in the recessed position when the first structure can be attached to the second structure with the cleat extending into the recess. The latch can have a third arrangement in which the actuator can be in the second position and the slug can be in the extended position to maintain the actuator in the second position when the first structure can be attached to the second structure.

In some aspects, the first structure can be removable from the second structure when the latch can be in the third arrangement.

In some aspects, the latch can be arranged to move from the third arrangement to the first arrangement when the first structure can be removed from the second structure.

In some aspects, the slug can contact the second structure when in the extended position in the third arrangement.

In some aspects, the slug can be positioned within an internal hole of the latch.

In some aspects, a bottom surface of the slug can rest on the second structure when the first structure can be mated to the second structure to maintain the slug in the recessed position when the latch can be in the second arrangement.

In some aspects, the first structure and the second structure can be containers.

In some aspects, the first structure can be a container and the second structure can be a wall mount or a floor mount.

In another aspect, a latch assembly is provided that includes a latch body pivotally positioned on a structure, the latch body having an actuator portion and one or more cleats, a first biasing element positioned between the latch body and the structure, the first biasing element arranged to bias the latch body into a first position, a slug positioned within a recess in the actuator portion and arranged to move relative to the actuator between extended and retracted positions, and a second biasing element positioned within the recess and arranged to bias the slug into the extended position.

In some aspects, the slug can include a tab extending laterally outward from the structure.

In some aspects, the slug can include a first slug and a second slug spaced longitudinally along the actuator portion.

In some aspects, the slug can be arranged to extend at least partially below the actuator portion.

In some aspects, the one or more cleats can include a plurality of cleats positioned opposite the actuator portion of the latch body along an axis of rotation which the latch body pivots about.

In some aspects, the slug can be positioned vertically above the one or more cleats.

In another aspect, a system is provided that includes a first structure having a first plurality walls defining a first volume, the first plurality of walls including a top wall and a bottom wall opposite the top wall, the first structure including a first plurality of connecting features positioned along the top wall, and a second plurality of connecting features positioned along the bottom wall. The system can include a second structure having a second plurality walls defining a second volume that can be less than the first volume, the second plurality of walls including a top wall and a bottom wall opposite the top wall, the second structure including a third plurality of connecting features positioned along a top wall, and a fourth plurality of connecting features positioned along a bottom wall. The fourth plurality of connecting features can be arranged such that second structure can be releasably mounted to the top wall of the first structure by engaging the fourth plurality of connecting features with the first plurality of connecting features. The second plurality of connecting features can be arranged such that they can be incapable of engaging with the third plurality of connecting features to prevent the first structure from being mounted to the top wall of the second structure.

In some aspects, the system can further include a third structure having a plurality walls defining a third volume that can be less than the first volume, the third plurality of walls including a top wall and a bottom wall opposite the top wall, the third structure including a fifth plurality of connecting features positioned along a top wall, and a sixth plurality of connecting features positioned along a bottom wall. The fourth plurality of connecting features can be arranged such that second structure can be releasably mounted to the top wall of the third structure by engaging the fourth plurality of connecting features with the fifth plurality of connecting features. The sixth plurality of connecting features can be arranged such that third structure can be releasably mounted to the top wall of the first structure by engaging the sixth plurality of connecting features with the first plurality of connecting features. The sixth plurality of connecting features can be arranged such that third structure can be releasably mounted to the top wall of the second structure by engaging the sixth plurality of connecting features with the third plurality of connecting features. The second plurality of connecting features can be arranged such that they can be incapable of engaging with the fifth plurality of connecting features to prevent the first structure from being mounted to the top wall of the third structure.

In some aspects, the first plurality of connecting features can be a first plurality of pockets, and the third plurality of connecting features can be a second plurality of pockets.

In some aspects, the second plurality of connecting features can be a first plurality of cleats, and the fourth plurality of connecting features can be a second plurality of cleats.

In some aspects, the first plurality of pockets can be smaller than the second plurality of pockets.

In some aspects, the first plurality of cleats can be larger than the second plurality of pockets, preventing the first plurality of cleats from being positioned within the second plurality of pockets.

In some aspects, the second plurality of connecting features can include a first cleat positioned on a first side of the first structure, and a second cleat positioned on a second side of the first structure, opposite the first side.

In some aspects, at least one of the first cleat and the second cleat can be moveable relative to the first structure.

In some aspects, the second cleat can be rigidly connected to the first structure.

In one aspect, a structure is provided that includes a housing having an exterior surface, a first corner edge, and a second corner edge. The structure can include a lid pivotally connected to the housing and arranged to selectively alternate between a closed position and an open position. The structure can include a first rail positioned along the first corner edge of the housing and having a first channel extending there through. The structure can include a second rail positioned along the second corner of the housing and having a second channel extending there through, the second rail extending parallel to the first rail. The structure can include a bar arranged to removably mate to a first side of the housing, between the first rail and the second rail. The bar can include a first cleat and a second cleat arranged to be mated to the first and second channels in the first and second rails, respectively. The first and second cleats can be movable between a first orientation in which the bar can be locked in a position between the first rail and the second rail, and a second orientation in which the bar can be movable relative to the first rail and the second rail.

In some aspects, the first rail can further include a third channel extending therethrough, and the second rail can further include a fourth channel extending therethrough, wherein the third channel can be positioned perpendicular to the first channel of the first rail and the fourth channel can be positioned perpendicular to the second channel of the second rail.

In some aspects, the first channel can include an opening facing outward from the first side of the housing and the second channel can include an opening facing outward from the first side of the housing.

In some aspects, the first rail can abut the exterior surface of the housing along the entire length of the first rail.

In some aspects, the first channel can include a first access opening adjacent to the top surface, and the second channel can include a second opening adjacent to the top surface. The first cleat and the second cleat can be slidably inserted into the first channel via the first access opening and the second channel via the second access opening, respectively, when the lid can be in the open position. The lid can prevent the first and second cleats from being inserted into or removed from the first and second channels via the first and second access openings, respectively, when the lid can be in the closed position.

In some aspects, the bar can be removably mated to the first side of the housing by laterally placing the first cleat and the second cleat into the first and second channels, respectively, when the first and second cleats can be in the second orientation, and pivoting the first and second cleats to the first orientation to lock the bar in a mated position on the first rail and the second rail.

In another aspect, a structure is provided that includes a housing having a top wall, a bottom wall, a first sidewall, a second sidewall opposite the first sidewall, a third sidewall positioned between the first sidewall and the second sidewall, and a fourth sidewall opposite the third sidewall. The structure can include a first plurality of pockets in the top wall. The structure can include a second plurality of pockets in the top wall. The structure can include a first corner rail positioned along a first edge between the first sidewall and the third sidewall. The structure can include a second corner rail positioned along a second edge between the first sidewall and the fourth sidewall. The structure can include a bar having a first end arranged to removably mate to the first corner rail, and a second end arranged to removably mate to the second corner rail. The structure can include an accessory having a connection assembly arranged to allow the accessory to selectively mate to one or more pockets of the first plurality of pockets and one or more pockets of the second plurality of pockets in a first orientation relative to the housing, and to the bar in a second orientation relative to the housing.

In some aspects, the connection assembly can include a first cleat positioned at a first end of the accessory, and a second cleat positioned at a second end of the accessory, opposite the first end.

In some aspects, first cleat can be moveable relative to the accessory.

In some aspects, the accessory can further include a projection extending outward from the accessory opposite the first cleat, the projection arranged to selectively engage with an accessory housing to connect the accessory housing to the accessory.

In some aspects, the first corner rail can include a first channel positioned therein.

In some aspects, the second corner rail can include a second channel positioned therein.

In some aspects, the bar can include a first rotatable tab positioned at the first end of the bar, and a second rotatable tab positioned at the second end of the bar, opposite the first end.

In some aspects, the first tab can be arranged to rotate from a first position, where the first tab can be inserted into the first channel, and a second position, where the first tab can be retained within the first channel.

In some aspects, the second tab can be arranged to rotate from a first position, where the second tab can be inserted into the second channel, and a second position, where the second tab can be retained within the second channel.

In some aspects, the bar can include a channel extending therethrough, from the first end to the second end, and wherein the accessory can be arranged to selectively mate the channel of the bar in the second orientation.

In another aspect, a structure is provided that includes a housing having a top wall, a bottom wall, a first sidewall, a second sidewall opposite the first sidewall, a third sidewall positioned between the first sidewall and the second sidewall, and a fourth sidewall opposite the third sidewall, a first corner rail positioned along a first edge between the first sidewall and the third sidewall, a second corner rail positioned along a second edge between the first sidewall and the fourth sidewall, a bar selectively extending between the first and second corner rails, and an accessory arranged to selectively connect to the channel of the bar in a first orientation relative to the housing and a second orientation relative to the housing.

In some aspects, the accessory can include a first cleat positioned at a first end of the accessory, and a second cleat positioned at a second end of the accessory, opposite the first end.

In some aspects, first cleat can be moveable relative to the accessory.

In some aspects, the accessory can further include a projection extending outward from the accessory opposite the first cleat, the projection arranged to selectively engage with an accessory housing to connect the accessory housing to the accessory.

In some aspects, the first corner rail can include a first channel positioned therein. In some aspects, the second corner rail can include a second channel positioned therein.

In some aspects, the bar can include a first rotatable tab positioned at the first end of the bar, and a second rotatable tab positioned at the second end of the bar, opposite the first end. In some aspects, the first tab can be arranged to rotate from a first position, where the first tab can be inserted into the first channel, and a second position, where the first tab is retained within the first channel.

In some aspects, the second tab can be arranged to rotate from a first position, where the second tab can be inserted into the second channel, and a second position, where the second tab is retained within the second channel.

In some aspects, the bar can include a channel extending therethrough, from a first end to a second end.

In another aspect, a stackable container system is provided that includes a plurality of stackable containers including at least a first container and a second container, the first container being releasably connectable on top of the second container, each container including a container portion and a lid portion, a bottom of the container portion having a first connection portion, the lid portion having a second connection portion that is connectable with the first connection portion, the first and second connection portions having mutually engageable pivotable connection elements, the pivotable connection elements including a first pivot region on the first connection portion and a second pivot region on the second connection portion, the first and second connection portions further having mutually engageable locking elements, the locking elements including a first locking element on the first connection portion and a second locking element on the second connection portion, the first and second connection portions being releasably connectable to one another by engaging the mutually engageable pivotable connection elements, to create a pivotal engagement between the first and second containers, and pivoting the first container relative to the second container about the mutually engageable pivotable connection elements until the first locking element on the first connection portion lockingly engages with the second locking element on the second connection portion, wherein the mutually engageable pivotable connection elements and the locking engagement between the first locking element and the second locking element cooperate to releasably lock the first container with the second container.

In some aspects, the mutually engageable pivotable connection elements can include a first tooth on the first connection portion and a second tooth on the second connection portion, the first connection portion having a first opposing surface spaced from the first tooth, the second connection portion having a second opposing surface spaced from the second tooth, wherein the first tooth and the first opposing surface can define a first gap, the first gap including a first distance between the first tooth and the first opposing surface, and the space between the second tooth and the second opposing surface can define a second gap, the second gap including a second distance between the second tooth and the second opposing surface, wherein the first tooth can have a first length, and the second tooth can have a second length, wherein the first tooth can have a first thickness and the second tooth can have a second thickness, wherein the first gap can have a first depth and the second gap can have a second depth, wherein the dimensions of the first depth, the second depth, the first distance, the second distance, the first thickness, the second thickness, the first length, and the second length can enable the first tooth to be received in the second gap and the second tooth to be received in the first gap to provide for the mutually pivotable engagement.

In another aspect, a stackable container system is provided that includes a plurality of stackable containers including at least a first container and a second container, the first container being releasably connectable on top of the second container, each container including a container portion and a lid portion, a bottom of the container portion having a first connection portion, the lid portion having a second connection portion that is connectable with the first connection portion, the first and second connection portions including mutually engageable locking elements, the locking elements including a first locking element on the first connection portion and a second locking element on the second connection portion, a lock assembly including (i) a user actuatable member arranged to be actuated by a user and (ii) the first locking element on the first connection portion, the lock assembly arranged to be movable between a lock position in which the first locking element is arranged to lockingly engage with the second locking element on the second connection portion and a release position in which the first locking element disengages from the second locking element so as to release the first container from the second container, wherein the lock assembly further including a lock open member, the lock open member includes a first position and a second position, wherein the lock assembly is arranged to enable single-handed operation to lock the first container with the second container and to release and remove the first container from the second container, wherein, for the single-handed operation, actuation of the user actuatable member causes the lock assembly to be moved to its release portion so as to disengage the first locking element from the second locking element and causes the lock open member to be moved to its first position such that the lock open member engages with portions of the lid portion, wherein the engagement between the lock open member in its first position and the portions of the lid portion provides a retention force that is arranged to maintain the lock assembly to be in its release position, even when the user releases the user actuatable member, to enable removal of the first container from the second container.

In some aspects, once the first container is removed from the second container, as there is no engagement between the lock open member in its first position and the portions of the lid portion, the lock assembly can be moved from its release position to its lock position.

In some aspects, the lock assembly can include a bias member that is arranged to bias the lock assembly between its lock position and its release position.

In some aspects, the lock assembly can further include a lock open bias member operatively connected to the lock open member, wherein, in its first position, the lock open member can be arranged to be biased away from the lock assembly by the lock open bias member, wherein, in its second position, the lock open member can be arranged to be biased against the lock open bias member.

In some aspects, the stackable container system can include (1) a stack arrangement in which the first container is releasably connected on top of the second container, the lock assembly is in its lock position in which the first locking element lockingly engages with the second locking element on the second connection portion, and the lock open member is in its second position, and (2) a release arrangement in which, upon the actuation of the user actuatable member, the lock assembly is moved to its release position so as to release the first container from the second container, and the lock open member is moved to its first position such that the lock open member engages with the portions of the lid portion.

In some aspects, the portions of the lid portion can be first portions of the lid portion, wherein, when the stackable container system is in the stack arrangement, the lock open member can be pressed against the bias of the lock open bias member by second portions of the lid portion, wherein the second portions of the lid portion can be different from the first portions of the lid portion.

In some aspects, the stackable container system can further include a standby arrangement in which the first container is ready to be releasably connected on top of the second container, the lock assembly is in its lock position, and the lock open member is in its first position.

In some aspects, the lock assembly can include a rotatable lever lock assembly that is arranged to be pivotable about a pivot axis, wherein the user actuatable member can include a actuator, wherein the actuator can be disposed on a first side of the pivot axis, wherein the first locking element can be disposed on a second side of the pivot axis.

In some aspects, the first locking element can be one of a one or more first locking elements, wherein, along the pivot axis, the lock open member can be disposed between the first locking elements, wherein the lock open member can be one of one or more lock open members, each lock open member can include an associated lock open bias member, wherein the lock open member can be disposed on the second side of the pivot axis, and wherein, along the pivot axis, the one or more first locking elements can be disposed on both sides of the actuator.

In some aspects, the lock assembly can be a push button lock assembly that is arranged to be linearly movable along an axis, and wherein the user actuatable member can include a push button that is arranged to moveable along the axis.

In some aspects, the retention force can be arranged to prevent the lock assembly from moving back to its lock position, even when the user releases the user actuatable member, to enable removal of the first container from the second container.

In another aspect, a container system is provided that includes a plurality of containers including at least a first container, a second container, and a third container, the second and third container each arranged to releasably connect on top of the first container, the first and third container each arranged to releasably connect on top of the second container. The first and second containers each include a bottom portion and a top portion, the bottom portion of the first container having a first bottom connection portion with a first bottom connector, the top portion of the first container having a first top connection portion with a first top connector, the bottom portion of the second container having a second bottom connection portion with a second bottom connector, the top portion of the second container having a second top connection portion with a second top connector, the first container being selectively connectable to the second container in at least two mating arrangements i) wherein the first bottom connector is matingly connected to the second top connector, and ii) wherein the second bottom connector is matingly connected to the first top connector, the third container including a top portion having a third top connector and a bottom portion having a third bottom connector, the third container being selectively connectable to i) the first container wherein the third bottom connector is connected to the first top connector in a mating arrangement, and ii) the second container wherein the third bottom connector is connected to the second top connector in a mating arrangement, wherein the first bottom connector and third top connector have a non-mating arrangement preventing the first bottom connector from being connected to the third top connector.

In some aspects, the first bottom connector can include a first bottom tooth with a first thickness, wherein the third connector can include a gap distance, wherein the gap distance can be arranged to be less than the first thickness of the first bottom tooth to prevent connection between the third top connector and the first bottom connector.

In some aspects, the first top connector can further include a first top tooth having a second thickness, the third bottom connector can include a second gap distance, and wherein the second gap distance can be arranged to be equal to or greater than the second thickness of the first top tooth to allow connection of the third bottom connector and the first top connector.

In some aspects, the first bottom connection portion and second bottom connection portion can each further include a movable lock member, and wherein the movable lock member can be movable between a locked arrangement and a released arrangement with respect to either i) the first top connection portion of the first container or ii) the second top connection portion of the second container.

In some aspects, the third bottom connection portion can further include a movable lock member, and wherein the movable lock member can be movable between a locked arrangement and a released arrangement with respect to the first top connection portion of the first container or the second top connection portion of the second container.

In some aspects, the system can further include a fourth container, the fourth container including a top portion having a fourth top connector and a bottom portion having a fourth bottom connector, the fourth container being selectively connectable to i) the first container wherein the fourth bottom connector is connected to the first top connector in a mating arrangement, ii) the second container wherein the fourth bottom connector is connected to the second top connector in a mating arrangement, and iii) the third container wherein the fourth bottom connector is connected to the third top connector in a mating arrangement.

In another aspect, a stackable component system is provided that includes a plurality of stackable components including at least a first component and a second component, the first component including a first connection portion, the second component including a second connection portion that is connectable with the first connection portion of the first component, the first and second connection portions including a first connector on the first connection portion and a second connector on the second connection portion, the first and second connection portions further having mutually engageable lock elements, the lock elements including a first lock element on the first connection portion and a second lock element on the second connection portion, and wherein the first lock element and/or the second lock element includes a movable lock member, wherein the movable lock member is movable between a locked arrangement and a released arrangement, the first and second components being releasably connectable to one another in at least two arrangements, including: i) a first arrangement wherein the first connector of the first component is connected to the second connector of the second component, and the first lock element of the first component is connected to the second lock element of the second component, and ii) a second arrangement wherein the first lock element of the first component is connected to the second connector of the second component, and the first connector of the first component is connected to the second lock element of the second component.

In some aspects, the first lock element of the first component can include the movable lock member, wherein the movable lock member of the first lock element can be arranged to be moved into the locked arrangement with respect to the second lock element of the second component when the components are in the first arrangement, and wherein the movable lock member of the first component can be arranged to be moved into the locked arrangement with respect to the second connector of the second component when the components are in the second arrangement.

In some aspects, the second connection portion can further include a first aperture, and wherein the first lock element and first connector can each be disposed within the first aperture of the second connection portion in both the first and second arrangements.

In some aspects, the second connector of the second component and the second lock element of the second component can each include a top surface and a bottom surface, and wherein the first lock element and the first connector can each extend above the top surface and below the bottom surface of both the second lock element and the second connector.

In some aspects, the second connection portion can further include a third connector, wherein the first and second components can be releasably connectable to one another in at least three arrangements, including: iii) a third arrangement wherein the first lock member of the first component is connected to the third connector of the second component, and the first connector of the first component is connected to the second lock element and/or the second connector of the second component.

In some aspects, the second connection portion can further include a third connector and a third lock element, wherein the first and second components can be releasably connectable to one another in at least four arrangements, including: iii) a third arrangement wherein the first connector of the first component is connected to the third connector of the second component, and the first lock element of the first component is connected to the third lock element of the second component, and iv) a fourth arrangement wherein the first lock element of the first component is connected to the third connector of the second component, and the first connector of the first component is connected to the third lock element of the second component.

In some aspects, the second connection portion can further include a fourth connector and a fourth lock element, wherein the first and second components can be releasably connectable to one another in at least six arrangements, including: v) a fifth arrangement wherein the first connector of the first component is connected to the fourth connector of the second component, and the first lock element of the first component is connected to the fourth lock element of the second component, and vi) a sixth arrangement wherein the first lock element of the first component is connected to the fourth connector of the second component, and the first connector of the first component is connected to the fourth lock element of the second component.

In some aspects, the second connection portion can further include a fifth connector and a fifth lock element, wherein the first and second components can be releasably connectable to one another in at least eight arrangements, including: vii) a seventh arrangement wherein the first connector of the first component is connected to the fifth connector of the second component, and the first lock element of the first component is connected to the fifth lock element of the second component, and viii) an eighth arrangement wherein the first lock element of the first component is connected to the fifth connector of the second component, and the first connector of the first component is connected to the fifth lock element of the second component.

In some aspects, the second connection portion can further include a first aperture, and wherein the first lock element and first connector can each be disposed within the first aperture of the second connection portion in each of the first through eighth arrangements.

In another aspect, a stackable container system is provided that includes a plurality of stackable containers including at least a first container and a second container, the first container being releasably connectable on top of the second container, each container including a container portion and a lid portion, a bottom of the container portion having a first connection portion, the lid portion of one of the containers having a second connection portion that is connectable with the first connection portion of the other of the containers, the first and second connection portions including a first connector on the first connection portion and a second connector on the second connection portion, the first and second connection portions further having mutually engageable lock elements, the lock elements including a first lock element on the first connection portion and a second lock element on the second connection portion, and wherein the first lock element or the second lock element includes a movable lock member, wherein the movable lock member is movable between a locked arrangement and a released arrangement, the first and second containers being releasably connectable to one another in at least two arrangements, including i) a first arrangement wherein the first connector of the first container is connected to the second connector of the second container, and the first lock element of the first container is connected to the second lock element of the second container, and ii) a second arrangement wherein the first lock element of the first container is connected to the second connector of the second container, and the first connector of the first container is connected to the second lock element of the second container.

In some aspects, the first lock element of the first container can include a movable lock member, wherein the movable lock member of the first lock element can be arranged to be moved into the locked arrangement with respect to the second lock element of the second container when the containers are in the first arrangement, and wherein the movable lock member of the first container can be arranged to be moved into the locked arrangement with respect to the second connector of the second container when the containers are in the second arrangement.

In some aspects, the system can further include at least a third container, the third container arranged to be positioned in side-by-side relationship with the second container, the third container including a third connection portion connectable with the first connection portion of the first container at the same time that the second connection portion of the second container is connected to the first connection portion of the first container.

In some aspects, the system can further include at least a third container, the third container arranged to be positioned in side-by-side relationship with the first container, the third container including a third connection portion connectable with the second connection portion of the second container at the same time that the first connection portion of the first container is connected to the second connection portion of the second container.

In some aspects, the second connection portion of the second container can include at least one additional second connector and at least one additional second lock element, and wherein the first container can be arranged to be connected to the second container at a different position on the second container by connecting the first connector and first lock element of the first connection portion to the additional second connector and the additional lock element of the second connection portion.

In some aspects, the lid portion of the first container can include a second connection portion.

In another aspect, a connection assembly is provided that includes a first body having a plurality of openings formed therein and spaced apart from one another; a second body having a plurality of connectors, each connector being arranged to be received in one of the plurality of openings, and each connector having an overhang arranged to extend over a portion of the first body adjacent to the opening to engage the second body with the first body, at least one lock positioned adjacent to at least one of the plurality of connectors, the lock being movable between an extended position in which the lock is arranged to extend into the at least one of the plurality of openings when the plurality of connectors are received in the plurality of openings with the overhang extending over the portion of the first body to engage the second body with the first body, and a retracted position in which the lock is retracted from the at least one of the plurality of openings, the at least one lock preventing disengagement of the second body from the first body in the extended position, and the lock allowing disengagement of the second body from the first body in the retracted position.

In some aspects, the assembly can further include an actuator arranged to move the at least one lock between the extended and retracted positions.

In some aspects, the actuator can include a actuator and a rotating lock bar, movement of the actuator being arranged to cause rotation of the lock bar to move the lock between the extended and retracted positions.

In some aspects, the lock can be biased to the extended position.

In some aspects, the plurality of openings can have a polygonal shape, and wherein the lock and the at least one of the plurality of connectors together can have a corresponding polygonal shape.

In some aspects, the first body can be arranged to slide related to the second body to cause the overhang to extend over the portion of the first body adjacent to the opening to engage the second body with the first body.

In some aspects, the first body can have first and second surfaces spaced apart from one another and defining a cavity there between, the plurality of openings being formed in the first surface, and wherein the plurality of connectors can be arranged to extend into the cavity when received in the plurality of openings.

In some aspects, the overhang can be arranged to be positioned within the cavity and to extend over the first surface to engage the first surface.

In some aspects, the second body can have a first surface and a second surface spaced apart from one another and defining a cavity therebetween, the at least one lock being arranged to be at least partially received in the cavity in the retracted position.

In some aspects, the at least one lock can include a plurality of locks, and wherein the quantity of connectors can exceed the quantity of locks.

In some aspects, the first body can be arranged to mate with the second body in a first arrangement and a second arrangement, the second arrangement being rotationally or longitudinally offset from the first arrangement.

In another aspect, a container system is provided that includes a plurality of containers including at least a first container a second container, and a third container, the first container arranged to be selectively connectable on top of i) the second container alone, or ii) both the second and the third containers simultaneously by bridging the second and third containers, each container including a container portion and a lid portion, a bottom of the first container portion having a first connection portion, the lid portion of the second container having a second connection portion, and the lid portion of the third container having a third connection portion, the first connection portion of the first container being selectively connectable i) with the second connection portion of the second container alone, or ii) with the second connection portion of the second container and the third connection portion of the third container simultaneously, the first, second, and third connection portions including a first connector on the first connection portion, a second connector on the second connection portion, and a third connector on the third connection portion, the first, second, and third connection portions further having mutually engageable lock elements, the lock elements including a first lock element on the first connection portion, a second lock element on the second connection portion, and a third lock element on the third connection portion, and wherein the first lock element includes a movable lock member, wherein the movable lock member is movable between a locked arrangement and a released arrangement either i) with respect to the second lock element alone, or ii) simultaneously with both the second and third lock elements, wherein the first connector and the first lock element are spaced from one another at a first distance, the second connector and the second lock element are spaced from one another at a second distance, and the third connector and the third lock element are spaced from one another at a third distance, wherein the first connector has first laterally spaced connect surfaces that are spaced from one another at a first connector spacing, and the first lock element has first laterally spaced lock surfaces that are spaced from one another at a first lock spacing, wherein the second connector has second laterally spaced connect surfaces that are spaced from one another at a second connector spacing, and the second lock element has second laterally spaced lock surfaces that are spaced from one another at a second lock spacing, wherein the third connector has third laterally spaced connect surfaces that are spaced from one another at a third connector spacing, and the third lock element has third laterally spaced lock surfaces that are spaced from one another at a third lock spacing, wherein the first distance, second distance, third distance, first connector spacing, second connector spacing, third connector spacing, first lock spacing, second lock spacing and third lock spacing have a spacing therebetween to enable the first connector and the first lock element to be selectively connectable to either i) the second connection portion alone, or ii) simultaneously to the second connection portion and the third connection portion.

In some aspects, the first and second containers can be releasably connectable to one another in at least two arrangements, including i) a first arrangement wherein the first connector of the first container is connected to the second connector of the second container, and the first lock element of the first container is connected to the second lock element of the second container, and ii) a second arrangement wherein the first lock element of the first container is connected to the second connector of the second container, and the first connector of the first container is connected to the second lock element of the second container.

In some aspects, the first lock element of the first container can include the movable lock member, and wherein the movable lock member of the first lock element can be arranged to be moved into the locked arrangement with respect to the second lock element of the second container when the containers are in the first arrangement, and wherein the movable lock member of the first container can be arranged to be moved into the locked arrangement with respect to the second connector of the second container when the containers are in the second arrangement.

In some aspects, the first distance, second distance, and third distance can be measured in a first direction, the first connector spacing, second connector spacing, third connector spacing, first lock spacing, second lock spacing, and third lock spacing can be spaced in a second direction that is perpendicular to the first direction.

In some aspects, the first container can include an actuator for selectively moving the movable lock member between the locked arrangement and the released arrangement, and wherein the actuator can be disposed on an external surface of the first container.

In some aspects, the first container can be arranged to selectively connect by being placed down on top of i) the second container alone, or ii) both the second and the third containers simultaneously by bridging the second and third containers.

In some aspects, the second lock element can include a movable lock member, wherein the movable lock member can be movable between a locked arrangement and a released arrangement i) with respect to the first lock element alone, ii) with respect to the third lock element alone, or iii) simultaneously with both the first and third lock elements, and wherein the third lock element can include a movable lock member, wherein the movable lock member can be movable between a locked arrangement and a released arrangement i) with respect to the first lock element alone, ii) with respect to the second lock element alone, or iii) simultaneously with both the first and second lock elements.

In another aspect, a service component system is provided that includes a plurality of service components including at least a first service component, a second service component, and a third service component, the first service component arranged to be selectively connectable on top of i) the second service component alone, or ii) both the second and the third service components simultaneously by bridging the second and third service components, each service component including a bottom portion and a top portion, the bottom portion of the first service component having a first connection portion, the top portion of the second service component having a second connection portion, and the top portion of the third service component having a third connection portion, the first connection portion of the first service component being selectively connectable i) with the second connection portion of the second service component alone, or ii) with the second connection portion of the second service component and the third connection portion of the third service component simultaneously, the first, second, and third connection portions including a first connector on the first connection portion, a second connector on the second connection portion, and a third connector on the third connection portion, the first, second, and third connection portions further having mutually engageable lock elements, the lock elements including a first lock element on the first connection portion, a second lock element on the second connection portion, and a third lock element on the third connection portion, and wherein the first lock element includes a movable lock member, wherein the movable lock member is movable between a locked arrangement and a released arrangement either i) with respect to the second lock element alone, or ii) simultaneously with both the second and third lock elements, wherein the first connector and the first lock element are spaced from one another at a first distance, the second connector and the second lock element are spaced from one another at a second distance, and the third connector and the third lock element are spaced from one another at a third distance, wherein the first connector has first laterally spaced connect surfaces that are spaced from one another at a first connector spacing, and the first lock element has first laterally spaced lock surfaces that are spaced from one another at a first lock spacing, wherein the second connector has second laterally spaced connect surfaces that are spaced from one another at a second connector spacing, and the second lock element has second laterally spaced lock surfaces that are spaced from one another at a second lock spacing, wherein the third connector has third laterally spaced connect surfaces that are spaced from one another at a third connector spacing, and the third lock element has third laterally spaced lock surfaces that are spaced from one another at a third lock spacing, wherein the first distance, second distance, third distance, first connector spacing, second connector spacing, third connector spacing, first lock spacing, second lock spacing and third lock spacing have a spacing therebetween to enable the first connector and the first lock element to be selectively connectable to either i) the second connection portion alone, or ii) simultaneously to the second connection portion and the third connection portion.

In some aspects, the second connection portion can further include an inner second connector and an inner second lock element disposed between the second connector and second lock element, wherein the inner second connector and inner second lock element can be spaced from one another at an inner second distance, wherein the inner second distance can have a spacing therebetween to enable a fourth connector and a fourth lock element of a fourth service component to be selectively connectable to the second connection portion.

In some aspects, the third connection portion can further include an inner third connector and an inner third lock element disposed between the third connector and third lock element, and wherein the inner third connector and inner third lock element can be spaced from one another at an inner third distance, wherein the inner third distance can have a spacing therebetween to enable the fourth connector and fourth lock element to be selectively connectable to either i) the third connection portion alone, or ii) simultaneously to the second connection portion and the third connection portion.

In some aspects, the first service component can be connected to both the second and third service components simultaneously by bridging the second and third service components, while simultaneously, the fourth connector and fourth lock element can be connected to the third connection portion.

In another aspect, a connection assembly is provided that includes a first body having a plurality of openings formed therein, each opening having at least a first edge and a second edge; a second body having a face, and a plurality of connectors extending from the face, each connector being arranged to be received in one of the plurality of openings, and each connector having a lock and a lip portion arranged to extend over the face; wherein, when the connectors are received in the openings, the lock is movable between at least two arrangements, including i) an unlocked arrangement wherein the lock does not extend past the second edge, and ii) a locked arrangement wherein at least a portion of the lip portion extends past the first edge and the lock extends past the second edge wherein, in the locked arrangement, the lock prevents disengagement of the second body from the first body.

In some aspects, the plurality of openings can be spaced apart in a grid arrangement.

In some aspects, the connector can further include an aperture, and wherein the lock can extend outwardly from the aperture when it is in the locked arrangement. In some aspects, the connector can further include a corridor, and wherein the lock can be movable through the corridor when it moves between the locked and unlocked arrangements. In some aspects, the corridor can define a linear path which extends over the face at an angle between 5 degrees and 80 degrees. In some aspects, the corridor can define a linear path which extends over the face at an angle between 45 degrees and 20 degrees.

In some aspects, the connector can include a first side and a second side, and wherein, when the lock is in the locked arrangement, the lock can extend from the first side and the lip portion of the connector can be positioned on the second side. In some aspects, the first side and second side can be arranged opposite each other. In some aspects, the connector can include a first side, a second side, and a third side, wherein the lock can extend from between the first side and the second side, and wherein the lip portion can be positioned on the third side.

In some aspects, the plurality of openings can each have an opening thickness, and wherein the lip portion can be offset from the face at a distance equal to or greater than the opening thickness.

In some aspects, the second body can include an actuator arranged to move the lock from the locked arrangement to the unlocked arrangement.

In some aspects, the actuator can include a biasing member arranged to bias the lock towards the locked arrangement. In some aspects, the actuator can be a push button actuator including a cam and a follower, and wherein, during actuation from the locked arrangement to the unlocked arrangement, a direction of movement of the push button actuator and a direction of movement of the lock can be less than 90 degrees apart.

In another aspect, a toolbox assembly is provided that includes a plurality of containers including at least a first container and a second container the first container arranged to be selectively connectable on top of the second container, each container including a container portion and a lid portion, a bottom of the first container portion having a first connection portion, the lid portion of the second container having a second connection portion, wherein the first container includes a first end, a second end, and a center located midway between the first end and the second end, wherein the first connection portion includes a row of first laterally spaced connectors that are spaced apart from one another in a direction from the first end toward the second end at a first connector spacing, the first connection portion further including a row of first lock members that are spaced apart from one another in the direction from the first end toward the second end, wherein the second container includes a third end, a fourth end, and a center located midway between the third end and the fourth end, wherein the second connection portion includes a row of second laterally spaced connectors that are spaced apart from one another in a direction from the third end toward the fourth end at the first connector spacing, and a row of second lock members that are spaced apart from one another in the direction from the third end toward the fourth end, wherein the first container is selectively connectable on top of the second container in a number of connection locations, wherein the number of connection locations includes at least i) a left location wherein the center of the first container is located above the lid portion of the second container between the third end and the center of the second container, ii) a central location wherein the center of the first container is located above the lid portion of the second container and the center of the second container is generally aligned with the center of the first container, and iii) a right location wherein the center of the first container is located above the lid portion of the second container between the fourth end and the center of the second container, wherein, in each of the connection locations, at least one of the first lock members is engaged with one of the second lock members.

In some aspects, the number of connection locations can further include iv) a far-left location wherein the center of the first container overhangs past the third end of the second container, and v) a far-right location wherein the center of the first container overhangs past the fourth end of the second container.

In some aspects, the far-left location can include a connection location wherein the first laterally spaced connector closest to the second end can be connected to the second laterally spaced connector closest to the third end, and wherein the far-right location can include a connection location wherein the first laterally spaced connector closest to the first end can be connected to the second laterally spaced connector closest to the fourth end.

In some aspects, the left location can include a connection location wherein the first end of the first container can overhang past the third end of the second container, and wherein the right location can include a connection location wherein the second end of the first container can overhang past the fourth end of the second container.

In some aspects, the far-left location, the left location, the right location, and the far-right location can each include a plurality of connection locations.

In some aspects, the number of connection locations can satisfy the following equation, C≥FLSC+SLSC−1, wherein C is the number of connection locations, wherein FLSC is a total number of first laterally spaced connectors on the first container, wherein SLSC is a total number of second laterally spaced connectors on the second container.

In some aspects, the plurality of containers can further include a third container, the lid portion of the third container having a third connection portion, wherein the third container can include a fifth end, a sixth end, and a center located midway between the fifth end and the sixth end, wherein the third connection portion can include a row of third laterally spaced connectors that are spaced apart from one another in a direction from the fifth end toward the sixth end at the first connector spacing, the third connection portion further including a row of third lock members that are spaced apart from one another in the direction from the fifth end toward the sixth end, wherein, the first container can be simultaneously connected to the second container and the third container, bridging the second and third containers in the far-left location and in the far-right location.

In some aspects, the first container can be simultaneously connected to the second container and the third container, bridging the second and third containers in the left location and the right location.

In some aspects, the first container can further include a lock actuator, wherein the row of first lock members can include at least one movable lock member, selectively movable by the actuator between a locked position and an unlocked position, and wherein the at least one movable lock member can prevent separation of the first and second containers in the locked position.

In some aspects, the first container can further include a lock actuator, wherein the row of first lock members can include at least one movable lock member, selectively movable by the actuator between a locked position and an unlocked position, and wherein the at least one movable lock member can prevent separation of the first container from both the third and second containers in the locked position.

In some aspects, the first lock members can be spaced apart from one another at the first connector spacing. In some aspects, the second lock members can be spaced apart from one another at the first connector spacing. In some aspects, the third lock members can be spaced apart from one another at the first connector spacing.

In some aspects, the center of the first container can define a first plane that is generally parallel and midway between the first end and the second end, wherein the center of the second container can define a second plane that is generally parallel and midway between the third end and fourth end, and wherein the first plane and the second plane can be generally coplanar when the center of the second container is generally aligned with the center of the first container.

In some aspects, the row of first laterally spaced connectors can skip at least one first laterally spaced connector, and wherein the connectors positioned closest to the center of the first container can be spaced apart from each other at two times the first connector spacing.

In another aspect, a storage system is provided that includes a container including four sides, a top, and a bottom. The storage system can include a crossrail connected to the container and extending alongside one of the sides, and in spaced relation to said one of the sides. The top can have at least one connector portion. The storage system can include an accessory having a releasable connector, the releasable connector arranged to releasably connect to the at least one connector portion, and to releasably connect to the crossrail along a continuous connecting region of the crossrail.

In some aspects, the top can include a plurality of connector portions, wherein each connector portion can provide a discrete connection location, wherein the releasable connector can be arranged to releasably connect to each connector portion.

In some aspects, the top can have at least five connector portions.

In some aspects, the top of the container can be arranged to simultaneously connect to i) a bottom of a second container and ii) the accessory, wherein the second container and the accessory can be connected to the top of the container at different connection locations.

In some aspects, the accessory can include movable lock arranged to selectively engage with both the crossrail and the at least one connector portion, and wherein engagement of the movable lock with either the crossrail or the at least one connector portion can prevent the release of the accessory from the respective crossrail or at least one connector portion.

In some aspects, the storage system can further include a second crossrail connected to the container and extending alongside one of the sides, and in spaced relation to said one of the sides, and wherein the second crossrail can be longer than the crossrail.

In some aspects, the second crossrail can extend along one of the sides adjacent to the one of the sides which the crossrail can extend along.

In some aspects, each of the four sides can include at least two vertical rails, and wherein each of the four sides can be adapted to receive and connect to the crossrail via the at least two vertical rails thereof.

Advantages may include one or more of the following. The impact tools and methods may lead to improved control and speed of fastening operation, while increasing power delivered when needed for impacting and reducing the use of unneeded power, thus saving energy, being more efficient, and protecting tool components from damage. These and other advantages and features will be apparent from the description, the drawings, and the claims.

### BRIEF DESCRIPTION OF THE DRAWINGS

The numerous advantages of this systems described herein may be better understood by those skilled in the art by reference to the accompanying Figures. In the drawings, like reference numerals designate corresponding parts throughout the several views.

FIG. 1 illustrates various configurations of a stackable container system in accordance with the systems described herein;

FIG. 2 is an exemplary stackable container that is configured to be used in the stackable container system of FIG. 1;

FIG. 3 is another exemplary stackable container that is configured to be used in the stackable container system of FIG. 1;

FIG. 4 is a rear perspective view of the stackable container of FIG. 3 showing a first connection portion on a bottom of a container portion of the stackable container, wherein a first pivot region and a first pivotable connection element of the first connection portion are shown;

FIG. 5 is a side view of the container portion of the stackable container of FIG. 3 showing the first connection portion on the bottom of the container portion of the stackable container, wherein the first pivot region, the first pivotable connection element, and a first locking element of the first connection portion are also shown;

FIG. 6 is a sectional side view of a lid portion of the stackable container of FIG. 3 showing a second connection portion, a second pivot region, a second pivotable connection element, and a second locking element of the second connection portion;

FIG. 7 is a left side perspective view of a lid portion of the stackable container of FIG. 3;

FIG. 8 is an exemplary side view of a first container being releasably connected and stacked on top of a second container;

FIGS. 9A-9B are side views of a locking element of the a container in a standby (ready for stacking) state/configuration and in an unlock state/configuration;

FIGS. 9C-9D illustrates a side view of the locking element of FIGS. 9A-9B in an open configuration, and its corresponding lock open member and spring, respectively;

FIG. 10A is a table defining different stacking states/configurations of the first and the second containers in accordance with the systems described herein;

FIGS. 10B-10E illustrate various views of the locking elements of the first and second containers and the lock open members when the first and the second containers are in different stacking states/configurations described in FIG. 10A;

FIGS. 10F-10G illustrate a lock assembly in accordance with the systems described herein;

FIGS. 11A-11B illustrate locking elements of one of the first and second containers in locked and locked configurations in accordance with the systems described herein;

FIGS. 11C-11E illustrate a locking assembly of one of the first container and the second container in its exploded configuration and its assembled configuration in accordance with the systems described herein;

FIG. 12 illustrates different views of the second connecting portion and a central rail portion on the lid portion of FIG. 3;

FIG. 13 illustrates the first container and the second container in locked and unlocked configurations in accordance with the systems described herein;

FIGS. 14-16 are perspective views, front views, and side views, respectively, of the first/upper container of FIG. 13 releasably connected and stacked on top of the second/lower container of FIG. 13, and the first container disconnected/unstacked from the second container;

FIG. 17A illustrates various sectional views of the first container of FIG. 13 and the second container of FIG. 13 in a connected (stacked) configuration with lock engaged, in a stack released configuration with lock disengaged, and in a disconnected configuration;

FIG. 17B is a perspective view of one of the first and second containers of FIG. 17A and its lock assembly, wherein the lock assembly is in its exploded configuration;

FIG. 17C illustrates various perspective views of the first container and the second container of FIG. 17A in the connected (stacked) configuration with the lock engaged, and in the stack released configuration with the lock disengaged;

FIGS. 18A-18E illustrate dimensions of different containers in accordance with the systems described herein;

FIG. 19 illustrate static teeth and dynamic teeth for different containers in accordance with the systems described herein;

FIG. 20 is an exemplary side view of a first container being releasably connected and stacked on top of a second container in accordance with the systems described herein;

FIG. 21 is a diagrammatic illustration of a container of the container system, which includes connecting teeth in accordance with the systems described herein;

FIGS. 22 and 23 illustrate a plurality of the first containers and/or a plurality of the second containers that are stacked on each other in various configurations in accordance with the systems described herein;

FIG. 24 illustrates two first containers being connected to each other, two second containers being connected to each other, or a first container being connected to a second container in accordance with the systems described herein;

FIG. 25 is another diagrammatic illustration of a container of the container system, which includes connecting teeth in accordance with the systems described herein;

FIG. 26 illustrates two exemplary containers before being connected to each other in accordance with the systems described herein;

FIG. 27 illustrates two exemplary containers after being connected to each other in accordance with the systems described herein;

FIG. 28 is a diagrammatic illustration of various connections between various containers stacked on top of one another in accordance with the systems described herein, wherein FIG. 28 also illustrates that a first/a second container cannot be stacked on top of and connected with a third/a fourth container;

FIG. 29 illustrates a plurality of third/fourth containers stacked on top of and connected with a first/a second container in accordance with the systems described herein;

FIG. 30 illustrates a third/fourth container being stacked on top of and before being connected with a first/a second container in accordance with the systems described herein;

FIG. 31 illustrates a first/a second container cannot be stacked on top of and connected with a third/a fourth container in accordance with the systems described herein;

FIGS. 32, 33, and 34 illustrate an exploded view, an assembled view and a top elevational view, respectively, of a second connection portion in accordance with the systems described herein;

FIG. 35 illustrates a perspective view of a first connection portion and a lock assembly in accordance with the systems described herein;

FIG. 36 illustrates another perspective view of the first connection portion of FIG. 35, where portions of the lock assembly including first lock element(s) and user actuatable member are not shown to better illustrate the other portions;

FIG. 37 is a partially exploded view of the first connection portion and the lock assembly of FIG. 35;

FIG. 38 illustrates portions of the lock assembly of FIG. 35 including user actuatable member and a member connecting the first lock element(s) and the user actuatable member;

FIG. 39 illustrates portions of the lock assembly of FIG. 35 including the user actuatable member, the member connecting the first lock element(s) and the user actuatable member, and the first lock element(s);

FIGS. 40 and 41 illustrate the lock assembly of FIG. 35 in which the lock assembly is in a released configuration in FIG. 40 and in which the lock assembly is in a locked configuration in FIG. 41;

FIGS. 42 and 43 illustrate the first connection portion configured to be disposed on the bottom of the container, wherein the lock assembly is in a released configuration in FIG. 42 and in which the lock assembly is in a locked configuration in FIG. 43;

FIGS. 44A-44C illustrate an exemplary quad (four connector) configuration in accordance with the systems described herein, FIG. 44A illustrates a first connection portion configured to disposed on the bottom of the container and a second connection portion configured to be disposed on the top of the container, FIGS. 44B-44C illustrate another exemplary configuration of first connectors and first lock elements of the first component and second connectors and second lock elements of the second component;

FIGS. 45-52 illustrate exemplary first through eighth configurations in which a first connector of a first component is connected to one of a second through a fifth connector or a second through a fifth lock elements of a second component and a first lock element of a first component is connected to the other of the second through fifth connectors or the second through fifth lock elements of the second component in accordance with the systems described herein;

FIG. 53 is a diagram illustrating three exemplary configurations in which the first and second components may be releasably connectable to one another in accordance with the systems described herein;

FIGS. 54 and 55 illustrate two stacked configurations of the first and second containers in which the first and second containers are stacked in a first configuration and a second configuration, respectively;

FIG. 56 illustrates a stacked configuration of first, second and third containers, wherein the first and third containers are stacked in a first configuration and the second and first containers are stacked in a second configuration;

FIGS. 57-58 illustrate a front and a rear view of a stacked configuration of first, second and third containers, wherein the third container is in a side-by-side relationship with one of the first or second containers and is connected to the other of the first or second containers;

FIGS. 59 and 60 illustrate containers releasably connected to each other in various offset configurations as described herein;

FIGS. 61-64 illustrate various container configurations in accordance with the systems described herein;

FIG. 65 is a perspective view of a second body of a connection assembly in accordance with the systems described herein;

FIG. 66 is a perspective view of a first body of the connection assembly in accordance with the systems described herein;

FIGS. 67 and 68 are perspective views of another exemplary second body of the connection assembly in accordance with the systems described herein, including a lock, an actuator, and a biasing member;

FIG. 69 is a cross-sectional view of a connection assembly in which the connector of the second body is being received in one of the plurality of openings in the first body;

FIGS. 70 and 71 are perspective and cross-sectional views, respectively of the connection assembly in which the connector of the second body is received in the opening of the first body and the lock of the connector is in the locked configuration to prevent the disengagement of the second body from the first body;

FIGS. 72-73 are perspective views of the connector of the second body in which the actuator is actuated to move the lock from the locked configuration to an unlocked configuration;

FIG. 74 is a cross-sectional view of the connection assembly in which the connector of the second body is received in the opening of the first body and the lock of the connector is in the unlocked configuration;

FIG. 75 is a front view of another exemplary container comprising a container portion and a lid portion in accordance with the systems described herein;

FIG. 76 is a top perspective view of a portion of the lid portion of the container of FIG. 75;

FIG. 77 is a top elevational view of the container of FIG. 75 including two rows of laterally spaced lock members of the lid portion;

FIG. 78 is a bottom elevational view of the container of FIG. 75 including two rows of laterally spaced lock members of the container portion;

FIG. 79 is a diagrammatic illustration of a toolbox assembly in which a first container is selectively connectable on top of a second container in a left location wherein a center of the first container is located above a lid portion of the second container between a third end and a center of the second container;

FIG. 80 is another diagrammatic illustration of a toolbox assembly in which a first container is selectively connectable on top of a second container in a central location wherein the center of the first container is located above a lid portion of the second container and the center of the second container is generally aligned with the center of the first container;

FIG. 81 is another diagrammatic illustration of a toolbox assembly in which a first container is selectively connectable on top of a second container in a right location wherein the center of the first container is located above a lid portion of the second container between the fourth end and the center of the second container;

FIGS. 82A and 82B are additional diagrammatic illustrations of a toolbox assembly in which a first container is selectively connectable on top of a second container in a plurality of locations with the left locations;

FIG. 83 is another diagrammatic illustration of a toolbox assembly having a first, a second and a third containers, wherein the first container is simultaneously be connected to the second container and the third container, bridging the second and third containers in the far-left location and in the far-right location;

FIG. 84 is another diagrammatic illustration of a toolbox assembly having a first, a second and a third containers, wherein the first container is simultaneously be connected to the second container and the third container, bridging the second and third containers in the far-left location and in the far-right location;

FIGS. 85-86 are perspective views of a container system in accordance with the systems described herein, where two accessories/small containers are releasably connected to a first crossrail that is releasably connected to a first side of the container, and where a second crossrail that is being releasably connected to a second side of the container;

FIG. 87 illustrates a first accessory releasably connected to the first crossrail that is releasably connected to the first side of the container;

FIG. 88 illustrates a second accessory (or small container) releasably connected to the first crossrail that is releasably connected to the first side of the container;

FIG. 89 illustrates a third accessory releasably connected to the first crossrail that is releasably connected to the first side of the container;

FIG. 90 is a rear view of exemplary crossrail that includes two releasable connectors that are configured to releasably connect to the crossrail to a side of the container;

FIG. 91 is a front view of the crossrail of FIG. 90, where both releasable connectors are shown in their unlocked positions;

FIG. 92 illustrates the third accessory (shown in FIG. 89) being releasably connected, using a releasable connector, to at least one connector portion of a top of a container and at a first connection location;

FIG. 93 illustrates the third accessory (shown in FIG. 89) releasably connected to the at least one connector portion of the top of the container and at the first connection location;

FIG. 94 illustrates the first accessory (shown in FIG. 87) releasably connected to the at least one connector portion of the top of the container and at a second connection location, the second connection location being different from the first connection location shown in FIG. 93;

FIG. 95 illustrates a fourth accessory being releasably connected to the crossrail that is releasably connected to the container, wherein the fourth accessory includes a releasable connector, in accordance with the systems described herein, that is configured to releasably connect the fourth accessory to the crossrail;

FIG. 96 is a perspective view of a container system in accordance with the systems described herein, where two accessories/small containers are releasably connected to the at least one connector portion of the top of the (larger) container;

FIG. 97 is a bottom view of the left-side accessory/small container of FIG. 96 and a top view of the right-side accessory/small container of FIG. 96 in accordance with the systems described herein;

FIG. 98 is a perspective view of a container system in accordance with the systems described herein, where an accessory/small container is releasably connected to the at least one connector portion of a top of a larger container;

FIG. 99 is a bottom view of the accessory/small container of FIG. 98 and a releasable connector of the accessory/small container that releasably connects to either the top of the larger container or to the crossrail that is connected to the larger container;

FIG. 100 is a perspective view of an exemplary container in accordance with the systems described herein; and

FIG. 101 is a cross-section view of a portion of the container of FIG. 100 taken along an axis 101-101.

FIG. 102 is a perspective view of an exemplary container in accordance with the systems described herein;

FIG. 103 illustrates various top views of a container system showing a plurality of stacking configurations for a plurality of containers on a top surface of the container of FIG. 102;

FIG. 104 shows an adapter or mount which can be used with the systems described herein; and

FIG. 105 is a top elevation view of an array of a plurality of the adapters/mounts of FIG. 104.

Corresponding reference names and/or numerals indicate corresponding parts throughout the several views of the drawings.

### DETAILED DESCRIPTION

Carpenters, handy persons, other tradesmen (electricians, plumbers, internal design, etc.) often need to carry multiple containers to job sites, and these containers typically need to be connected together for transport. Traditional container systems rely on latches that require two hands to operate; one hand to hold a swinging portion with a hook, and another hand to engage it with a protruding portion on the second container. This two-handed operation is cumbersome when workers are trying to quickly set up or pack up their tools. Many conventional stacking systems only allow containers to connect in one specific position and orientation, limiting flexibility in how tools and materials can be organized. Additionally, traditional systems having various sized containers provide no structural features that prevent smaller, weaker containers from being overloaded with heavier containers stacked on top of them, which can lead to structural failure and potential injury. Furthermore, existing container systems lack versatile exterior mounting options for accessories like lights, chargers, or specialized tool holders, or other containers, which are frequently used, forcing workers to store these items within larger containers or carry separate loads.

The container systems described herein address these limitations by providing comprehensive and modular storage and transport solutions. The container systems described herein include complementary connection features provided on tops and bottoms of the separate structures that allow for the structures to be securely stacked and unstacked in a one-handed operation. The systems also allow for the structures to be connected to one another in multiple locations and orientations, rather than just one fixed position, significantly increasing modular versatility of the systems. The systems described herein also include stay-open release mechanisms that include for actuators (e.g., levers, handles, buttons, etc.) of the connection mechanisms which, when actuated while the structures are connected, can be released and maintain in an open position, allowing for the structures to be conveniently separated any time thereafter without having to hold the actuator open. This design eliminates the need for continuous two-handed operation when removing one structure from connection with another, advantageously allowing the operator to use both hands to lift one structure off of the top of another, if needed.

The systems described herein also include structural safety features that prevent overloading on any given structure. The safety features include connection mechanisms on the structures that are specifically designed and sized to prevent larger containers from being stacked on top of smaller containers, which can lead to structural failure and potential injury, thus improving safety of the systems. The structures can also be designed to include exterior rails/channels/tracks that allow for versatile and secure mounting of accessories and accessory mounting bars on the exterior walls of the structures. The accessories can include a wide variety of items, including but not limited to, smaller containers, lights, tools, tool holders, etc. The systems can also include additional accessory bars, which can secured to the exterior rails/channels/tracks (e.g., T-slot rails) of the structure at a variety of positions and orientations on the structures, and accessories can be securely mounted to any position on the accessory bar that is desired.

The systems described herein provide numerous practical advantages for users. The single-handed operation capability significantly improves efficiency and convenience, allowing workers to quickly connect and disconnect containers even when their other hand is occupied. The multiple positioning options provide flexibility in organizing tools and materials, enabling users to customize their setup based on the specific requirements of each job. The stay-open release mechanism eliminates the frustration of trying to hold a release lever while simultaneously lifting heavy containers, reducing physical strain and the risk of dropping valuable tools. The safety features prevent structural failures and potential injuries by ensuring that containers are only stacked in safe configurations. This is particularly important in professional environments where containers may be loaded with heavy tools and materials. The T-slot rail designs and universal accessory systems transform simple storage containers into comprehensive mobile workstations, allowing users to mount a wide array of accessories to the structures, reducing the number of items needed to be carried around and providing easy access to frequently used items. The compatibility between different mounting methods allows users to reconfigure their setup quickly as needs change throughout the workday.

Overall, these systems provide a level of versatility, safety, and ease of use that exceeds traditional container systems, making them particularly valuable for professionals who need reliable, flexible storage solutions that can adapt to changing work requirements while maintaining the security and organization of their tools and materials.

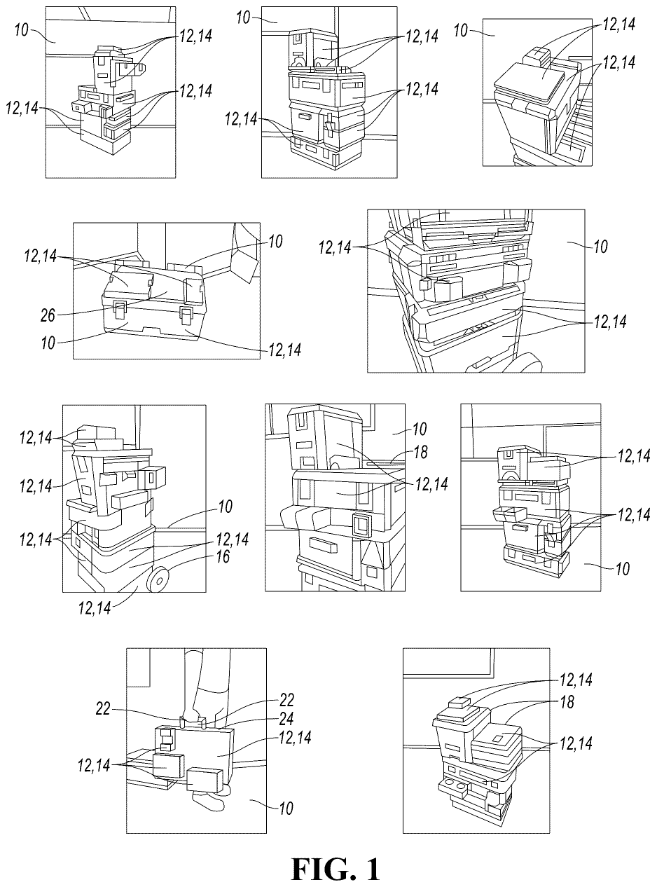

FIGS. 1-3 illustrate various configurations and components of a container system 10 according to the subject matter described herein. The container system 10 may interchangeably referred to as stackable container system 10, transportable container system 10, and transportable and stackable container system 10. The stackable container system 10 comprises a plurality of stackable containers 12, 14 including at least a first container 12 and a second container 14. The number of containers in the container system 10 may vary. Also, as will be described in detail in the discussions below, the sizes, shapes and/or configurations of the first and second containers 12, 14 may vary or may be the same. The first container 12 is releasably connectable on top of the second container 14. That is, the second container 14 may be releasably connectable on top of the first container 12.

In addition to being used for stackable containers, the system 10 may also be used for stackable utilities/items/accessories (e.g., light, radio, fan, charger, cup, flashlight, thermos etc.). That is, such utilities/items/accessories may be configured to be stackable with the system 10. The stackable utilities may include the light, charger, radio, fan, etc. and even may include small accessories like cup, flashlight that connect/stack on top but may not stack under.

The stackable containers described herein may be referred to as stackable utility elements so that they can include stackable containers and/or other stackable utilities/items/accessories. The stackable system 10 may be stackable container system or stackable utilities system.

Referring to FIG. 1, the stackable container system 10 may be a rolling (stackable) container system that may be generally used for transporting articles between working locations and/or to carry a plurality of working tools to a working location. The rolling container system may include adjustable mount structures that enable at least one of the containers to be releasably mounted to the rolling container system, one or more rotatable ground engaging wheels 16 mounted towards the bottom of the rolling container system for rotation about an axis to provide rolling support for the rolling container system, and a manually engageable pulling handle 18. The handle 18 and the one or more ground engaging wheels 16 may be configured to be arranged to enable a user to manually pull the handle 18 generally rearwardly so as to tilt the rolling container system rearwardly to a tilted rolling movement position, thereby enabling the user to roll the rolling container system to a desired location by pushing or pulling the handle 18 in a desired direction. The rolling container system may also include a frame and the at least one container 12, 14 may be connected to the frame. In some aspects, the adjustable mount structures may enable one of the containers 12 to be releasably mounted to (e.g., the frame of) the rolling container system and the other of the containers 14 may releasably connected/stacked on top of the container 12. In some aspects, as shown in FIG. 1, the container system 10 may not have a rolling container system configuration, and the container system 10 (with its stacked containers) may be configured to be transportable using handles of one of the containers.

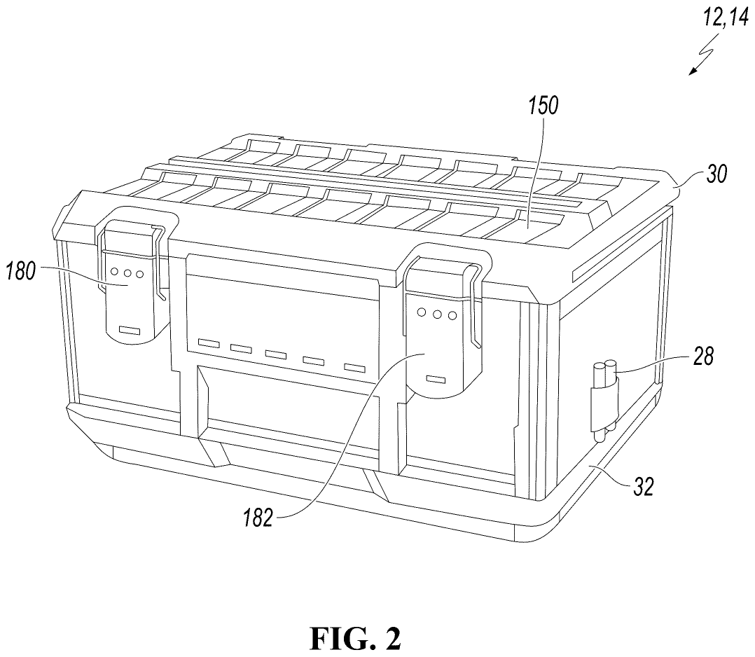

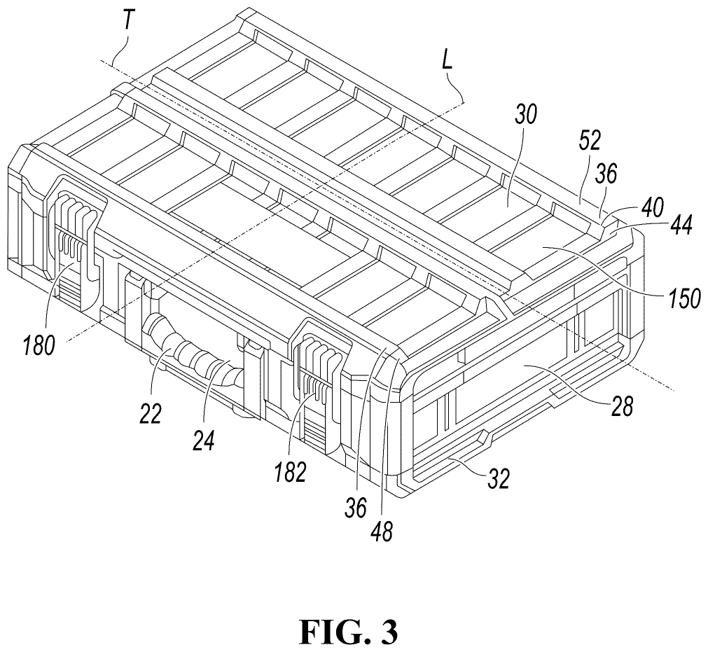

FIG. 2 illustrates an exemplary container 12, 14 that is configured to be used in the stackable container system 10. FIG. 3 illustrates another exemplary container 12, 14 that is configured to be used in the stackable container system 10.

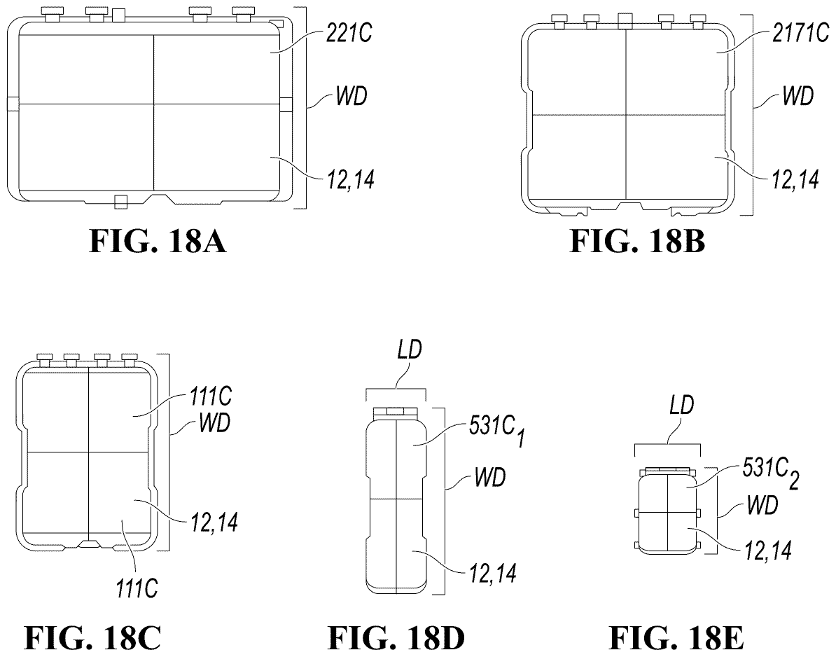

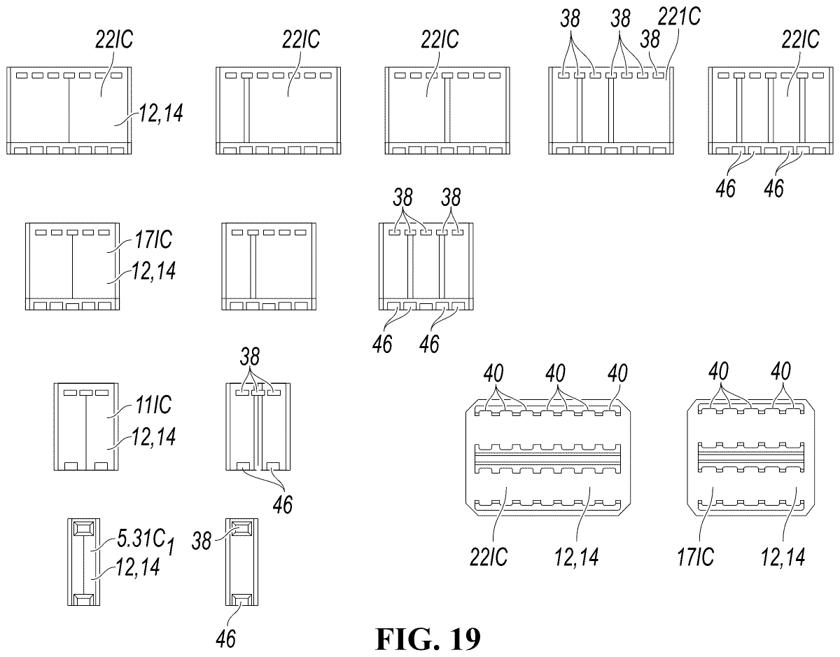

The containers 12, 14 of the stackable container system 10 may have same size, shape and/or configuration or may have different sizes, shapes and/or configurations. For example, the container 12 and the container 14 may have the same size, shape and/or configuration. The container 12 and the container 14 may have different sizes, shapes and/or configurations. FIGS. 18A-18E show various containers 12, 14 having different sizes, shapes and/or configurations. For example, the container 12, 14 in FIG. 18A may include a 22 inch shaped configuration container (referred to as 22 inch container or 22IC), the container 12, 14 in FIG. 18B may include a 17 inch shaped configuration container (referred to as 17 inch container or 17IC), the container 12, 14 in FIG. 18C may include a 11 inch shaped configuration container (referred to as 11 inch container or 11IC), the container 12, 14 in FIG. 18D may include a 5.3 inch shaped configuration container (referred to as 5.3 inch container or 5.3IC₁), and the container 12, 14 in FIG. 18E may include another 5.3 inch shaped configuration container (referred to as another 5.3 inch container or 5.3IC₂). However, it is also realized that the dimensions of the containers of FIGS. 18A-18E may be greater than or less than the exemplary dimensions provided.

As shown, the width dimension WD of the containers 22IC, 17IC, 11IC, and 5.3IC₁ may be the same, but can also vary. In some aspects, the width dimension WD of the containers 22IC, 17IC, 11IC, and 5.3IC₁ may be 385 millimeters, however other dimensions are also realized. The width dimension WD of the container 5.3IC₂ may be different from the width dimension WD of the containers 22IC, 17IC, 11IC, and 5.3IC₁. The width dimension WD of the container 5.3IC₂ may be 170 millimeters, however other dimensions are also realized. The length dimension LD of the container 5.3IC₂ may be the same as the length dimension LD of the container 5.3IC₁. The length dimension LD of the container 5.3IC₂ and the container 5.3IC₁ may be 135 millimeters, however other dimensions are also realized.

Referring to FIG. 1, the stackable container system 10 may be a transportable (stackable) container system that may be generally used for transporting articles between working locations and/or to carry a plurality of working tools to a working location. The container 12, 14 may include one or more handles. In some aspects, each handle may be integrally formed with one or more sides/surfaces of the container 12, 14. In some aspects, each handle may be coupled to and extend from one or more sides/surfaces of the container 12, 14. The container 12, 14 may include a rotatable and/or an extendable pull handle. The container 12, 14 may include a handle 22 that may extend from a top side 26 of the container 12, 14. The handle 22 may extend along the entire length of the top side 26 of the container 12, 14. The container 12, 14 may include a handle 22 that may extend from a front side/surface 24 of the container 12, 14.

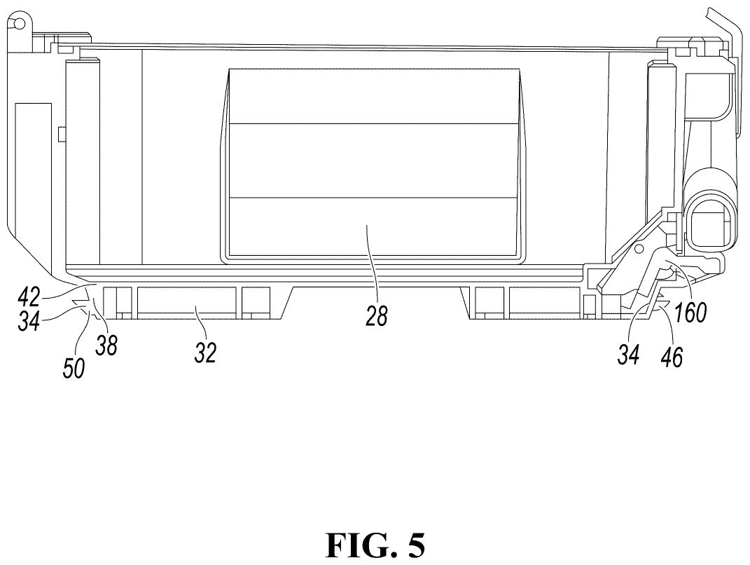

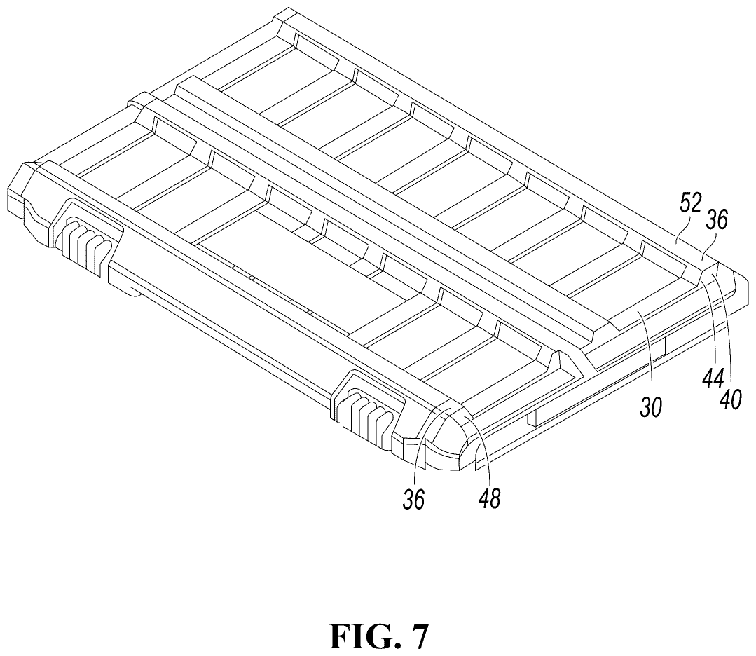

Referring to FIGS. 2-8, each container 12, 14 may include a container portion 28 and a lid portion 30.

Each container 12, 14 may include a bottom 32 having a perimeter edge and at least one side wall extending vertically up from the perimeter edge. The bottom 32 and the at least one side wall define a cavity or a volume within the container 12, 14 for receiving and storing objects therein. The container portion 28 may include the bottom 32 and the at least one side wall extending vertically up from the perimeter edge of the bottom 32.

Each container 12, 14 may include four side walls (e.g., a front wall, a first side wall, a second side wall, and a rear wall) extending vertically up from the perimeter edge of the bottom 32. In one example, these four side walls may be configured in the shape of a rectangle. However, any other four-sided shape is contemplated herein, such as a square, parallelogram, trapezoid, etc. In some aspects, it is also realized that the containers described herein (e.g., containers 12, 14) can be provided with any other number of sides walls, including, but not limited to, single-sided (such as in a circular or oval container), three-sided, five sided, etc. In some aspects, the bottom 32 and the side walls can be integrally formed with one another. Alternatively, the bottom 32 and the side walls may be formed separately and coupled together. In some aspects, the bottom 32 and the side walls are made of plastic, such as high density polyethylene. However, other materials, including metals, alloys, and/or wood can additionally or alternatively be used to form the bottom 32 and the side walls.

The bottom 32 of the container portion 28 has a first connection portion 34. The first connection portion 34 may be disposed on bottom side surfaces of the bottom 32 of the container portion 28. The bottom side surfaces may be transitional surfaces between generally horizontal bottom side and generally vertical sides of the container. The bottom side surfaces may be angled/ramped with respect to the generally horizontal bottom side and the generally vertical sides of the container. These transitional surfaces define first and second regions between the bottom wall and the sidewalls of the container 12, 14. In some aspects, the portable structure may comprise a housing having a top wall, a bottom wall, a first sidewall, and a second sidewall opposite the first sidewall. The housing may correspond to the containers 12, 14 themselves, with the top wall, bottom wall, and sidewalls referring to the various walls of the container. In some aspects, the portable structure may not include a lid portion, but rather may be a container with drawers or other features provided on a sidewall thereof. A first mating element having a cleat portion may be positioned on a first region between the bottom wall and the first sidewall, with the cleat portion extending laterally outward from the first region. The first mating element may correspond to the non-movable connection portion 34 with tooth/cleat 50. The first mating element may be immovably positioned in the first region and may include a plurality of cleats spaced longitudinally, with the plurality of cleats extending parallel to the bottom wall. The cleat portion of the first mating element may include a tapered surface to facilitate engagement with corresponding pockets.

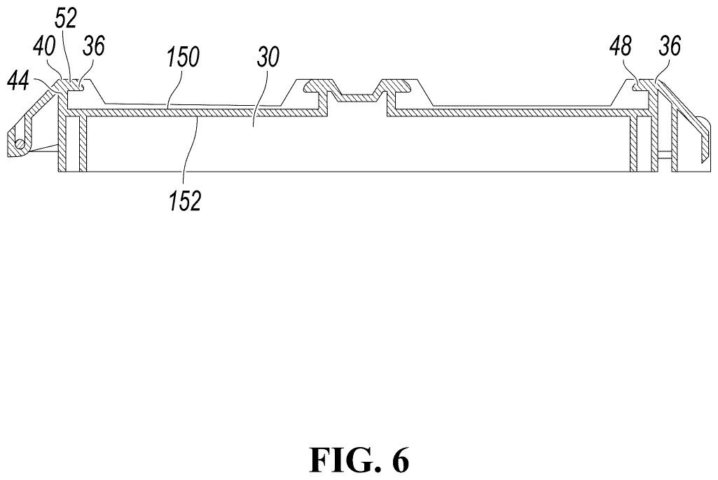

The lid portion 30 of the container 12, 14 may interchangeably referred to as lid. As shown in FIG. 6, the lid portion 30 may include a top side/surface 150 and an opposing bottom side/surface 152.

As shown in FIGS. 2 and 3, the container 12, 14 may also include one or more latching mechanisms 180, 182 disposed on one or more of the side walls. Many different forms of latching mechanism known in the art may be used and included herein. For example, each latching mechanism may include a solid lip and adjustable latch that can be mounted on an outer surface of the particular side wall. The adjustable solid lip section allows a user to easily lift the latch to release the lid portion 30 from the respective side wall. The lid portion 30 may include a mating latch bar or receiving recess that the latch can engage and disengage from. In some aspects, one or more latching mechanisms may be disposed along the front wall, as shown in FIGS. 2 and 3, or along any other side of the container. For example, it is also realized that any one or more of the first side wall, second side wall, and the rear wall may also include one or more latching mechanisms for removably coupling the lid portion 30 to the side wall.

The lid portion 30 may configured to be rotatably (e.g., by way of one or more hinges) and/or removably coupled to the container portion 28 and may be manually adjustable from an open position to a closed position. That is, the lid portion 30 may be configured to move/rotate between the first or closed position and the second or open position. The one or more hinges may be coupled along one side to the rear wall of the container 12, 14 and along the other side to the lid portion 30. Any other known devices for rotatably coupling the container portion 28 and the lid portion 30 may be substituted for the example hinge.

In the closed position of the lid portion 30, at least a portion of the lid portion 30 abuts or otherwise rests upon at least one or more of the side walls of the container portion 28. In the closed position, the lid portion 30 covers or substantially covers the cavity defined by the sides into the container 12, 14 and is disposed orthogonal or substantially orthogonal to one or more of the sides. The bottom side/surface 152 of the lid portion 30 may face the top surface of the bottom 32 of the container 12, 14 when the lid portion 30 is in the closed position. In the open position, the lid portion 30 may be disposed in a less than vertical position. In some aspects, the lid portion 30 in the open position can have a maximum opening position such that it positions the lid portion 30 at an angle short of being vertical. In some aspects, the lid portion 30 in the open position can be vertical or substantially vertical.

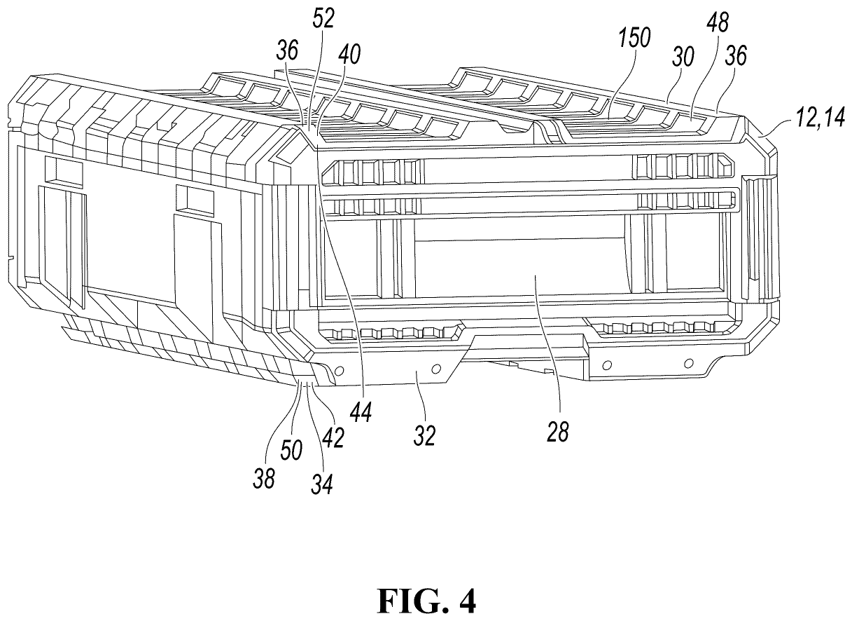

As shown in FIGS. 3-4, the lid portion 30 has a second connection portion 36 that is connectable with a first connection portion 34 provided at a base of another container, as discussed in greater detail below. The second connection portion 36 of the lid portion 30 may be disposed on the upper/top side/surface 150 of the lid portion 30.

The container of the container system 10 may not include a lid portion. In this case, the container may have an upper surface and the second connection portion may be disposed on the upper surface of the container. For example, the container that does not have a lid portion may include units like drawer modules, crates, or other utilities (fan, charger, etc.).

The system 10 may be configured such that a container may be attached to any of the connection elements on the lid.

The first connection portion 34 disposed on the bottom 32 of the container portion 28 of the upper container 12 may be configured to be connectable with the second connection portion 36 disposed on the lid portion 30 of the lower container 14. The container 12 may also be referred to herein as upper container and the container 14 may also be referred to herein as lower container. It is also noted that the container 12 may be used as a lower container and the container 14 may be used an upper container.

In some aspects, the first and second connection portions 34, 36 may have mutually engageable pivotable connection elements 38, 40. The pivotable connection elements 38, 40 may include a first pivot region 42 on the first connection portion 34 and a second pivot region 44 on the second connection portion 36. That is, the first pivotable connection element 38 of the first connection portion 34 may include the first pivot region 42 on the first connection portion 34. The second pivotable connection element 40 of the second connection portion 36 may include the second pivot region 44 on the second connection portion 36.

The number of the first pivotable connection elements 38 on the bottom 32 of the upper container 12 may be the same as the number of the second pivotable connection elements 40 on the lid portion 30 of the lower container 14. The number of the first pivotable connection elements 38 on the bottom 32 of the upper container 12 may be different from the number of the second pivotable connection elements 40 on the lid portion 30 of the lower container 14.

The number of the first pivotable connection elements 38 and the second pivotable connection elements 40 may vary depending on the size, shape and/or configuration of the container 12, 14. For example, referring to FIG. 19, the container 22IC may have seven first pivotable connection elements 38 and seven second pivotable connection elements 40. The container 17IC may have five first pivotable connection elements 38 and five second pivotable connection elements 40. The container 11IC may have three first pivotable connection elements 38. Although not shown, the container 11IC may have three second pivotable connection elements 40. The container 5.3IC₁ may have one first pivotable connection element 38. Although not shown, the container 5.3IC₁ may have one second pivotable connection element 40. However, the quantities of connection elements for all of the containers described herein may vary. The pitch between the first pivotable connection elements 38 or between the second pivotable connection elements 40 may be 71.2 millimeters, however other dimensions are also realized. The number of the first pivotable connection elements 38 and the second pivotable connection elements 40 and the pitch between the first pivotable connection elements 38 or between the second pivotable connection elements 40 are all exemplary and may vary.

The spacing of pivotable connection elements may be configured to be consistent/same across all different sized containers of the stackable container system. This configuration enables a first sized container may be stacked on top of a second, different sized container. That is, the containers of the stackable container system may not be limited or restricted to a configuration in which only a first full sized container may be stacked on top of a second full sized container. For example, this configuration may allow (a) half sized containers can be stacked across the entire width and on top of a full sized lower container, (b) long containers (as shown in FIG. 18D) to be disposed on just one side of a different (full) sized lower container, or (c) any other stacking configuration as would be appreciated by a person of ordinary skill in the art.

The first pivotable connection element 38 of the first connection portion 34 may be fixedly connected (e.g., integrally formed or formed separately and coupled together) to the container portion 28 of the upper container 12. The first pivotable connection element 38 of the first connection portion 34 may extend away from the container portion 28 of the upper container 12. The second pivotable connection element 40 of the second connection portion 36 may be fixedly connected (e.g., integrally formed or formed separately and coupled together) to the lid portion 30 of the lower container 14. The second pivotable connection element 40 of the second connection portion 36 may extend upwardly (and away) from the upper/top side/surface 150 of the lid portion 30 of the lower container 14. Because of the fixed connection between the pivotable connection element and the container portion 28 of the upper container 12/the lid portion 30 of the lower container 14, the first pivotable connection element 38/a first tooth 50 and the second pivotable connection element 40/a second tooth 52 may be referred to as static pivotable connection element/tooth. In some aspects, one of the rear connection elements or the front connection element may be static, and the other of the rear connection elements or the front connection element may be configured to pivotably engage with the static element. The pivotable elements described herein may also be referred to as dynamic connections that can be pivotable (i.e., rotatable) or arranged to move linearly.

When the stackable utilities/items/accessories are stacked/attached to the container, a single connection/engagement between the connection elements (i.e., instead of two connections between the connection elements that are used when stacking two containers to each other) may be used for mounting small utilities-accessories, thermos, flashlight, etc. to the container. The single connection may include a lock. In some aspects, the single connection may not include a lock.

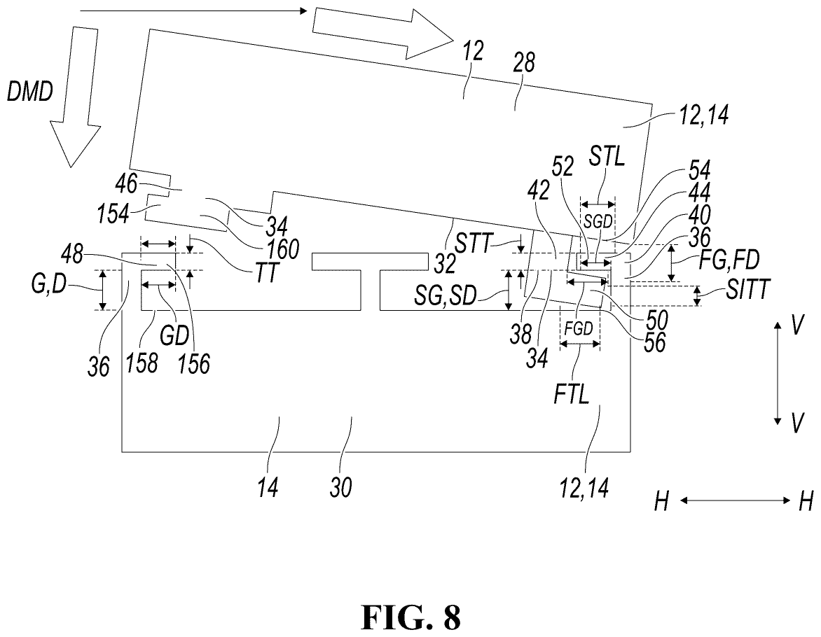

Referring to FIG. 8, the mutually engageable pivotable connection elements 38, 40 may comprise the first tooth 50 on the first connection portion 34 and the second tooth 52 on the second connection portion 36. That is, the first pivotable connection element 38 may comprise the first tooth 50 on the first connection portion 34 and the second pivotable connection element 40 may comprise the second tooth 52 on the second connection portion 36. One of the first and second tooth may be referred to as a tooth, and the other of the first and second tooth may be referred to as a rib.

As shown in FIG. 8, the first pivotable connection element 38 may have an L-shaped configuration and the second pivotable connection element 40 may have an inverted L-shaped configuration. The first pivotable connection element 38 and the second pivotable connection element 40 may have other shaped configurations that may be configured to provide mutually engagement and pivotal connection between the first pivotable connection element 38 and the second pivotable connection element 40.

As further shown in FIG. 8, the first pivotable connection element 38 may be disposed near a rear end portion of the container portion 28 of the upper container 12 and the second pivotable connection element 40 may be disposed near a rear end of the lid portion 30 of the lower container 14. In this case, mutually engageable locking elements 46, 48 (that will be described in detail in the discussions below) of the first and second connection portions 34, 36 may be disposed near front end portions of the container portion 28 of the upper container 12 and the lid portion 30 of the lower container 14, respectively. In this case, the first container 12 may be titled about a transverse axis T-T (as shown in FIG. 3) of the container 12, 14 to facilitate pivotal connection between the first pivotable connection element 38 of the upper container 12 and the second pivotable connection element 40 of the lower container 14.

In some aspects, the first pivotable connection element 38 may be disposed on one side of the container portion 28 of the upper container 12 and the second pivotable connection element 40 may be disposed on the same/corresponding side of the lid portion 30 of the lower container 14. In some aspects, the mutually engageable locking elements 46, 48 of the first and second connection portions 34, 36 may be disposed on opposing sides (i.e., opposite to the sides with the first pivotable connection element 38 and with the second pivotable connection element 40) of the container portion 28 of the upper container 12 and the lid position 30 of the lower container 14. In this case, the first container 12 may be titled about a longitudinal axis L-L (as shown in FIG. 3) of the container 12, 14 to facilitate the pivotal connection between the first pivotable connection element 38 of the upper container 12 and the second pivotable connection element 40 of the lower container 14. As shown in FIG. 3, the longitudinal axis L-L and the transverse axis T-T of the container 12, 14 are generally perpendicular to each other.

The connecting elements on the side wall of the container may facilitate small containers to be stacked/connected/attached on the side of the container.

Referring again to FIG. 8, the first connection portion 34 may have a first opposing surface 54 spaced from the first tooth 50. A top surface of the first tooth 50 and the first opposing surface 54 may be generally or substantially parallel to each other. The first opposing surface 54 may be part of the bottom 32 of the upper container 12. The first tooth 50 and the first opposing surface 54 may define a first gap FG. The first gap FG may include a first distance FD between the first tooth 50 and the first opposing surface 54. The first distance FD may be measured along a vertical axis V-V. The first gap FG may also have a first depth FGD. The first depth FGD of the first gap FG may be measured along a horizontal axis H-H.

The second connection portion 36 may have a second opposing surface 56 spaced from the second tooth 52. A bottom surface of the second tooth 52 and the second opposing surface 56 may be generally or substantially parallel to each other. The second opposing surface 56 may be part of the lid portion 30 of the lower container 14. The space between the second tooth 52 and the second opposing surface 56 may define a second gap SG. The second gap SG may include a second distance SD between the second tooth 52 and the second opposing surface 56. The second distance SD may be measured along the vertical axis V-V. The second gap SG may also have a second depth SGD. The first depth FGD of the first gap FG and the second depth SGD of the second gap SG may be measured along the horizontal axis H-H.

The first tooth 50 may have a first length FTL, and the second tooth 52 may have a second length STL. The first length FTL of the first tooth 50 and the second length STL of the second tooth 52 may be measured along a horizontal axis H-H. The first tooth 50 may have a first thickness FTT and the second tooth 52 may have a second thickness STT. The first thickness FTT of the first tooth 50 and the second thickness STT of the second tooth 52 may be measured along the vertical axis V-V.

The dimensions of the first depth FGD of the first gap FG, the second depth SGD of the second gap SG, the first distance FD of the first gap FG, the second distance SD of the second gap SG, the first thickness FTT of the first tooth 50, the second thickness STT of the second tooth 52, the first length FTL of the first tooth 50, and the second length STL of the second tooth 52 may enable the first tooth 50 to be received in the second gap SG and the second tooth 52 to be received in the first gap FG to provide for the mutually pivotable engagement.

As noted above, the first connection portion 34 disposed on the bottom 32 of the container portion 28 may be configured to be connectable with the second connection portion 36 disposed on the upper/top side/surface 150 of the lid portion 30. The first and second connection portions 34, 36 may further have the mutually engageable locking elements 46, 48. That is, the locking elements 46, 48 include the first locking element 46 on the first connection portion 34 and the second locking element 48 on the second connection portion 36.

The first locking element 46 of the first connection portion 34 may be movably/pivotably connected to the bottom 32 of the upper container 12. The first locking element 46 of the first connection portion 34 may extend away from the bottom 32 of the container portion 28 of the upper container 12. Because of the movable/pivotable connection between the first locking element 46 and the bottom 32 of the upper container 12, the first locking element 46 may be referred to as active locking element.

The second locking element 48 of the second connection portion 36 may be fixedly connected (e.g., integrally formed or formed separately and coupled together) to the lid portion 30 of the lower container 14. The second locking element 48 of the second connection portion 36 may extend upwardly (and away) from the upper/top side/surface 150 of the lid portion 30 of the lower container 14. Because of the fixed connection between the second locking element 48 and the lid portion 30 of the lower container 14, the second locking element 48 may be referred to as static locking element.

The first locking element 46 may have an inverted L-shaped configuration and the second locking element 48 may also have an inverted L-shaped configuration, as shown in FIG. 8. The inverted L-shaped configuration of the first locking element 46 and the inverted L-shaped configuration of the second locking element 48 may be complementary to each other so as to provide mutually engagement and lock connection between the first locking element 46 and the second locking element 48. The first locking element 46 and the second locking element 48 may have other shaped configurations that may be configured to provide mutually engagement and lock connection between the first locking element 46 and the second locking element 48.

Additionally, as shown in FIG. 8, the first locking element 46 may be disposed near the front end portion of the container portion 28 of the upper container 12 and the second locking element 48 may be disposed near the front end of the lid portion 30 of the lower container 14. In this case, the mutually engageable pivotable connection elements 38, 40 may be disposed near the rear end portions of the container portion 28 of the upper container 12 and the lid portion 30 of the lower container 14, respectively.

In some aspects, the first locking element 46 may be disposed on one side of the container portion 28 of the upper container 12 and the second locking element 48 may be disposed on the same/corresponding side of the lid portion 30 of the lower container 14. The mutually engageable pivotable connection elements 38, 40 of the first and second connection portions 34, 36 may be disposed on opposing sides (i.e., opposite to the sides with the first locking element 46 and with the second locking element 48) of the container portion 28 of the upper container 12 and the lid position 30 of the lower container 14.

The mutually engageable lock elements 46, 48 may comprise a first lock tooth (or projections) 154 on the first connection portion 34 and a second lock tooth (or overhanging ledges) 156 on the second connection portion 36. That is, the first locking element 46 may comprise the first lock tooth 154 on the first connection portion 34 and the second locking element 48 may comprise the second lock tooth 156 on the second connection portion 36.

The second connection portion 36 may have an opposing surface 158 spaced from the second lock tooth 156. A bottom surface of the second lock tooth 156 and the opposing surface 158 may be generally or substantially parallel to each other. The opposing surface 158 may be part of the lid portion 30 of the lower container 14. The space between the second lock tooth 156 and the opposing surface 158 may define a gap G. The gap G may include a distance D between the second lock tooth 156 and the opposing surface 158. The distance D may be measured along the vertical axis V-V. The gap G may also have a depth GD. The depth GD of the gap G may be measured along the horizontal axis H-H. The second lock tooth 156 may have a length TL. The length TL of the second lock tooth 156 may be measured along a horizontal axis H-H. The second lock tooth 156 may have a thickness TT. The thickness TT of the second lock tooth 156 may be measured along the vertical axis V-V.

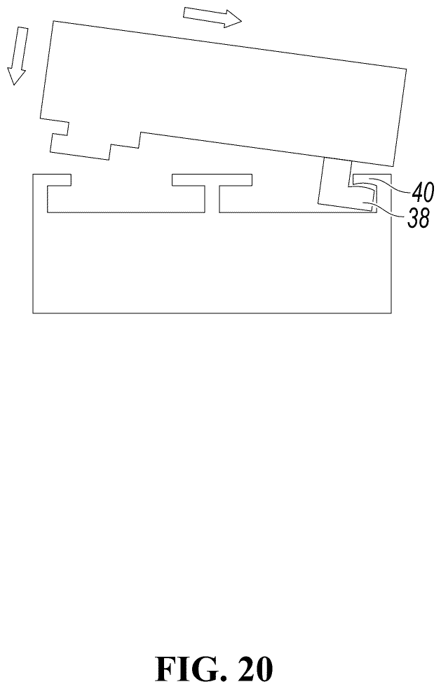

In some aspects, the engagement surfaces of the mutually engageable pivotable connection elements 38, 40 may be planar/parallel surfaces, as shown in FIG. 8. In some aspects, the engagement surfaces of the mutually engageable pivotable connection elements 38, 40 may be curved surfaces. For example, FIG. 20 shows another exemplary side view of the first container being releasably connected and stacked on top of the second container, where the engagement surfaces of the mutually engageable pivotable connection elements 38, 40 are curved surfaces. The mating engagement surfaces of the mutually engageable pivotable connection elements 38, 40 may also be curved in the opposite direction (to those shown in FIG. 20). The engagement between the curved surfaces of the mutually engageable pivotable connection elements 38, 40 may be configured to provide a further locking fit at that end of the engagement.

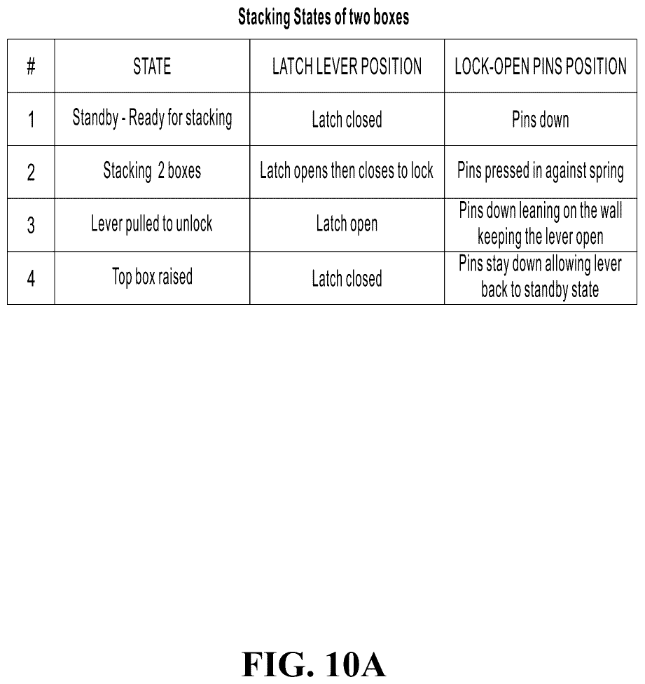

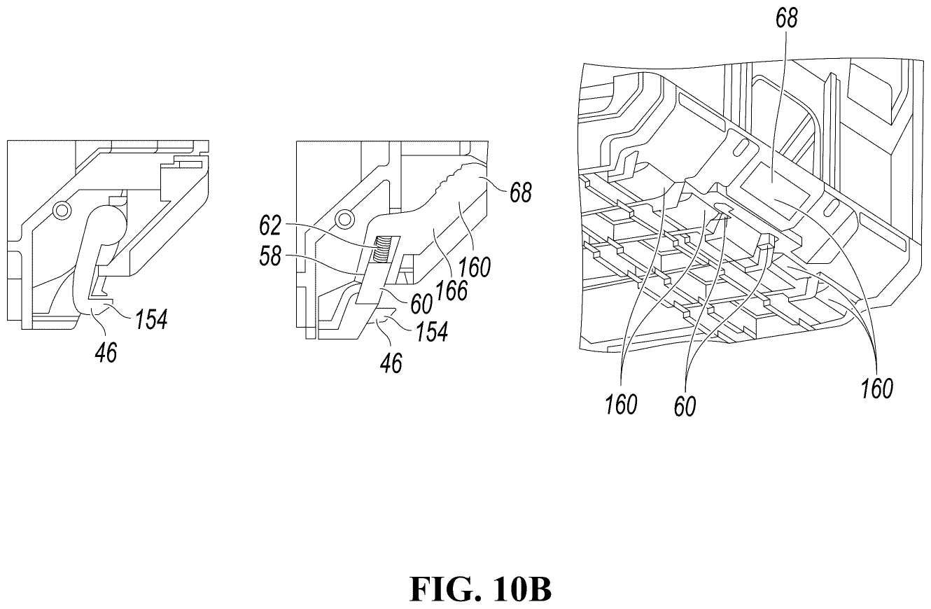

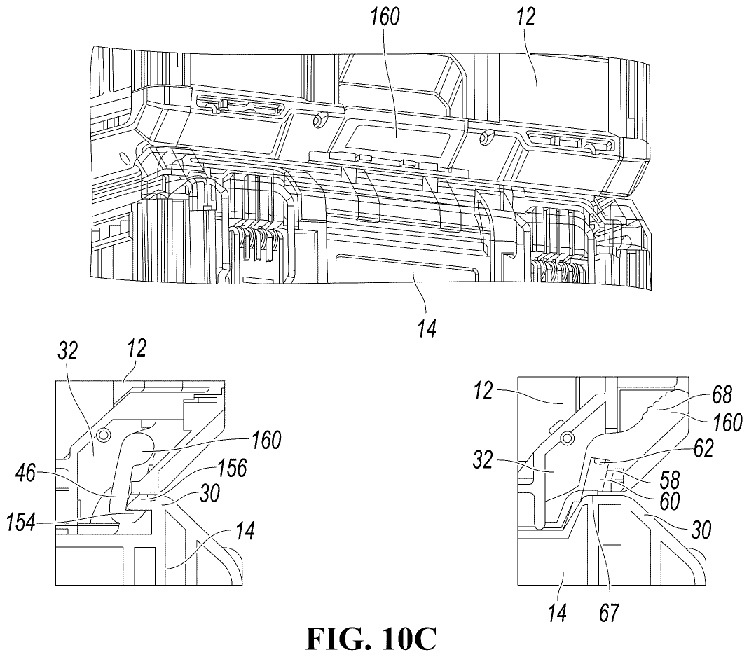

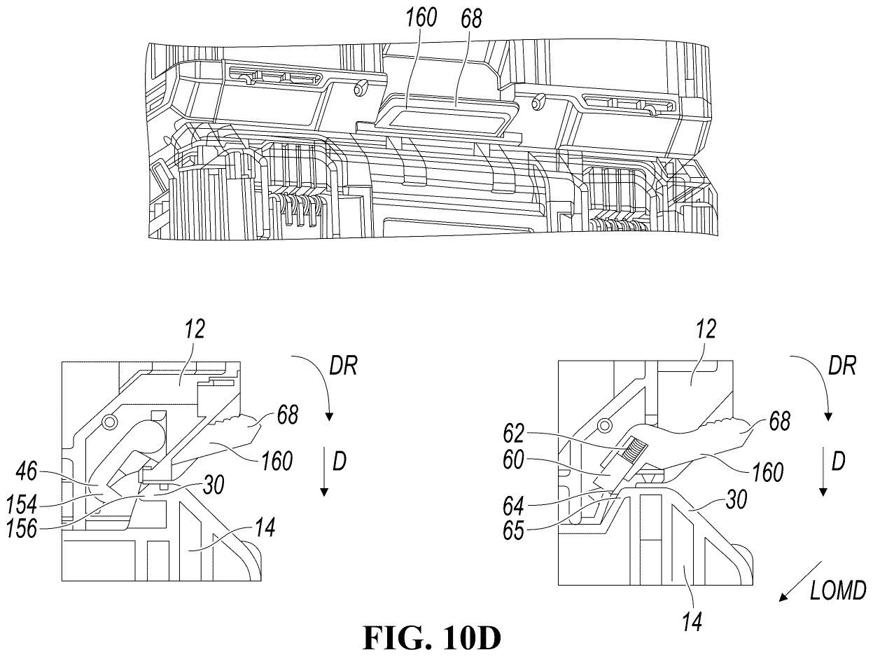

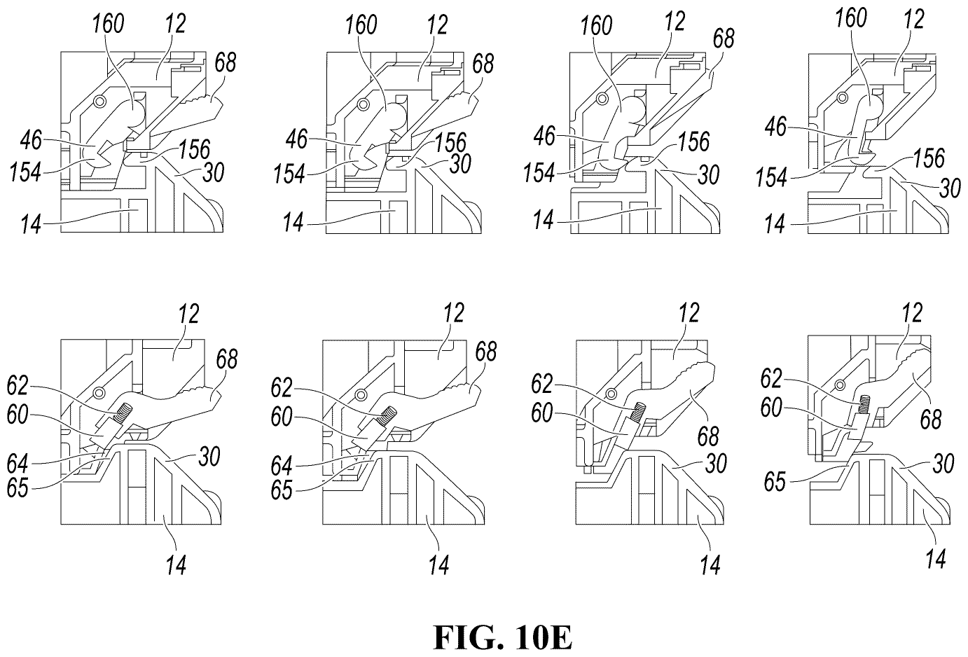

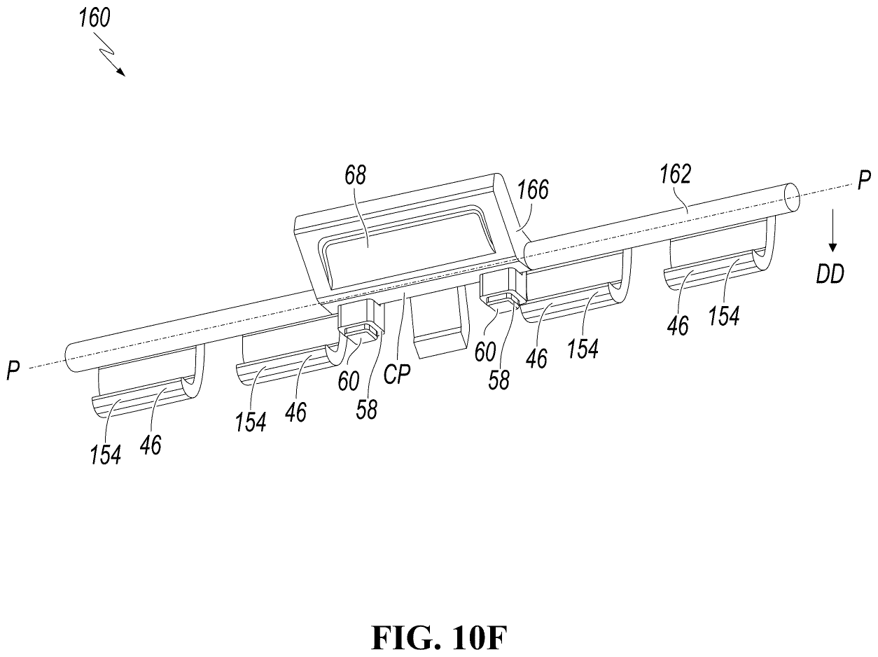

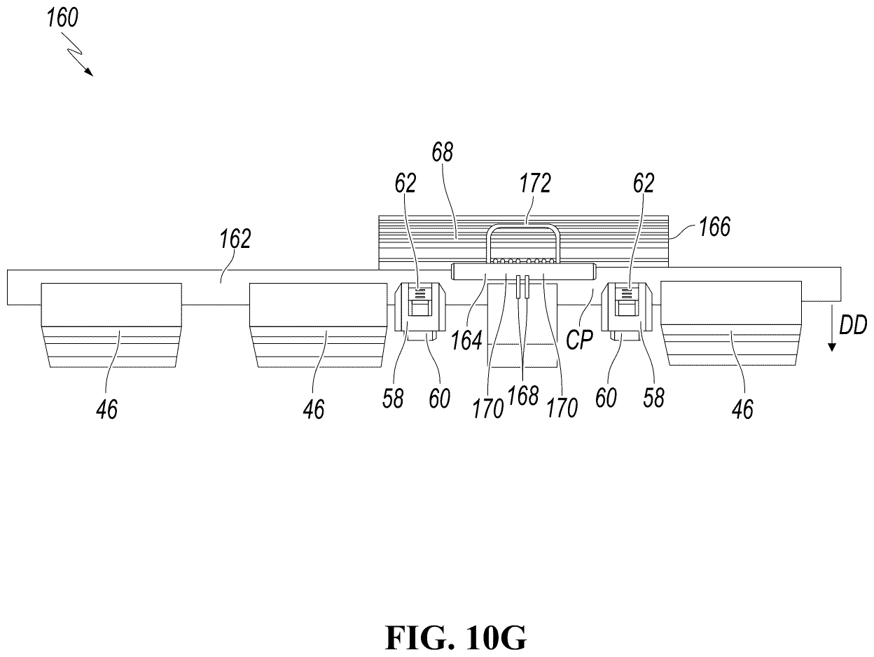

FIGS. 10F and 10G show a lock assembly 160. The lock assembly 160 may interchangeably referred to as a rotatable or pivotable latch lever. The lock assembly 160 may be disposed on the bottom 32 of the upper container 12. The lock assembly 160 may include a lock body 166 and a spring or a bias member 164.

The lock assembly 160 may include (i) a user actuatable member 68 configured to be actuated by a user and (ii) the first locking element 46 on the first connection portion 34. The user actuatable member 68 may be interchangeably referred as a handle or lever.

The lock assembly 160 may be configured to be movable between (a) a lock position in which the first locking element 46 is configured to lockingly engage with the second locking element 48 on the second connection portion 36 and (b) a release position in which the first locking element 46 disengages from the second locking element 48 so as to release the first container 12 from the second container 14. The bias member/spring 164 may be configured to bias the lock assembly 160 between its lock position and its release position.

The lock assembly 160 may further include a lock open member 60. The lock open member 60 comprises a first position and a second position.

The first locking element 46 of the first connection portion 34 and the first lock tooth 154 on the first connection portion 34 may be part of the lock body 166. The lock body 166 may include one or more first locking elements 46. Each first locking element 46 includes the first lock tooth 154. The lock body 166 includes four first locking elements 46 and four corresponding first lock teeth 154. The one or more first locking elements 46 (and four corresponding first lock teeth 154) may be spaced apart from each other. The lock body 166 may also include the handle 68 and a member 162. The handle 68 may be configured to be actuatable by the user. That is, the user actuates the lock assembly 160 using the handle 68.

The one or more first locking elements 46 may be fixedly connected (e.g., integrally formed or formed separately and coupled together) to the member 162 and may extend downwardly (and away) from the member 162. The handle 68 may also be fixedly connected (e.g., integrally formed or formed separately and coupled together) to the member 162 and may extend upwardly (and away) from the member 162. The one or more first locking elements 46 may be spaced part from each other along the member 162. The handle 68 may be disposed in a central portion CP of the member 162. The one or more first locking elements 46 may be disposed on both sides of the handle 68 (and on both sides of the central portion CP of the member 162).

Referring to FIG. 10G, the spring 164 is configured to bias the lock body 166 toward its first position in which the first lock teeth 154 of the upper container 12 engage with the second lock teeth 156 of the lower container 14 to releasably lock the containers 12, 14 to each other. The spring 164 may be a torsion spring including two tines 168, two coils 170, and a torsion loop 172. One end of the spring 164 may be operatively connected to the bottom 32 of the upper container 12 and the other end of the spring 164 may be operatively connected to the lock body 166. The member 162 may be configured to be pivoted or rotated about a pivot axis P-P. The axis P-P may be generally parallel to the transverse axis T-T (as shown in FIG. 3) of the upper container 12. The user may actuate the handle 68 to pivot or rotate the lock body 166 about the pivot axis P-P and against the bias of the spring 164. This causes the first lock teeth 154 of upper container 12 to disengage from the second locking element(s) 48 of the lower container 14. It is also realized that the spring may not be limited to the torsion spring and the spring may include any kind of spring including compression spring (e.g., leaning on the back wall), tension spring, a flexible element in general applying pressure, etc.

The number of the first locking elements 46 (and their corresponding lock teeth 154) and the second locking elements 48 (and their corresponding lock teeth 156) may vary depending on the size, shape and/or configuration of the container 12, 14. For example, referring to FIG. 19, the container 22IC may have four or five first locking elements and seven second locking elements. The container 17IC may have four first locking elements and five second locking elements. The container 11IC may have two first locking elements and three second locking elements. The container 5.3IC₁ may have one first locking element and one second locking element. The number of the first locking elements 46 and the second locking elements 48 are all exemplary and may vary.

The spacing of locking elements may be configured to be consistent/same across all different sized containers of the stackable container system. This configuration enables a first sized container may be stacked on top of a second, different sized container. That is, the containers of the stackable container system may not be limited or restricted to a configuration in which only a first full sized container may be stacked on top of a second full sized container. This configuration may allow (a) half sized containers can be stacked across the entire width and on top of a full sized lower container, (b) long containers (as shown in FIG. 18D) to be disposed on just one side of a different (full) sized lower container, or (c) any other stacking configuration as would be appreciated by a person of ordinary skill in the art.

When the stackable containers/utility elements are stacked/attached to one another, the stackable containers/utility elements may not to be aligned exactly with each other, a small container may be stacked on a big/larger container, a big/larger container may be stacked on a small container, several (small) container may be stacked on a single container, a single container may be stacked on several (small) containers, one container attached/stacked may be offset to the other container out of the footprint of the containers, etc.

The system 10 may not be limited to having the footprint of the top/upper stackable container within the footprint of the bottom/lower stackable container. That is, the top/upper stackable container and the bottom/lower stackable container may be stacked to each other in an offset configuration (e.g., sticking out of the side of the bottom/lower stackable container, sticking out of the side of the upper/top stackable container, stack a large top/upper stackable container on a small bottom/lower stackable container, stack a small top/upper stackable container on a large bottom/lower stackable container, etc.).

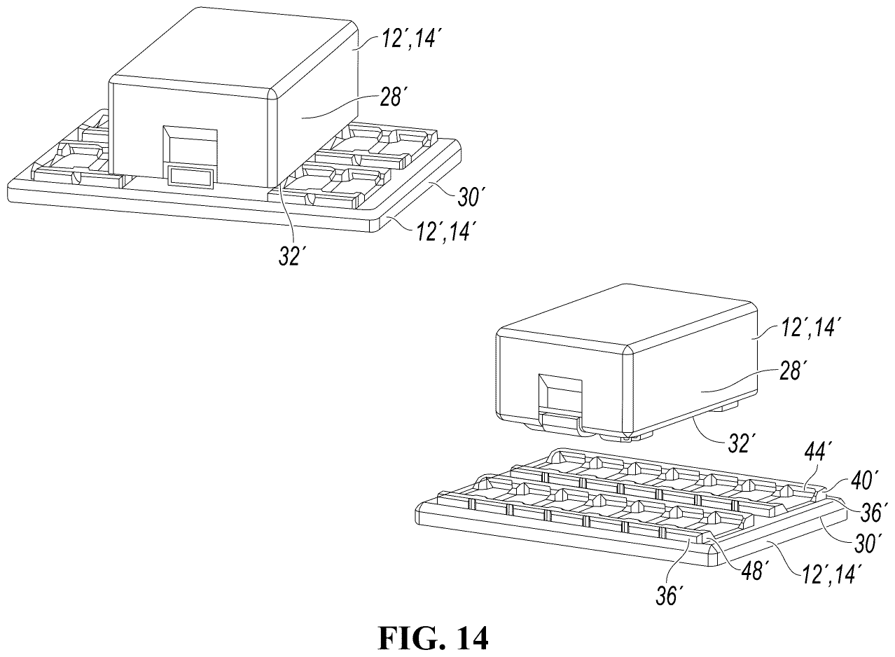

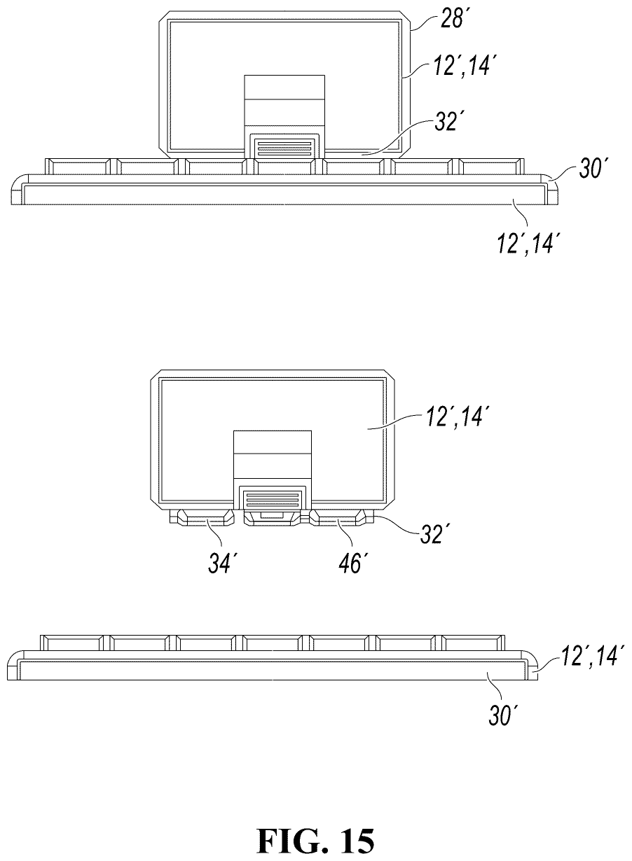

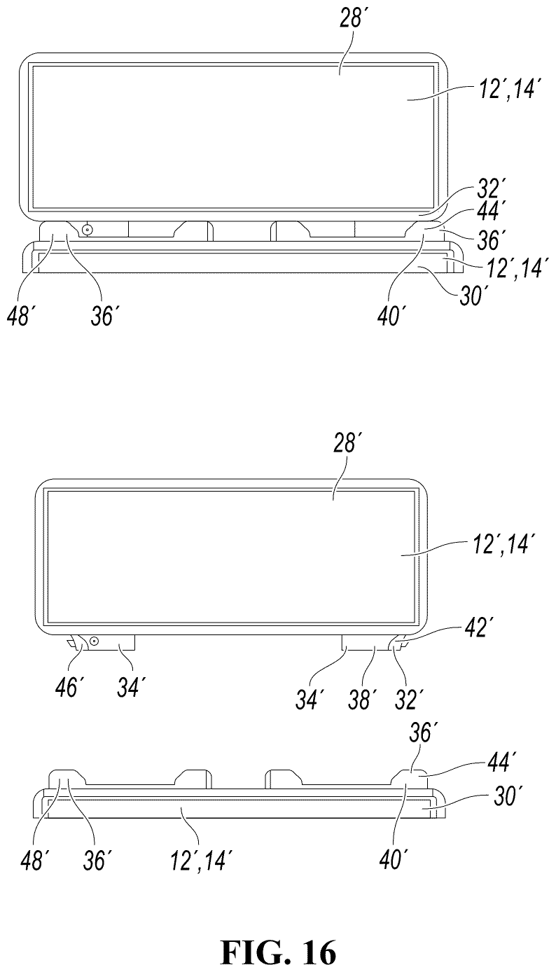

Referring to FIGS. 8-10G, the first and second connection portions 34, 36 are releasably connectable to one another by engaging the mutually engageable pivotable connection elements 38, 40, to create a pivotal engagement between the first and second containers 12, 14, and pivoting the first (e.g., upper) container 12 relative to the second (e.g., lower) container 14 about the mutually engageable pivotable connection elements 38, 40 until the first locking element 46 on the first connection portion 34 lockingly engages with the second locking element 48 on the second connection portion 36. The first container 12 may be moved with respect to and downwardly towards the second container 14 in the direction of DMD to provide locking engagement between the first and second containers 12, 14. The mutually engageable pivotable connection elements 38, 40 and the locking engagement between the first locking element 46 and the second locking element 48 cooperate to releasably lock the first container 12 with the second container 14. The first structure may be configured to be mated to the second structure by angularly inserting the plurality of cleats of the first mating element on the first structure into one or more of the first plurality of pockets in the second structure and rotating the first structure from a first position (e.g., as shown in FIG. 8) in which the bottom wall of the first structure extends at an acute angle relative to the top wall of the second structure, to a second position (e.g., connected/stacked configuration as shown in FIGS. 14-16) in which the bottom wall of the first structure is substantially parallel to the top wall of the second structure. The second mating element may be configured to pivot when the first structure is moved from the first position to the second position, and the plurality of cleats on the second mating element are configured to engage one or more of the second plurality of pockets when the first structure is in the second position to attach the first structure to the second structure. This angular insertion and rotation process, as shown in FIGS. 8 and 20, enables secure connection between structures while accommodating the pivotal movement of the second mating element.

For example, tilt, drop, and lock stacking may be used for the containers 12, 14 in the stackable container system 10. That is, the connection of the containers 12, 14 in the stackable container system 10 may be achieved by (a) tilting (with respect to either the transverse axis T-T or the longitudinal axis L-L) one of the containers (e.g., upper container) 12 with respect to the other container (e.g., lower container) 14, (b) engaging rear static teeth 34, 38 (disposed on the bottom 32) of the upper container 12 with a rear undercut area (with rear undercuts) 36, 40, 44 in the lid 30 of the lower container 14 to secure a stable anchorage (mutual engagement and pivotal connection) between the containers 12, 14, and (c) locking dynamic front teeth 46 (positioned on the bottom 32 and at the front part) of the upper container 12 with a front undercut area (with front undercuts) 48 in the lid portion 30 of the lower container 14 to lock the upper and lower containers 12, 14. The dynamic front teeth 46 of the upper container 12 may be moved in response to the activation of a downward pressing mechanism (e.g., the lock assembly 160) , allowing for precise connection and alignment between the containers 12, 14. This method of connectivity may be configured to create a unified structure between the two containers 12, 14, ensuring a full contact surface between the bottom 30 of the upper container 12 and the lid 30 of the lower container 14. The term “tilt” as used herein may refer to an ergonomic feature that allows a user to tilt the upper container 12 with respect to the lower container 14 for easier access or to align the upper container 12 with respect to the lower container 14 during the stacking procedure. The term “drop” as used herein may refer to a feature that allows for ease of placing the upper container 12 on top of the lower container 14, emphasizing a simple and quick stacking procedure. The term “lock” as used herein may refer to a feature in which the upper and lower containers 12, 14 are stacked, the upper and lower containers 12, 14 are securely locked into place, ensuring stability and safety during transport and use of the stackable container system 10. The term “stacking” as used herein may refer to a feature that conveys that the stackable container system 10 is designed to allow multiple containers 12, 14 to be stacked on top of each other, saving space and enhancing organization.

The lock assembly 160 may have a rotational lever or linear button configuration. For example, the lock assembly 160 may include a rotatable lever lock assembly that is configured to be pivotable about the pivot axis P-P. The user actuatable member 68 may include a handle. The handle may be disposed on a first (e.g., upper/above) side of the pivot axis P-P. The first locking element 46 may be disposed on a second side (e.g. lower/below) of the pivot axis P-P. The first locking element 46 may be one of a one or more first locking elements. Along the pivot axis P-P, the lock open member 60 may be disposed between the first locking element 46 and may be disposed below the handle 68. The lock open member 60 may be one of one or more lock open members. Each lock open member 60 may include an associated lock open bias member 62. The lock open member 60 may be disposed on the second side (e.g. lower/below) of the pivot axis P-P. Along the pivot axis P-P, the one or more first locking elements 46 may be disposed on both sides (e.g., right and left sides) of the handle 68.

The locking procedure for the rotational lever configuration may include (a) tilt and insert procedure in which the upper container 12 is tilted slightly to align its rear static teeth with the undercut area of the lower container 14 and (b) drop and engage procedure in which the upper container 12 is lowered to make contact between the dynamic front teeth, which may move slightly backward before locking forward to achieve a full overlap and secure connection. The releasing procedure of the rotational lever configuration may include (a) unlocking procedure in which the ergonomic handle is tilted downward to unlock the lock assembly 160 and (b) removal procedure in which the upper container 12 can be removed from the lower container 14.

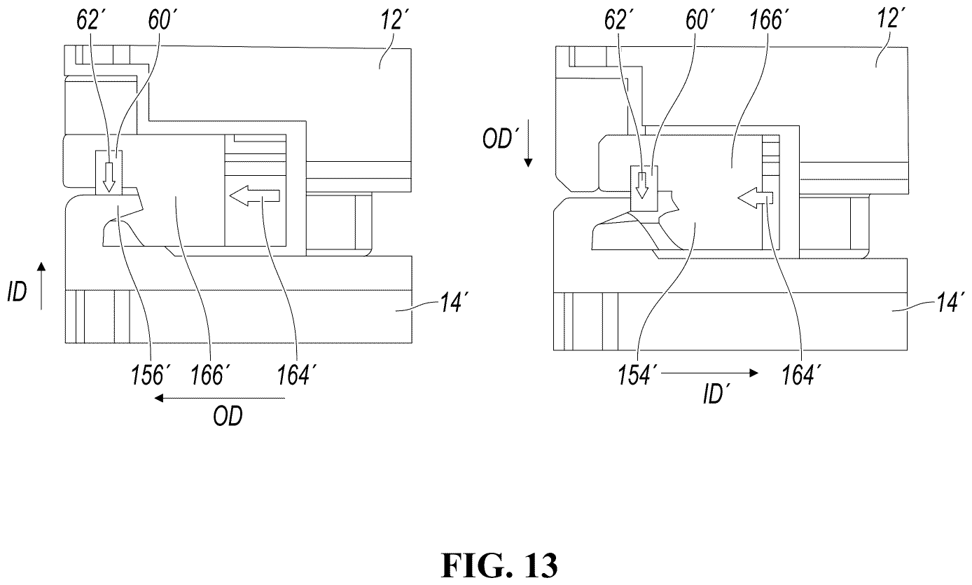

As shown in and described in detail with respect to FIGS. 13-17C, the lock assembly 160′may include a simple linear button configuration. The lock assembly 160′ may be a push button lock assembly that is configured to be linearly movable along an axis. The user actuatable member 68′ includes a push button that is configured to moveable along the axis. The axis may be an axis parallel to the transverse axis (e.g., T-T in FIG. 3) when the lock assembly 160′ is disposed on the left/right side of the container. The axis may be an axis parallel to the longitudinal axis (e.g., L-L in FIG. 3) when the lock assembly 160′ is disposed on the front/rear of the container.

The locking procedure of the simple linear button configuration may include (a) tilt and insert procedure that is similar to the rotational linear button configuration/mechanism and in which the upper container 12 is tilted slightly to align its rear static teeth with the undercut area of the lower container 14 and (b) drop and engage procedure in which the upper container 12 is lowered to make contact between the dynamic front teeth, which may move slightly backward and then forward to lock the upper and lower containers 12, 14. The releasing procedure of the simple linear button configuration may include (a) unlocking procedure in which straightforward push button is simply pressed to unlock the lock assembly 160, the push button that may be spring-loaded, and (b) removal procedure in which the upper container 12 can be removed from the lower container 14.

In some aspects, the first structure may be configured to be mated to the second structure by dropping the first structure straight down onto the second structure, rather than having to insert the first structure at an angle as described above. To facilitate this functionality, the plurality of cleats of both of the first mating element and the second mating element may include pivotable locking elements/cleats, like locking element 46. This dual movable cleat configuration enables straight-down drop-to-lock functionality, where the container can be positioned directly above another container and dropped straight down without requiring angular insertion and rotation. When the containers are pressed together, both sets of movable cleats may temporarily retract to allow engagement, then spring back to their extended positions to lock the containers together. In this case, either one, or both of the first mating element and the second mating element may be provided with an actuator, allowing for single-handed release of the container first structure from the second structure, similarly to as described above. In some aspects, the actuator provided can include any of the actuators described herein (e.g., the lever/handle, the linear button, etc.).

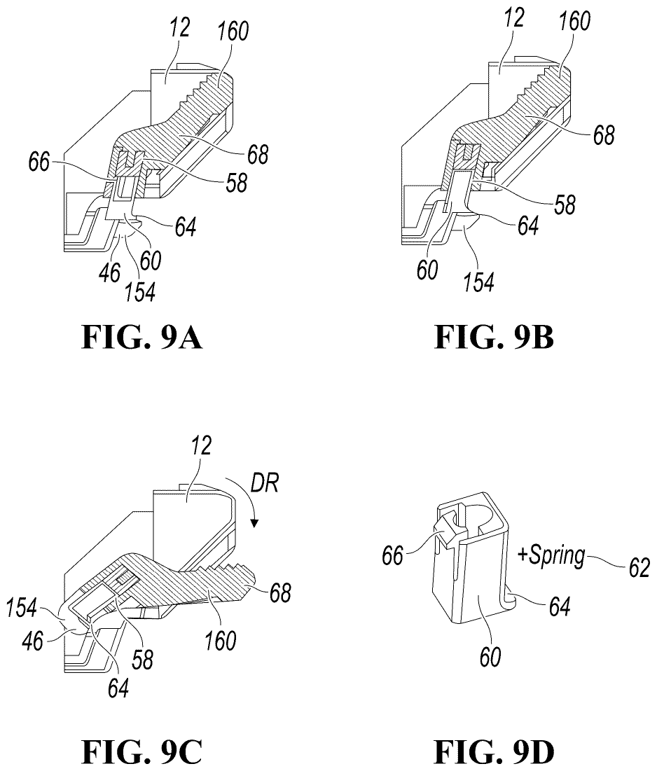

Referring to FIGS. 9, 10F and 10G, the lock assembly 160 may include an opening 58 (e.g., column) therein that are configured to receive a lock open member 60 and to facilitate the (upwardly or downwardly) movement of the lock open member 60 in the opening 58. In some aspects, the longitudinal axis of the column/opening 58 can be inclined relative to the generally vertical direction. The lock assembly 160 may include two lock open members 60 and two openings 58. In some aspects, the lock assembly 160 may include two lock open members 60 and two openings 58, disposed on opposing sides of the handle/actuator 68, as shown in FIGS. 10F-10G. The lock open member 60 may interchangeably referred to as auto release member. The lock open member 60 and its associated spring 62 are also shown in FIGS. 9A-9D and 10B-10C. The spring 62 may interchangeably referred to as lock open bias member. The spring 62 may be operatively connected to the lock open member 60. In its first position, the lock open member 60 may be configured to be biased away from the lock assembly 160 by the lock open bias member 62. In its second position, the lock open member 60 may be configured to be biased against the lock open bias member 62. The spring 62 may be configured to bias the lock open member 60 downwardly in the direction of an arrow DD in the opening 58. The number of the lock open members 60, the corresponding openings 58, and the associated springs 62 may vary.

The lock open member/slug 60 may include lower forward projection/tab 64 and upper rearward projection/tab 66. As shown in FIG. 9A, the upper rearward projection 66 of the lock open member 60 may be configured to engage with portions of the locking element/cleat 46 when the lock element is in its standby and ready for stacking configuration/state or in its stacking configuration/state. The upper rearward projection 66 may be optional.

FIGS. 9A-10G show locking engagement and disengagement between the locking elements 46, 48 of the first and second containers 12, 14. As shown in FIG. 10A, the lock assembly 160 and the lock open member 60 may be in different positions during pre-stacking, stacking and locking, releasing, and removing procedures of the upper and lower containers 12, 14. The pre-stacking may refer to a procedure before the stacking and locking procedure. The containers 12, 14 are stacked and locked during the stacking and locking procedure. The releasing may refer to a procedure in which the lock assembly 160 is opened or released to unlock the upper container 12 from the lower container 14. The removing procedure may refer to a procedure in which the upper container 12 is removed from the lower container 14.

For example, the stackable container system 10 may comprise (1) a stack configuration in which the first container 12 is releasably connected on top of the second container 14, the lock assembly 160 is in its lock position in which the first locking element 46 lockingly engages with the second locking element 48 on the second connection portion, and the lock open member/slug 60 is in its recessed/second position, and (2) a release configuration in which, upon the actuation of the user actuatable member 68, the lock assembly 160 is moved to its release position so as to release the first container 12 from the second container 14, and the lock open member/slug 60 is moved to its extended/first position such that the lock open member 60 engages with portions 65 of the lid portion 30. The stackable container system 10 may further comprise a standby or a pre-stacking configuration in which the first container 12 is ready to be releasably connected on top of the second container 14, the lock assembly 160 is in its lock position, and the lock open member/slug 60 is in its extended/first position.

The portions 65 of the lid portion 30 are first portions of the lid portion 30. When the stackable container system 10 is in the stack configuration, the lock open member/slug 60 is pressed against the bias of the lock open bias member 62 by second portions 67 (as shown in FIG. 10C) of the lid portion 30 (recessed position). The second portions 67 of the lid portion 30 are different from the first portions 65 of the lid portion 30. For example, the second portions 67 may be parallel or generally parallel to a horizontal axis. The first portions 65 may be angled or inclined with respect to a vertical axis. The first portions 65 and the second portions 67 of the lid portion 30 may be part of the second connection portion 36 of the lid portion 30.

When the first structure (upper container 12 is detached from the second structure, in a standby and ready for stacking/first configuration/state as shown in FIGS. 9A and 9B and in FIG. 10B, the latch may be in a first configuration in which the handle/actuator 68 is biased to a first position, against the first structure. In this configurations, the biasing element/spring 164 of the lock assembly 160 (positioned between the latch/lock body 166 and the structure) biases the lock body 166 such that the lock assembly 160 is in its closed/first position. Also, in the standby and ready for stacking configuration/state, the lock open members/tabs 60 are extended downwardly from the openings in the lock assembly 160 to their extended positions. The springs 62 are configured to bias the lock open members 60 to their downwardly extended positions.

Referring to FIG. 10C, during the stacking and locking procedure, as front end portion of the upper container 12 is moved downwardly towards front end portion of the lower container 14 (while the upper and lower containers 12, 14 are in pivotal connection at the rear end portions thereof), the teeth 154 of the upper container 12 interacts the teeth 156 of the lower container 14. This causes the lock body 166 to pivot/rotate against the bias of the spring 164 to allow engagement between the teeth 154 of the upper container 12 and the teeth 156 of the lower container 14. The spring 164 then biases the lock body 166 back such that the lock assembly 160 is in its closed/first position as shown in FIG. 10C. That is, during the stacking procedure, the lock assembly 160 may be opened and then closed to lock the containers 12, 14. In FIG. 10C, the lock assembly 160 is positioned such that the first lock teeth 154 of the upper container 12 are engaged with the second lock teeth 156 of the lower container 14 to retain the upper container 12 and the lower container 14 in their stacked configuration/state. Also, in the stacked configuration/state, the lock open members 60 are retracted upwardly into the openings in the lock assembly 160. That is, the lock open members 60 are pressed into their upwardly retracted positions, against the bias of their springs 62, by the portions 67 (as shown in FIG. 10C) of the lid portion 30 of the lower container 14. When the first structure (upper container 12) is mated to the second structure (lower container 14), the handle/actuator 68 may be in a second configuration in which the handle/actuator 68 is biased to the first/closed position, against the first structure, and the slug 60 is in the recessed position.

Referring to FIG. 10D, the user may actuate the actuator/handle 68 of the lock body 166 to release the upper container 12 from the lower container 14. In this case, the handle/actuator 68 may be moved to a third configuration in which the handle/actuator 68 is biased to the second/open position. The lock body 166 of the upper container 12 is rotated (e.g., in the direction of an arrow DR) by pushing the handle 68 downwardly (e.g., in the direction of an arrow D) to remove the first lock teeth 154 of the locking element 46 on the bottom 32 of the upper container 12 from beneath the second lock teeth 156 of the locking element 48 on the lid 30/top surface of the lower container 14. That is, the first lock teeth 154 of the upper container 12 are disengaged from the second lock teeth 156 of the lower container 14 to enable the upper container 12 to be removed or detached from the lower container 14. The lock assembly 160 is in its open/second position. Also, in the release configuration/state, the lock open members 60 are extended downwardly from the openings in the lock assembly 160. The springs 62 are configured to bias the lock open members 60 to their downwardly extended positions. As explained above, this downwardly extending position/configuration of the lock open members 60 enables the lock assembly 160 to remain in its open/second position.

The lock assembly 160 is configured to enable single-handed operation to lock the first container 12 with the second container 14 and to release and remove the first container 12 from the second container 14. For the single-handed operation, actuation of the user actuatable member 68 causes the lock assembly 160 to be moved to its release portion so as to disengage the first locking element 46 from the second locking element 48 and causes the lock open member 60 to be moved to its first position such that the lock open member 60 engages with portions 65 of the lid portion 30. The engagement between the lock open member 60 in its first position and the portions 65 of the lid portion 30 provides a retention force that is configured to maintain the lock assembly 160 to be in its release position, even when the user releases the user actuatable member 68, to enable removal of the first container 12 from the second container 14. The retention force may be configured to prevent the lock assembly 160 from moving back to its lock position, even when the user releases the user actuatable member 68, to enable removal of the first container 12 from the second container 14. Once the first container 12 is removed from the second container 14, as there is no engagement between the lock open member 60 in its first position and the portions 65 of the lid portion 30, the lock assembly 160 is moved from its release position to its lock position.

Referring to FIGS. 10D and 10E, when the lock body 166 of the upper container 12 is rotated (e.g., in the direction of an arrow DR) by pushing the handle 68 of the lock body 166 downwardly (e.g., in the direction of an arrow D) to remove or disengage the first lock teeth 154 of the locking element 46 on the bottom 32 of the upper container 12 from beneath the second lock teeth 156 of the locking element 48 on the lid 30/top surface of the lower container 14, the lock open member 60 is configured to be pushed downward (e.g., in the direction of an arrow LOMD) by the spring 62 until the projection/tab 64 thereof hooks onto portions 65 of the lower container 14. The portions 65 of the lower container 14 may include portions that are underneath one of the second lock teeth 156 of the lower container 14. The engagement between the projection/tab 64 and the portions 65 of the lower container 14 may be configured to preclude the lock open member 60 from moving upwardly against the bias of the spring 62.

This retention of the lock open member 60 provides just enough retention force to preclude the lock body 166 from rotating back to its initial position, even when the operator releases the handle 68. Thus, the lock body 166 is maintained in its position where its first lock teeth 154 are withdrawn from beneath the first lock teeth 156 of the lower container 14 and the upper container 12 can be removed from the lower container 14. This functionality is referred to herein as a “stay-open” functionality, allowing a person to press the handle or actuate the lever, and anytime after that actuation, lift the container off of another container to which it is attached at the user's convenience, without requiring continuous actuation of the handle/actuator. However, once the upper container 12 is removed, there is no longer any contact between the lock open member 60 and the portions 65 of the lower container 14. Accordingly, the lock body 166 may be allowed to pivot back to its initial position, moving from the third configuration back to the first configuration, when the first structure is removed from the second structure, as the slug no longer contacts the second structure portions.

When the upper container 12 is replaced on the lower container 14 for stacking, even though the lock body 166 may undergo a slight rotation (from its closed towards its open position), the rotation of the lock body 166 is not enough to engage the lock open members 60 with the portions 65 of the lower container 14. Therefore, the lock body 166 can snap into its container retaining position.

FIGS. 13-17C illustrate another lock assembly 160′ and lock open member 60′. For example, the lock assembly 160′ includes a push button configuration. The portions shown in FIGS. 13-17C have been described in detail above, and have been designated by the same reference numerals but with the addition of prime. Accordingly, like components are not described.

FIG. 13 shows the containers 12′, 14′ stacked on top of each other and locked to each other. In this locked configuration/position, the latch/lock body 166′ is pushed outwardly in the direction of an arrow OD by the spring 164′ such that the first lock tooth 154′ on the lock body 166′ of the upper container 12′ engages with the lock tooth 156′ of the lower container 14′ to lock the upper and lower containers 12′ and 14′. In the locked position, the lock open member 60′ is pushed inwardly in the direction of an arrow ID by the portions (upper surfaces of the lower container 14′) against the bias of the spring 62′. The spring 62′ is in a compressed state.

FIG. 13 also shows the container 12′, 14′ when the lock assembly 160′is in its unlocked position and the lock open member 60′ is engaged. The latch/lock body 166′ is pushed inwardly in the direction of an arrow ID′ by the user (and against the bias of the spring 164′) and the latch/lock body 166′ is held in this “unlocked” position by the auto release/lock open member 60′. In the unlocked position, the lock open member 60′ is pushed downwardly (in the direction of an arrow OD') by the spring 62′ and the lock open member 60′ engages with portions of the lower container 14′ so as to prevent the latch/lock body 166′ from going back to its locked position.

FIGS. 14-16 illustrate perspective views, front views, and side views, respectively, of the first/upper container 12′ of FIG. 13 releasably connected and stacked on top of the second/lower container 14′ of FIG. 13, and the first container 12′ disconnected/unstacked from the second container 14′.

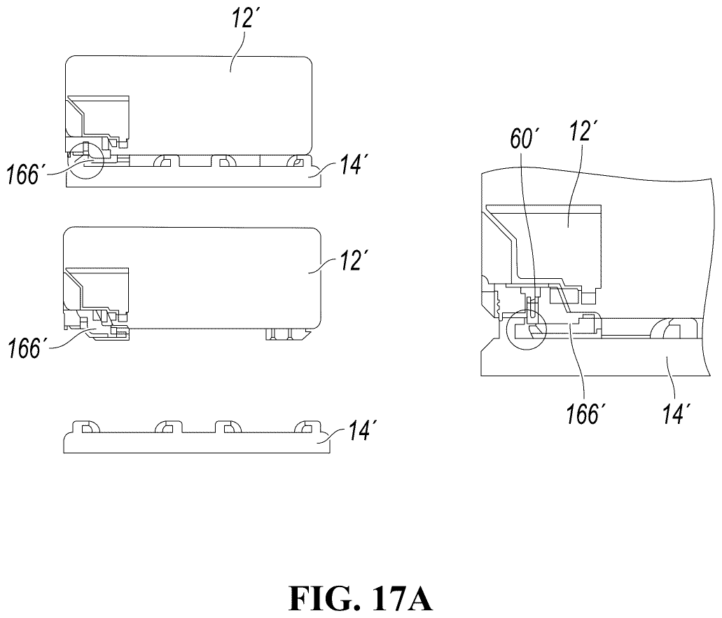

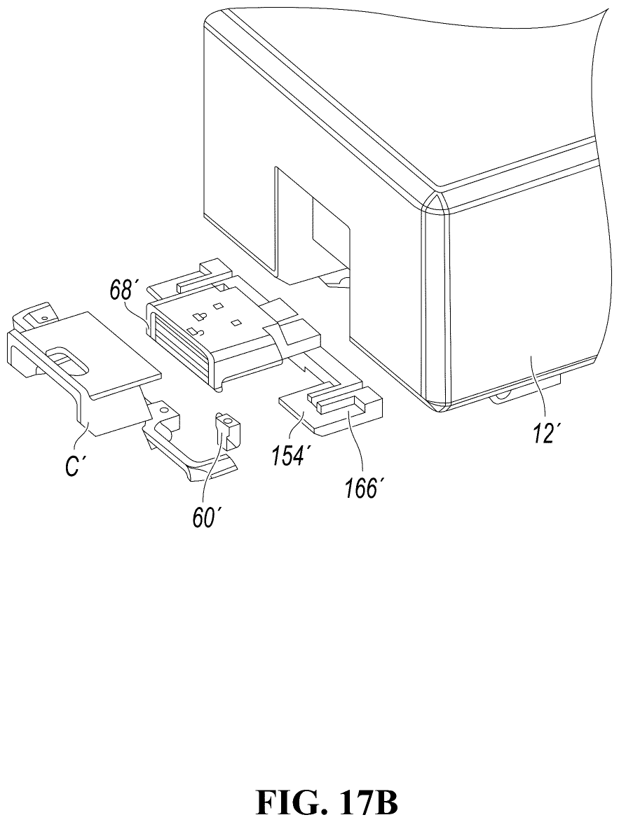

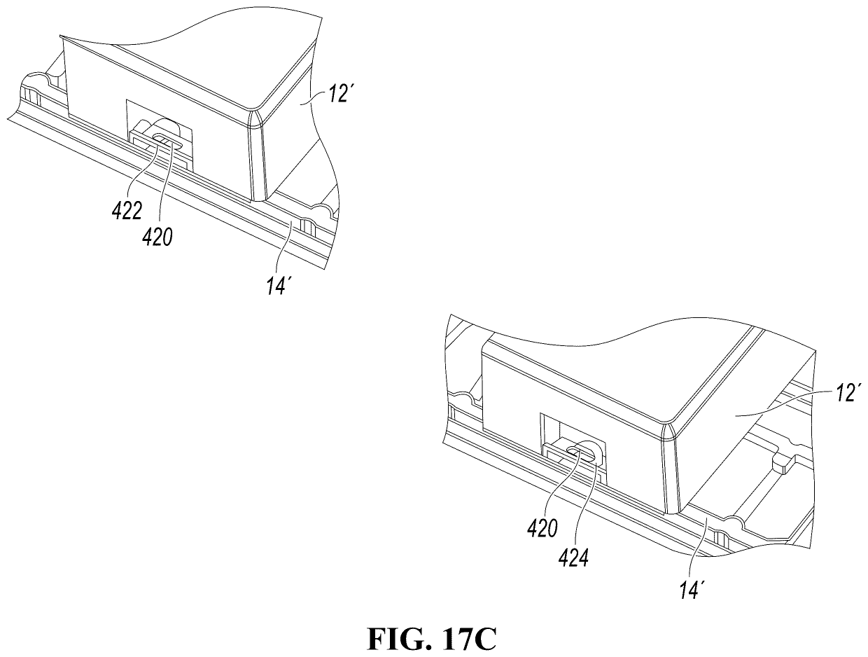

FIG. 17A illustrates sectional views of the first container 12′ and the second container 14′ in a connected (stacked) configuration with the lock engaged, in a stack released configuration with lock disengaged, and in a disconnected configuration. FIG. 17B illustrates a perspective view of one of the first and second containers of FIG. 17A and its lock assembly, wherein the lock assembly is in its exploded configuration. As shown in FIG. 17B, the push button lock assembly 160′ may include a cover C′ , the lock open member 60′, push button 68′, and linear latch (with the latch/lock body 166′ and the teeth 154′).

FIG. 17C illustrates perspective views of the first container 12′ and the second container 14′ of FIG. 17A in the connected (stacked) configuration with the lock engaged, and in the stack released configuration with the lock disengaged. The lock assembly 160′ includes a latch status indicator 420 that is configured to provide a user with a first indication 422 that the latch 166′ is engaged and the containers 12′ and 14′ are locked together or with a second indication 424 that the latch 166′ is disengaged and the containers 12′ and 14′ are unlocked or released from each other.

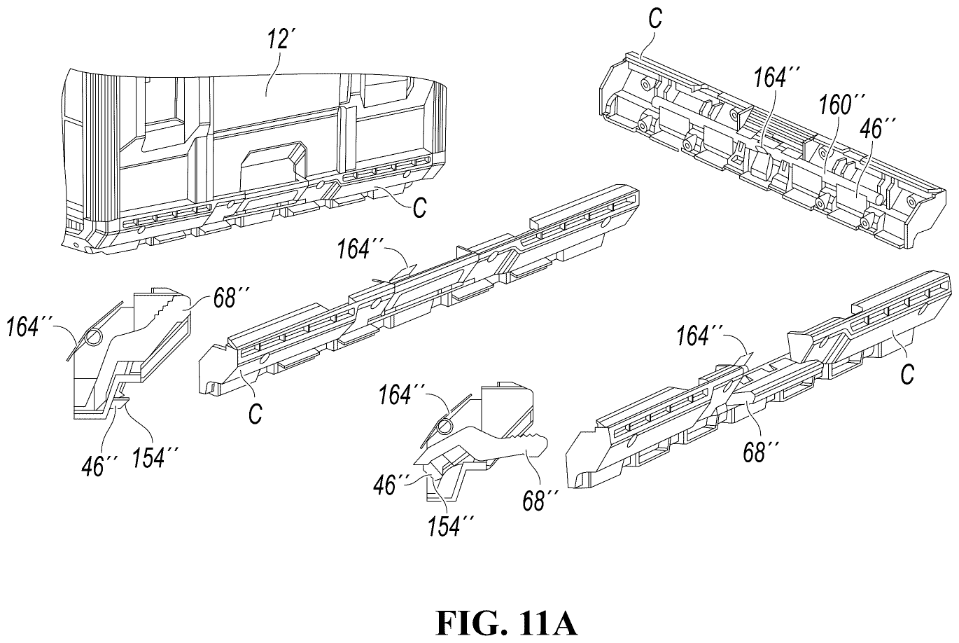

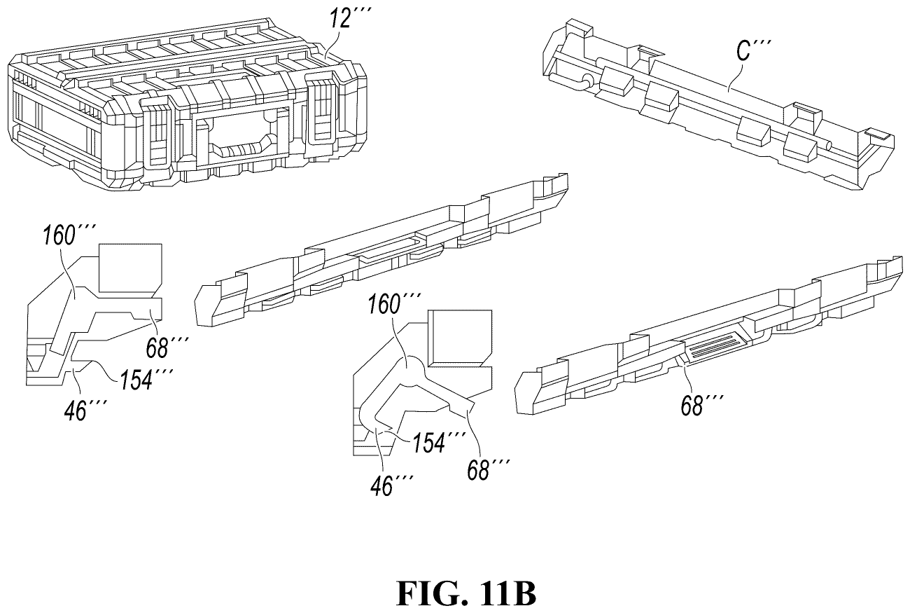

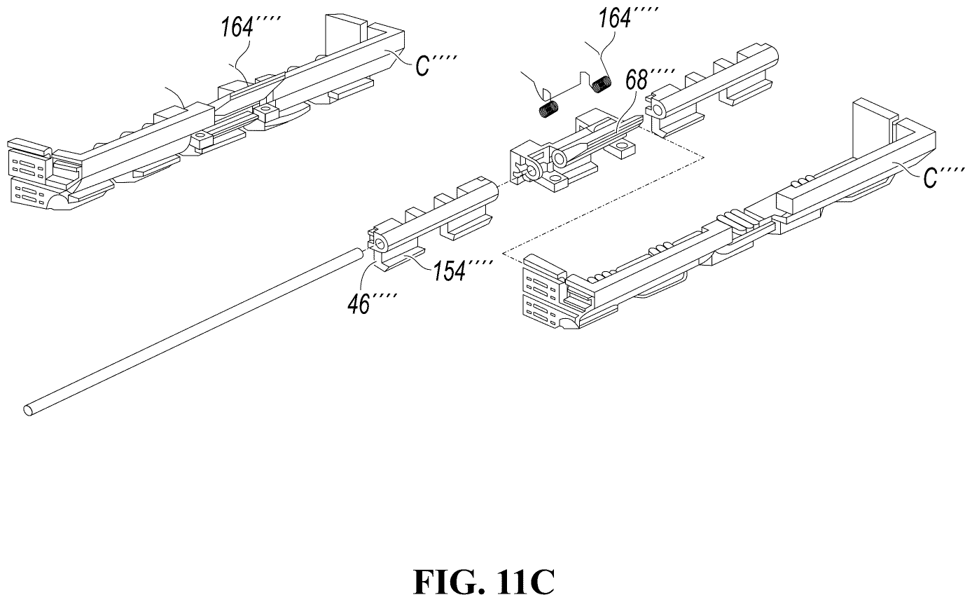

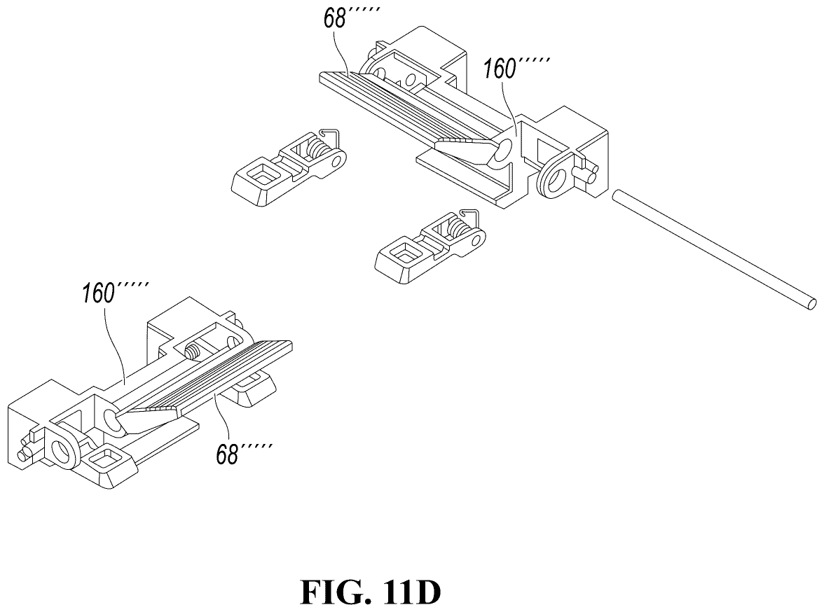

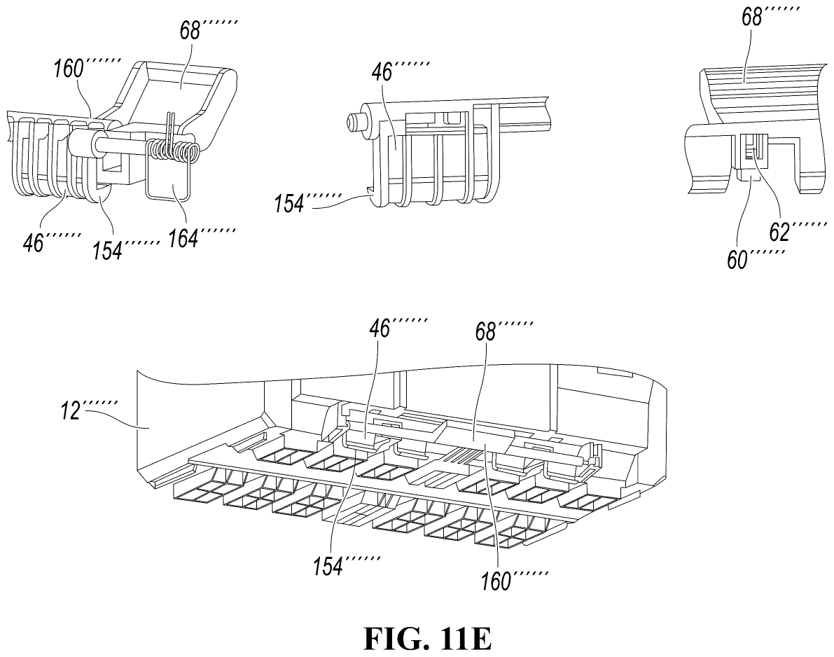

The lock assembly 160 may include a cover portion C (e.g., as shown in FIG. 11A) that is configured to cover portions of the lock assembly 160 such that (a) the handle 68 is still accessible for actuation by the user, and (b) the first lock teeth 154 of the upper container 12 are still accessible for engagement with the second lock teeth 156 of the lower container 14. The cover portion may be optional.

FIGS. 11A and 11B illustrate the lock assembly of one of the first and second containers in locked and locked configurations in accordance with the systems described herein. The portions shown in FIGS. 11A-11B have been described above, and have been designated by the same reference numerals but with the addition of primes. Accordingly, like components are not described.

FIGS. 11A and 11B show the lock assembly 14 to include a rotational/pivotal lever configuration. The rotational lever in FIG. 11A is similar to that described in FIGS. 9-10G except that the rotational lever in FIG. 11A does not include the lock open member 60. The rotational lever in FIG. 11B is similar to that described in FIGS. 9-10G except that the rotational lever in FIG. 11B includes a flat handle configuration. As the operation of the rotational levers in FIGS. 11A and 11B are similar to that described with respect to FIGS. 9-10G, the operation of the rotational levers in FIGS. 11A and 11B will not be described in detail here again.

FIGS. 11C-11E illustrate locking assembly of one of the first container and the second stackable container in its exploded configuration and its assembled configuration.

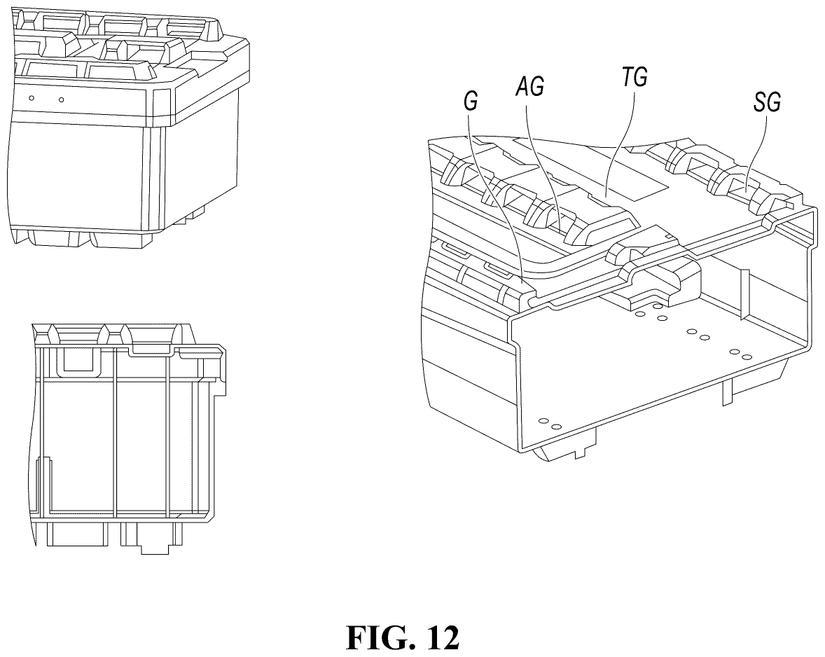

FIG. 12 shows a central rail of the lid portion.

In some aspects, a structure with a plurality of connector mechanisms spaced along first and second opposite edges/sides is provided. For example, the connector mechanisms on one side may include at least one active element. The portable structures (e.g., containers, drawers, etc.) described herein may include a housing (e.g., the container portion 28), a first mating element (e.g., the first pivotable connection element 38), and a second mating element (e.g., the locking element 46). The (portable) structure may include a first container or a second container (e.g., container 12, 14) as described herein. The housing of the portable structure may have a top wall (e.g., the lid portion 30), a bottom wall (e.g., the bottom 32), a first side wall, and a second side wall opposite the first side wall. The first mating element may have a handle portion and a cleat portion (e.g., the tooth 50). The first mating element is positioned on a first region between the bottom wall and the first side wall. The cleat portion extending laterally outward from the first region. The handle portion of the first mating element is optional. The second mating element may have a handle portion (e.g., the handle 68) and a cleat portion (e.g., lock tooth or projections 154). The second mating element is positioned in a second region between the bottom wall and the second side wall. The second mating element may be pivotally movable about a pivot axis (e.g., the pivot axis P-P) extending longitudinally along the second region. The second mating element may be biased to a first position (e.g., as shown in FIGS. 10B and 10C) in which the handle is positioned against the second region and the cleat extends laterally outward from the second region. The second mating element may be movable to a second position in which the handle is spaced laterally outward from the second region and the cleat is retracted laterally inward relative to the second region. The first mating element may be immovably positioned in the first region.

Two structures (containers), where one structure has pockets along edges and the other structure has connectors along edges are provided. The two structures may be configured to be inserted at angle and pivot down to connect. A system includes a plurality of structures including a first structure and a second structure. The first structure may include a first container (e.g., the container 12) and the second structure may include a second container (e.g., the container 14). Each structure may include a top wall (e.g., the lid portion 30), a bottom wall (e.g., the bottom 32) opposite the top wall, a first side wall, and a second side wall opposite the first side wall. Each structure may also include a first plurality of pockets (e.g., the gap G or the second gap SG) positioned on the top wall adjacent the first side wall, a second plurality of pockets (e.g., the gap G or the second gap SG) positioned on the top wall adjacent the second side wall. For example, the first and second plurality of pockets can correspond to the locking elements/pockets 48 on upper connection portions 36. Each structure may also include a first mating element (e.g., the first pivotable connection element 38) positioned on a first region between the bottom wall and the first side wall, and a second mating element (e.g., the locking element 46) positioned on a third region between the bottom wall and the second side wall. The first mating element may include a plurality of cleats (e.g., the tooth 50) extending laterally outward from the first region and may be immovable. The second mating element having a plurality of cleats (e.g., lock portion/projections 154) extending laterally outward from the third region and being pivotally movable relative to the bottom wall. The first structure may be configured to be mated to the second structure by angularly inserting the plurality of cleats of the first mating element on the first structure into one or more of the first plurality of pockets in the second structure and rotating the first structure from a first position (e.g., as shown in FIG. 8) in which the bottom wall of the first structure extends at an acute angle relative to the top wall of the second structure, to a second position (e.g., connected (stacked) configuration as shown in FIGS. 14-16) in which the bottom wall of the first structure is substantially parallel to the top wall of the second structure. The second mating element may be configured to pivot when the first structure is moved from the first position to the second position, and the plurality of cleats on the second mating element are configured to engage one or more of the second plurality of pockets when the first structure is in the second position to attach the first structure to the second structure.

An arrangement of connectors along a top of a structure (i.e., not limited to a container or a lid), namely rows along front, back, and middle is provided. Each row may have multiple undercuts/pockets. A structure may include a housing (e.g., the container portion 28 or other housing portion for the lid portion 30), a first plurality of pockets (e.g., the gap G or the second gap SG) positioned along a first edge of the top wall, and a second plurality of pockets (e.g., the gap G or the second gap SG) positioned along a second edge of the top wall. The structure may include a container (e.g., the container 12 or the container 14) or a lid portion (e.g., the lid portion 30). The housing may include a plurality of walls including a top wall (e.g., the lid portion 30), a bottom wall (e.g., the bottom 32 or other portions for the lid portion 30), a first side wall, and a second side wall, as described herein. In some aspects, the first and second side walls may be side walls of the lid portion 30. The structure may also include a third plurality of pockets, as shown in FIG. 3, spaced along axis T-T, and as seen in FIG. 12 with a central row of pockets AG and TG positioned along the top wall at a location between the first edge and second edge. The third plurality of pockets may include a first set of pockets (e.g., TG) each having an opening facing the first plurality of pockets (e.g., SG in FIG. 8), and a second set of pockets (e.g., AG) each having an opening facing the second plurality of pockets (e.g., G in FIG. 8). The first, second, and third plurality of pockets each have the same shape and size.

In some aspects, containers that may be configured to mate to same connectors in both first and second directions are provided. The first and second directions may be different (e.g., 180 degrees). In this case, the system can include a first structure and a second structure. The first structure may include a first container (e.g., the container 12) and the second structure may include a second container (e.g., the container 14). Each of the first structure and the second structure may include a plurality of walls including a top wall (e.g., the lid portion 30), a bottom wall (e.g., the bottom 32), a first side wall, and a second side wall opposite the first side wall. The first structure may have a first plurality of pockets (e.g., the gap G or the second gap SG) positioned on the top wall adjacent the first side wall, a second plurality of pockets (e.g., the gap G or the second gap SG) positioned on the top wall adjacent the second side wall. The second structure may have a first cleat (e.g., the tooth 50 or the lock tooth/projection 154) positioned on a first region between the bottom wall and the first side wall, and a second cleat (e.g., the tooth 50 or the lock tooth/projection 154) positioned on a fourth edge between the bottom wall and the second side wall. At least one of the first and second cleats being pivotally movable relative to the second structure. The second structure may be configured to be matable to the first structure in a first orientation in which the first cleat is positioned in one of the first plurality of pockets and the second cleat is positioned in one of the second plurality of pockets, and the second structure may be configured to be matable to the first structure in a second orientation in which the first cleat is positioned in one of the second plurality of pockets and the second cleat is positioned in one of the first plurality of pockets.

Two containers are provided where one container may be configured to mate at multiple positions/configurations on/with respect to the other container. The multiple positions may be multiple horizontal positions. In some aspects, one container may be configured to mate at different positions along length and width of the other container. In some aspects, one container may be configured to mate at offset/overhung configuration with respect to the other container. In some aspects, one container may be configured to mate at a forward configuration or a backward configuration with respect to the other container. In some aspects, one container may be configured to mate on sides of the other container. The mechanical structure that provides this modularity capability for the containers includes undercuts that may serve simultaneously as latching elements. A system includes a first structure and a second structure. The first structure may include a first container (e.g., the container 12) and the second structure may include a second container (e.g., the container 14). Each of the first structure and the second structure may include a plurality of walls including a top wall (e.g., the lid portion 30), a bottom wall (e.g., the bottom 32), a first side wall, and a second side wall opposite the first side wall. The first structure may have a first plurality of pockets (e.g., the gap G or the second gap SG) spaced longitudinally along the top wall adjacent to the first side wall and a second plurality of pockets (e.g., the gap G or the second gap SG) spaced longitudinally along the top wall adjacent to the second side wall. The second structure having a first cleat (e.g., the tooth 50 or the lock tooth/projection 154) positioned on a first region between the bottom wall and the first side wall and a second cleat (e.g., the tooth 50 or the lock tooth/projection 154) positioned on a second region between the bottom wall and the second side wall. At least one of the first and second cleats being pivotally movable relative to the second structure. The first cleat may be configured to be received in any one of the first plurality of pockets with the second cleat being received in a corresponding second plurality of pockets such that the second structure may be configured to be selectively mated to the first structure at a plurality of longitudinal positions.

Two containers are provided where one container may be configured to mate along middle of the other container. A system includes a first structure and a second structure. The first structure may include a first container (e.g., the container 12) and the second structure may include a second container (e.g., the container 14). Each of the first structure and the second structure may include a plurality of walls including a top wall (e.g., the lid portion 30), a bottom wall (e.g., the bottom 32), a first side wall, and a second side wall opposite the first side wall. The first structure may have a first plurality of pockets (e.g., the gap G or the second gap SG) positioned on the top wall adjacent the first edge, a second plurality of pockets (e.g., the gap G or the second gap SG) positioned along the top wall adjacent the second edge, and a third plurality of pockets (e.g., see FIG. 12 with a central row of pockets AG and TG) positioned on the top wall along a mid-portion of the top wall between the first edge and the second edge. The second structure may have a first cleat (e.g., the tooth 50 or the lock tooth/projection 154) positioned along a first region between the bottom wall and first side wall, and a second cleat (e.g., the tooth 50 or the lock tooth/projection 154) positioned along a second region between the bottom wall and the second side wall. The first cleat may be configured to engage with any one of the third plurality of pockets to connect the first structure to the second structure along the mid-portion of the top wall, and the second cleat may be configured to be moveable relative to the bottom wall and configured to engage with the first plurality of pockets or the second plurality of pockets when the first cleat is engaged with the third plurality of pockets.

A stay-open button to allow a user to press button and any time after lift the container off is provided. A system may include a first structure (e.g., the container 12 or 14) and a second structure (e.g., the container 12 or 14). The first structure may include a latch (e.g., the lock assembly 160) with a handle (e.g., the user actuatable member 68) and a cleat (e.g., the lock tooth/projections 154). The latch may be configured to be pivotally movable relative to the first structure. The latch may include a slug (e.g., the lock open member 60) movable between extended position (e.g., see FIGS. 10B, 10D and 10E) and recessed position (e.g., see FIG. 10C). The second structure may include a recess (e.g., the gap G or the second gap SG) configured to receive the cleat on the first structure so as to mate the first and second structures. When the first structure is mated to the second structure, the handle is movable from an engaged position in which the cleat is received in the recess, to a released position in which the cleat is withdrawn from the recess, movement of the handle from the engaged position to the released position causing the slug to move from the recessed position to the extended position, and the slug in the extended position maintaining the handle in the released position thereby allowing the first structure to be detached from the second structure.

A system is provided. The system may include a first structure (e.g., the container 12 or 14) and a second structure (e.g., the container 12 or 14). The first structure may include a latch body (e.g., the lock assembly 160) and a slug (e.g., the lock open member 60). The latch body may be pivotally disposed on the first structure and may be configured to rotate between first position (e.g., as shown in FIGS. 10B and 10C) and second position (e.g., as shown in FIGS. 10D and 10E). The latch body may include a handle (e.g., the user actuatable member 68) and a cleat (e.g., the lock tooth/projections 154). The slug may at least partially disposed within the latch body and may be configured move relative to the latch body between a recessed position (e.g., see FIG. 10C) and an extended position (e.g., see FIGS. 10B, 10D and 10E). The second structure (e.g., the container 12 or 14) may have a recess (e.g., the gap G or the second gap SG) configured to receive the cleat so as to mate the first structure to the second structure. As shown in FIGS. 10D and 10E, when the first structure is detached from the second structure, the latch has a first configuration in which the handle is biased to the first position and the slug biased to the extended position. As shown in FIG. 10C, when the first structure is attached to the second structure with the cleat extending into the recess, the latch has a second configuration in which the handle is biased to the first position and the slug is in the recessed position. When the first structure is attached to the second structure, the latch has a third configuration in which the slug is in the extended position to maintain the handle in the second position.

The first structure may be removable from the second structure when the latch is in the third configuration. The latch may be configured to move from the third configuration to the first configuration when the first structure is removed from the second structure.

A latch assembly (e.g., the lock assembly 160) is provided. The latch assembly may include a latch body (e.g., the lock body 166), a first biasing element (e.g., the spring/bias member 164), a slug (e.g., the lock open member 60), and a second biasing element (e.g., the lock open bias member 62). The latch body may be pivotally positioned on a structure (e.g., the container 12 or 14). The latch body may include a handle portion (e.g., the user actuatable member 68) and a plurality of cleats (e.g., the lock tooth/projections 154). The first biasing element may be positioned between the latch body and the structure. The first biasing element is configured to bias the latch body into the first position. The slug may be positioned within a recess (e.g., the opening 58) in the handle portion of the body and may be configured to move relative to the latch body between extended position (e.g., see FIGS. 10B, 10D and 10E) and retracted position (e.g., see FIG. 10C). The second biasing element may be positioned within the recess between the latch body and the slug to bias the slug into the extended position.

Each of the containers 12, 14 of the stackable container system 10 may be made from impact-resistant materials that protect tools stored therein from damage during transport and during usage in tough environments. Each of the containers 12, 14 of the stackable container system 10 may include weatherproof seals to protect tools stored therein against dust and moisture, ensuring tools remain in good condition.

The stackable container system 10 may include removable bins, adjustable dividers, and/or customizable shelving. This provides users flexibility to organize their tools and materials efficiently according to their specific requirements/based on project requirements.

The stackable container system 10 may be suitable for various harsh environments such as construction sites (e.g., environments where the containers must withstand harsh conditions such as dust, water, and heavy impacts), workshops (e.g., areas where tools stored in the containers need to be organized efficiently for quick access during various projects), home garages (e.g., personal workspaces where hobbyists and DIY enthusiasts require organized storage solutions for their tools), and mobile workstations (e.g., situations where the containers are frequently transported between different job sites, requiring ease of mobility and secure stacking).

Typical usage scenarios for the stackable container system 10 may include (a) daily tool transport (e.g., moving tools from one job site to another, ensuring they are securely stored and easy to carry), (b) project setup (e.g., organizing tools in a way that allows for quick setup and access during different phases of a project), (c) tool maintenance and storage (e.g., keeping tools in good condition and stored in a systematic manner when not in use), (d) DIY and home improvement projects (e.g., providing a flexible and portable storage solution for home projects, allowing users to carry and organize tools as needed), etc.

The stackable container system features quick-release latches that allow for easy attachment and detachment of the containers, promoting quick reconfiguration based on specific needs. The modular design of the stackable container system allows for different configurations, making it suitable for various tasks and environments. Each stackable container is designed with protuberances and channels that interlock uniformly across different sized/configuration units, ensuring a stable and secure connection.

The containers can be stacked securely on top of each other, regardless of size or shape due to standardized base design and standardized top design. The containers may be designed to fit with various platforms, including rolling carts, wall mounts, and stationary stands, allowing for versatile usage scenarios. By focusing on these connectivity features, the modular container system provides users with a highly adaptable, durable, and efficient storage solution that meets the demands of various environments and usage scenarios.

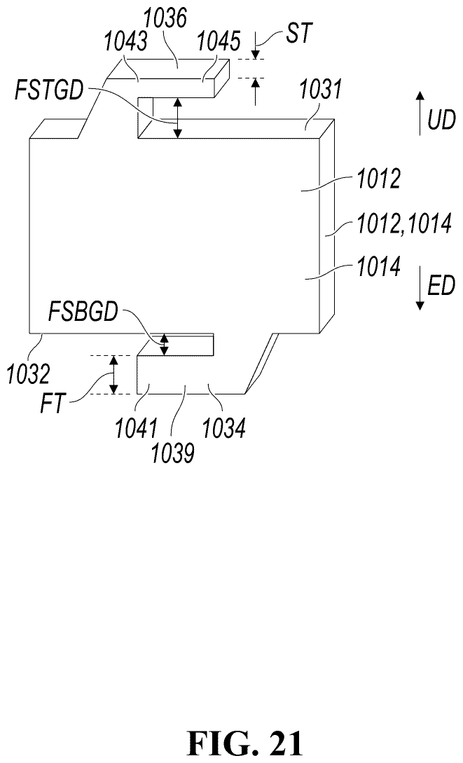

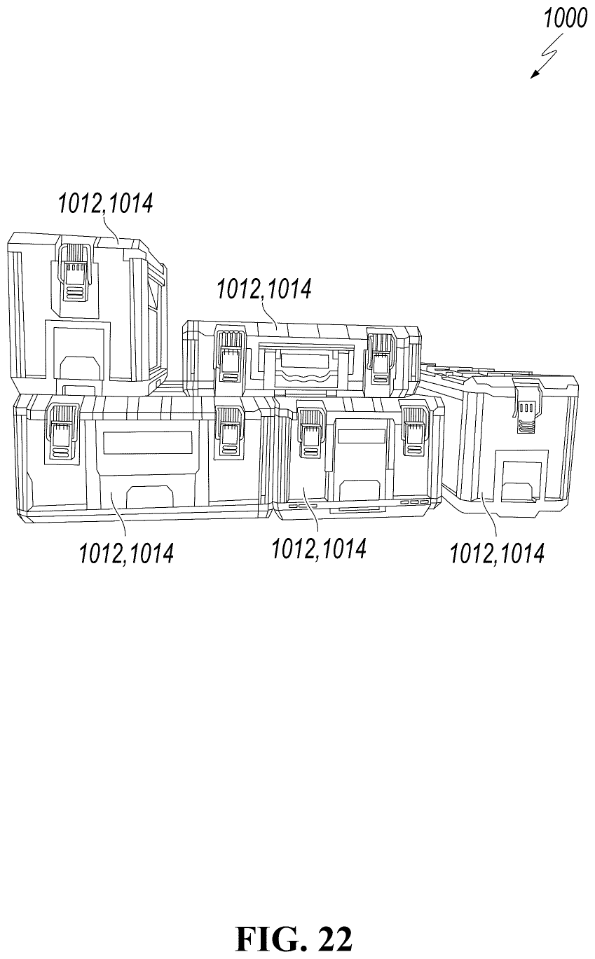

FIGS. 21-31 illustrate another embodiment container system. For example, FIGS. 22-23, 27-28 and 29 show a container system 1000. In some aspects, the container system 1000 may have similar components, configurations, and operation to the other systems described herein and, therefore, the container system 1000 will not be described in detail below except for the differences noted below.

The container system 1000 comprises a plurality of containers 1012, 1014, 1015 including at least a first container 1012, a second container 1014, and a third container 1015. The container system 1000 may also include a fourth container 1017. The number of containers in the container system 1000 may vary. The containers may be similar in configuration and operation to the other systems described herein and, therefore, the containers will not be described in detail below except for the differences noted below.

The first and the second containers 1012 and 1014 may be referred to as large containers or large boxes. The third and the fourth containers 1015 and 1017 may be referred to as small containers or small boxes. The first and the second containers 1012, 1014 may be larger (in size (length/width/height), volume, weight, etc.) than the third and the fourth containers 1015, 1017. That is, the third and the fourth containers 1015, 1017 may be smaller in size (length/width/height), volume, weight, etc.) than the first and the second containers 1012, 1014.

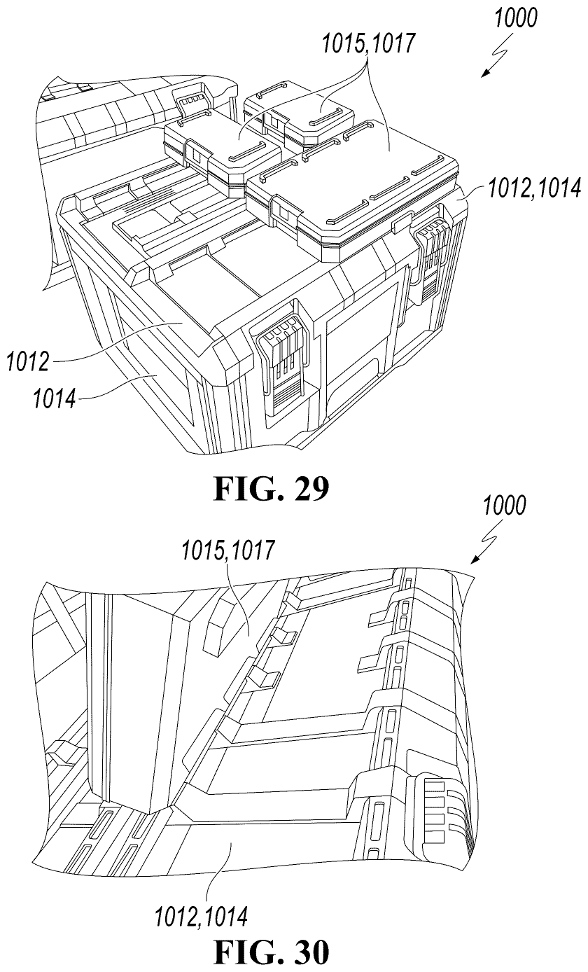

It is noted that the container system 1000 may include any combination of large and small containers. For example, FIG. 29 shows the container system 1000 having one first/second container 1012, 1014, and three third/fourth containers 1015, 1017. Also, as shown in FIG. 29, the third/fourth containers 1015, 1017 may have different shapes, sizes and configurations.

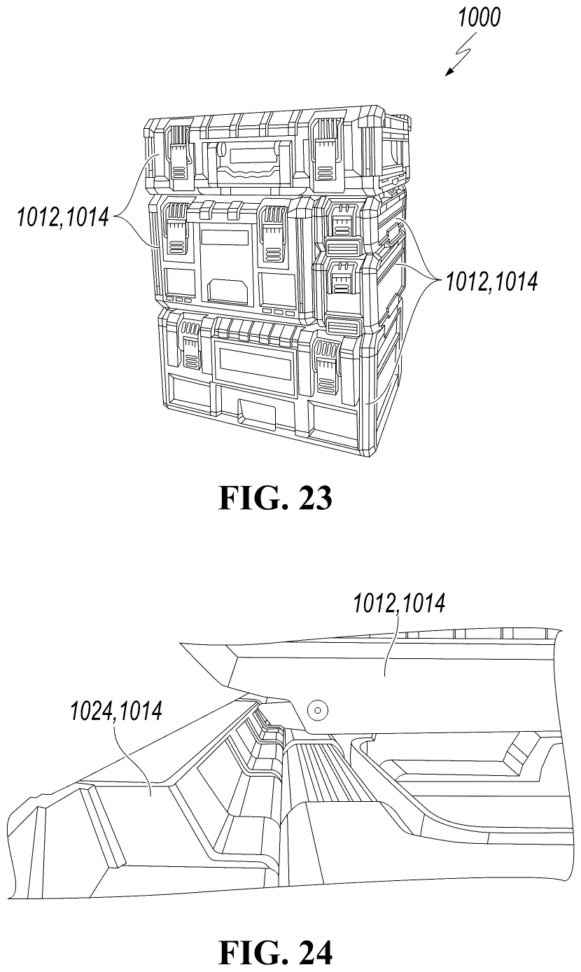

The container system 1000 may include the first and the second containers 1012 and 1014 as shown in FIGS. 22-24. As shown in FIGS. 22-23, the first and the second containers 1012 and 1014 may have different shapes, sizes and configurations. The first and the second containers 1012 and 1014 may be configured to be connected to each other in different ways as shown in FIG. 22. For example, one of the first and the second containers 1012 and 1014 may be stacked at 90 degrees, 180 degrees, or 270 degrees with respect to and releasably connected on top of the other of the first and the second containers 1012 and 1014. One first/second container 1012, 1014 may be stacked and releasably connected on top of two first/second containers 1012 and 1014. FIG. 24 illustrates two first containers 1012 being connected to each other, two second containers 1014 being connected to each other, or the first container 1012 being connected to the second container 1014.

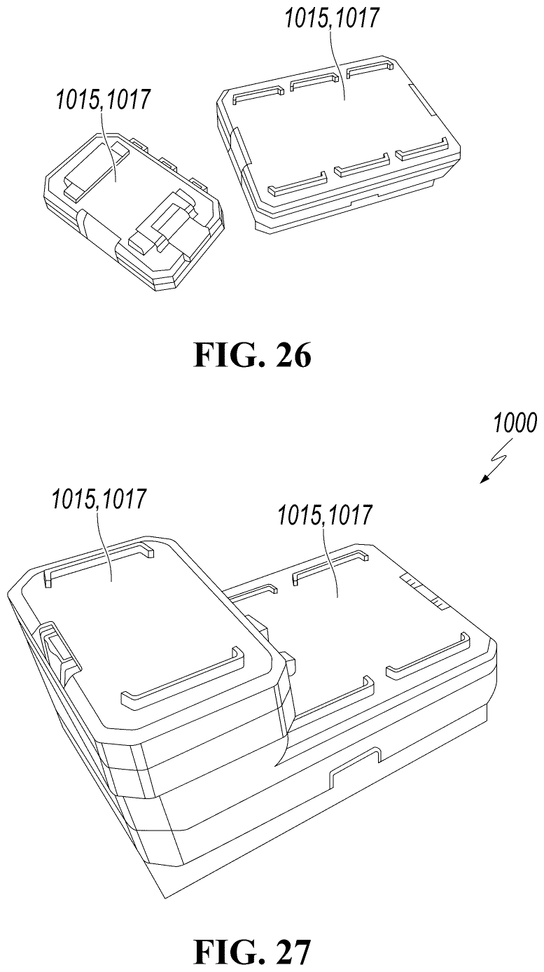

In some aspects, the container system 1000 may include the third and the fourth containers 1015 and 1017 as shown in FIGS. 26-27. FIG. 26 shows two third containers 1015 before being connected to each other, two fourth containers 1017 before being connected to each other, or the third container 1015 before being connected to the fourth container 1017. FIG. 27 illustrates two third containers 1015 after being connected to each other, two fourth containers 1017 after being connected to each other, or the third container 1015 after being connected to the fourth container 1017.

In some aspects, the container system 1000 may also include one or more medium containers that may be larger (in size (length/width/height), volume, weight, etc.) than the third and the fourth containers 1015, 1017 and may be smaller (length/width/height), volume, weight, etc.) than the first and the second containers 1012, 1014. The medium container may be configured to be stacked and releasably connected on top of the large container. The small container may be configured to be stacked and releasably connected on top of the medium container (and/or on top of the larger container). The medium container may also be configured to be stacked and releasably connected on top or on bottom of another medium container. The medium container may not be configured to be stacked and releasably connected on top of the small container. The large container may also not be configured to be stacked and releasably connected on top of the medium container.

In some aspects, one or more of the containers described herein (e.g., the medium container) may not be built to hold the load of another larger container. Similarly, the small container may not be built to hold the load of the medium container (or larger container). Accordingly, in some aspects, each container described herein can be provided with one or more teeth on top and bottom surfaces thereof, where the teeth are designed protrude from the top and the base, respectively, by a gap distance that is specifically sized according to the container size. In some aspects, the one or more teeth provided on the tops of containers described herein can also be referred to as pockets and the one or more teeth provided on the bases of the containers described herein can be referred to as cleats. By sizing the gap distance of the top teeth/pockets and bottom teeth/cleats based on the container size, the systems described herein can advantageously prevent larger containers from being mounted on top of smaller containers. This safety functionality is achieved through dimensional incompatibilities between connecting features of different sized containers.

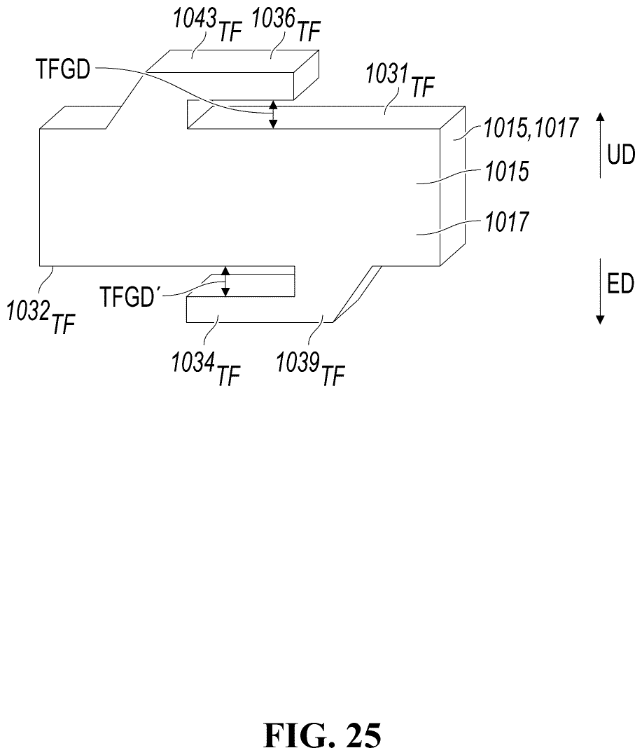

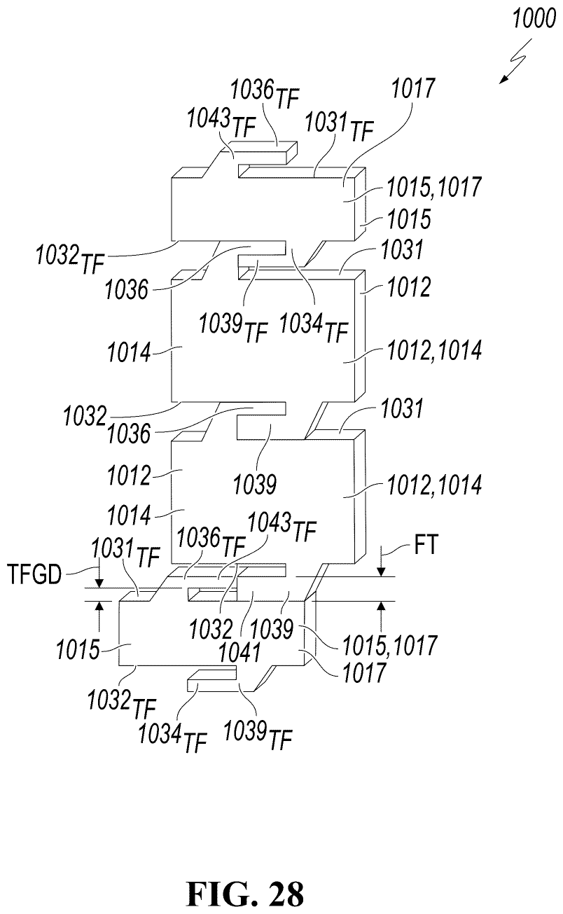

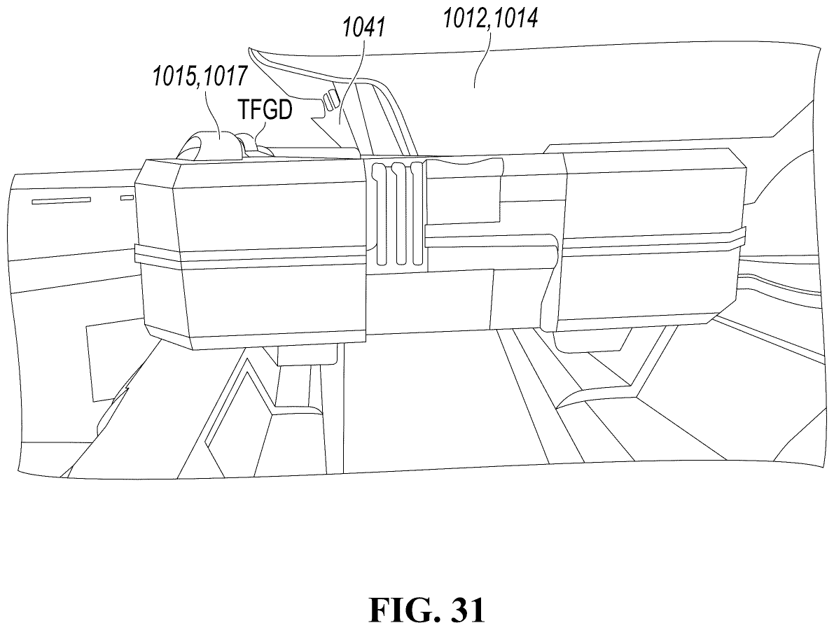

For example, as shown in FIGS. 21 and 28, a first structure (e.g., large container 1012, 1014) includes a first plurality of walls defining a first volume may include first plurality of connecting features (such as first top connector 1043 with first top tooth 1045) positioned along the top wall, and second plurality of connecting features (such as first bottom connector 1039 with first bottom tooth 1041) positioned along the bottom wall. As shown in FIGS. 25 and 28, a second structure (e.g., small container 1015, 1017) inlcudes a second plurality of walls defining a second volume that is less than the first volume may include third plurality of connecting features (such as third top connector 1043_{TF}) positioned along its top wall, and fourth plurality of connecting features (such as third bottom connector 1039_{TF}) positioned along its bottom wall. In some aspects, the fourth plurality of connecting features (third bottom connector 1039_{TF}) can be sized to allow for engagement with the first plurality of connecting features (first top connector 1043), allowing the smaller second structure to mount on top of the larger first structure. However, in some aspects, the second plurality of connecting features (first bottom connector 1039) can be sized to be incompatible with the third plurality of connecting features (third top connector 1043_{TF}), to prevent the larger first structure from mounting on top of the smaller second structure. For example, FIG. 31 shows how a thickness FT of bottom tooth 1041 of the larger container 1012, 1014 is larger than a gap distance TFGD (on the top) of the small container 1015, 1017 so as to prevent connection between the top connector of the small container 1015, 1017 with bottom connector of the large container 1012, 1014. The thickness FT and the gap distance TFGD are described in detail in the discussions below.

Referring to FIG. 28, the second container 1014 and the third container 1015 are each configured to releasably connect on top of the first container 1012. For example, the second container 1014 and the first container 1012 may be large containers and the third container 1015 may be small container.

FIGS. 22-24 show the second container 1014 that is configured to releasably connect on top of the first container 1012. Referring to FIGS. 28 and 29, the third container 1015 is configured to releasably connect on top of the first container 1012. FIG. 29 shows three third containers 1015 (having different shapes, sizes, and configuration) that are configured to releasably connect on top of the first container 1012. The number of third containers 1015 that are releasably connected on top of the first container 1012 may vary. FIG. 30 shows the third container 1015 as it being releasably connected on top of the first container 1012.

Referring to FIG. 28, the first container 1012 and the third container 1015 are each configured to releasably connect on top of the second container 1014.

FIGS. 22-24 show the first container 1012 is configured to releasably connect on top of the second container 1014. Referring to FIGS. 28 and 29, the third container 1015 is configured to releasably connect on top of the second container 1014. FIG. 29 shows three third containers 1015 (having different shapes, sizes, and configuration) are configured to releasably connect on top of the second container 1014. The number of third containers 1015 that are releasably connected on top of the second container 1014 may vary. FIG. 30 shows the third container 1015 as it being releasably connected on top of the second container 1014.

The first and the second containers 1012, 1014 each comprises a bottom portion 1032 and a top portion 1031.

The bottom portion 1032 of the first container 1012 has a first bottom connection portion 1034 with a first bottom connector 1039. The first bottom connection portion 1034 and the first bottom connector 1039 may be configured to protrude/extend downwardly (in the direction of an arrow ED) from the bottom portion 1032 of the first container 1012. The first bottom connector 1039 has a first bottom tooth 1041 with a first thickness FT. The first thickness FT of the first bottom tooth 1041 may include a distance between the top surface and the bottom surface of the first bottom tooth 1041. As shown, the first thickness may be 2X (where X is a variable). A gap distance between the top surface of the first bottom tooth 1041 and a surface of the bottom portion 1032 may be FSBGD. As shown, the gap distance of the first bottom tooth 1041 (from the bottom portion 1032) FSBGD may be X (where X is a variable). The first bottom connector 1039 may have similar configuration and operation as first locking element of the first connection portion and/or first pivotable connection element of the first connection portion described above.

The top portion 1031 of the first container 1012 has a first top connection portion 1036 with a first top connector 1043. The first top connection portion 1036 and the first top connector 1043 may be configured to protrude/extend upwardly (in the direction of an arrow UD) from the top portion 1031 of the first container 1012. The first top connector 1043 has a first top tooth 1045 having a second thickness ST. The second thickness ST of the first top tooth 1045 may include a distance between the top surface and the bottom surface of the first bottom tooth 1045. As shown, the second thickness ST may be X (where X is a variable). A gap distance between the bottom surface of the first top tooth 1045 and a surface of the top portion 1031 may be FSTGD. As shown, the gap distance of the first top tooth 1045 (from the top portion 1031) FSBGD may be 2X (where X is a variable). The first top connector 1043 may have similar configuration and operation as second locking element of the second connection portion and/or second pivotable connection element of the second connection portion described above.

Similarly, the bottom portion 1032 of the second container 1014 has a second bottom connection portion 1034 with a second bottom connector 1039. The top portion 1031 of the second container 1014 has a second top connection portion 1036 with a second top connector 1043. The gap distances and the tooth thickness of the second container 1014 are same as those described with respect to the first container 1012 and, therefore, will not be discussed here again. The second bottom connector 1039 may have similar configuration and operation as first locking element of the first connection portion and/or first pivotable connection element of the first connection portion described above. The second top connector 1043 may have similar configuration and operation as second locking element of the second connection portion and/or second pivotable connection element of the second connection portion described above.

As shown in FIG. 28, the first container 1012 is selectively connectable to the second container 1014 in at least two mating configurations i) wherein the first bottom connector 1039 of the first container 1012 is matingly connected to the second top connector 1043 of the second container 1014, and ii) wherein the second bottom connector 1039 of the second container 1014 is matingly connected to the first top connector 1043 of the first container 1012. In the first configuration, the first container 1012 is releasably connected on the top of the second container 1014. In the second configuration, the second container 1014 is releasably connected on the top of the first container 1012.

Referring to FIG. 25, the third container 1015 comprises a top portion 1031_{TF} having a third top connector 1043_{TF} and a bottom portion 1032_{TF} having a third bottom connector 1039_{TF}. The third container 1015 may have a third top connection portion 1036_{TF} with the third top connector 1043_{TF} and may have a third bottom connection portion 1034_{TF} with the third bottom connector 1039_{TF}. The third bottom connection portion 1034_{TF} and the third bottom connector 1039_{TF} may be configured to protrude/extend downwardly (in the direction of an arrow ED) from the bottom portion 1032_{TF} of the third container 1015. The third top connection portion 1036_{TF} and the third top connector 1043_{TF} may be configured to protrude/extend upwardly (in the direction of an arrow UD) from the top portion 1031_{TF} of the third container 1015. The third bottom connector 1039_{TF} may have similar configuration and operation as first locking element of the first connection portion and/or first pivotable connection element of the first connection portion described above. The third top connector 1043_{TF} may have similar configuration and operation as second locking element of the second connection portion and/or second pivotable connection element of the second connection portion described above.

As shown in FIG. 28, the third container 1015 may be configured to be selectively connectable to i) the first container 1012 wherein the third bottom connector 1039_{TF} of the third container 1015 is connected to the first top connector 1043 of the first container 1012 in a mating configuration, and ii) the second container 1014 wherein the third bottom connector 1039_{TF} of the third container 1015 is connected to the second top connector 1043 of the second container 1014 in a mating configuration. In the first configuration, the third container 1015 is releasably connected on the top of the first container 1012. In the second configuration, the third container 1015 is releasably connected on the top of the second container 1014.

The first bottom connector 1039 and the third top connector 1043_{TF} may have a non-mating configuration preventing the first bottom connector 1039 from being connected to the third top connector 1043_{TF}.

Referring to FIGS. 21, 25, and 28, the third top connector 1043_{TF} of the third container 1015 has a gap distance TFGD. The gap distance TFGD may be a distance between the bottom surface of the third top connector 1043_{TF} and a surface of the top portion 1031_{TF}. As shown, the gap distance of the third top connector 1043_{TF} (from the top portion 1031_{TF}) TFGD may be X (where X is a variable). The gap distance TFGD is configured to be less than the first thickness FT of the first bottom tooth 1041 of the first container 1012 to prevent connection between the third top connector 1043_{TF} of the third container 1015 and the first bottom connector 1039 of the first container 1012. This dimensional incompatibility creates a safety mechanism where the first plurality of pockets (defined by gap TFGD between third top connector 1043_{TF} and surface of top portion 1031_{TF}) are smaller than the first plurality of cleats (bottom connection portion 1034 with first bottom connector 1039), preventing the larger first container from being positioned on top of the smaller third container. The first plurality of cleats are larger than the first plurality of pockets, preventing the first plurality of cleats from being positioned within the first plurality of pockets.

Referring to FIG. 25, the third bottom connector 1039_{TF} of the third container 1015 may comprise a second gap distance TFGD'. The gap distance TFGD′ may be a distance between the top surface of the third bottom connector 1039_{TF} and a surface of the bottom portion 1032_{TF}. As shown, the gap distance of the third bottom connector 1039_{TF} (from the bottom portion 1032_{TF}) TFGD′ may be X (where X is a variable). The second gap distance TFGD′ may be configured to be equal to or greater than the first thickness FT of the first top tooth 1045 to allow connection of the third bottom connector 1039_{TF} of the third container 1015 and the first top connector 1043 of the first container 1012. This dimensional compatibility allows the second plurality of cleats (bottom connection portion 1034_{TF} with third bottom connector 1039_{TF}) to engage with the second plurality of pockets (defined by gap FSTGD between bottom surface of first top tooth 1045 and surface of top portion 1031), enabling the smaller third container to be positioned on top of the larger first container. The second plurality of cleats are sized to fit within the second plurality of pockets, allowing proper mating between the smaller and larger containers in this orientation.

The first bottom connection portion 1034 of the first container 1012 and second bottom connection portion 1034 of the second container 1014 each may further comprise a movable lock member. The movable lock member may be movable between a locked configuration and a released configuration with respect to either i) the first top connection portion 1036 of the first container 1012 or ii) the second top connection portion 1036 of the second container 1014. The movable lock member may have similar configuration as the second locking element of the second connection portion described above.

The third bottom connection portion 1034_{TF} of the third container 1015 may further comprise a movable lock member. The movable lock member may be movable between a locked configuration and a released configuration with respect to the first top connection portion 1036 of the first container 1012 or the second top connection portion 1036 of the second container 1014. The movable lock member may have similar configuration as the second locking element of the second connection portion described above.

In some aspects, the first top connection portion of the first container 1012 and second top connection portion of the second container 1014 each may further comprise a movable lock member. The movable lock member may be movable between a locked configuration and a released configuration with respect to either i) the first bottom connection portion of the first container 1012 or ii) the second bottom connection portion of the second container 1014. In some aspects, the third top connection portion of the third container 1015 may further comprise a movable lock member. The movable lock member may be movable between a locked configuration and a released configuration with respect to the first bottom connection portion of the first container 1012 or the second bottom connection portion of the second container 1014.

As shown in FIGS. 25-31, the container system 1000 may further comprise the fourth container 1017. The fourth container 1017 may comprise a top portion 1031_{TF} having a fourth top connector 1043_{TF} and a bottom portion 1032_{TF} having a fourth bottom connector 1039_{TF}. The fourth container 1017 may have a fourth top connection portion 1036_{TF} with the fourth top connector 1043_{TF} and may have a fourth bottom connection portion 1034_{TF} with the fourth bottom connector 1039_{TF}. The thickness of the tooth/connectors and the gap distances of the tooth/connectors of the fourth container 1017 may be similar to those described with respect to the third container 1015 and, therefore, will not be described in detail here again. The fourth container 1017 has a fourth volume that is less than the first volume of the first container 1012, similar to the third container 1015. The dimensional relationships between the fourth container 1017 and other containers follow the same safety principles, where larger containers cannot mount on smaller containers due to incompatible connecting feature dimensions. The fifth plurality of connecting features (fourth top connector 1043_{TF}) and sixth plurality of connecting features (fourth bottom connector 1039_{TF}) are dimensionally configured to prevent larger containers from mounting on top while allowing smaller containers to mount on larger ones.

The fourth container 1017 may be selectively connectable to i) the first container 1012 wherein the fourth bottom connector 1039_{TF} of the fourth container 1017 is connected to the first top connector 1043 of the first container 1012 in a mating configuration, ii) the second container 1014 wherein the fourth bottom connector 1039_{TF} of the fourth container 1017 may be connected to the second top connector 1043 of the second container 1014 in a mating configuration, and iii) the third container 1015 wherein the fourth bottom connector 1039_{TF} of the fourth container 1017 is connected to the third top connector 1043_{TF} of the third container 1015 in a mating configuration. In these configurations, the fourth container 1017 may be configured to be releasably connected to be on top of the first container 1012, on top of the second container 1014, or on top of the third container 1015.

The fourth container 1017 may also be selectively connectable to the third container 1015 wherein the fourth bottom connector 1043_{TF} of the fourth container 1017 is connected to the third bottom connector 1034_{TF} of the third container 1015. In this configuration, the fourth container 1017 may be configured to be releasably connected to the bottom of the third container 1015. The safety functionality ensures that while the smaller fourth container 1017 can mount on larger containers (first container 1012, second container 1014) and similar-sized containers (third container 1015), the larger containers cannot mount on top of the smaller fourth container 1017 due to the dimensional incompatibilities between their respective connecting features. This prevents unsafe loading conditions where smaller containers would need to support the weight of larger containers above them.

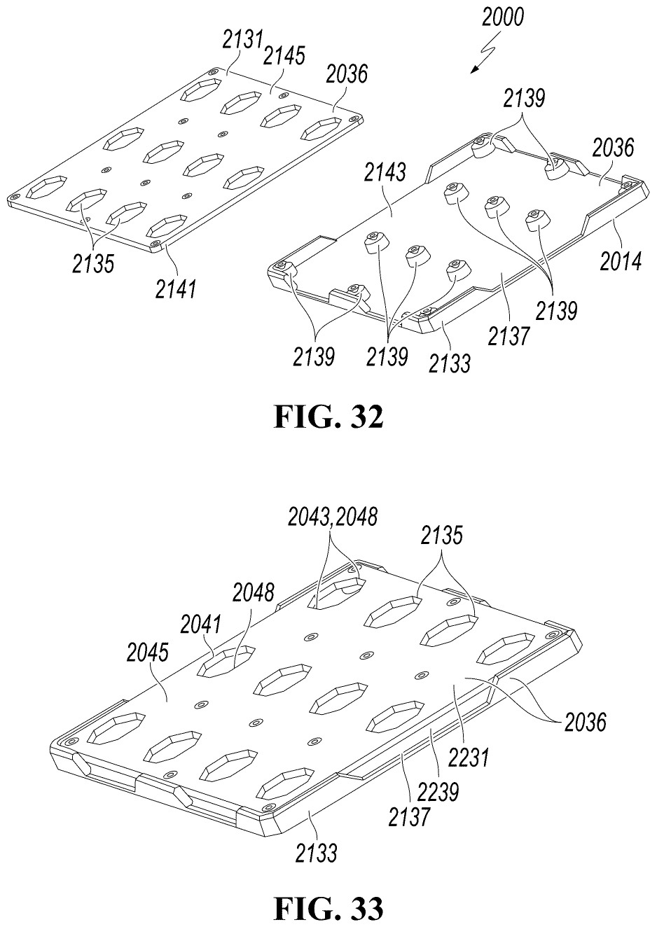

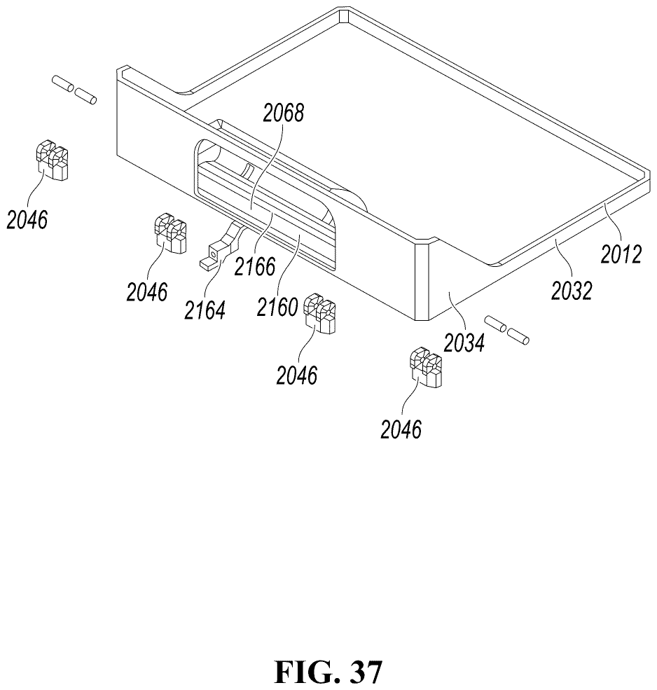

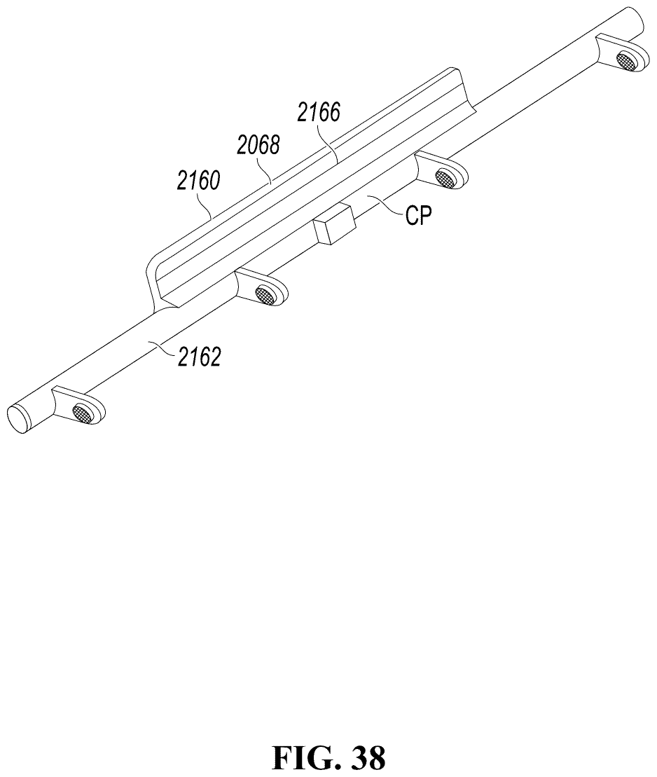

Referring to FIGS. 32-52, a stackable component system 2000 is provided. The stackable component system 2000 comprises a plurality of stackable components 2012, 2014 including at least a first component 2012 and a second component 2014. The first component 2012 may include a first container 2012 and the second component 2014 may include a second container 2014. For illustrative purposes, partial or cutaway views of containers 2012, 2014 are shown instead of the entire containers 2012, 2014. Each of the first container 2012 and the second container 2014 may include a container portion and a lid portion as described herein.

The components of the stackable component system 2000 may also be referred to as modules. The components/modules may include, but not limited to, tools, charger/charging devices, power storage devices, other construction/jobsite equipment, light, radio, fan, charger, cup, flashlight, thermos, etc.

The first component 2012 and the second component 2014 may include the same type of components. That is, the first component 2012 and the second component 2014 may be containers. In some aspects, the first component 2012 and the second component 2014 may include different types of components. For example, one of the first component 2012 and the second component 2014 may include a container 2012 and the other of the first component 2012 and the second component 2014 may include other types of components/modules as discussed above.

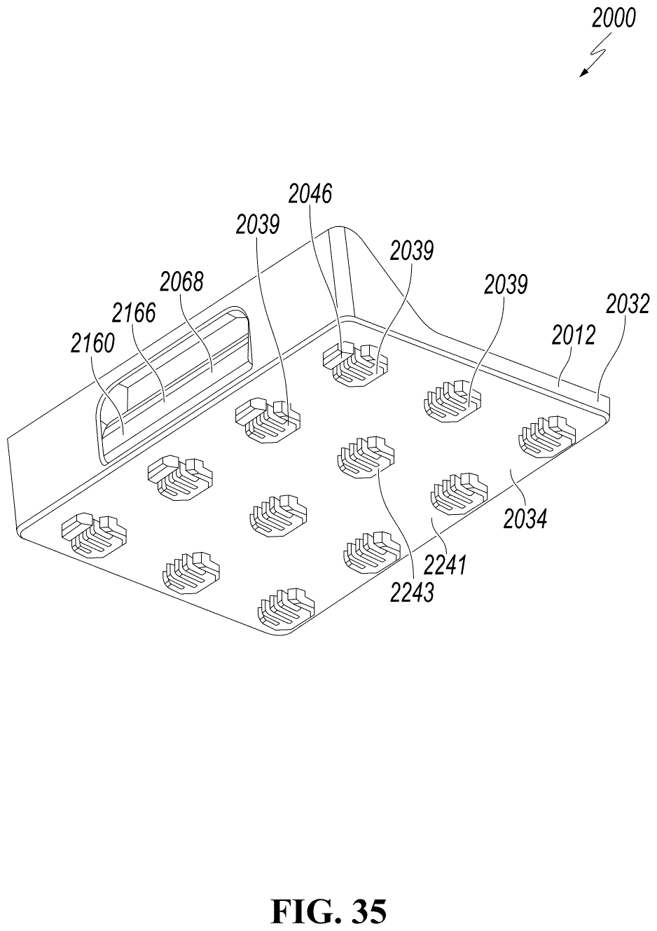

The first component 2012 comprises a first connection portion 2034 (as shown in and described in detail with respect to FIGS. 35-44A), the second component 2014 comprises a second connection portion 2036 (as shown in and described in detail with respect to FIGS. 32-34 and 44A) that is connectable with the first connection portion 2034 of the first component 2012. That is, the first component 2012 and the second component 2014 may be configured to be releasably connected to each other via the first connection portion 2034 and the second connection portion 2036.

In some aspects, one of the first component 2012 and the second component 2014 may be releasably connectable on top/bottom of the other of the first component 2012 and the second component 2014. For example, the bottom of the container portion (of one of the first container 2012 and the second container 2014) may include the first connection portion 2034, and the lid portion (of other of the first container 2012 and the second container 2014) may include the second connection portion 2036 that is connectable with the first connection portion 2034. The bottom of the container portion of the first container 2012 has the first connection portion 2034, and the lid portion of the second container 2014 has the second connection 2036 that is connectable with the first connection portion 2034. In some aspects, one of the first component 2012 and the second component 2014 may be releasably connectable to any of the sides of the other of the first component 2012 and the second component 2014. One of the sides of one of the first component 2012 and the second component 2014 may be releasably connectable one of the sides of the other of the first component 2012 and the second component 2014.

As will be explained in detail with respect to FIGS. 35-44C, the first connection portion 2034 may include a first connector 2039 on the first connection portion 2034. As will be explained in detail with respect to FIGS. 32-34 and 44A, the second connection portion 2036 may include a second connector 2043 on the second connection portion 2036. The first and second connection portions 2034, 2036 may have mutually engageable lock elements 2046, 2048. The lock elements 2046, 2048 may include a first lock element 2046 on the first connection portion 2034 and a second lock element 2048 on the second connection portion 2036. The first lock element 2046 and/or the second lock element 2048 may include a movable lock member. The movable lock member is movable between a locked configuration and a released configuration. In some aspects, one of the first lock element 2046 and the second lock element 2048 may include a movable lock member and the other of the first lock element 2046 and the second lock element 2048 may include an edge of the opening 2135 that is configured to engage with the one of the first lock element 2046 and the second lock element 2048.

FIGS. 32, 33, and 34 show an exploded view, an assembled view and a top elevational view, respectively, of the second connection portion 2036. For example, the second connection portion 2036 may be configured to be disposed on top/a lid portion of one of the first component 2012 and the second component 2014. In some aspects, the second connection portion 2036 may be configured to be disposed on side of one of the first component 2012 and the second component 2014.

Referring to FIGS. 32-33, the second connection portion 2036 may include a first member 2131 and a second member 2133. The first member 2131 may include apertures 2135 therein and may have a plate/flat/planar configuration. The first member 2131 and the second member 2133 may be integrally formed or may be removably connected to each other (via fasteners through members 2139). The first member 2131 and the second member 2133 may be disposed in a spaced apart configuration. That is, the first member 2131 and a bottom surface 2137 of the second member 2133 may each be disposed in planes that are parallel to each other. The spaced apart configuration may be provided by the members 2139 that are disposed (may be integrally formed) on the second member 2133. As shown, twelve members 2139 are shown. The number of the members 2139 may vary. The space between a bottom surface 2141 of the first member 2131 and a top surface 2143 of the second member 2133 may be configured to receive at least portions of the first lock element 2046 and the first connector 2039 when the first component 2012 and the second component 2014 are releasably connected to each other.

The second member 2133 may be part (integrally formed or attached) of the second component 2014 and the first member 2131 may then be connected/attached to the second member 2133. In some aspects, the first member 2131 and the second member 2133 may be connected to each other, and then the second connection portion 2036 (including the first member 2131 and the second member 2133) may then be connected/attached to the second component 2014.

The second connector 2043 of the second component 2014 and the second lock element 2048 of the second component 2014 may each comprise a top surface 2145 and the bottom surface 2141. The first lock element 2046 and the first connector 2039 may each extend above the top surface 2145 and below the bottom surface 2141 of both the second lock element 2048 and the second connector 2043 when the first component 2012 and the second component 2014 are releasably connected to each other.

The second connection portion 2036 may further comprise a first aperture 2135. The first lock element 2046 and the first connector 2039 may each be disposed within the first aperture 2135 of the second connection portion 2036 when the first component 2012 and the second component 2014 are releasably connected to each other (i.e., in both the first and the second configurations as will be explained in discussion in detail below).

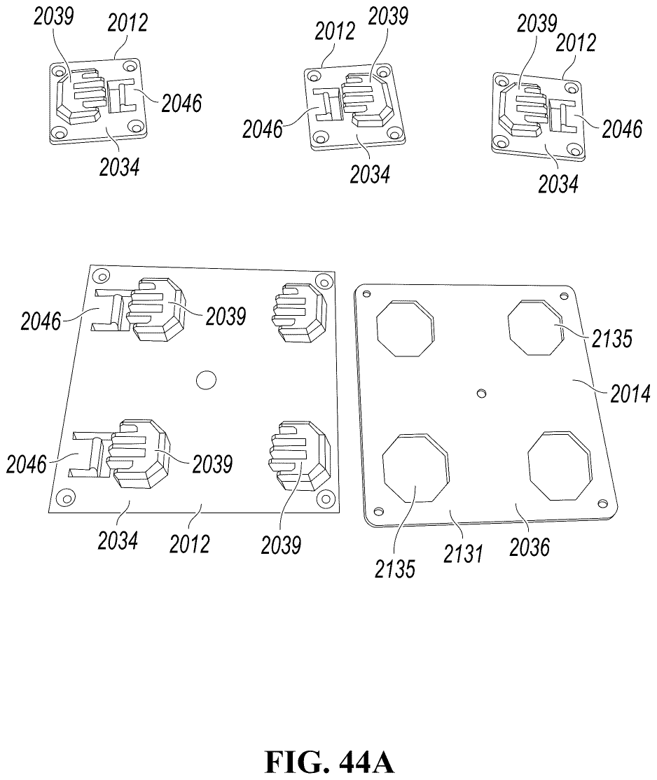

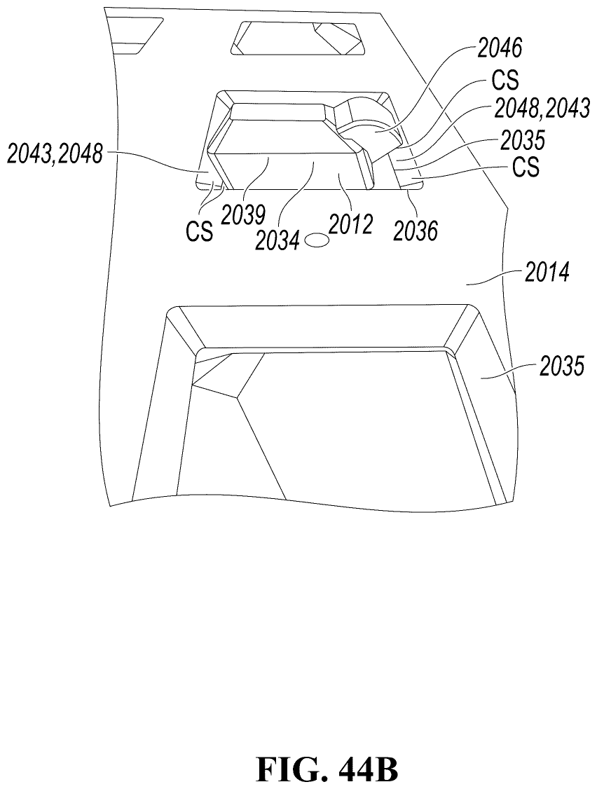

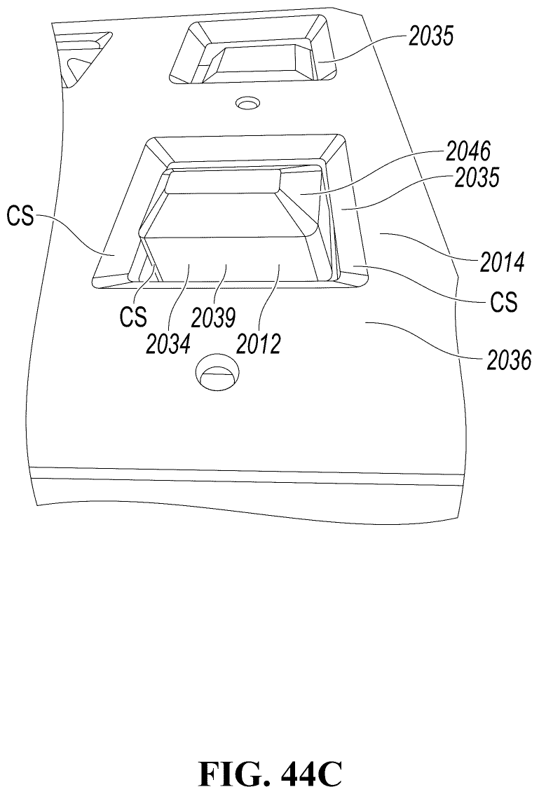

As shown in FIGS. 32-34, the second connection portion 2036 is shown to have sixteen apertures 2135. As shown in FIG. 44A, the second connection portion 2036 may include four apertures 2135. The number of apertures 2135 may vary. The aperture 2135 may include an octagonal shaped aperture having eight sides. The aperture may have other shaped configurations include, but not limited to, square, hexagon, decagon, or dodecagon shaped configurations.

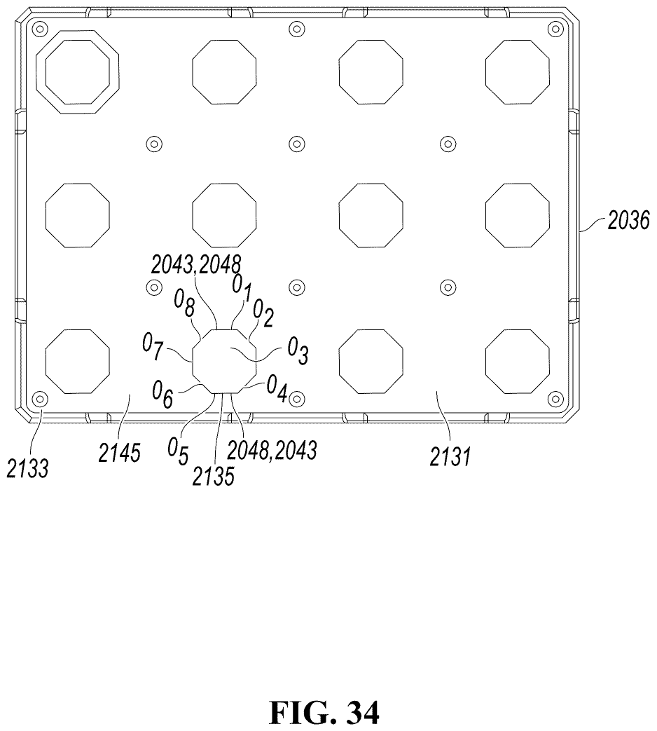

Referring to FIG. 34, the octagonal aperture 2135 may include eight sides O₁, O₂, O₃, O₄, O₅, O₆, O₇, and O₈. Each of the sides O₁, O₂, O₃, O₄, O₅, O₆, O₇, and O₈ of the aperture 2135 may be configured to function as either the connector 2043 of the second connection portion 2036 or the lock element 2048 of the second connection portion 2036. For example, one of the sides O₁, O₂, O₃, O₄, O₅, O₆, O₇, and O₈ of the aperture 2135 may function as the connector 2043 of the second connection portion 2036 and the other of the sides O₁, O₂, O₃, O₄, O₅, O₆, O₇, and O₈ of the aperture 2135 may function as the lock element 2048 of the second connection portion 2036. The side(s) that may function as the connector 2043 of the second connection portion 2036 and the side(s) that may function as the lock element 2048 of the second connection portion 2036 may be disposed diametrically opposite to each other of the aperture 2135.

For example, one of the sides O₁, O₅ of the aperture 2135 may function as the connector 2043 of the second connection portion 2036 and the other of the sides O₁, O₅ of the aperture 2135 may function as the lock element 2048 of the second connection portion 2036. Similarly, one of the sides O₂, O₆ of the aperture 2135 may function as the connector 2043 of the second connection portion 2036 and the other of the sides O₂, O₆ of the aperture 2135 may function as the lock element 2048 of the second connection portion 2036. One of the sides O₃, O₇ of the aperture 2135 may function as the connector 2043 of the second connection portion 2036 and the other of the sides O₃, O₇ of the aperture 2135 may function as the lock element 2048 of the second connection portion 2036. One of the sides O₄, O₈ of the aperture 2135 may function as the connector 2043 of the second connection portion 2036 and the other of the sides O₄, O₈ of the aperture 2135 may function as the lock element 2048 of the second connection portion 2036.

In some aspects, instead of one side discussed above, one of the combination of sides O₁-O₄ and sides O₅-O₈ of the aperture 2135 may function as the connector 2043 of the second connection portion 2036 and the other of the combination of sides O₁-O₄ and sides O₅-O₈ of the aperture 2135 may function as the lock element 2048 of the second connection portion 2036. The combination of the sides of the aperture 2135 may vary. For example, instead of sides O₁-O₄ or sides O₅-O₈, the combination may include sides O₂-O₅ and sides O₆-O₁; include sides O₃-O₆ and sides O₇-O₂; or include sides O₄-O₇ and sides O₈-O₃. The sides of the aperture 2135 in the combination of sides of the aperture 2135 may be adjacent to each other.

The number of sides in the combination of sides of the aperture 2135 may vary. For example, instead of four sides in the above discussion, the combination may include two sides in an octagonal shaped aperture. The combination may include two sides in a square shaped aperture. The combination may include two sides, or five sides in a decagonal shaped aperture. The combination may include two sides, three sides, four sides, or six sides in a dodecagonal shaped aperture.

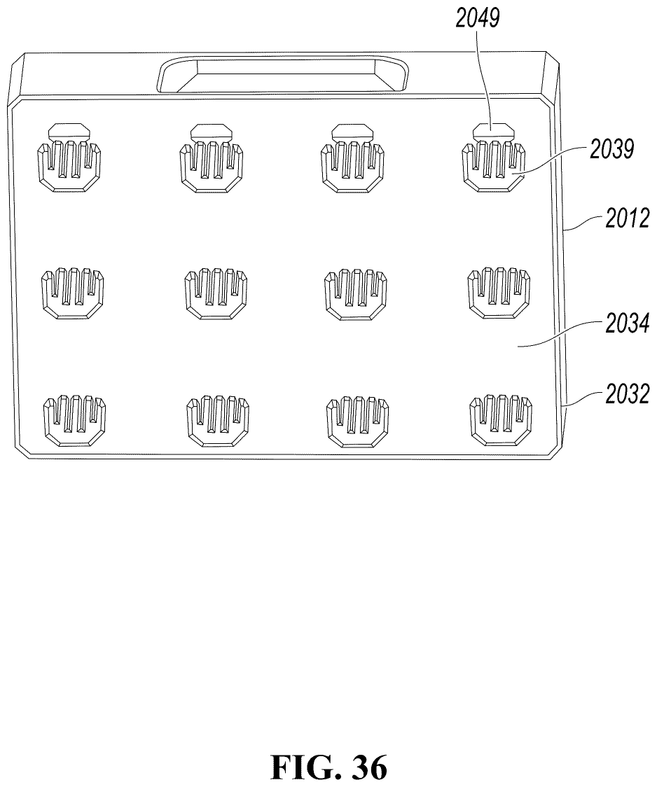

FIG. 35 shows a perspective view of the first connection portion 2034 and a lock assembly 2160. FIG. 36 shows another perspective view of the first connection portion 2034 of FIG. 35, where portions of the lock assembly 2160 including the first lock element(s) 2046 and user actuatable member 2068 are not shown to better illustrate the other portions.

Referring to FIGS. 35 and 36, the first connection portion 2034 may include sixteen first connectors 2039 and four first lock members 2046. That is, the first lock members 2046 may be included in the front row/side along with the front row/side first connectors 2039. The number of the first connectors 2039 and the first lock members 2046 may vary. For example, FIG. 44A shows the first connection portion 2034 may include four first connectors 2039 and may include two first lock members 2046. As shown in FIG. 36, the first connection portion 2034 may also include openings 2049 that are configured to receive and allow the first lock members 2046 to pass therethrough. The number of openings 2049 may vary and may correspond to the number of the lock members 2046. The first connection portion 2034 may be configured to be disposed on bottom of one of the first component 2012 and the second component 2014. In some aspects, the first connection portion 2034 may be configured to be disposed on side of one of the first component 2012 and the second component 2014.

As shown, the first connector 2039 may include a four sided (half octagonal) shaped configuration that may correspond with the shape of the aperture 2135. The number of sides the first connector 2039 may have may vary. The first connector 2039 may include a one side (of the octagonal) shaped configuration. In some aspects, the first connector 2039 may have a L-shaped, C-shaped, U-shaped, or F-shaped cross-sectional configurations. Some of the surfaces of the L-shape, F-shape, C-shape, or U-shape may be configured to extend (and/or engage with) above the top surface 2145 and below the bottom surface 2141 of the both the lock element 2048 and the connector 2043 of the second component 2014. For example, as shown in FIG. 35, the first connector 2039 includes an underhang portion 20390 which extends under a face 2241 of the connection portion 2034 creating a gap 2243 between the face 2241 and the underhang portion 20390. Although the underhang portion 20390 is described as an underhang, depending on the orientation of the component 2012 (e.g., flipped upside down), the underhang portion 2039ₒ can be described as an overhang or extending over the face 20390.

Referring to FIGS. 35-43, the lock assembly 2160 may interchangeably referred to as a rotatable or pivotable latch lever. The lock assembly 2160 may be disposed on the bottom 2032 of the upper/first component 2012. The lock assembly 2160 may include a lock body 2166 and a spring or a bias member 2164. The lock assembly 2160 may include (i) a user actuatable member 2068 configured to be actuated by a user and (ii) the first lock elements 2046 on the first connection portion 2034. The user actuatable member 2068 may be interchangeably referred as a handle or lever.

The lock assembly 2160 may be configured to be movable between (a) a lock position in which the first lock element 2046 is configured to lockingly engage with either the lock element 2048 or the connector 2043 of the second connection portion 2036 and (b) a release position in which the first lock element 2046 disengages from either the lock element 2048 or the connector 2043 or the connector 2043 of the second connection portion 2036 so as to release the first component 2012 from the second component 2014. The bias member/spring 2164 may be configured to bias the lock assembly 2160 between its lock position and its release position.

The first lock elements 2046 of the first connection portion 2034 may be part of the lock body 2166. The lock body 2166 may include one or more first locking elements 2046. Each first locking element 2046 includes the first lock tooth 2154. As shown, the lock body 2166 includes four first lock elements 2046 and four corresponding first lock teeth 2154. The one or more first locking elements 2046 (and four corresponding first lock teeth 2154) may be spaced apart from each other. The lock body 2166 may also include the handle 2068 and a member 2162. The handle 2068 may be configured to be actuatable by the user. That is, the user actuates the lock assembly 2160 using the handle 2068.

The one or more first lock elements 2046 may be fixedly connected (e.g., integrally formed or formed separately and coupled together) to the member 2162 and may extend downwardly (and away) from the member 2162. The handle 2068 may also be fixedly connected (e.g., integrally formed or formed separately and coupled together) to the member 2162 and may extend upwardly (and away) from the member 2162. The one or more first lock elements 2046 may be spaced part from each other along the member 2162. The handle 2068 may be disposed in the central portion CP of the member 2162. The one or more first lock elements 2046 may be disposed on both sides of the handle 2068 (and on both sides of the central portion CP of the member 2162).

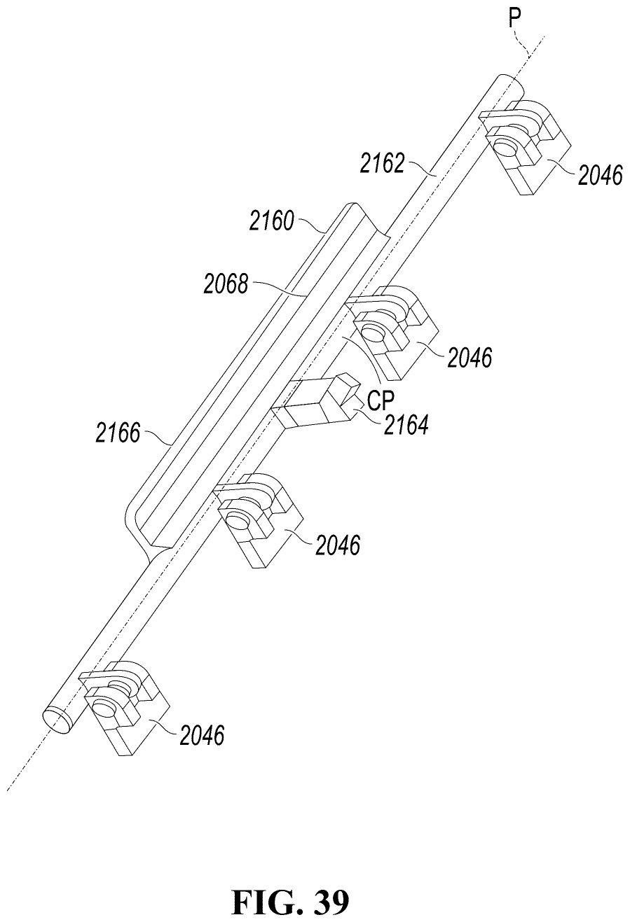

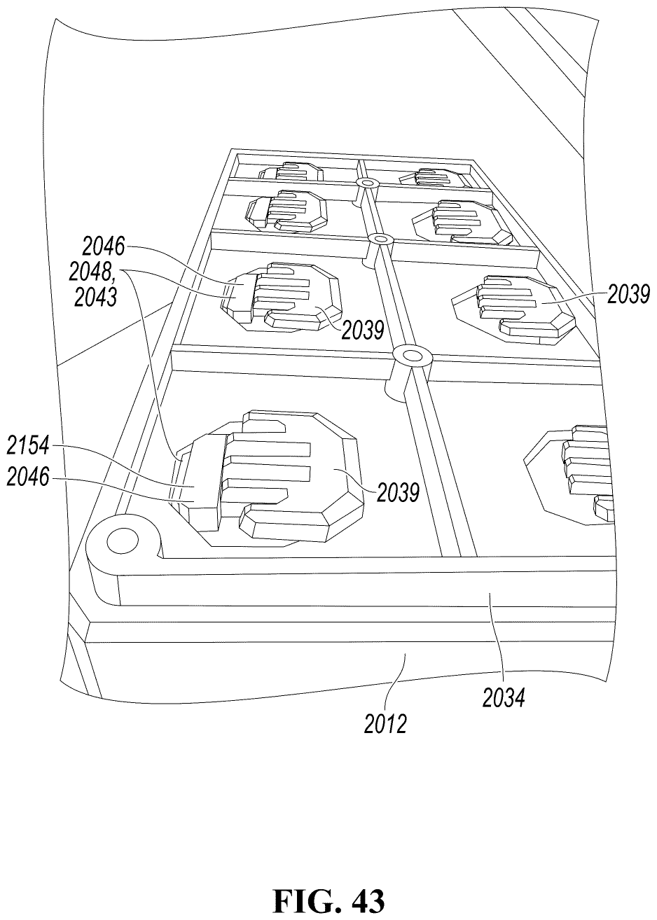

Referring to FIGS. 39-44A, the spring 2164 is configured to bias the lock body 2166 toward its first position in which the first lock teeth 2154/first lock elements 2046 of the first component 2012 engage with the lock elements 2048 or the connectors 2043 of the second component 2014 to releasably lock the components 2012, 2014 to each other. For example, as shown in FIG. 43, the lock teeth 2154/lock elements 2046 are extended in a locked position to take up space between the lock elements 2048 or the connectors 2043 and the connector 2039, thereby blocking sliding movement between the lock elements 2048 or the connectors 2043 and the connector 2039. The lock element 2048, when extended in the locked position, fills up the space between the lock elements 2048 or the connectors 2043 and the connector 2039 so as to prevent the connector 2039 from sliding away from the corresponding the lock elements 2048 or the connectors 2043 (i.e., the overhang 20390 of the connector 2039 still extends over the portion 2237 (FIG. 44A) of the second component 2014 adjacent to the opening 2135).

One end of the spring 2164 may be operatively connected to the bottom 2032 of the first component 2012 and the other end of the spring 2164 may be operatively connected to the lock body 2166. The rotating lock body 2166 may be configured to cause the movement of the lock member 2046 between the lock position and the un-locked position. The lock body 2166 is in the form of the bar 2162 that is offset from the lock element 2046. The bar 2162 may include rigid arms that are connected to the top surfaces of the lock elements 2046. The arms may be pivotally connected to the lock elements 2046, e.g., using bolts/fasteners. When the lock body 2166 rotates in a counterclockwise direction, the arms of the bar 2162 move upward, thereby pulling the lock elements 2046 upward. When the lock body 2166 rotates in a clockwise direction, the arms of the bar 2162 move downward, thereby moving the lock elements 2046 downward. The pivotal connection allows the arms of the bar 2162 to move in a circumferential motion while the lock elements 2046 move linearly upward or downward.

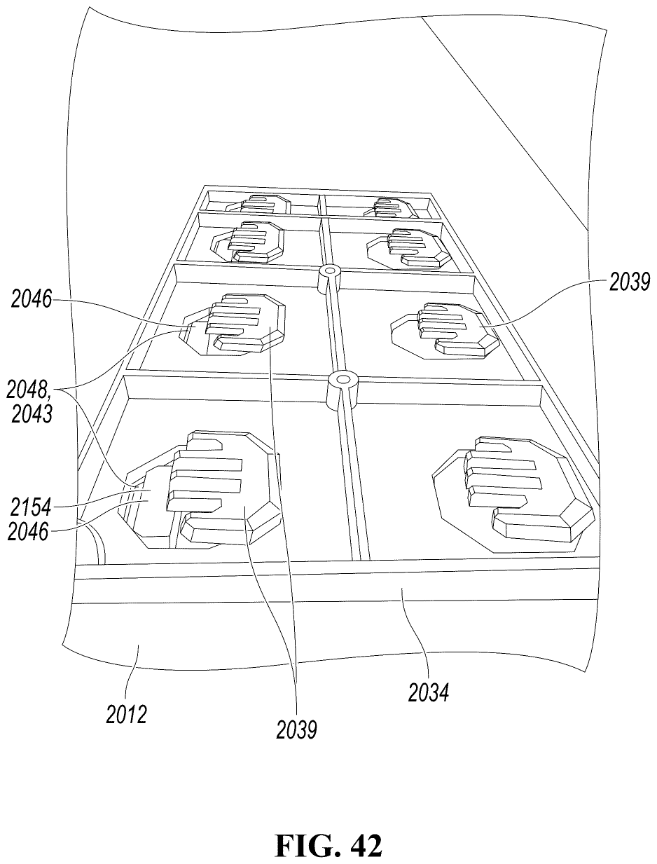

The member 2162 may be configured to be pivoted or rotated about the pivot axis P-P. The user may actuate the handle 2068 to pivot or rotate the lock body 2166 about the pivot axis P-P and against the bias of the spring 2164. This causes the first lock elements 2046 of the first component 2012 to disengage from the lock elements 2048 or the connectors 2043 of the second component 2014. For example, as shown in FIG. 42, the lock teeth 2154/lock elements 2046 are retracted to an un-locked position lower than the lock elements 2048 or the connectors 2043, thereby allowing sliding movement between the lock elements 2048 or the connectors 2043 and the connector 2039. The lock element 2048, when retracted to the un-locked position, allows the connector 2039 to slide away from the corresponding the lock elements 2048 or the connectors 2043 (i.e., the overhang 20390 of the connector 2039 does not extend over the portion 2237 (FIG. 44A) of the second component 2014 adjacent to the opening 2135).

The number of the first lock elements 2046 and the second lock elements 2048 and/or the connectors 2043 may vary depending on the size, shape and/or configuration of the component 2012, 2014. The number of the first lock elements 2046 and the second lock elements 2048 are all exemplary and may vary.

The spacing of lock elements 2046, 2048 may be configured to be consistent/same across all different sized components of the stackable component system. This configuration enables a first sized component may be stacked on top of a second, different sized component. That is, the components of the stackable component system may not be limited or restricted to a configuration in which only a first full sized component may be stacked on top of a second full sized component. For example, this configuration may allow (a) half sized component can be stacked across the entire width and on top of a full sized lower component, (b) long components to be disposed on just one side of a different (full) sized lower component, or (c) any other stacking configuration as would be appreciated by a person of ordinary skill in the art.

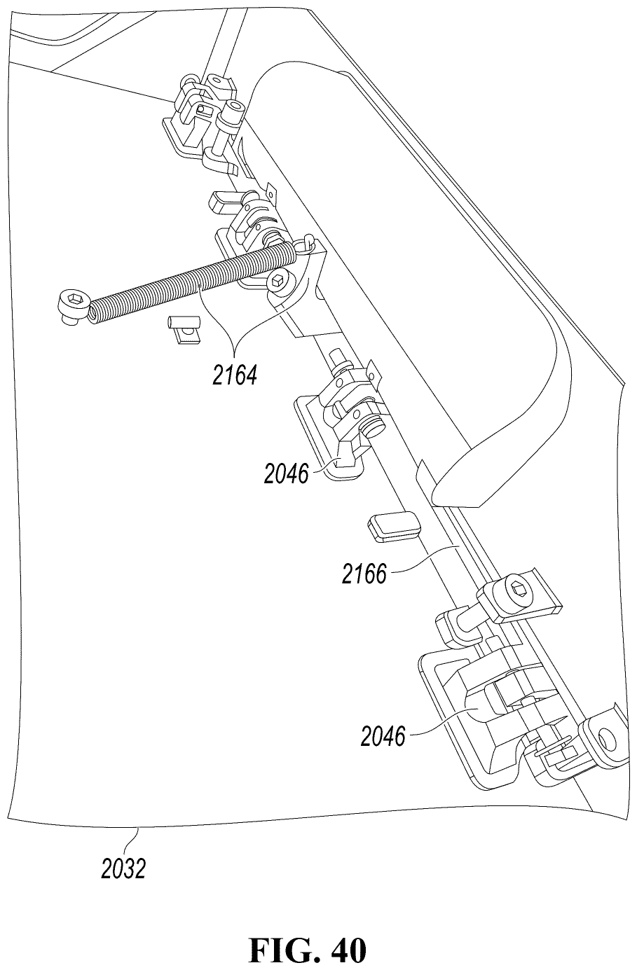

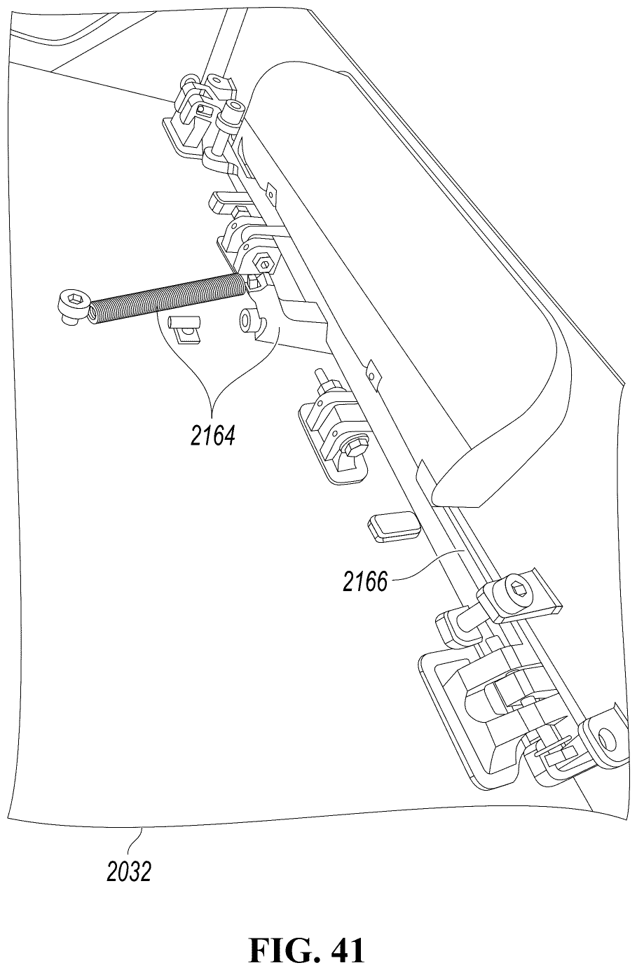

FIGS. 40 and 41 show the lock assembly 2160. In FIG. 40, the lock assembly 2160 is in a released configuration with the first lock elements 2046 retracted/disengaged from the lock elements 2048 or connectors 2043 of the second connection portion 2036. In FIG. 41, the lock assembly 2160 is in a locked configuration with the first lock elements 2046 are extended and being engaged with the lock elements 2048 or connectors 2043 of the second connection portion 2036.

FIGS. 42 and 43 show the first connection portion 2034 configured to be disposed on (e.g., the bottom of) the component 2012, 2014. In FIG. 42, the lock assembly 2160 is in a released configuration with the first lock elements 2046 retracted/disengaged from the lock elements 2048 or connectors 2043 of the second connection portion 2036. In FIGS. 35, 42, and 44A, the first connector 2039 is still engaged with the corresponding lock elements/connectors 2043/2048 (with the overhang 20390 extending over/under the portion 2237 of the first body 2014 and the gap 2242 of the connector 2039 receiving portions of the corresponding lock elements/connectors 2043/2048) because the lock elements/connectors 2046 extend into the at least one of the plurality of openings 2035 and disposed in the gap 2135G between the first connector 2039 and the lock elements/connectors 2043/2048 (that corresponds to the lock elements/connectors 2046). The gap 2135G (as shown in FIG. 42) may be part of the opening 2135 and may be between the first connector 2039 and the lock elements/connectors 2043/2048 (that corresponds to the lock elements/connectors 2046). However, because the first lock elements 2046 are configured to be retracted/disengaged from the gap 2135G between the first connector 2039 and the lock elements/connectors 2043/2048 (that corresponds to the lock elements/connectors 2046), the connector 2039 is free to disengage by sliding past the corresponding lock elements/connectors 2043/2048 (with the overhang 20390 does not extend over/under the portion 2237 of the first body 2014 and the gap 2242 of the connector 2039 not receiving portions of the corresponding lock elements/connectors 2043/2048). In FIG. 43, the lock assembly 2160 is in a locked configuration with the first lock elements 2046 are extended and being engaged with the lock elements 2048 or connectors 2043 of the second connection portion 2036. The connector 2039 is not free to slide and therefore the first and second containers/components are restricted from separating. In some aspects, the edges of the connector 2039 and the lock element 2046 may be tapered to assist in guiding the connector 2039 and the lock element 2046 into the aperture 2135 for engagement.

As described in FIGS. 35-43, the first lock elements 2046 may have a configuration in which the first teeth/lock elements may be extended or retracted to lock or release the first lock elements 2046 with the lock elements 2048 or connectors 2043 of the second connection portion 2036 (to releasably connect the first container 2012 and the second container 2014) using the lock assembly arrangement. As shown in FIG. 44A, the stackable component system may not include the lock assembly and the first lock elements 2046 may have flexible elements/mechanism/members that are configured to lock or release the first lock elements 2046 with the lock elements 2048 or connectors 2043 of the second connection portion 2036 to releasably connect the first container 2012 and the second container 2014. That is, the first lock elements 2046 may include a flexible portion (e.g., cantilever structure) with a distal end protrusion portion. The flexible portion allows the connector 2039 to engage with the second connection portion 2036 by moving out of the way so the connector 2039 can fit into the aperture 2135. When the connector 2039 is fully engaged with the corresponding lock elements 2048 or connectors 2043 of the second container 2014, then the flexible portion is biased to move the protrusion portion into engagement with the corresponding lock elements 2048 or connectors 2043 of the second container 2014. In some aspects, the protrusion portion may be tapered along its engagement surface to assist with moving the protrusion portion out of the way for disengagement of the protrusion portion with the lock elements 2048 or connectors 2043 of the second container 2014. For example, the protrusion portion may be tapered along its long edges (e.g., to allow disengagement by sliding in a direction opposite of engagement sliding) and/or tapered along its short edges (e.g. to allow disengagement by twisting of the containers).

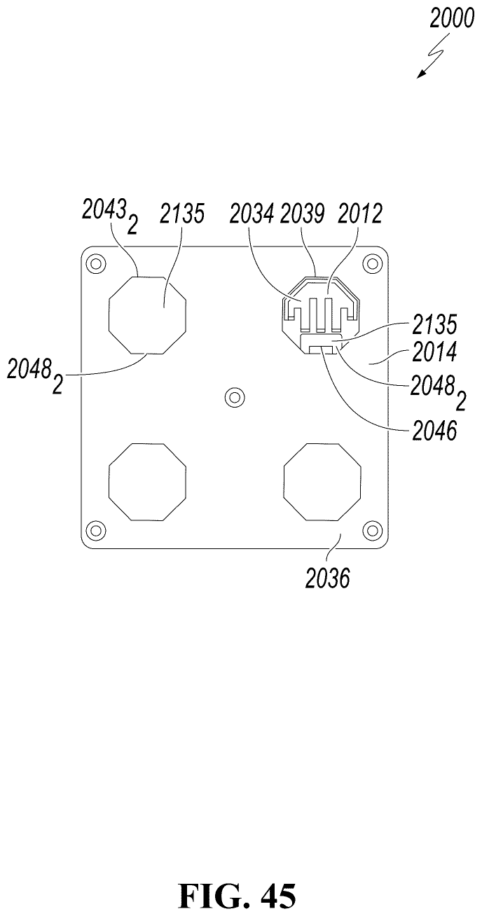

FIGS. 45-52 show exemplary first through eighth configurations in which the first connector 2039 of the first component 2012 is connected to one of second through fifth connectors 20432-20435 or second through fifth lock elements 20482-20485 of the second component 2014 and the first lock element 2046 of the first component 2012 is connected to the other of the second through fifth connectors 2043₂-2043₅ or the second through fifth lock elements 2048₂-2048₅ of the second component 2014. As noted above, the stackable component system 2000 may include more than or less than eight configurations. The eight configurations, and the octagonal apertures and connectors are exemplary. In one, the second component 2014 may include more or less than four lock elements and/or four connectors.

FIGS. 45-52 show bottom elevational views of the first component 2012 and the second component 2014 releasably connectable to one another in one of the eight configurations, some portions of the first component 2012 and the second component 2014 are not shown to better illustrate other portions of the first component 2012 and the second component 2014.

Also, as the connectors and the lock elements of the second components 2014 are not clearly visible when the first component 2012 and the second component 2014 releasably connectable to one another, the connectors and the lock elements of the second component 2014 are identified/referenced in the adjacent aperture 2135 (instead of the aperture 2135 in which the first connector 2039 and the first lock element 2046 of the first component 2012 are received) for sake of clarity and cannot be construed to be limiting in anyway.

The second connector of the second component 2014 may also be referred to as 2043₂, the third connector of the second component 2014 may be referred to as 2043₃, the fourth connector of the second component 2014 may be referred to as 2043₄, and the fifth connector of the second component 2014 may be referred to as 2043₅. Also, the second lock element of the second component 2014 may be referred to as 2048₂, the third lock element of the second component 2014 may be referred to as 2048₃, the fourth lock element of the second component 2014 may be referred to as 2048₄, and the fifth lock element of the second component 2014 may be referred to as 2048₅.

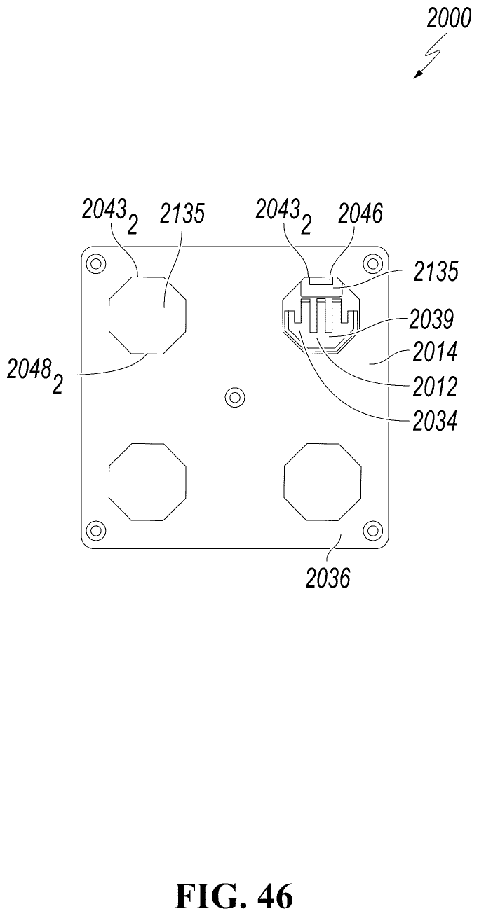

Referring to FIGS. 45-46, the first component 2012 and the second component 2014 may be releasably connectable to one another in at least two configurations, including: i) a first configuration, and ii) a second configuration. That is, referring to FIG. 45, the first component 2012 and the second component 2014 are releasably connectable to one another in the first configuration in which the first connector 2039 of the first component 2012 is connected to the second connector 2043, 2043₂ of the second component 2014, and the first lock element 2046 of the first component 2012 is connected to the second lock element 2048, 2048₂ of the second component 2014. Referring to FIG. 46, the first component 2012 and the second component 2014 are releasably connectable to one another in the second configuration in which the first lock element 2046 of the first component 2012 is connected to the second connector 2043, 2043₂ of the second component 2014, and the first connector 2039 of the first component 2012 is connected to the second lock element 2048, 2048₂ of the second component 2014.

The first lock element 2046 of the first component 2012 may comprise the movable lock member. The movable lock member of the first lock element 2046 may be configured to be moved into the locked configuration with respect to the second lock element 2048 of the second component 2014 when the first and the second components 2012, 2014 are in the first configuration. The movable lock member of the first component 2012 may be configured to be moved into the locked configuration with respect to the second connector 2043 of the second component 2014 when the first and the second components 2012, 2014 are in the second configuration.

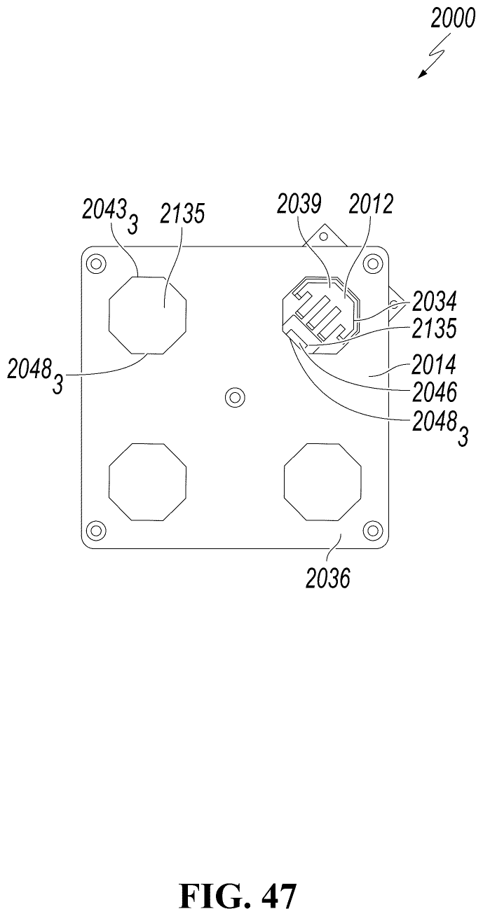

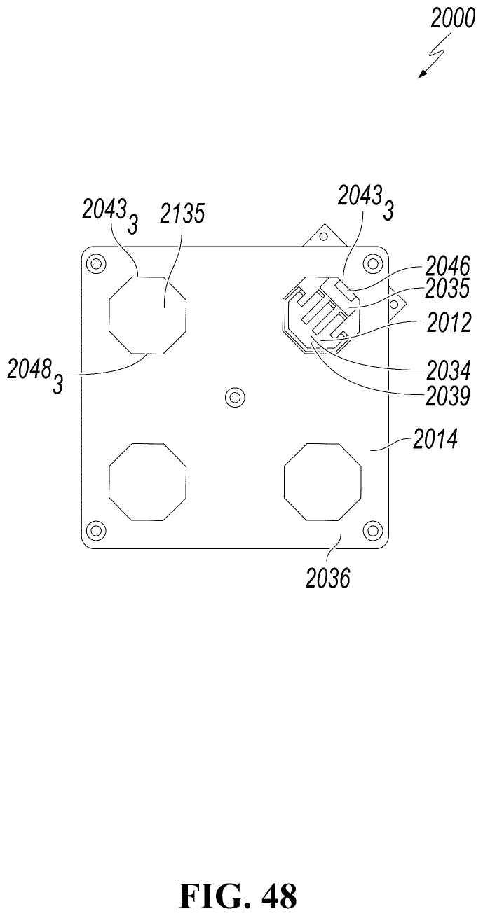

The second connection portion 2036 may further comprise the third connector 2043₃ and the third lock element 2048₃. The first component 2012 and the second component 2014 may releasably be connectable to one another in at least four configurations, including i) the first configuration (as shown in FIG. 45), ii) the second configuration (as shown in FIG. 46), iii) a third configuration (as shown in FIG. 47) in which the first connector 2039 of the first component 2012 may be connected to the third connector 2043₃ of the second component 2014, and the first lock element 2046 of the first component 2012 is connected to the third lock element 2048₃ of the second component 2014, and iv) a fourth configuration (as shown in FIG. 48) in which the first lock element 2046 of the first component 2012 may be connected to the third connector 2043₃ of the second component 2014, and the first connector 2039 of the first component 2012 is connected to the third lock element 2048₃ of the second component 2014.

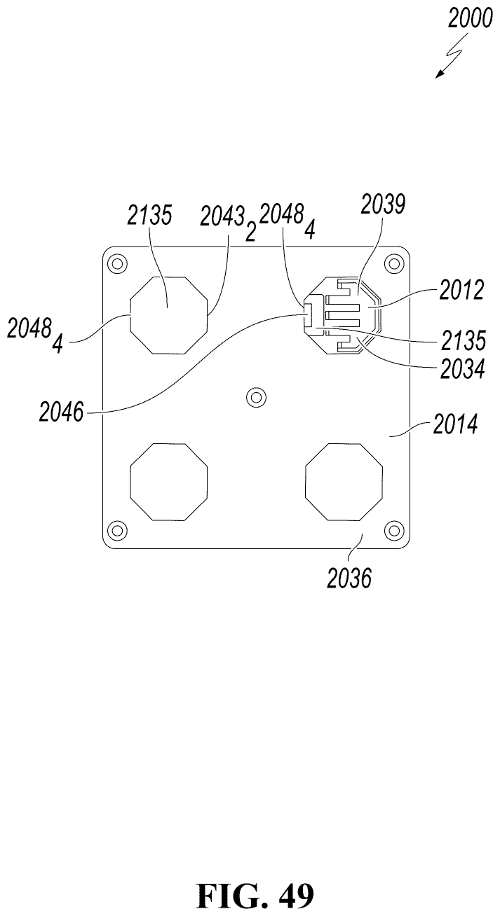

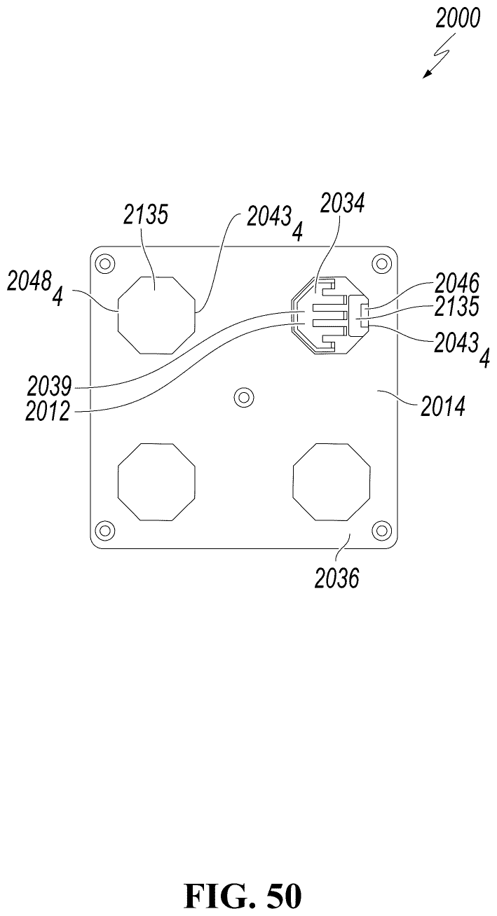

The second connection portion 2036 may further comprise a fourth connector 2043₄ and a fourth lock element 2048₄. The first component 2012 and the second component 2014 may be releasably connectable to one another in at least six configurations, including: i) the first configuration (as shown in FIG. 45), ii) the second configuration (as shown in FIG. 46), iii) a third configuration (as shown in FIG. 47), and iv) a fourth configuration (as shown in FIG. 48), v) a fifth configuration (as shown in FIG. 49) in which the first connector 2039 of the first component 2012 may be connected to the fourth connector 2043₄ of the second component 2014, and the first lock element 2046 of the first component 2012 is connected to the fourth lock element 2048₄ of the second component 2014, and vi) a sixth configuration (as shown in FIG. 50) wherein the first lock element 2046 of the first component 2012 may be connected to the fourth connector 2043₄ of the second component 2014, and the first connector 2039 of the first component 2012 is connected to the fourth lock element 2048₄ of the second component 2014.

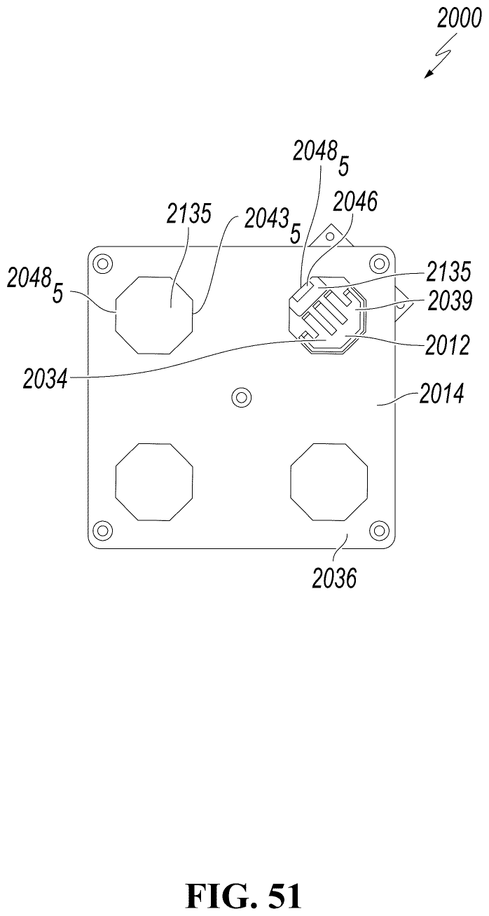

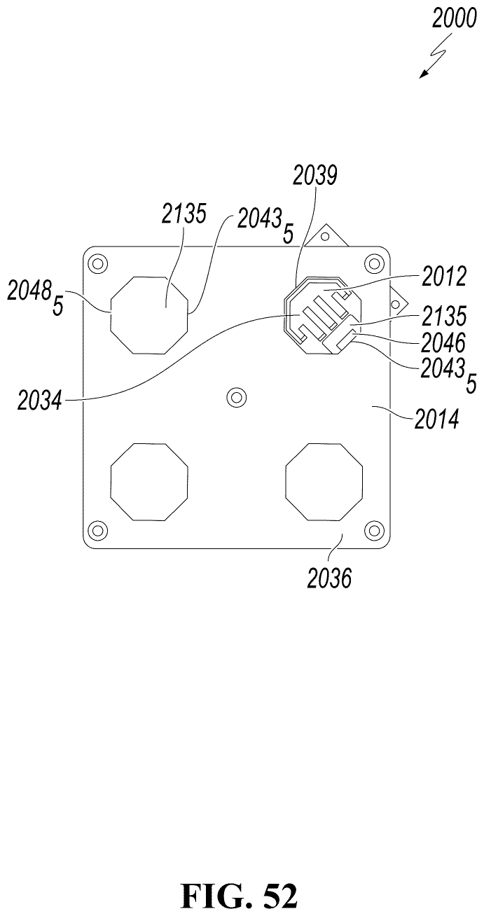

The second connection portion 2036 may further comprise a fifth connector 2043₅ and a fifth lock element 2048₅. The first component 2012 and the second component 2014 may releasably be connectable to one another in at least eight configurations, including: i) the first configuration (as shown in FIG. 45), ii) the second configuration (as shown in FIG. 46), iii) a third configuration (as shown in FIG. 47), and iv) a fourth configuration (as shown in FIG. 48), v) a fifth configuration (as shown in FIG. 49), vi) a sixth configuration (as shown in FIG. 50), vii) a seventh configuration (as shown in FIG. 51) in which the first connector 2039 of the first component 2012 is connected to the fifth connector 2043₅ of the second component 2014, and the first lock element 2046 of the first component 2012 is connected to the fifth lock element 2048₅ of the second component 2014, and viii) an eighth configuration (as shown in FIG. 52) in which the first lock element 2046 of the first component 2012 is connected to the fifth connector 2043₅ of the second component 2014, and the first connector 2039 of the first component 2012 is connected to the fifth lock element 2048₅ of the second component 2014.

Referring to FIGS. 44A-52, the second connection portion 2036 may include the first aperture 2135. The first lock element 2046 of the first component 2012 and the first connector 2039 of the first component 2012 may each disposed within the first aperture 2135 of the second connection portion 2036 in each of the first through eighth configurations.

FIGS. 44B-44C show the first connectors 2039 and the first lock elements 2046 of the first component 2012 and (the aperture 2135 having) the second connectors 2043 and the second lock elements 2048 of the second component 2014 have slightly different configurations. FIG. 44C shows the first connection portion 2034 and the second connection portion 2036 as they are being connected to each other. FIG. 44B shows the first connection portion 2034 and the second connection portion 2036 after they are connected to each other. As shown in FIGS. 44B and 44C, the first connectors 2039 and the first lock elements 2046 of the first component 2012 may have cam surfaces CS that are configured to engage with cam surfaces CS of the second connector 2043 and the second lock elements 2048 of the second component 2014 so as to facilitate connections between the first connection portion 2034 of the first component 2012 and the second connection portion 2036 of the second component 2014. The cam surfaces may include inclined surfaces. The cam surfaces CS of the first lock elements 2046 and the first connector 2039 of the first component 2012 and the cam surfaces CS of the of the second connector 2043 and the second lock elements 2048 of the second component 2014 may have corresponding mutually engaging profiles.

Referring to FIGS. 32-53, A connection assembly 2000 is provided. The connection assembly 2000 comprises a first body 2014 and a second body 2012. The first body 2014 has a plurality of openings 2135 formed therein and spaced apart from one another. The second body 2012 has a plurality of connectors 2039. Each connector 2039 is configured to be received in one of the plurality of openings 2135. As shown in FIGS. 42 and 44A, each connector 2039 has an overhang 2039ₒ configured to extend over a portion 2237 of the first body 2014 adjacent to the opening 2135 to engage the second body 2012 with the first body 2014. The second body 2012 includes at least one lock 2046 positioned adjacent to at least one of the plurality of connectors 2039. The lock 2046 is movable between an extended position in which the lock 2046 is configured to extend into the at least one of the plurality of openings 2035 when the plurality of connectors 2039 are received in the plurality of openings 2135 with the overhang 2039ₒ extending over the portion 2237 of the first body 2014 to engage the second body 2012 with the first body 2014, and a retracted position in which the lock 2046 is retracted from the at least one of the plurality of openings 2135. The lock 2046 prevents disengagement of the second body 2012 from the first body 2014 in the extended position. The lock 2046 allows disengagement of the second body 2012 from the first body 2014 in the retracted position.

The connection assembly 2000 may further comprise an actuator configured to move the at least one lock between the extended and retracted positions. The actuator described as the lock assembly 2160 herein is described in greater detail below. The actuator may comprise the handle 2068 and the rotating lock bar 2162. Movement of the handle 2068 may be configured to cause rotation of the lock bar 2162 to move the lock between the extended and retracted positions. The lock 2046 may be biased to the extended position.

The plurality of openings 2135 may have a polygonal shape. The lock 2046 and the at least one of the plurality of connectors 2039 together may have a corresponding polygonal shape.

The first body 2014 may be configured to slide related to the second body 2012 to cause the overhang 20390 to extend over the portion 2237 of the first body 2014 adjacent to the opening 2135 to engage the second body 2012 with the first body 2014.

The first body 2014 has first and second surfaces 2131, 2133 spaced apart from one another and defining a cavity 2239 (as shown in FIG. 33) therebetween. The plurality of openings 2135 may be formed in the first surface 2131. The plurality of connectors 2039 may be configured to extend into the cavity 2239 when received in the plurality of openings 2135.

The overhang 2039ₒ may be configured to be positioned within the cavity 2135 and to extend over the first surface 2131 to engage the first surface 2131.

The second body 2012 may have a first surface and a second surface spaced apart from one another and defining a cavity therebetween. The lock 2046 may be configured to be at least partially received in the cavity in the retracted position.

The lock 2046 may comprise a plurality of locks. The quantity of connectors 2039 may exceed the quantity of locks 2046.

The first body 2014 may be configured to mate with the second body 2014 in a first configuration and a second configuration. The second configuration may be rotationally or longitudinally offset from the first configuration.

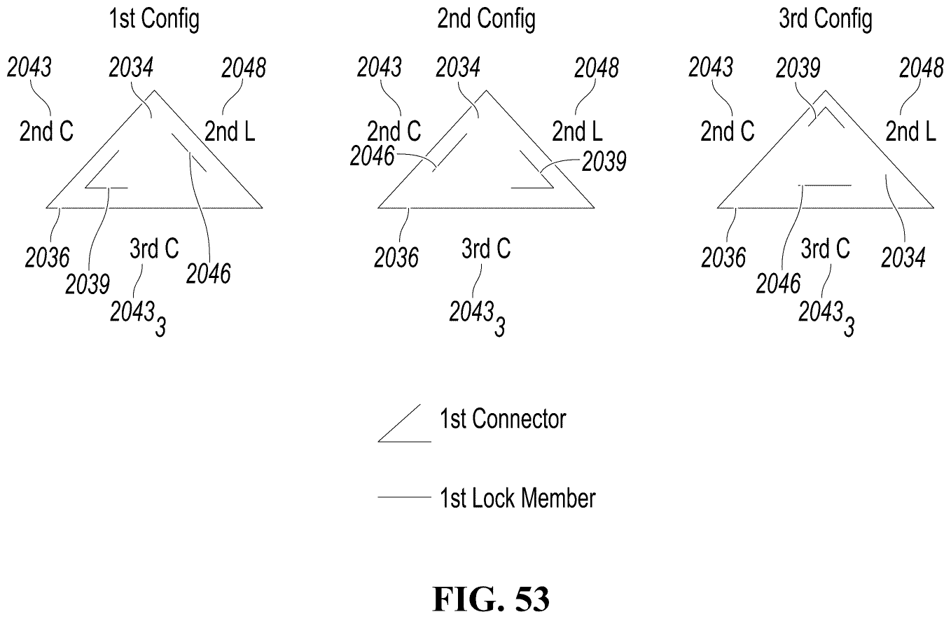

FIG. 53 shows exemplary three configurations in which the first component 2012 and the second component 2014 may be releasably connectable to one another. As shown in FIG. 53, the first connection portion 2034 may include the first connector 2039 and the first lock member 2046. The second connection portion 2036 may include two connectors 2043, 20433 and the lock member 2048. That is, the second connection portion 2036 may further comprise the third connector 2043₃. The first and second components 2012, 2014 may be releasably connectable to one another in at least three configurations as shown in FIG. 53, including: i) a first configuration wherein the first lock member 2046 of the first component 2012 is connected to the second lock member 2048 of the second component 2014, and the first connector 2039 of the first component 2012 is connected to the second connector 2043 and/or the third connector 2043₃ of the second component 2014, ii) a second configuration wherein the first lock member 2046 of the first component 2012 is connected to the second connector 2043 of the second component 2014, and the first connector 2039 of the first component 2012 is connected to the second lock element 2048 and/or the third connector 2043₃ of the second component 2014, and iii) a third configuration in which the first lock member 2046 of the first component 2012 is connected to the third connector 2043₃ of the second component 2014, and the first connector 2039 of the first component 2012 is connected to the second lock element 2048 and/or the second connector 2043 of the second component 2014. As shown, the component system may not limited to the aperture 2035 having even number of sides and may be equally applicable to aperture 2035 having odd number of sides. For example, the aperture 2035 may have triangular, pentagonal, heptagonal shaped configurations, etc.

The pivot region 42, 44 may include pivot connector or pivotable connection element 38, 40. The pivot region 42, 44 may interchangeably referred to as pivot connectors. The pivot connector 38, 40 or the connector 1039, 1043 or 2039, 2043 may all have the same configuration and operation. The pivot connector 38, 40 or the connector 1039, 1043 or 2039, 2043 may all have different same configurations and operations.

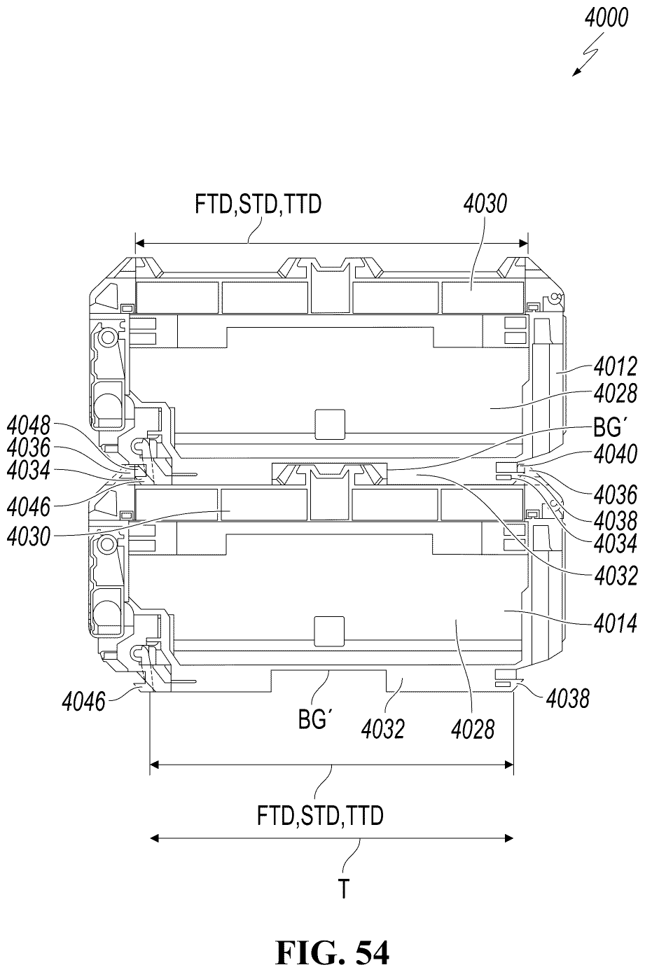

Referring to FIGS. 54-56, a stackable container system 4000 is provided. The stackable container system 4000 comprises a plurality of stackable containers 4012, 4014 including at least a first container 4012 and a second container 4014. The first container 4012 is releasably connectable on top of the second container 4014. The second container 4014 may be releasably connectable on top of the first container 4012.

Each container 4012, 4014 comprising a container portion 4028 and a lid portion 4030. A bottom 4032 of the container portion 4028 has a first connection portion 4034. The lid portion 4030 of one of the containers 4012, 4014 has a second connection portion 4036 that is connectable with the first connection portion 4034 of the other of the containers 4012, 4014. The lid portion 4030 of the first container 4012 includes the second connection portion 4036. The lid portion 4030 of the second container 4014 includes the second connection portion 4036.

The first and second connection portions 4034, 4046 include a first connector 4038 on the first connection portion 4034 and a second connector 4040 on the second connection portion 4036. The first and second connection portions 4034, 4036 further have mutually engageable lock elements 4046, 4048. The lock elements 4046, 4048 include a first lock element 4046 on the first connection portion 4034 and a second lock element 4048 on the second connection portion 4036.

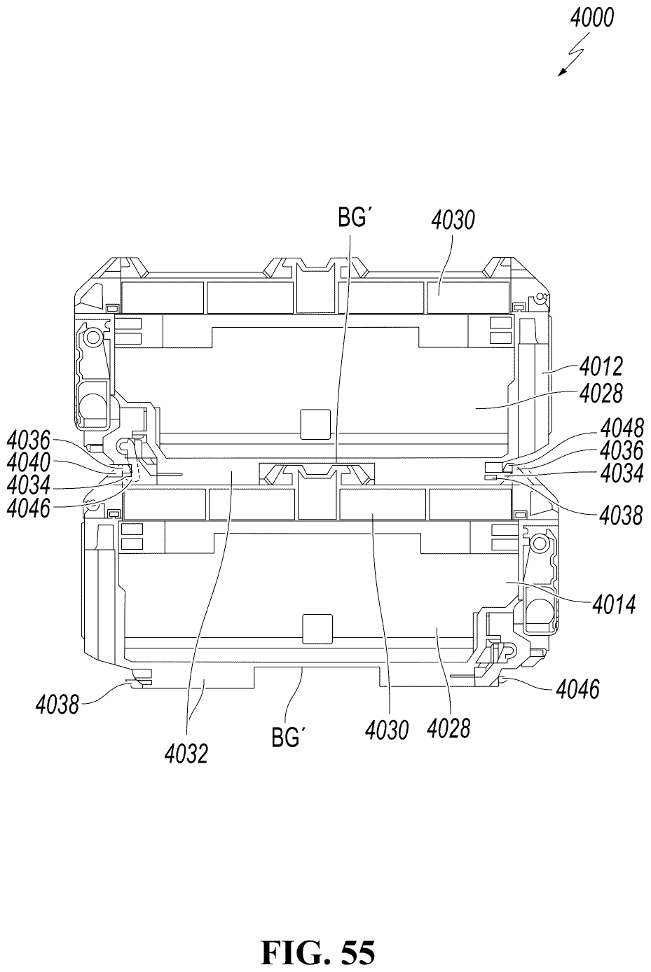

The first lock element 4046 or the second lock element 4048 comprises a movable lock member. The movable lock member is movable between a locked configuration and a released configuration. In some aspects, the movable lock member can be similar to the movable locking member described above. Accordingly, like components are not described further below. The first and second containers 4012, 4014 are releasably connectable to one another in at least two configurations, including i) a first configuration (as shown in FIG. 54) in which the first connector 4038 of the first container 4012 is connected to the second connector 4040 of the second container 4014, and the first lock element 4046 of the first container 4012 is connected to the second lock element 4048 of the second container 4014, and ii) a second configuration (as shown in FIG. 55) in which the first lock element 4046 of the first container 4012 is connected to the second connector 4040 of the second container 4014, and the first connector 4038 of the first container 4012 is connected to the second lock element 4048 of the second container 4014.

The first connection portion 4034, the first connectors 4038, and the first lock elements 4046 of the first container 4012 and the second connection portion 4036, the second connectors 4040 and the second lock elements 4048 of the second container 4014 are all described above. Accordingly, like components are not described further below.

FIGS. 54 and 55 show two similar cross-sectional views that show the ability of the containers 4012, 4014 to connect in two orientations that are 180 degrees apart. For example, the cross-sectional view in FIG. 54 is of two stacked containers 4012, 4014 showing both their connections/connectors aligned (i.e., fixed/pivotal connections/connectors 4038 of both containers 4012, 4014 on the right-hand side of the FIG. 54 and the latches 4046 of both containers 4012, 4014 on the left-hand side of the FIG. 54). The cross-sectional view in FIG. 55 is of two stacked containers 4012, 4014 showing the second container 4014 turned 180 degrees with the latch 4046 of the container 4014 on the right-hand side of the FIG. 55 and the fixed connection 4038 on the left-hand side of the FIG. 55, while the latch 4046 of the container 4012 remains on the left-hand side of the FIG. 55 and the fixed connection 4038 remains in the right-hand side of the FIG. 55. Comparing FIGS. 53 and 54, the first/top container 4012 remained in the same orientation/configuration and the second/lower container 4014 was rotated 180 degrees. The second/lower container 4014 may remain in its same configuration/orientation and the first/upper container 4012 may be rotated 180 degrees.

The first lock element 4046 of the first container 4012 comprises a movable lock member. The movable lock member of the first lock element 4046 is configured to be moved into the locked configuration with respect to the second lock element 4048 of the second container 4014 when the containers 4012, 4014 are in the first configuration. The movable lock member of the first lock element 4046 of the first container 4012 is configured to be moved into the locked configuration with respect to the second connector 4040 of the second container 4014 when the containers 4012, 4014 are in the second configuration.

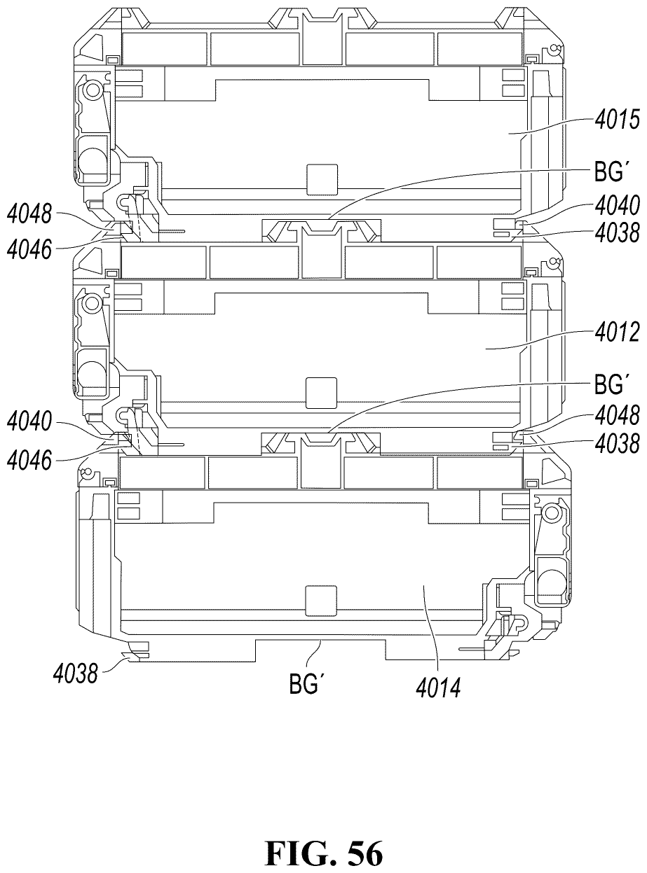

The stackable container system 4000 further comprises at least a third container 4015. FIG. 56 shows three containers 4012, 4014, 4015 that are in stacked configuration. The third container 4015 is releasably connected on top of the first container 4012. The first and second containers 4012, 4014 are in the second configuration in which the first lock element 4046 of the first container 4012 is connected to the second connector 4040 of the second container 4014, and the first connector 4038 of the first container 4012 is connected to the second lock element 4048 of the second container 4014. Referring to FIG. 56, the third and first containers 4015, 4012 are in the first configuration in which in which the connector 4038 of the third container 4015 is connected to the connector 4040 of the first container 4012, and the lock element 4046 of the third container 4015 is connected to the lock element 4048 of the first container 4012. That is, the first container 4012 and the third container 4015 have the same orientation as each other (i.e., similar to the first container 4012 and the second container 4014 in FIG. 54) and the second container 4014 and the first container 4012 have orientations that are 180 degrees apart (i.e., similar to the first container 4012 and the second container 4014 in FIG. 55).

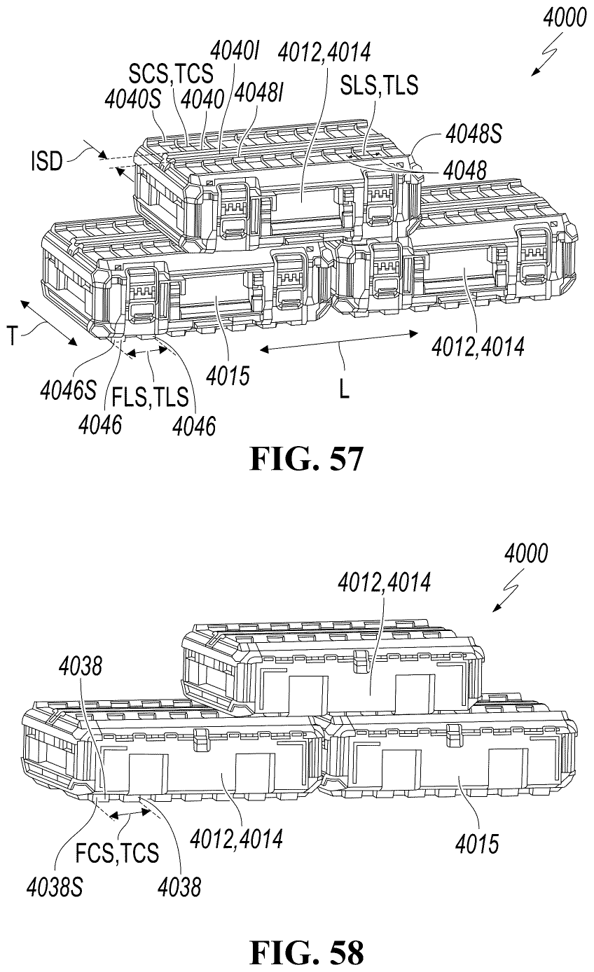

FIGS. 57-58 shows front perspective and rear perspective views of a top container (e.g., one of the first container 4012 and the second container 4014) attached to two side-by-side lower containers (e.g., the third container 4014 and the other of the first container 4012 and the second container 4014) and bridging the two lower containers (e.g., the third container 4014 and the other of the first container 4012 and the second container 4014).

Referring to FIGS. 57 and 58, the third container 4015 is configured to be positioned in side-by-side relationship with the second container 4014. The third container 4015 comprises a third connection portion 4036 connectable with the first connection portion 4034 of the first container 4012 at the same time that the second connection portion 4036 of the second container 4014 is connected to the first connection portion 4034 of the first container 4012. In some aspects, the third connection portion of the third container 4015 may have the same configuration and operation as the second connection portion 4036 of the second container 4014.

Each container may include the first connection portion 4034 disposed on the bottom 4032 of the container and the second connection portion 4036 disposed on the lid portion 4030 of the container. As described herein, in some aspects, the first connection portion 4034 (disposed on the bottom 4032) of the first container 4012 can be adapted to releasably engage with the second connection portion 4036 (on the lid portion 4030) of the second container 4014 so as connect the first container 4012 and the second container 4014. In some aspects, the first container 4012 may also include connection portion 4036 (disposed on the lid portion 4030), and the second container 4014 may also include connection portion 4034 (disposed on the bottom 4032). The connection portion 4036 of the first container 4012 may be configured to be releasably connected to the connection portion 4034 of the second container 4014, for example, when the second container 4014 is disposed on top of the first container 4012.

Referring to FIGS. 57 and 58, the third container 4015 may be configured to be positioned in side-by-side relationship with the first container 4012. The third container 4015 comprises a third connection portion 4036 connectable with the connection portion 4034 of the second container at the same time that the connection portion 4036 of the first container 4012 is connected to the connection portion 4034 of the second container 4014.

Like the first connection portion 4034 of the first container 4012 and the second connection portion 4036 of the second container 4014, the third connection portion of the third container 4015 may include third lock elements and third connectors. The structure, configuration, and the operation of the third lock elements and the third connectors may be similar to the second lock elements and the second connectors of the second container 4014 or the first lock elements and the first connectors of the first container 4012. As would be appreciated by a person of ordinary skill in the art, the third container may be releasably connected to either the first container 4012 or the second container 4014 using the third connection portion including the third lock elements and the third connectors. In some aspects, the third container 4015 may be releasably connected to be on top/bottom of the first container 4012/the second container 4014. When the third container 4015 is releasably connected to the first container 4012/the second container 4014, the third container 4015 and the first container 4012/the second container 4014 may be in one of the first configuration or the second configuration.

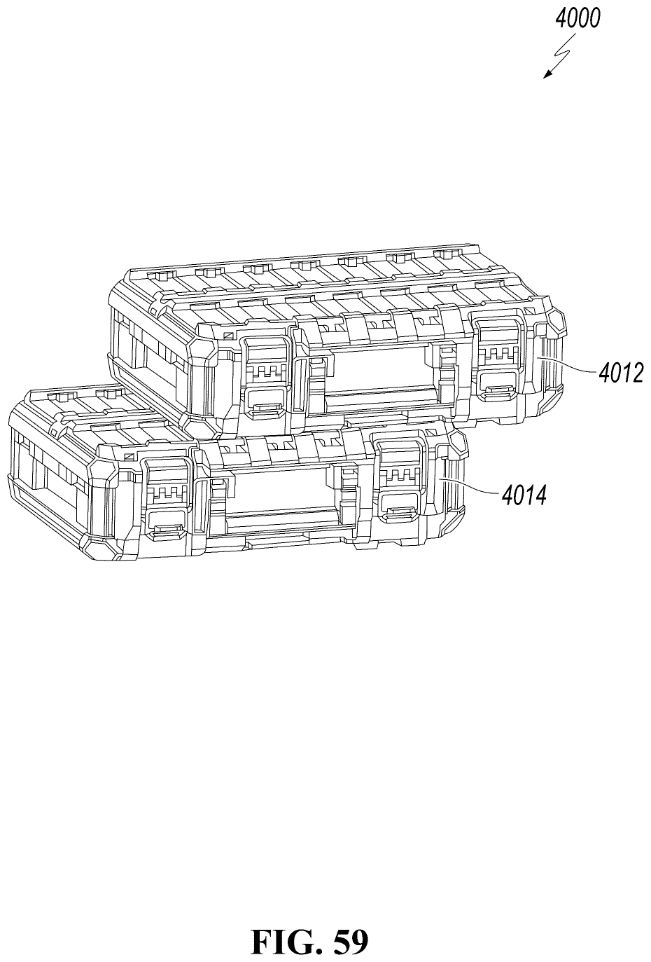

Referring to FIGS. 59-62, the second connection portion 4036 of the second container 4014 comprises at least one additional second connector 4040 and at least one additional second lock element 4048. The first container 4012 is configured to be connected to the second container 4014 at a different position on the second container 4014 by connecting the first connector 4038 and first lock element 4046 of the first connection portion 4034 to the additional second connector 4040 and the additional lock element 4048 of the second connection portion 4036.

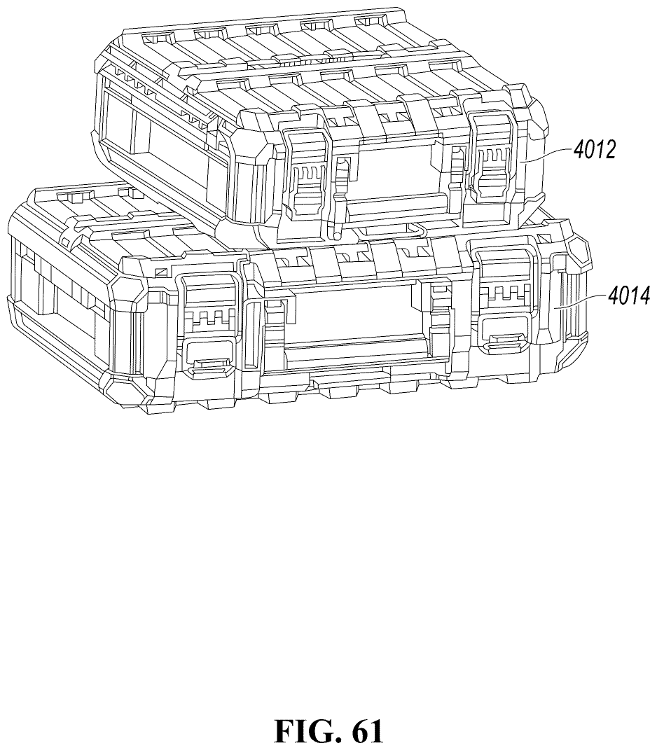

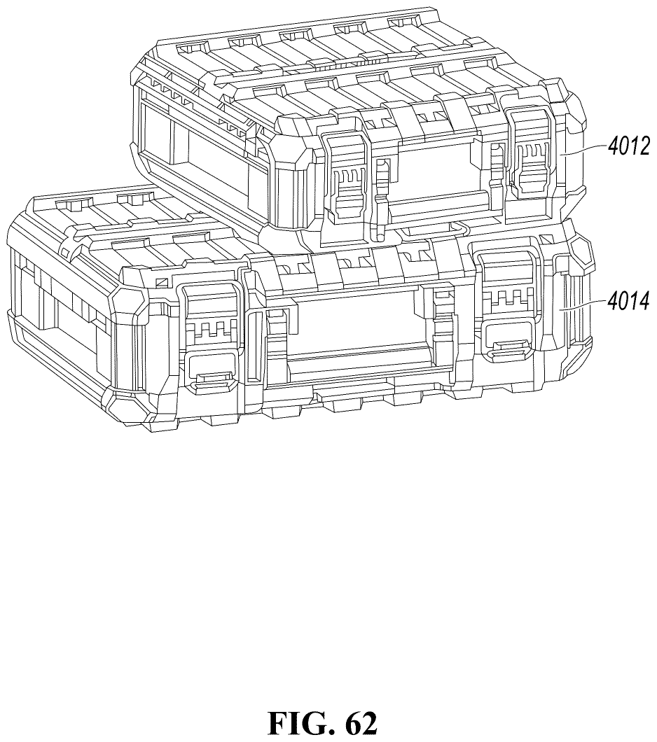

Comparing FIGS. 61 and 62, the first container 4012 may be releasably connected to the second container 4014 at two different positions on the second container 4014 by connecting the first connector 4038 and first lock element 4046 of the first connection portion 4034 to the additional second connector 4040 and the additional lock element 4048 of the second connection portion 4036. In FIG. 61, the first container 4012 is centered with respect to the second container 4014 and the first container 4012 may be releasably connected to the second container 4014, while, in FIG. 62, the first container 4012 is offset (e.g., to the right-hand side of FIG. 62) with respect to the second container 4014 to a different position and the first container 4012 may then be releasably connected to the second container 4014. The first container 4012 is offset (e.g., to the left-hand side of FIG. 62) with respect to the second container 4014 to a different position and the first container 4012 may then be releasably connected to the second container 4014. The first container 4012 is offset with respect to the second container 4014 to be in a different position (overhang configuration) and the first container 4012 may then be releasably connected to the second container 4014.

The number of the first pivotable connectors 4038 and the first lock elements 4046 of the first container 4012 and the second connectors 4040 and the second lock elements 4048 of the second container 4014 may vary and may depend on the size, shape and/or configuration of the respective containers 4012, 4014.

FIGS. 59-62 show various views of the containers 4012, 4014, 4015 stacked and latched. For example, in FIG. 59, the first container 4012 has an overhang off the side of the second container 4014, while the first container 4012 and the second container 4014 are (offset and) releasably connected to each other in a first configuration (front to front).

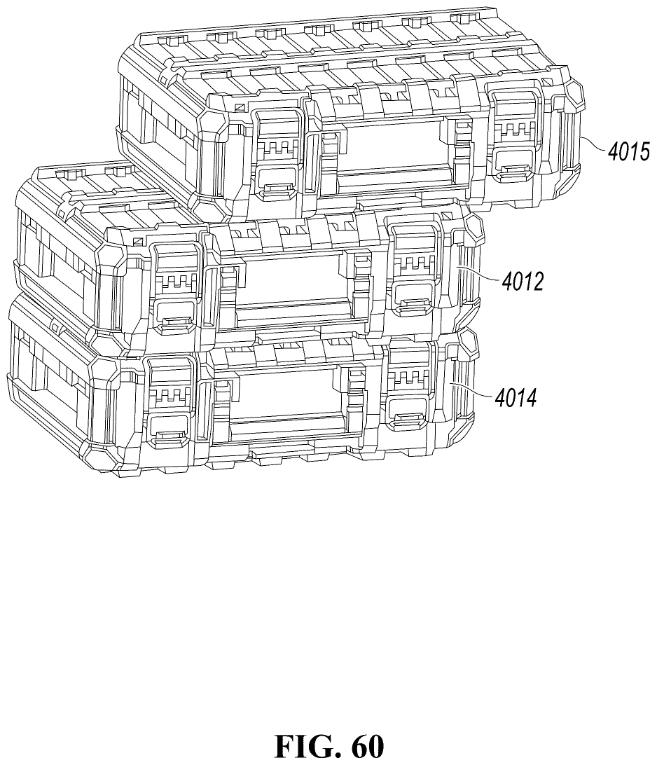

In FIG. 60, the third container 4015 has an overhang off the side of the first container 4012 in FIG. 60, while the first container 4012 and the second container 4014 are overlapped and releasably connected to each other in a first configuration (front to front) and the first container 4012 and the third container 4015 are (offset and) releasably connected to each other in a first configuration (front to front).

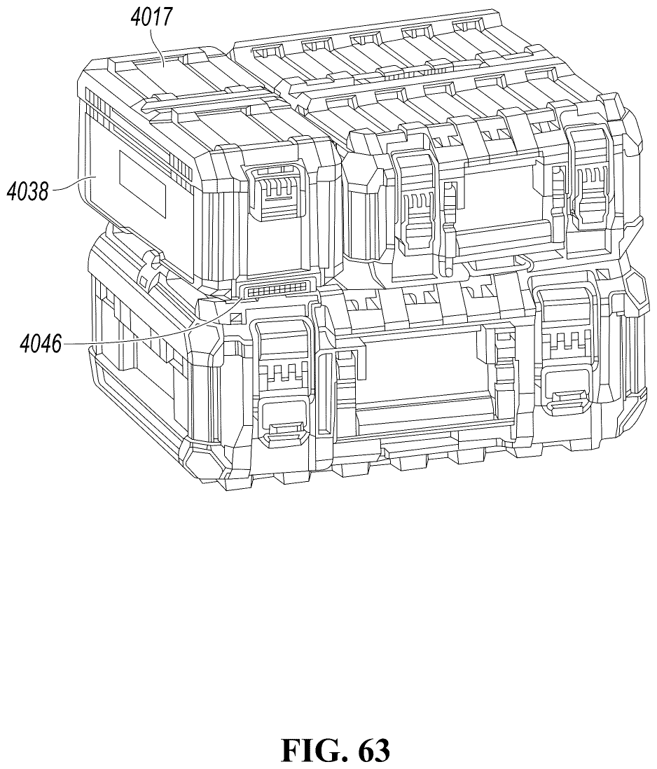

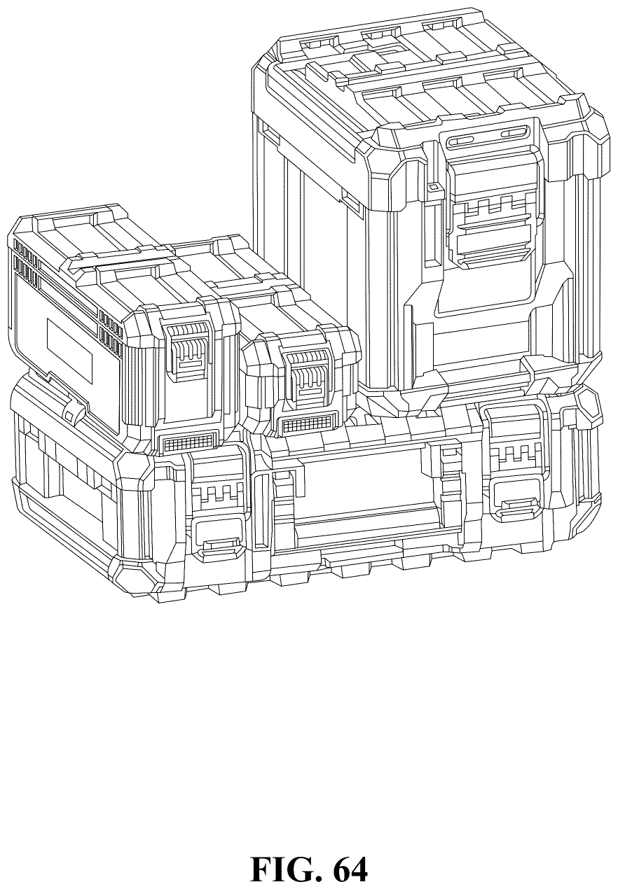

FIGS. 61-62 and 63-64 show various views of a full-size container on the bottom with half-size and quarter-size containers stacked on top of the full-size container. For example, in FIGS. 61-62, a 17 inch container is stacked over a 22 inch container. In FIG. 63, a 17 inch container and a 5 inch container are stacked over a 22 inch container. In FIG. 64, a 17 inch container and two 5 inch containers are stacked over a 22 inch container. However, it is also realized that the dimensions of the containers of FIG. 61-64 may be greater than or less than the exemplary dimensions provided.

As shown in FIGS. 54-64, the container system 4000 is provided. The container system 4000 comprises the plurality of containers 4012, 4014, 4015 including at least a first container 4012, a second container 4014, and a third container 4015. The first container 4012 is configured to be selectively connectable on top of i) the second container 4014 alone, or ii) both the second and the third containers 4014 and 4015 simultaneously by bridging the second and third containers 4014 and 4015. The first container 4012 may also be configured to be selectively connectable on top of iii) the third container 4015 alone.

The first container 4012 selectively connected on top of the second container 4014 alone is shown in FIG. 54 (in a first configuration or in a front to front configuration) and is also shown in FIG. 55 (in a second configuration or in front to back configuration), where the first and second configurations in FIGS. 54-55 are 180 degrees apart.

The first container 4012 selectively connected on top of both the second and the third containers 4014 and 4015 simultaneously by bridging the second and third containers 4014 and 4015 is shown in FIGS. 57 and 58.

Each container 4012, 4014, 4015 includes the container portion 4028 and the lid portion 4030. The bottom 4032 of the first container portion 4028 has the first connection portion 4034. The lid portion 4030 of the second container 4014 has the second connection portion 4036. The lid portion 4030 of the third container 4015 has the third connection portion 4036. The third connection portion may have a different configuration, as would be appreciated by a person of ordinary skill in the art, that may still be configured to be selectively connectable with the first connection portion 4034 of the first container 4012 and/or the second connection portion 4036 of the second container 4014 so that the third container 4015 may be selectively connected to the first container 4012/the second container 4014. The container portion 4028, the lid portion 4030, the bottom 4032, the first connection portion 4034, and the second connection portion 4036 are shown and described in reference to FIGS. 54-55.

The first connection portion 4034 of the first container 4012 is selectively connectable i) with the second connection portion 4036 of the second container 4014 alone, or ii) with the second connection portion 4036 of the second container and the third connection portion 4036 of the third container 4015 simultaneously. The first connection portion 4034 of the first container 4012 may also be selectively connectable iii) with the connection portion 4036 of the third container 4015 alone.

The first, second, and third connection portions 4034, 4036, 4034/4036 include the first connector 4038 on the first connection portion 4034, the second connector 4040 on the second connection portion 4036, and the third connector 4038/4040 on the third connection portion 4034/4036.

The first, second, and third connection portions 4034, 4036, 4034/4036 further have mutually engageable lock elements 4046, 4048. The lock elements 4046, 4048 include the first lock element 4046 on the first connection portion 4034, the second lock element 4048 on the second connection portion 4036, and a third lock element 4046/4048 on the third connection portion 4034/4036.

The first lock element 4046 may include a movable lock member. The movable lock member is movable between a locked configuration and a released configuration either i) with respect to the second lock element 4048 alone, or ii) simultaneously with both the second and third lock elements 4048, 4046/4048. The movable lock member 4046 is movable between a locked configuration and a released configuration with respect to third lock element 4046/4048 alone.

The first connector 4038 and the first lock element 4046 are spaced from one another at a first distance FTD, the second connector 4040 and the second lock element 4048 are spaced from one another at a second distance STD, and the third connector 4038/4040 and the third lock element 4046/4048 are spaced from one another at a third distance TTD. The first distance FTD, the second distance STD, and the third distance TTD are shown in FIG. 54. The first distance FTD, the second distance STD, and the third distance TTD are all the same. In some aspects, one or more of the first distance FTD, the second distance STD, and the third distance TTD may be different.

Referring to FIGS. 57-58, the first connector 4038 has first laterally spaced connect surfaces 4038S that are spaced from one another at a first connector spacing FCS, and the first lock element 4046 has first laterally spaced lock surfaces 4046S that are spaced from one another at a first lock spacing FLS. The second connector 4040 has second laterally spaced connect surfaces 4040S that are spaced from one another at a second connector spacing SCS, and the second lock element 4048 has second laterally spaced lock surfaces 4048S that are spaced from one another at a second lock spacing SLS. The third connector 4038/4040 has third laterally spaced connect surfaces 4038S/4040S that are spaced from one another at a third connector spacing TCS, and the third lock element 4046/4048 has third laterally spaced lock surfaces 4046S/4048S that are spaced from one another at a third lock spacing TLS.

The first distance FTD, second distance STD, third distance TTD, first connector spacing FCS, second connector spacing SCS, third connector spacing TCS, first lock spacing FLS, second lock spacing SLS, and third lock spacing TLS may have a spacing therebetween to enable the first connector 4038 and the first lock element 4046 to be selectively connectable to either i) the second connection portion 4036 alone, or ii) simultaneously to the second connection portion 4036 and the third connection portion 4034/4036. The first distance FTD, second distance STD, third distance TTD, first connector spacing FCS, second connector spacing SCS, third connector spacing TCS, first lock spacing FLS, second lock spacing SLS, and third lock spacing TLS may have a spacing therebetween to enable the first connector 4038 and the first lock element 4046 to be selectively connectable to iii) the third connection portion 4034/4036 alone.

Referring to FIGS. 54 and 57-58, the first distance FTD, second distance STD, and third distance TTD may be measured in a first direction (e.g., along the transverse axis T-T of the container 4012, 4014, 4015 as shown in FIGS. 54 and 57). The first connector spacing FCS, the second connector spacing SCS, the third connector spacing TCS, the first lock spacing FLS, the second lock spacing SLS, and the third lock spacing TLS may be spaced in a second direction (e.g., along the longitudinal axis L-L of the container 4012, 4014, 4015 as shown in FIG. 57) that is perpendicular to the first direction. As shown in FIG. 57, the longitudinal axis L-L and the transverse axis T-T of the container 4012, 4014, 4015 are generally perpendicular to each other.

The first container 4012 may include an actuator for selectively moving the movable lock member between the locked configuration and the released configuration. The actuator may be disposed on an external surface of the first container 4012. The actuator described as the lock assembly herein is described in greater detail below.

As shown in FIGS. 54-55 and 57-58, the first container 4012 may be configured to selectively connect by being placed down on top of i) the second container 4014 alone, or ii) both the second and the third containers 4014, 4015 simultaneously by bridging the second and third containers 4014, 4015. The first container 4012 may also be configured to selectively connect by being placed down on top of iii) the third container 4015 alone.

The second lock element may include a movable lock member. The movable lock member may be movable between a locked configuration and a released configuration i) with respect to the first lock element 4046 alone, ii) with respect to the third lock element 4046/4048 alone, or iii) simultaneously with both the first and third lock elements 4046, 4046/4048. The third lock element 4046/4048 may include a movable lock member. The movable lock member may be movable between a locked configuration and a released configuration i) with respect to the first lock element 4046 alone, ii) with respect to the second lock element 4048 alone, or iii) simultaneously with both the first and second lock elements 4046, 4048.

Referring to FIGS. 54-62, a service component system 4000 is provided. The service component system 4000 comprises a plurality of service components including at least a first service component 4012, a second service component 4014, and a third service component 4015. The service component may interchangeably referred to as a component. The first service component 4012 may include a first container 4012, the second service component 4014 may include a second container 4014, and the third service component 4015 may include a third container 4015. Each of the first container 4012, the second container 4014 and the third container 4015 may include a container portion and a lid portion as described herein. The service components of the service component system 4000 may also be referred to as modules. The service components/modules may include, but not limited to, tools, charger/charging devices, power storage devices, other construction/jobsite equipment, light, radio, fan, charger, cup, flashlight, thermos, etc.

The first service component 4012 is configured to be selectively connectable on top of i) the second service component 4014 alone, or ii) both the second and the third service components 4015, 4015 simultaneously by bridging the second and third service components. The first service component 4012 may also be configured to be selectively connectable on top of iii) the third service component 4015 alone.

Each service component 4012, 4014, 4015 comprises the bottom portion 4032 and the top portion 4030. The bottom portion 4032 of the first service component 4012 has the first connection portion 4034. The top portion 4030 of the second service component 4014 has the second connection portion 4036, and the top portion 4030 of the third service component 4015 has the third connection portion 4036.

The first connection portion 4034 of the first service component 4012 is selectively connectable i) with the second connection portion 4036 of the second service component 4014 alone, or ii) with the second connection portion 4036 of the second service component 4014 and the third connection portion 4036 of the third service component 4015 simultaneously. The first connection portion 4034 of the first service component 4012 may also be selectively connectable iii) with the third connection portion 4036 of the third service component 4015 alone.

The first, second, and third connection portions 4034, 4036, 4036 include a first connector 4038 on the first connection portion 4034, a second connector 4040 on the second connection portion 4036, and a third connector 4040 on the third connection portion 4036. The first, second, and third connection portions 4034, 4036, 4036 further have mutually engageable lock elements 4046, 4048. The lock elements 4046, 4048 include a first lock element 4046 on the first connection portion 4034, a second lock element 4048 on the second connection portion 4036, and a third lock element 4048 on the third connection portion 4036. The first lock element 4046 includes a movable lock member. The movable lock member is movable between a locked configuration and a released configuration either i) with respect to the second lock element 4048 alone, or ii) simultaneously with both the second and third lock elements 4048, 4048.

The first connector 4038 and the first lock element 4046 are spaced from one another at the first distance FTD, the second connector 4040 and the second lock element 4048 are spaced from one another at the second distance STD, and the third connector and the third lock element are spaced from one another at the third distance TTD. The first connector 4038 has first laterally spaced connect surfaces 4038S that are spaced from one another at a first connector spacing FCS, and the first lock element 4046 has first laterally spaced lock surfaces 4046S that are spaced from one another at the first lock spacing FLS. The second connector 4040 has second laterally spaced connect surfaces 4040S that are spaced from one another at a second connector spacing SCS, and the second lock element 4048 has second laterally spaced lock surfaces 4048S that are spaced from one another at a second lock spacing SLS. The third connector 4040 has third laterally spaced connect surfaces 4040S that are spaced from one another at a third connector spacing TCS, and the third lock element 4048 has third laterally spaced lock surfaces 4048S that are spaced from one another at a third lock spacing TLS.

The first distance FTD, the second distance STD, the third distance TTD, the first connector spacing FCS, the second connector spacing SCS, the third connector spacing TCS, the first lock spacing FLS, the second lock spacing SLS, and the third lock spacing TLS have a spacing therebetween to enable the first connector 4038 and the first lock element 4046 to be selectively connectable to either i) the second connection portion 4036 alone, or ii) simultaneously to the second connection portion and the third connection portion 4036, 4036. The first distance FTD, the second distance STD, the third distance TTD, the first connector spacing FCS, the second connector spacing SCS, the third connector spacing TCS, the first lock spacing FLS, the second lock spacing SLS, and the third lock spacing TLS have a spacing therebetween to enable the first connector 4038 and the first lock element 4046 to be selectively connectable to iii) the third connection portion 4036 alone.

As shown in FIGS. 57-58, the second connection portion 4036 may further include an inner second connector 4040I and an inner second lock element 4048I disposed between the second connector 4040 and the second lock element 4048. The inner second connector 4040I and the inner second lock element 4048I may be spaced from one another at an inner second distance ISD. The inner second distance ISD may have a spacing therebetween to enable a fourth connector 4038 and a fourth lock element 4046 of a fourth service component 4017 (as shown in FIG. 63) to be selectively connectable to the second connection portion 4036.

The third connection portion 4036 may further include an inner third connector 4040I and an inner third lock element 4048I disposed between the third connector 4040 and third lock element 4048. The inner third connector 4040I and the inner third lock element 4048I may be spaced from one another at an inner third distance ISD. The inner third distance ISD may have a spacing therebetween to enable the fourth connector 4038 and the fourth lock element 4038 of the fourth service component 4017 to be selectively connectable to either i) the third connection portion 4036 alone, or ii) simultaneously to the second connection portion 4036 and the third connection portion 4036.

As shown in FIGS. 57-58, the first service component 4012 may be connected to both the second and third service components 4014, 4015 simultaneously by bridging the second and third service components 4014, 4015, while simultaneously, the fourth connector 4038 and the fourth lock element 4046 of the fourth service component 4017 (as shown in FIG. 63) are connected to the third connection portion 4036.

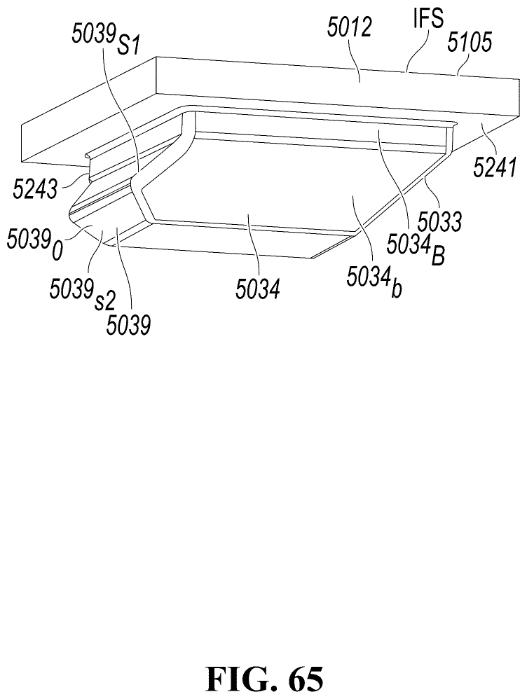

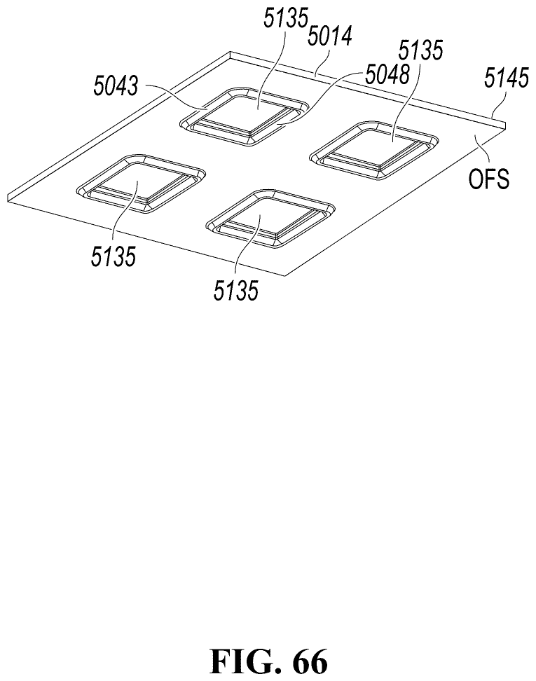

Referring to FIGS. 65-74, A connector assembly 5000 is provided. The connection assembly 5000 comprises a first body 5014 and a second body 5012. As shown in FIG. 66, the first body 5014 has a plurality of openings 5135 formed therein. Each opening 5135 has at least a first edge 5043 and a second edge 5048. The second body 5012 has a face 5241 and a plurality of connectors 5034 extending from the face 5241. Each connector 5034 of the second body 5012 is configured to be received in one of the plurality of openings 5135 of the first body 5014. Each connector 5034 has a lock 5046 and a lip portion 5039, 5039₀ configured to extend over the face 5241. When the connectors 5034 are received in the openings 5135, the lock 5046 is movable between at least two configurations, including an unlocked configuration wherein the lock 5046 does not extend past the second edge 5048, and a locked configuration wherein at least a portion of the lip portion 5039, 5039₀ extends past the first edge 5043 and the lock 5046 extends past the second edge 5048. In the locked configuration, the lock 5046 prevents disengagement of the second body 5012 from the first body 5014.

The second body 5012 may include a second container 5012 and the first body 5014 may include a first container 5014. For illustrative purposes, partial or cutaway views of containers/bodies 5012, 5014 are shown instead of the entire containers/bodies 5012, 5014. Each of the first container 5014 and the second container 5012 may include a container portion and a lid portion as described herein. The first body 5014 and the second body 5012 of the connection assembly 5000 may also be referred to as modules or components. The components/modules/bodies may include, but not limited to, tools, charger/charging devices, power storage devices, other construction/jobsite equipment, light, radio, fan, charger, cup, flashlight, thermos, etc.

The first body 5014 includes the plurality of openings 5135 and the second body 5012 includes the plurality of connectors 5034. In some aspects, the first body may include the plurality of connectors and the second body may include the plurality of openings. As shown in FIG. 65, one connector 5034 is shown to be extending from the face 5241. The number of connectors 5034 extending from the face 5241 may vary. In some aspects, the second body 5012 may include a plurality of connectors 5034 in a grid layout with multiple rows. For example, a row of connectors 5034 nearest to a push button actuator 5095 may each include locks 5046 which are actuated by the push button actuator 5095, and the connectors 5034 in the rows further away from the actuator 5095 may resemble the connector 5034 illustrated in FIG. 65 without a lock 5046.

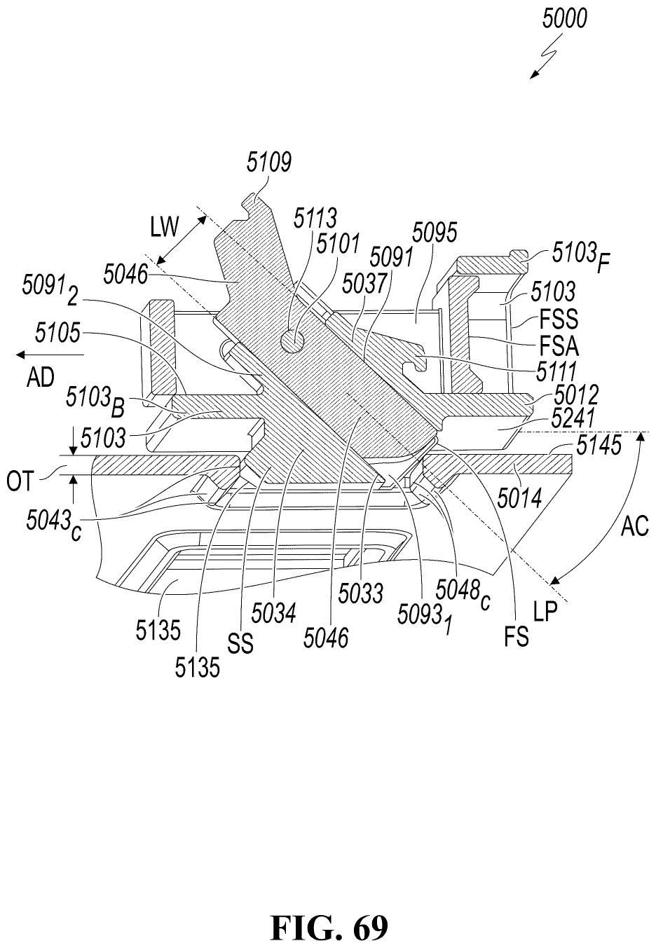

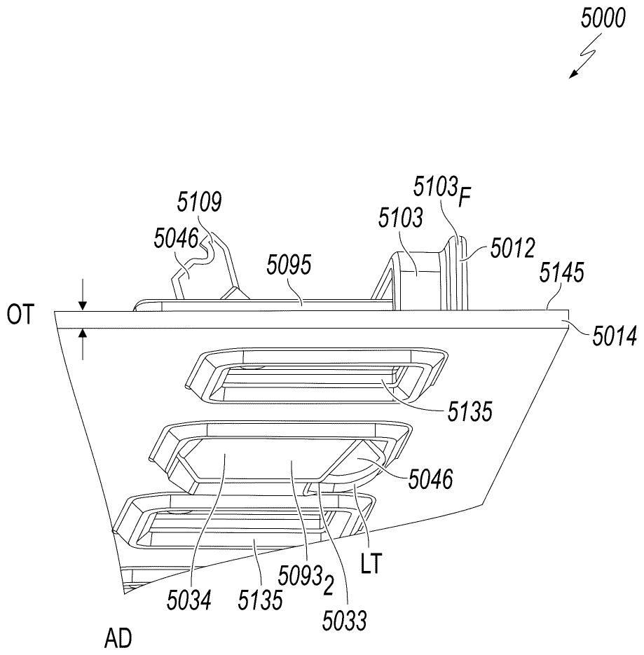

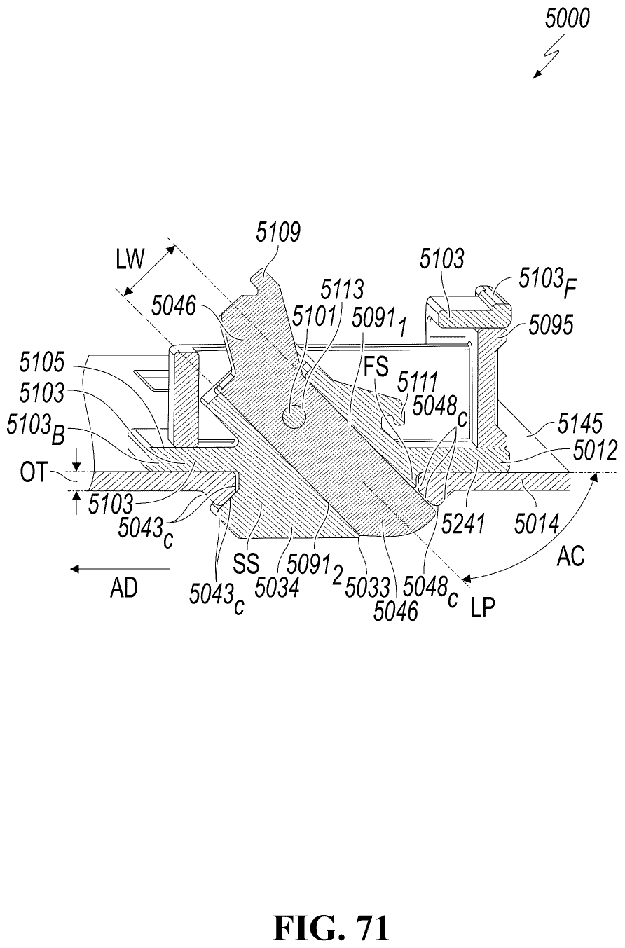

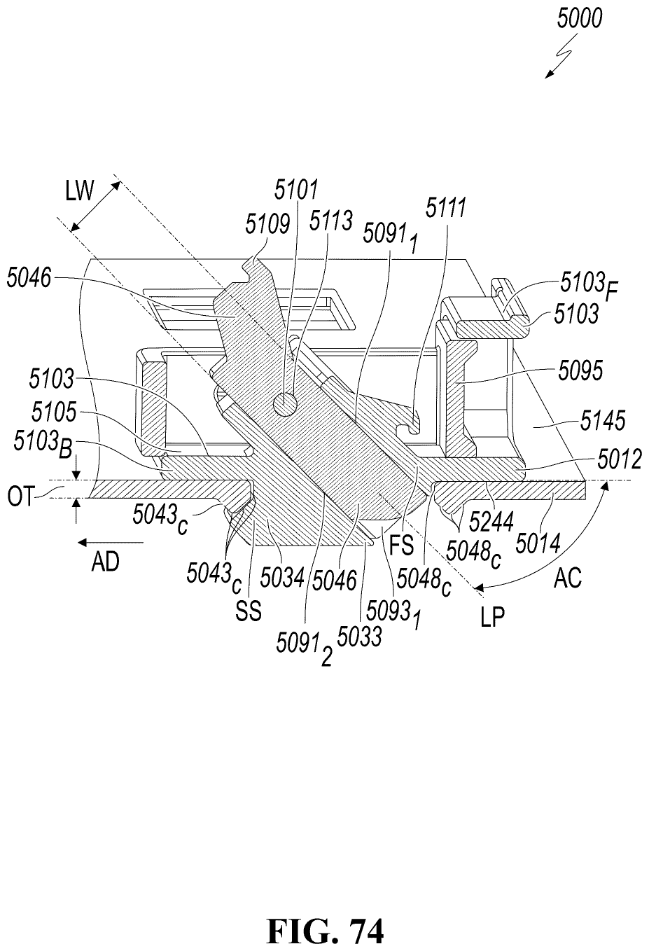

The face/surface 5241 of the second body 5012 may be configured to face (opposing) and engage with a face/surface 5145 of the first body 5014 when the first body 5014 and the second body 5012 are engaged and/or locked to each other. For example, as shown in FIG. 69, the surface 5241 of the second body 5012 and the surface 5145 of the first body 5014 face/opposing each other as the connector 5034 of the second body 5012 is being received in one of the plurality of openings 5135 of the first body 5014. As shown in FIG. 74, the surface 5241 of the second body 5012 and the surface 5145 of the first body 5014 face/opposing and engage with each other when the connector 5034 of the second body 5012 is received in one of the plurality of openings 5135 of the first body 5014 (and with the lock 5046 in the unlocked configuration). Also, as shown in FIG. 71, the surface 5241 of the second body 5012 and the surface 5145 of the first body 5014 face/opposing and engage with each other when the connector 5034 of the second body 5012 is received in one of the plurality of openings 5135 of the first body 5014 (and with the lock 5046 in the locked configuration).

The face/surface 5241 of the second body 5012 may be an outer (e.g., lower, side, or upper) surface of the second body 5012. A face IFS, opposing the face 5241, of the second body 5012 may be an inner surface of the second body 5012. The face/surface 5145 of the first body 5014 may be an outer (e.g., upper, side, or lower) surface of the first body 5014. A face OFS, opposing the face 5145, of the first body 5012 may be an inner surface of the first body 5014.

The connector 5034 may include a base portion 5034_{B}, a body portion 5034_{b}, an aperture 5033, the lock 5046, a corridor 5037, and the lip portion 5039, 5039₀. The base portion 5034_{B} may be configured to connect the connector body 5034_{b} to the face 5241. In some aspects, the connector 5034 and the face 5241 may be integrally formed. The base portion 5034_{B} may be configured to separate the lip portion 5039, 5039₀ from the face 5241 so that the lip portion 5039, 5039₀ may be offset from the face 5241.

The lip portion 5039, 5039₀ of the connector 5034 may include a forwardly projecting lip portion. The lip portion 5039, 5039₀ of the connector 5034 may include two surfaces 5039_{S1} and 5039_{S2} that connect with each other to form the lip portion 5039, 5039₀. For example, the surface 5039_{S1} of the lip portion 5039 may a downwardly angled surface and the surface 5039_{S2} of the lip portion 5039 may an upwardly angled surface. These surface 5039_{S1} and 5039_{S2} of the lip portion 5039 connect to each other to form the forwardly projecting lip portion. The lip portion 5039, 5039₀ of the connector 5034 may be configured to extend over the face 5241.

In some aspects, the forwardly projecting lip portion 5039, 5039₀ of the connector 5034 is positioned generally in an opposite area or opposite sides of the connector 5034 from the lock 5046 to allow for a locked connection in the locked configuration and allow insertion/removal of the connector 5034 from the opening 5135 in the unlocked configuration. The end portion of the lock comprises a contact surface LCS which is shaped to move the lock 5046 in a direction from the locked configuration toward the unlocked configuration to allow insertion of the connector 5034 into the opening 5135. For example, when a force is applied to bring the two bodies 5012, 5014 together (e.g., drop in, press together) and the connector 5034 generally aligned with the opening 5135, the contact surface LCS of the lock 5046 contacts the surface 5145 and/or edge 5048 of the first body 5014 and the resulting force moves the lock 5046 toward the unlocked configuration (e.g., against any biasing force of the bias member 5097) enough to allow the connector 5034 to be inserted into the opening 5135. The moment the connector 5034 is inserted sufficiently into the opening 5135, the contact surface LCS of the lock 5046 moves past the surface 5145 and/or edge 5048 of the first body 5014 and moves back to the locked configuration.

As shown in FIGS. 69, 71, and 74, the connector 5034 may comprise a first side FS and a second side SS. When the lock 5046 is in the locked configuration, the lock 5046 may extend from the first side FS and the lip portion 5039, 5039₀ of the connector 5034 may be positioned on the second side SS. The first side FS and second side SS may be configured to be opposite each other. In some aspects, the connector may comprise a first side, a second side, a third side, and a fourth side, the first side adjacent to the second and fourth sides and opposite the third side. The second side adjacent to the first side and third side and opposite the fourth side. In some aspects, the lip portion 5039, 5039₀ may be positioned on the third side and/or the fourth side. The lock 5046 may extend from a corner area between the first side and second side. In some aspects, the lock 5046 may extend from a corner area between the third side and the fourth side, while the lip portion 5039, 5039₀ may be positioned on the first side and/or the second side. The connector 5034 may comprise a first side, a second side and a third side. The lock 5046 may extend from between the first side and the second side (e.g., a corner area between the first side and the second side). The lip portion 5039, 5039₀ of the connector 5034 may be positioned on the third side.

As shown in FIGS. 69, 71, and 74, the connector 5034 may further comprise the corridor 5037. The lock 5046 may be movable through the corridor 5037 as the lock 5046 moves between the locked and unlocked configurations. The corridor 5037 may define a linear path (e.g., along the direction of an arrow LP as shown in FIGS. 69, 71, and 74) which extends over the face 5241 at an angle AC between 5 degrees and 80 degrees. In some aspects, the corridor 5037 may define the linear path (e.g., along the direction of an arrow LP as shown in FIGS. 69, 71, and 74) which extends over the face at an angle between 45 degrees and 20 degrees. The angle AC may be angle between the face 5241 of the second body 5012 and the linear path (e.g., along the direction of an arrow LP as shown in FIGS. 69, 71, and 74).

Referring to FIGS. 69-71 and 73-74, the corridor 5037 may include a passage that is formed by portions of the connector 5034. The corridor 5037 may include a first pair of opposing sides 5091₁, 5091₂, and a second pair of opposing sides 5093₁, 5093₂ (that together form the corridor 5037). The two sides of the first pair of opposing sides 5091₁, 5091₂ may be separated or spaced apart from each other by a distance that is equal to or greater than a width LW of the lock 5046. The two sides of the second pair of opposing sides 5093₁, 5093₂ may be separated or spaced apart from each other by a distance that is equal to or greater than a thickness LT (extending into the page in FIG. 69) of the lock 5046. The surfaces 5093₁, 5093₂ are angled so as to assist the insertion of the connector 5034 into the openings 5145. The sides may be angled toward each other at the outer end. This assists with the drop and lock connection.

The lock 5046 may be configured to be movable with respect to the connector 5034, while the lip portion 5039, 5039₀ may be configured to be stationary with respect to the connector 5034.

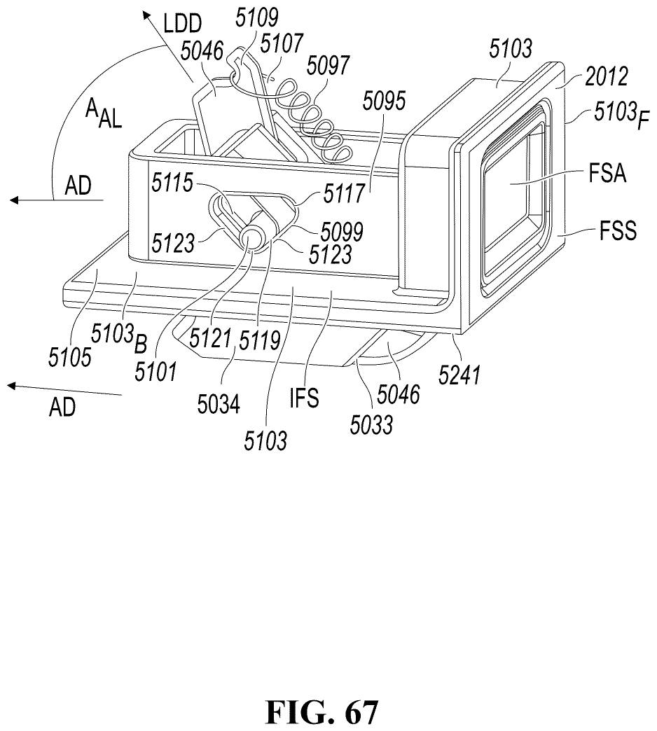

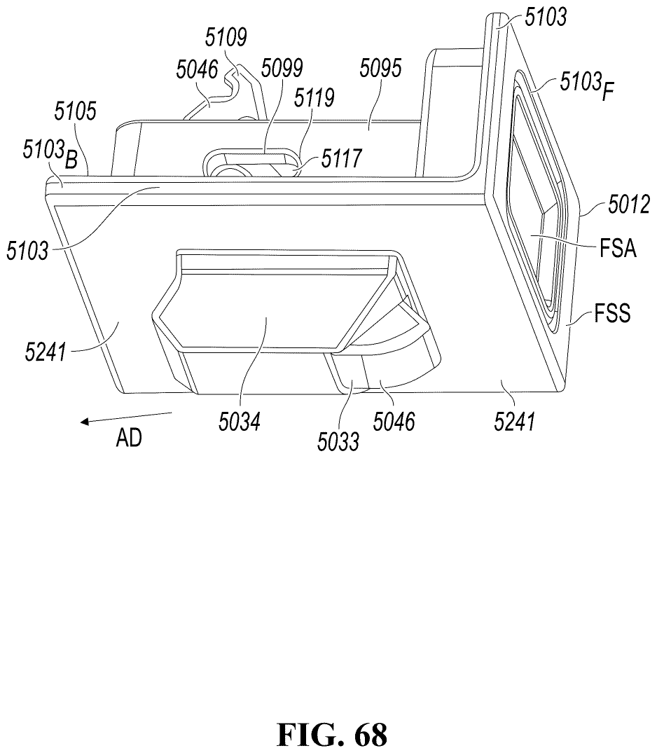

As shown in FIGS. 67-68, the connector 5034 may further comprise the aperture 5033. The aperture 5033 may be constructed and arranged to enable the lock 5046 move between the unlocked and locked configurations. The lock 5046 may extend outwardly from the aperture 5033 when lock 5046 is in the locked configuration. The lock 5046 may extend outwardly away from the face 5241 of the second body 5012 when lock 5046 is in the locked configuration.

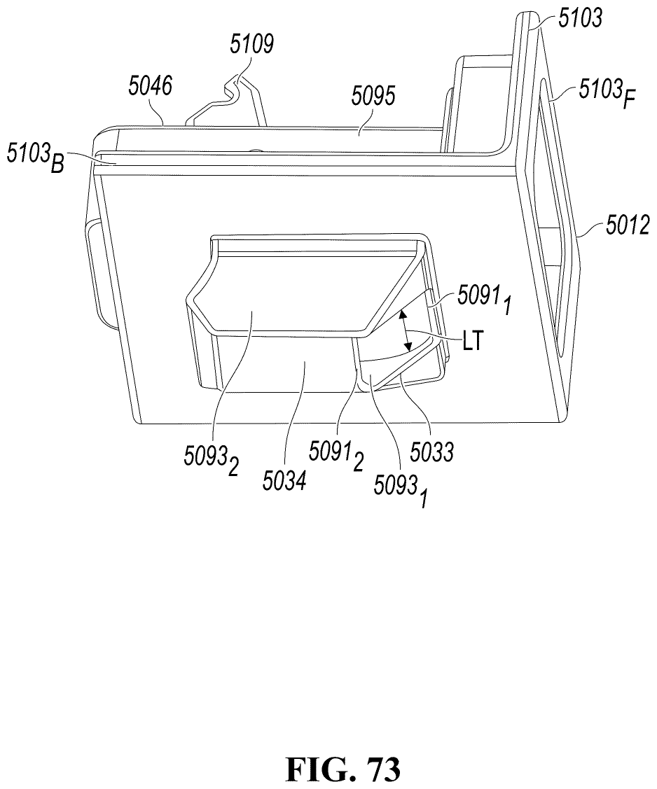

FIG. 69, and 73-74 show the lock 5046 within the aperture 5033 (and not extending outwardly from the aperture 5033) when lock 5046 is in the unlocked configuration. FIG. 69 shows the lock 5046 disposed within the aperture 5033 and is in the unlocked configuration, and the connector 5034 of the second body 5012 being received in one of the plurality of openings 5135 of the first body 5014. FIG. 73 shows the connector 5034, the second body 5012, and the lock 5046 disposed within the aperture 5033 and in the unlocked configuration, where the connector 5034 of the second body 5012 is not received in one of the plurality of openings 5135 of the first body 5014. FIG. 74 shows the connector 5034 of the second body 5012 received in one of the plurality of openings 5135 of the first body 5014 and with the lock 5046 disposed within the aperture 5033 and is in the unlocked configuration.

FIGS. 68 and 70-71 show the lock 5046 extending outwardly from the aperture 5033 when lock 5046 is in the locked configuration. FIG. 68 shows the connector 5034, the second body 5012, and the lock 5046 extending outwardly from the aperture 5033 and in the locked configuration, where the connector 5034 of the second body 5012 is not received in one of the plurality of openings 5135 of the first body 5014. FIGS. 70-71 show the connector 5034 of the second body 5012 received in one of the plurality of openings 5135 of the first body 5014 and with the lock 5046 extending outwardly from the aperture 5033 and is in the locked configuration.

Referring to FIG. 66, the first edge 5043 and the second edge 5048 of the opening 5135 may be disposed opposing each other and may form a first pair of opposing sides/edges. Each opening 5135 may also include a second pair of opposing sides/edges having a third edge and a fourth edge. The third and fourth edges of the opening 5135 may be disposed opposing each other with the first edge 5043 and the second edge 5048 disposed between therebetween (i.e., the third and fourth edges).

The lip portion 5039 and the lock 5046 of the second body 5012 may be configured to engage and/or lock with the first edge 5043 and the second edge 5048 of the first body 5014. In some aspects, the lip portion 5039 and the lock 5046 of the second body 5012 may be configured to engage and/or lock with the third edge and the fourth edge of the first body 5014.

The plurality of openings 5135 of the first body 5014 may be spaced apart in a grid configuration as shown in FIG. 66. There are four openings 5135 that are spaced apart and in the grid configuration as shown in FIG. 66. In some aspects, the number of openings 5135 may vary. In some aspects, the openings 5135 may be spaced apart and may be disposed in either along a vertical line configuration or a horizontal line configuration (rather than being in a grid configuration).

As shown in FIGS. 69-71 and 74, the plurality of openings 5135 of the first body 5014 may each have an opening thickness OT. The lip portion 5039, 5039₀ of the connector 5034 of the second body 5012 is offset from the face 5241 at a distance equal to or greater than the opening thickness OT when the connector 5034 of the second body 5012 is received in the opening 5135 of the first body 5014 as shown in FIGS. 71 and 74.

The plurality of connectors 5034 of the second body 5012 extend outwardly (e.g., sidewardly, upwardly, or downwardly away) from the face 5241. Although one connector 5034 is shown, the number of connectors 5034 extending outwardly from the face 5241 of the second body 5012 may vary.

As shown in FIGS. 67-74, the second body 5012 may comprise an actuator 5095 configured to move the lock 5046 from the locked configuration to the unlocked configuration. The actuator 5095 may be configured to be movable (e.g., in a direction of an arrow AD) with respect to (e.g., portions 5103 of) the second body 5012 between a first position (as shown in FIGS. 67-68 and 71) and a second position (as shown in FIG. 69 and 73-74). The portions 5103 of the second body 5012 may include front portion 5103_{F} of the second body 5012 and bottom portions 5103_{B} of the second body 5012. The actuator 5095 may be configured to be movable with respect to the second body 5012 along a surface 5105/IFS of the second body 5012. The surface 5105 may be disposed opposite to the face 5241.

The actuator 5095 may comprise the biasing or bias member 5097 configured to bias the lock 5046 towards the locked configuration. The biasing member 5097 may include a spring. One end 5107 of the biasing member 5097 may be connected to a portion 5109 of the lock 5046, and the other (opposing) end of the biasing member 5097 may be connected to a portion 5111 of the second body 5012. As would be appreciated by a person of ordinary skill in the art, the bias member 5097 may include torsion spring, compression spring, tension spring, or a flexible element in general applying pressure, etc.

The actuator 5095 may be a push button actuator 5095 that may comprise a cam 5099 and a follower 5101. During actuation from the locked configuration to the unlocked configuration, a direction (as shown by the arrow AD) of movement of the push button actuator 5095 and a direction (as shown by the arrow LDD) of movement of the lock 5046 may be less than 90 degrees apart. That is, as shown in FIG. 67, an angle AAL between the direction (as shown by the arrow AD) of movement of the push button actuator 5095 and the direction (as shown by the arrow LDD) of movement of the lock 5046 may be less than 90 degrees apart. The push button actuator 5095 may be configured to pull back the spring-loaded pin/follower 5101 for release of the connector 5034.

As shown in FIG. 67, the cam 5099 of the actuator 5095 may include surfaces 5117 of an opening 5119 in the actuator 5095. The opening 5119 may include a triangular shaped opening. In some aspects, the opening 5119 may include other shaped configurations.

The follower 5101 may include a slide pin. The follower 5101 may be configured to be received in an opening 5113 of the lock 5046 and may be configured to be fixedly connected to the lock 5046. On both sides of the lock 5046, the follower 5101 may be configured to extend outwardly from the opening 5113 of the lock 5046 and extend outwardly from sides/surfaces of the lock 5046.

On both sides of the lock 5046, portions of the follower 5104 (that extend outwardly from the opening 5113 and the lock 5046) may be configured to pass through an elongated opening 5115 in the second body 5012. The elongated opening 5115 of the second body 5012 may extend along the direction (as shown by the arrow LDD) of movement of the lock 5046. The elongated opening 5115 of the second body 5012 may include two opposing ends (e.g., an upper end and a lower end) along the direction (as shown by the arrow LDD) of movement of the lock 5046. For example, the lower end may be closer to the surface IFS of the second body 5012, and the upper end may be away from the surface IFS of the second body 5012.

The elongated opening 5115 of the second body 5012 may be constructed and arranged such that it enables the follower 5101 (and the lock 5046 fixedly connected thereto) to move within the elongated opening 5115 of the second body 5012 as the lock 5046 is being moved (along the direction (as shown by the arrow LDD) of movement of the lock 5046) between the locked and unlocked configurations. The movement of the follower 5101 between the lower end and the upper end of the opening 5115 enables the lock 5046 to move between the lock configuration and the unlocked configuration. For example, the follower 5101 may be at the lower end of the opening 5115 when the lock 5046 is in its locked configuration, and the follower 5101 may be at the upper end of the opening 5115 when the lock 5046 is in its unlocked configuration.

On both sides of the second body 5012, portions of the follower 5104 (that extend outwardly from the opening 5115 and from the second body 5012) may be configured to pass through the opening 5119 in the actuator 5095 to engage with the surfaces 5117 of the cam 5099 of the actuator 5095. The opening 5119 may be constructed and arranged such that it enables the follower 5101 (and the lock 5046 fixedly connected thereto) to move along the surfaces 5117 of the cam 5099 of the actuator 5095 as the lock 5046 is being moved (along the direction (as shown by the arrow LDD) of movement of the lock 5046) between the locked and unlocked configurations.

The method of operation of the connection assembly 5000 is discussed in detail with respect to FIGS. 67-74.

In FIGS. 67-68, the second body 5012 (along with the connector 5034, the lock 5046, the bias member 5097, and the actuator 5095 with the cam 5099, the follower 5101, etc.) is shown and the first body 5014 is not shown. The lock 5046 is in its locked configuration in which the lock 5046 extends outwardly from the aperture 5033. The bias member 5097 is configured to bias the lock 5046 towards the locked configuration. The actuator 5095 is in its first/original/rest position. As shown in FIGS. 67-68, when the actuator 5095 is in its first position, a front surface FSA (e.g., user engageable surface) of the actuator 5095 may be configured to be substantially flush with a front surface FSS of the second body 5012.

The follower 5101 extends through and outwardly from the opening 5113 of the lock 5046, and extends through and outwardly from the opening 5115 of the second body 5012. The follower 5101 then engages with the surfaces 5117 of the cam 5099 of the actuator 5095. When the lock 5046 is in its lock configuration as shown in FIGS. 67-68, the follower 5101 is positioned at the lower end (closer to the surface IFS of the second body 5012) of the opening 5115 of the second body 5012. Also, when the lock 5046 is in its lock configuration as shown in FIGS. 67-68, the follower 5101 engages with portions 5121 of the surfaces 5117 of the cam 5099 of the actuator 5095. For example, the portions 5121 of the surfaces 5117 may be include an intersection of two legs/sides 5123 of the triangular opening 5119.

FIG. 69 shows a procedure (and a cross-sectional view) in which the connector 5034 of the second body 5012 is being inserted into the opening 5135 of the first body 5014. The lock 5046 is moved from its locked configuration to its unlocked configuration before the insertion of the connector 5034 of the second body 5012 into the opening 5135 of the first body 5014. This is done by engaging the front surface FSA of the actuator 5095 and moving the actuator 5095 in the direction (as shown by the arrow AD) of the movement of the actuator 5095 and with respect to the portions (e.g., the front portion 5103_{F} and bottom portions 5103_{B}) of the second body 5012. In some aspects, this is accomplished by the lock contact surface LCS of the lock 5046 contacting the first body 5014 and actuating the lock 5046.

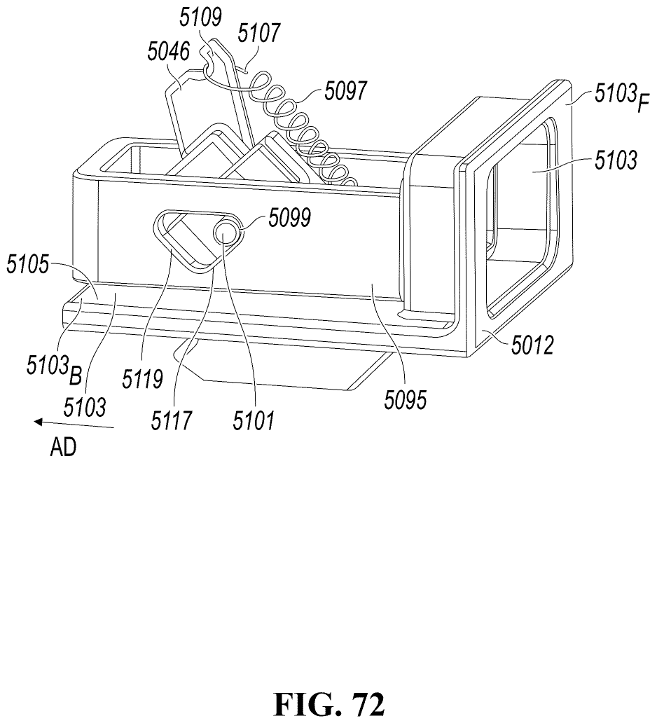

As shown in FIGS. 67-74, the user may actuate the actuator 5095 (e.g., in a direction (as shown by the arrow AD) of movement of the actuator 5095) to move the lock 5046 from its locked configuration to its unlocked configuration. The actuation of the actuator 5095 causes (a) the follower 5105 ride/move along a portion (e.g., surface/side 5123) of the opening 5119 from a first position (as shown in FIG. 67) of the follower 5105 to a second position (as shown in FIG. 72) of the follower 5105, and (b) the follower 5105 to also move from the lower end (as shown in FIG. 67) of the opening 5119 to the upper end (as shown in FIG. 72) of the opening 5119. These movements of the follower 5105 in turn causes the lock 4046 to move/slide the lock 5046 along the corridor 5037 and against the bias of the bias member 5097. This movement of the lock 5046 causes the lock 5046 of the second body 5012 to move from its locked configuration to its unlocked configuration and/or causes the lock 5046 of the second body 5012 to disengage from the opening 5135 of the first body 5014.

For example, comparing FIGS. 67 and 69, the front surface FSA of the actuator 5095 is substantially flush with the front surface FSS of the second body 5012 when the lock 5046 is in its locked configuration as shown in FIG. 67, while the front surface FSA of the actuator 5095 is offset (e.g., along the direction (as shown by the arrow AD) of the movement of the actuator 5095) with respect to the front surface FSS of the second body 5012 when the lock 5046 is in its unlocked configuration as shown in FIG. 69. Also, the lock 5046 extends outwardly from the opening 5033 when the lock 5046 is in its locked configuration as shown in FIG. 67, while the lock 5046 is within the opening 5033 when the lock 5046 is in its unlocked configuration as shown in FIG. 69.

The opening 5133 of the first body 5014 may include cam surfaces 5043_{C} along the edge 5043 of the opening 5133. The cam surfaces 5043_{C} (e.g., on the second side SS of the connector 5034) may be configured to engage with the cam surfaces 5039_{S1} and 5039_{S2} of the lip portion 5039 of the connector 5034 of the second body 5012 as the connector 5034 of the second body 5012 is being inserted into the opening 5135 of the first body 5014. That is, the camming action between the cam surfaces 5043_{C} of the opening 5133 and the cam surfaces 5039_{S1} and 5039_{S2} of the connector 5034 causes connector 5034 to be received into the opening 5133. The engagement between the cam surfaces 5043_{C} of the opening 5133 and the cam surfaces 5039_{S1} and 5039_{S2} of the connector 5034 and the beginning of the camming action is shown in FIG. 69.

The connector 5034 of the second body 5012 is being inserted into the opening 5135 of the first body 5014 while the lock 5046 is still in its unlocked configuration.

FIG. 74 shows a procedure (and a cross-sectional view) in which the connector 5034 of the second body 5012 is inserted into the opening 5135 of the first body 5014 and the lock 5046 is still in its unlocked configuration. The opening 5133 of the first body 5014 may also include surfaces 5048_{C} along the edge 5048 of the opening 5133. As shown in FIG. 74, some of the surfaces 5048_{C} may engage with some surfaces (e.g., adjacent the opening 5033 and on the first side FS) of the connector 5034 when the connector 5034 of the second body 5012 is received in the opening 5135 of the first body 5014.

When the connector 5034 of the second body 5012 is inserted into the opening 5135 of the first body 5014 as shown in FIG. 74, the user may stop actuating the actuator 5095 (e.g., in a direction (as shown by the arrow AD) of movement of the actuator 5095) to move the lock 5046 from its unlocked configuration to its locked configuration. This causes (a) the follower 5105 ride/move along the portion (e.g., surface/side 5123) of the opening 5119 from the second position (as shown in FIG. 72) of the follower 5105 to the first position (as shown in FIG. 67) of the follower 5105, and (b) the follower 5105 to also move from the upper end (as shown in FIG. 72) of the opening 5119 to the lower end (as shown in FIG. 67) of the opening 5119 to. These movements of the follower 5105 in turn causes the lock 4046 to move/slide the lock 5046 along the corridor 5037. This movement of the lock 5046 causes the lock 5046 of the second body 5012 to move from its unlocked configuration to its locked configuration and/or causes the lock 5046 of the second body 5012 to engage from the opening 5135 of the first body 5014.

When a force is applied to bring the two bodies 5012, 5014 together (e.g., drop in, press together) and the connector 5034 generally aligned with the opening 5135, the contact surface LCS of the lock 5046 contacts the surface 5145 and/or edge 5048 of the first body 5014 and the resulting force moves the lock 5046 toward the unlocked configuration (e.g., against any biasing force of the bias member 5097) enough to allow the connector 5034 to be inserted into the opening 5135. The moment the connector 5034 is inserted sufficiently into the opening 5135, the contact surface LCS of the lock 5046 moves past the surface 5145 and/or edge 5048 of the first body 5014 and moves back to the locked configuration.

The user may stop actuating the actuator 5095, or the lock contact surface LCS may stop actuating the actuator 5095. When the lock contact surface LCS moves past the edge 5048, there is no more contact and the lock 5046 moves back to the locked position.

The connection assembly, as shown in FIGS. 65-74, facilities a drop and lock connection between the first body and the second body. The connection assembly may include a diagonal slide with perpendicular lock. The connection assembly enables a variety of footprints and modules to be connected to each other. The connection assembly also enables stacking between the first body and the second body in four directions. The connection assembly enables vertical and horizontal connectivity between the first body and the second body. The connection assembly provides auto lock and one hand activation for release but without the need of pushing back to lock (drop and lock system). As explained in detail above with respect to FIGS. 65-74, one or more connectors that slide diagonally into the openings with parallel diagonal surfaces where at least one connector has a perpendicular to slide direction pin that prevents the connectors from sliding out. The locking pin may be spring loaded or may have a snap lock on its own.

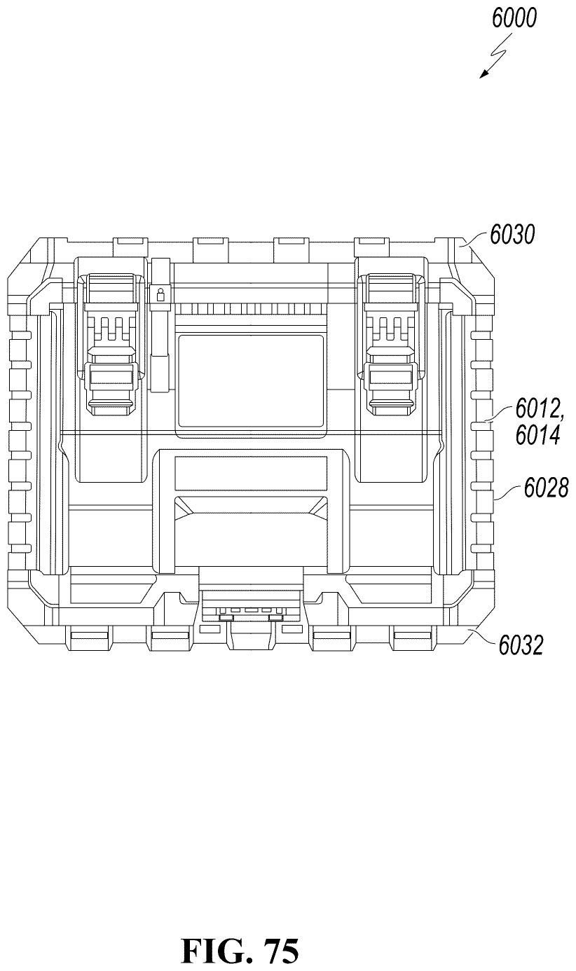

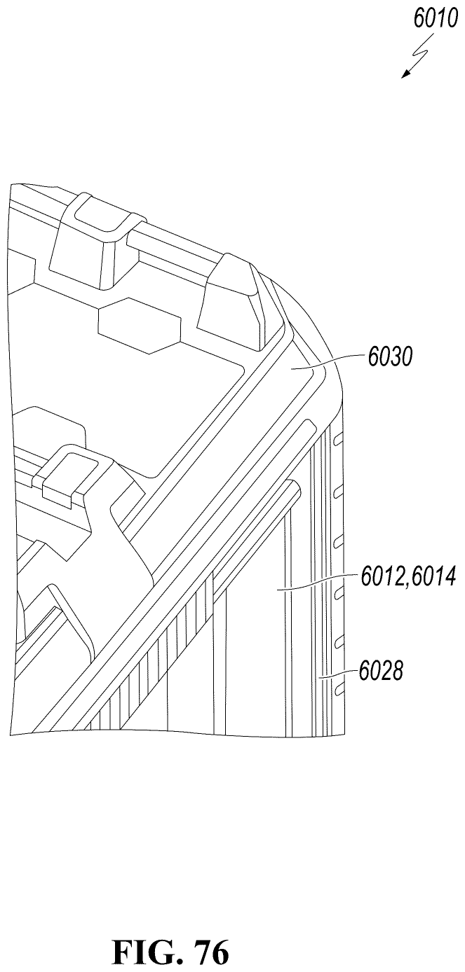

FIGS. 75-78 show a toolbox assembly 6010. The toolbox assembly 6010 may be interchangeably referred to as a container system and the toolbox assembly 6010 may include one or more features of the container system, as described in greater detail below.

The toolbox assembly 6010 comprises a plurality of containers 6012, 6014 including at least a first container 6012 and a second container 6014. The plurality of containers may further comprise a third container 6015. The number of containers in the toolbox assembly 6010 may vary. The containers 6012, 6014, 6015 of the toolbox assembly 6010 may have same size, shape and/or configuration or may have different sizes, shapes and/or configurations as described herein.

Each container 6012, 6014, 6015 comprises a container portion 6028 and a lid portion 6030. A bottom 6032 of the first container portion 6028 has a first connection portion 6034. The lid portion 6030 of the second container 6014 has a second connection portion 6036. The lid portion 6030 of the third container 6015 may have a third connection portion 6036.

As would be appreciated by a person of ordinary skill in the art, the lid portion 6030 of the first container 6012 may have a connection portion 6036, the bottom 6032 of the second container portion 6028 may a connection portion 6034, and the bottom 6032 of the third container portion 6028 may a connection portion 6034. These connection portions 6034, 6036 of the containers 6012, 6014, 6015 are constructed and arranged such that they allow one or more the containers 6012, 6014, 6015 to be selectively connectable (on top or on bottom) of the other containers 6012, 6014, 6015.

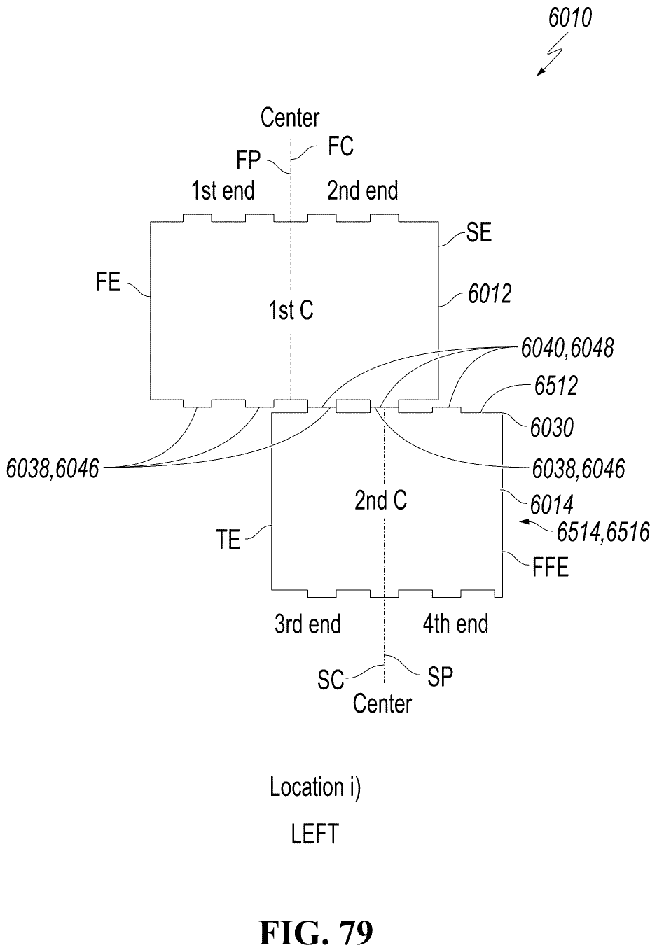

The first container 6012 may be configured to be selectively connectable on top 6512 of the second container 6014. For example, FIGS. 79-84 are diagrammatic illustrations of a plurality of configurations/arrangements of multiple containers 6012, 6014, 6015 of the toolbox assembly 6010. It is noted that the containers 6012, 6014, 6015 of the toolbox assembly configurations shown in FIGS. 79-84 are not to scale and are only intended to illustrate some of the various modular stacking configurations provided by the systems described herein.

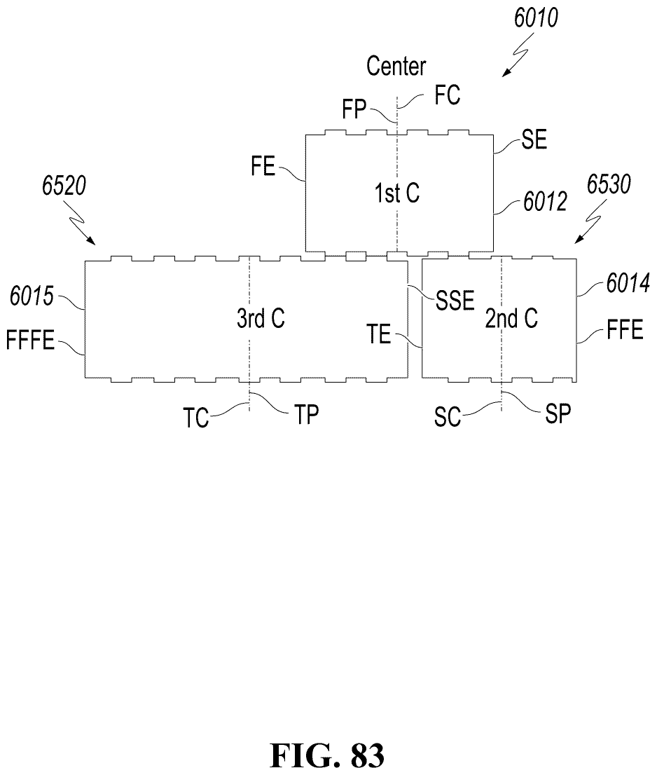

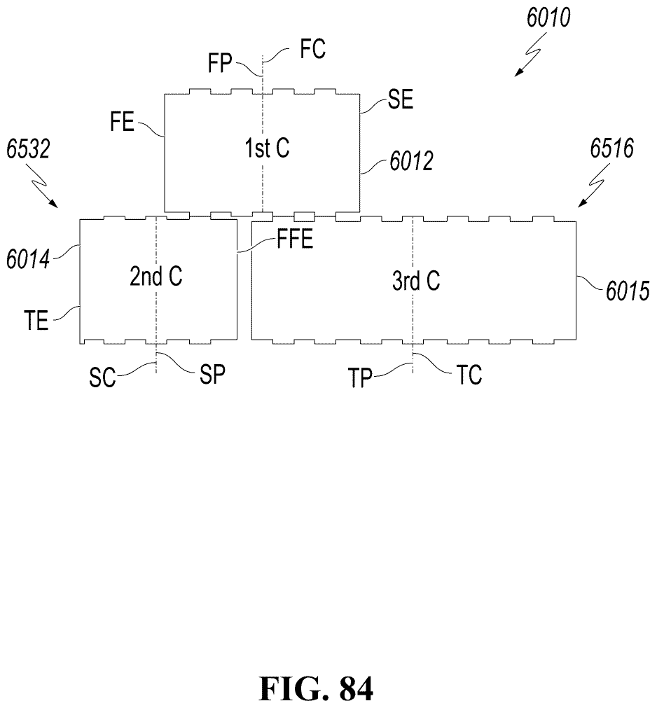

In FIGS. 79-84, the first container 6012 is configured to be selectively connectable on the top 6512 of the second container 6014. The first container 6012 may be configured to be selectively connectable on top of the third container 6015. In FIGS. 83-84, the first container 6012 is configured to be selectively connectable on top of the third container 6015.

In some aspects, (a) the second container 6014 may be configured to be selectively connectable on top of the first container 6012, (b) the third container 6015 may be configured to be selectively connectable on top of the first container 6012, (c) the third container 6015 may be configured to be selectively connectable on top of the second container 6014, (d) the second container 6014 may be configured to be selectively connectable on top of the third container 6015, (e) the second container 6014 may be configured to be selectively connectable on top of the first container 6012 and the third container 6015, and/or (f) the third container 6015 may be configured to be selectively connectable on top of the first container 6012 and the second container 6014. These are just a few exemplary arrangements/configurations of the toolbox assembly 6010 having two or three containers but the toolbox assembly 6010 may have any number of containers in the toolbox assembly 6010 and their various arrangements/configurations in the toolbox assembly 6010.

Referring to FIGS. 79-84, the first container 6012 comprises a first end FE, a second end SE, and a center FC located midway (e.g., a longitudinal midpoint located approximately halfway) between the first end FE and the second end SE.

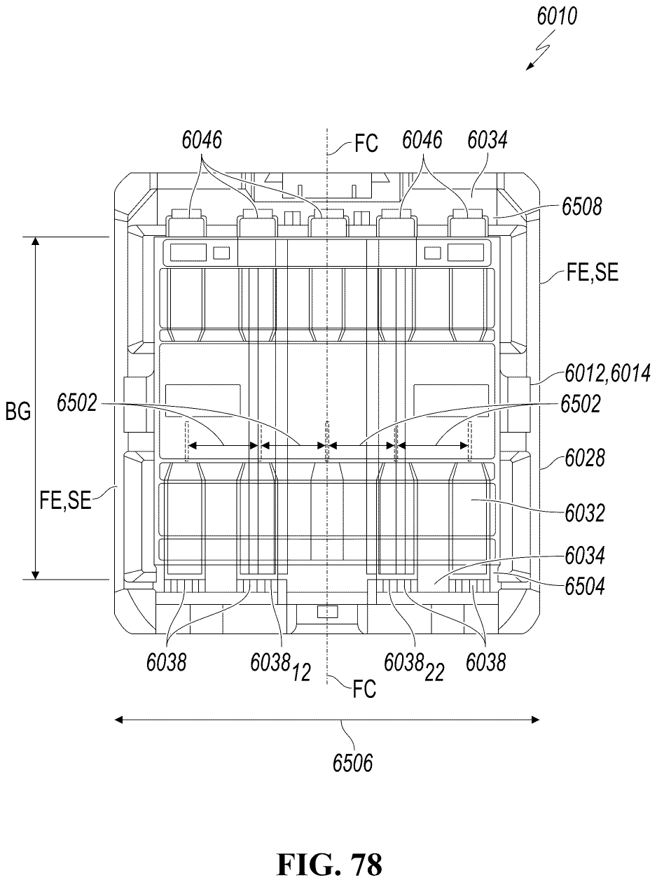

Referring to FIG. 78, the first connection portion 6034 comprises a row 6504 of first laterally spaced connectors 6038 that are spaced apart from one another in a direction (e.g., along the direction of an arrow 6506) from the first end FE toward the second end SE (or from the second end SE to the first end FE) at a first connector spacing 6502. The first connection portion 6034 may further comprise a row 6508 of first laterally spaced lock members 6046 that are spaced apart from one another in the direction (e.g., along the direction of an arrow 6506) from the first end FE toward the second end SE (or from the second end SE to the first end FE). The first laterally spaced lock members 6046 of the first connection portion 6034 may be spaced apart from each other by the first connector spacing 6502.

Referring to FIGS. 79-84, the second container 6014 comprises a third end TE, a fourth end FFE, and a center SC located midway (e.g., a longitudinal midpoint located approximately halfway) between the third end TE and the fourth end FFE.

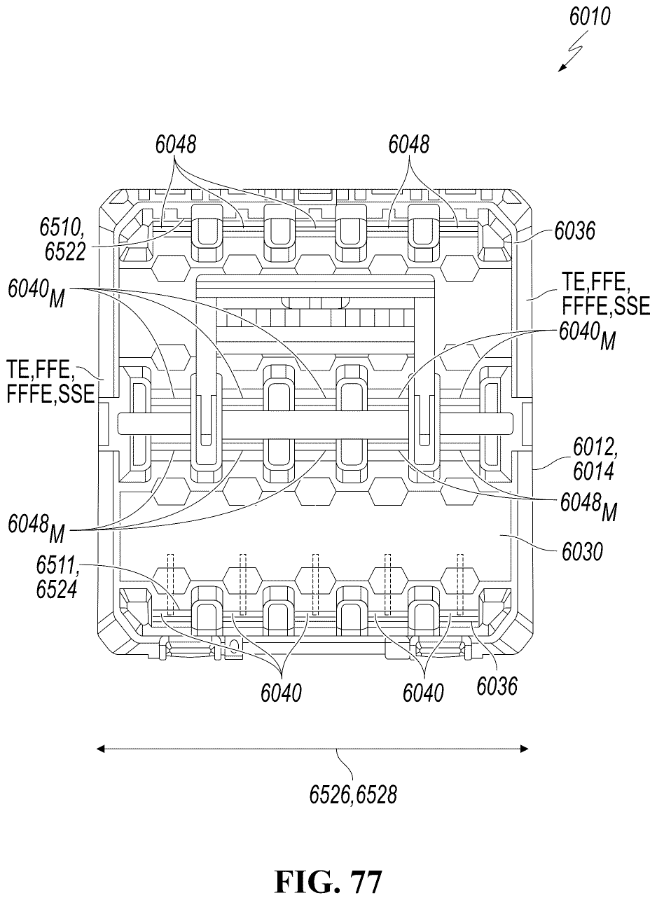

Referring to FIG. 77, the second connection portion 6036 comprises a row 6511 of second laterally spaced connectors 6040 that are spaced apart from one another in a direction (e.g., along the direction of an arrow 6526) from the third end TE toward the fourth end FFE (or from the fourth end FFE to the third end TE) at the first connector spacing 6502, and a row 6510 of second laterally spaced lock members 6048 that are spaced apart from one another in the direction (e.g., along the direction of an arrow 6526) from the third end TE toward the fourth end FFE (or from the fourth end FFE to the third end TE). The second laterally spaced lock members 6048 of the second connection portion 6036 may be spaced apart from each other by the first connector spacing 6502.

Referring to FIGS. 83-84, the third container 6015 may comprise a fifth end FFFE, a sixth end SSE, and a center TC located midway (e.g., a longitudinal midpoint located approximately halfway) between the fifth end FFFE and the sixth end SSE.

Referring to FIG. 77, the third connection portion 6036 may comprise a row 6524 of third laterally spaced connectors 6040 that are spaced apart from one another in a direction (e.g., along the direction of an arrow 6528) from the fifth end FFE toward the sixth end SSE (or from the sixth end SE to the fifth end FFFE) at the first connector spacing 6502. The third connection portion 6036 may further comprise a row 6522 of third laterally spaced lock members 6048 that are spaced apart from one another in the direction (e.g., along the direction of an arrow 6528) from the fifth end FFE toward the sixth end SSE (or from the sixth end SE to the fifth end FFFE). The third laterally spaced lock members 6048 of the third connection portion 6036 may be spaced apart from each other by the first connector spacing 6502.

The center FC of the first container 6012 may define a first plane FP that is generally parallel and midway between the first end FE and the second end SE of the first container 6012. The center SC of the second container may define a second plane SP that is generally parallel and midway between the third end TE and fourth end FFE. The center TC of the third container may define a third plane TP that is generally parallel and midway between the fifth end FFFE and sixth end SSE. The first plane FP and the second plane SP may generally be coplanar when the center SC of the second container 6014 is generally aligned with the center FC of the first container 6012. That is, the planes (passing through the centers) of the containers may generally be coplanar when the centers of the containers 6014 are generally aligned with each other.

The first plane FP and the second plane SP may generally be parallel and spaced apart from each other in the right location 6520, the left location 6516, the far-left location 6530, and the far-right location 6532. The first plane FP, the second plane SP, and the third plane TP may generally be parallel and spaced apart from each other in the right location 6520, the left location 6516, the far-left location 6530, and the far-right location 6532. That is, the planes (passing through the centers) of the containers may generally be parallel and spaced apart from each other when the containers are generally offset with respect to each other.

Referring to FIGS. 77-78, the first lock members 6046 may be spaced apart from one another at the first connector spacing 6502. The second lock members 6048 may be spaced apart from one another at the first connector spacing 6502. The third lock members 6048 may be spaced apart from one another at the first connector spacing 6502.

Referring to FIGS. 77-78, the first connectors 6038 may be spaced apart from one another at the first connector spacing 6502. The second connectors 6040 may be spaced apart from one another at the first connector spacing 6502. The third connectors 6040 may be spaced apart from one another at the first connector spacing 6502.

The spacing between the corresponding lock members 6046, 6048 and the spacing between the corresponding connectors 6038, 6040 remain the same (e.g., first connector spacing 6502) no matter what the sizes, shapes, or configurations of the containers 6012, 6014, 6015 are. This enables for various stacked configurations between the containers 6012, 6014, 6015.

As FIGS. 79-84 show the front views of the toolbox assembly 6010, one of the laterally spaced lock members 6046, 6048 or the laterally spaced connectors 6038, 6040 for each container 6012, 6014, 6015 are shown. However, a person of ordinary skill in the art would ready appreciate that the other of the laterally spaced lock members 6046, 6048 or the laterally spaced connectors 6038, 6040 for each container 6012, 6014, 6015 may be seen in the rear views of the toolbox assembly 6010.

For example, in the front views of the toolbox assembly 6010 in FIGS. 79-84, the first container 6012 may be configured to be selectively connectable on top of the second container 6014 and/or top of the third container 6016 such that the laterally spaced lock members 6046 of the first container 6012 are engaged with the laterally spaced lock members 6048 of the second container 6014 and/or the third container 6015. In some aspects, the laterally spaced connectors 6038 of the first container 6012 can engage with the laterally spaced connectors 6040 of the second container 6014 and/or the third container 6015.

In some aspects, when the first container 6012 is selectively connectable on top of the second container 6014 and/or top of the third container 6016, the laterally spaced connectors 6038 of the first container 6012 are engaged with the laterally spaced connectors 6040 of the second container 6014 and/or the third container 6015, and these connections can be seen in the front views of the toolbox assembly 6010. In some aspects, the laterally spaced lock members 6046 of the first container 6012 are engaged with the laterally spaced lock members 6048 of the second container 6014 and/or the third container 6015, and these connections can be seen in the rear views of the toolbox assembly 6010.

Referring to FIGS. 79-81, the first container 6012 is selectively connectable on the top 6512 of the second container 6014 in a number of connection locations 6514. The number of connection locations 6514 may vary. The number of connection locations 6514 may depend on the sizes, shapes, and configurations of the containers being selectively connected to each other.

The number of connection locations C, 6514 may satisfy the following equation, C≥FLSC+SLSC−1, wherein C is the number of connection locations, FLSC is a total number of first laterally spaced connectors 6038 on the first container 6012, and SLSC is a total number of second laterally spaced connectors 6040 on the second container 6014.

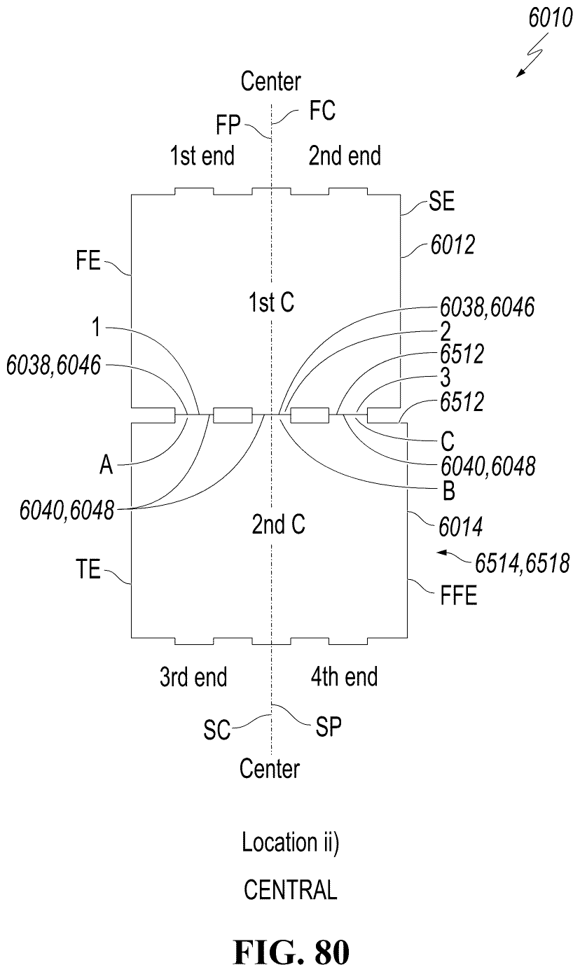

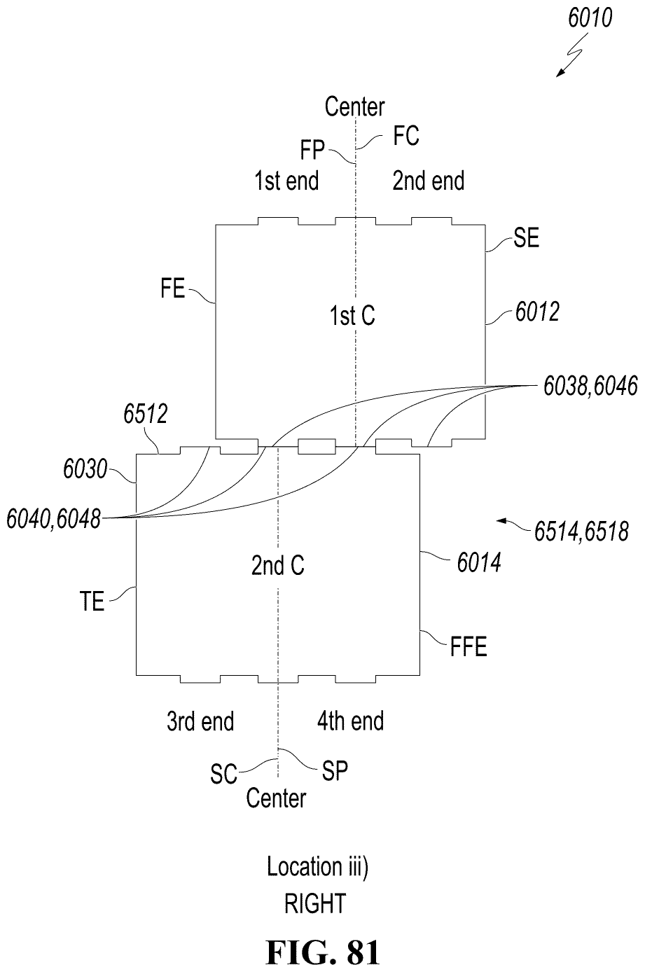

As shown in FIGS. 80-81, the total number FLSC of first laterally spaced connectors 6038 on the first container 6012 is three, the total number SLSC of second laterally spaced connectors 6040 on the second container 6014 is three, and the number of connection locations C, 6514 is at least five using the above-discussed equation. The number of connection locations C, 6514 may be equal to five or more than five.

For example, if the three laterally spaced connectors on the first container 6012 are labeled as 1, 2, 3 and the three laterally spaced connectors on the second container 6014 are labeled as A, B, C, then the five exemplary connection locations C, 6514 may include: connection location (i) 1->A, 2->B, 3->C in which the connectors 1, 2, 3 of the first container 6012 are engaged with the connectors A, B, C of the second container 6014, respectively; connection location (ii) 2->A, 3->B in which the connectors 2 and 3 of the first container 6012 are engaged with the connectors A, B of the second container 6014, respectively; the connector 1 of the first container 6012 overhangs on the lefthand side of the toolbox assembly 6010; and the connector C of the second container 6014 is exposed on the righthand side of the toolbox assembly 6010; connection location (iii) 3->A in which the connector 3 of the first container 6012 is engaged with the connector A of the second container 6014, respectively; the connectors 1, 2 of the first container 6012 overhang on the lefthand side of the toolbox assembly 6010; and the connectors B, C of the second container 6014 are exposed on the righthand side of the toolbox assembly 6010; connection location (iv) 1->B, 2->C in which the connectors 1 and 2 of the first container 6012 are engaged with are engaged with the connectors B, C of the second container 6014, respectively; the connector 3 of the first container 6012 overhangs on the righthand side of the toolbox assembly 6010; and the connector A of the second container 6014 is exposed on the lefthand side of the toolbox assembly 6010; and connection location (v) 1->C in which the connector 1 of the first container 6012 is engaged with the connector C of the second container 6014, respectively; the connectors 2, 3 of the first container 6012 overhang on the righthand side of the toolbox assembly 6010; and the connectors A, B of the second container 6014 are exposed on the lefthand side of the toolbox assembly 6010.

A variety of exemplary connection configurations are described below in reference to the figures, however, other connection configurations are also realized and the examples provided below are not intended to be limiting.

As shown in FIG. 79, a first exemplary connection location (i) represents a left location where the connectors 2 and 3 of the first container 6012 are engaged with the connectors A, B of the second container 6014, respectively. In this configuration, the connector 1 of the first container 6012 overhangs on the lefthand side of the toolbox assembly 6010, while the connector C of the second container 6014 is exposed on the righthand side of the toolbox assembly 6010.

As shown in FIG. 80, a second exemplary connection location (ii) represents a central location where the connectors 1, 2, 3 of the first container 6012 are engaged with the connectors A, B, C of the second container 6014, respectively. In this configuration, the containers are aligned such that all connectors of both containers are engaged.

As shown in FIG. 81, a third exemplary connection location (iii) represents a right location where the connectors 1 and 2 of the first container 6012 are engaged with the connectors B, C of the second container 6014, respectively. In this configuration, the connector 3 of the first container 6012 overhangs on the righthand side of the toolbox assembly 6010, while the connector A of the second container 6014 is exposed on the lefthand side of the toolbox assembly 6010.

As shown in FIG. 83, a fourth exemplary connection location (iv) represents a far-left location where only the connector 3 of the first container 6012 is engaged with the connector A of the second container 6014. In this configuration, the connectors 1, 2 of the first container 6012 overhang on the lefthand side of the toolbox assembly 6010, while the connectors B, C of the second container 6014 are exposed on the righthand side of the toolbox assembly 6010.

As shown in FIG. 84, a fifth exemplary connection location (v) represents a far-right location where only the connector 1 of the first container 6012 is engaged with the connector C of the second container 6014. In this configuration, the connectors 2, 3 of the first container 6012 overhang on the righthand side of the toolbox assembly 6010, while the connectors A, B of the second container 6014 are exposed on the lefthand side of the toolbox assembly 6010.

Referring again to FIG. 79, the total number FLSC of first laterally spaced connectors 6038 on the first container 6012 is four, the total number SLSC of second laterally spaced connectors 6040 on the second container 6014 is three, and the number of connection locations C, 6514 is at least six. The number of connection locations C, 6514 may be equal to or more than six.

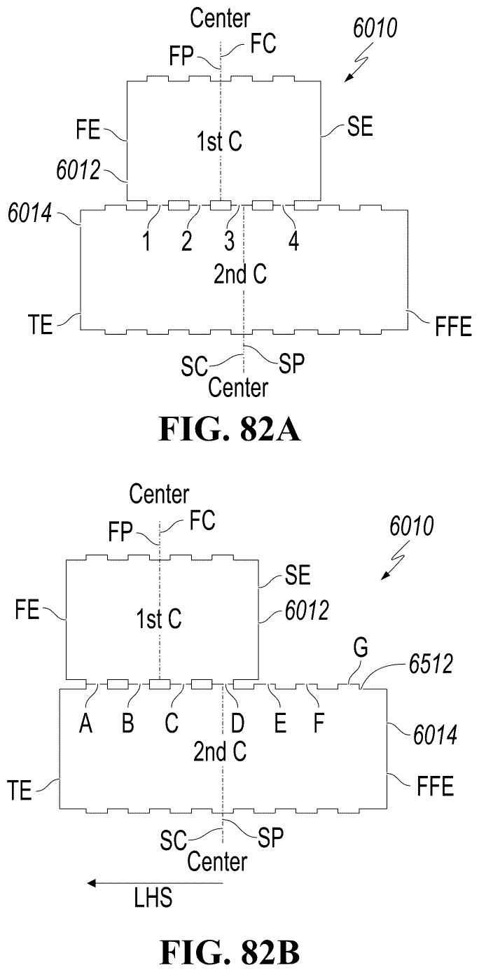

Also, as shown in FIGS. 82A-82B, the total number FLSC of first laterally spaced connectors 6038 on the first container 6012 is four, the total number SLSC of second laterally spaced connectors 6040 on the second container 6014 is seven, and the number of connection locations C, 6514 is at least ten. The number of connection locations C, 6514 may be equal to or more than ten.

As shown in FIGS. 83-84, the total number FLSC of first laterally spaced connectors 6038 on the first container 6012 is four, the total number SLSC of second laterally spaced connectors 6040 on the second container 6014 is three, the total number of second laterally spaced connectors 6040 on the third container 6015 is seven. The number of connection locations C, 6514 between the first container 6012 and the second container 6014 is at least six. The number of connection locations C, 6514 between the first container 6012 and the second container 6014 may be equal to or more than six. The number of connection locations C, 6514 between the first container 6012 and the third container 6015 is at least ten. The number of connection locations C, 6514 between the first container 6012 and the third container 6015 may be equal to or more than ten.

Referring to FIGS. 54-55 and their related descriptions, the first and second containers may be stacked in the first configuration (or stacked front to front). The total number of first laterally spaced connectors 6038 on the first container 6012 is three, and total number of second laterally spaced connectors 6040 on the second container 6014 is three. The number of connection locations may be five, for example, in the first configuration of the first and second containers.

The first container may then be disengaged from the second container when they are in their first configuration and the first container may then be reversed with respect to the second container so as to be stacked in the second configuration (or stacked front to back). The total number of first laterally spaced connectors 6046 on the first container 6012 is three, and total number of second laterally spaced connectors 6040 on the second container 6014 is three. The number of connection locations may be five, for example, in the second configuration of the first and second containers.

Thus, the first and second containers may have five connection locations in the first configuration and five additional connection locations in the second configuration, making a total number of connection locations between the first and second containers to be ten connection locations.

In some aspects, the first container may then be disengaged from the second container when they are in their first configuration and the second container may then be reversed with respect to the first container so as to be stacked in yet another stacking configuration (or stacked back to front). The total number of first laterally spaced connectors 6038 on the first container 6012 is three, and total number of second laterally spaced connectors 6048 on the second container 6014 is three. The number of connection locations may be five, for example, in this configuration of the first and second containers. Thus, the first and second containers may have five connection locations in the first configuration, five additional connection locations in the second configuration, and five more additional connection locations in the stacked back to front configuration, making a total number of connection locations between the first and second containers to be fifteen connection locations.

As discussed in detail above, the number of connection locations 6514 may include at least i) a left location 6516 wherein the center FC of the first container 6012 is located above the lid portion 6030 of the second container 6014 between the third end TE and the center SC of the second container 6014, ii) a central location 6518 wherein the center FC of the first container 6012 is located above the lid portion 6030 of the second container 6014 and the center SC of the second container 6014 is generally aligned with the center FC of the first container 6012, and iii) a right location 6520 wherein the center FC of the first container 6012 is located above the lid portion 6030 of the second container 6014 between the fourth end FFE and the center SC of the second container 6014. In each of the connection locations 6514, at least one of the first lock members 6046 is engaged with at least one of the second lock members 6048. In each of the connection locations 6514, at least one of the first connectors 6038 is engaged with at least one of the second connectors 6040.

The left location 6514, 6516 is shown in FIG. 79. The left location may interchangeably referred to as left connection location or left connection configuration. In FIG. 79, the first container 6012 includes four first laterally spaced connectors 6038 and four first laterally spaced lock members 6046. In some aspects, the first container 6012 includes three first laterally spaced connectors 6038 and three first laterally spaced lock members 6046 as shown in FIGS. 80-81. The number of first laterally spaced connectors 6038 and first laterally spaced lock members 6046 may vary.

The left location 6516 may include a connection location wherein the first end FE of the first container 6012 overhangs past the third end TE of the second container 6014. The left location 6516 may include a connection location wherein at least one connector 6038, 6046 of the first container 6012 or a portion of the at least one connector 6038, 6046 of the first container 6012 overhangs past the third end TE of the second container 6014. That is, the left location 6516 may include a connection location wherein at least one connector 6038, 6046 of the first container 6012, a portion of the at least one connector 6038, 6046 of the first container 6012, and/or the first end FE of the first container 6012 overhangs on the lefthand side of the toolbox assembly 6010.

The left location 6516 may include a connection location wherein at least one connector 6040, 6048 of the second container 6014, a portion of the at least one connector 6040, 6048 of the second container 6014, and/or fourth end FFE of the second container 6014 is past the second end SE of the first container 6012. The left location 6516 may include a connection location wherein at least one connector 6040, 6048 of the second container 6014, a portion of the at least one connector 6040, 6048 of the second container 6014, and/or fourth end FFE of the second container 6014 is exposed on the righthand side of the toolbox assembly 6010.

In some aspects, two exemplary left locations are shown in FIGS. 82A and 82B. In two exemplary left locations, the center FC of the first container 6012 is located above the lid portion 6030 of the second container 6014 between the third end TE and the center SC of the second container 6014. Although not shown, the first container 6012 may include one more exemplary left location with respect to the second container 6014. For example, this additional exemplary left location may be obtained by maintaining the second container 6014 in same position as shown in FIG. 82B and by moving the first container 6012 in the direction of an arrow LHS such that three connectors of the first container 6012 are engaged with three connectors of the second container 6014 (i.e., the left most connector of the first container 6014 overhangs).

The central location 6514, 6518 is shown in FIG. 80. The central location may interchangeably referred to as a central connection location or a central connection configuration. Referring to FIGS. 82A-82B, the first container 6012 and the second container 6014 may not have in a central connection location/configuration as the first container 6012 has even (e.g., four) number of connectors while the second container 6014 has odd (e.g., seven) number of connectors. The toolbox assembly 6010 may also not have a central connection location/configuration when the first container 6012 has odd number of connectors while the second container 6014 has even number of connectors. The toolbox assembly 6010 may have a central connection location/configuration when both the containers either have odd number of connectors or even number of connectors.

The right location 6514, 6520 is shown in FIG. 81. The right location may interchangeably referred to as a right connection location or a right connection configuration. The right location 6520 may include a connection location wherein the second end SE of the first container 6012 overhangs past the fourth end FFE of the second container 6014. The right location 6520 may include a connection location wherein at least one connector 6038, 6046 of the first container 6012 or a portion of the at least one connector 6038, 6046 of the first container 6012 overhangs past the fourth end FFE of the second container 6014. That is, the right location 6520 may include a connection location wherein at least one connector 6038, 6046 of the first container 6012, a portion of the at least one connector 6038, 6046 of the first container 6012, and/or the second end SE of the first container 6012 overhangs on the righthand side of the toolbox assembly 6010.

The right location 6520 may include a connection location wherein at least one connector 6040, 6048 of the second container 6014, a portion of the at least one connector 6040, 6048 of the second container 6014, and/or third end TE of the second container 6014 is past the first end SE of the first container 6012. The right location 6520 may include a connection location wherein at least one connector 6040, 6048 of the second container 6014, a portion of the at least one connector 6040, 6048 of the second container 6014, and/or third end TE of the second container 6014 is exposed on the lefthand side of the toolbox assembly 6010.

In some aspects, the first container 6012 may include four connectors labeled as 1, 2, 3, and 4, and the second container 6014 may include seven connectors labeled as A, B, C, D, E, F, and G (e.g., similar to the first and second containers 6012, 6014 shown in FIGS. 82A and 82B). Three exemplary right locations 6520 may include right location (i) 1->D, 2->E, 3->F, and 4->G; (ii) 1->C, 2->D, 3->E, and 4->F; and (iii) 1->E, 2->F, 3->G (with at least a portion of the connector 4 overhangs past the fourth end FFE of the second container 6014). In the above discussion, for example, “1->D” refers to connector 1 of the first container 6012 is engaged with connector D of the second container 6014. In each of these exemplary right locations 6520, the center FC of the first container 6012 is located above the lid portion 6030 of the second container 6014 between the fourth end FFE and the center SC of the second container 6014.

In the left location 6516 and in the right location 6520, the plane FP passing through the first center FC of the first container 6012 and the plane SP passing through the second center SC of the second container 6014 are parallel to each other and are spaced apart from each other. These planes are perpendicular to the longitudinal axes of the first container 6012 and the second container 6014.

As shown in FIG. 83, the number of connection locations 6514 may further include iv) a far-left location 6530 wherein the center FC of the first container 6012 overhangs past the third end TE of the second container 6014. The far-left location may interchangeably referred to as a far-left connection location or a far-left connection configuration. As shown in FIG. 83, the far-left location 6530 may include a connection location wherein the first laterally spaced connector 6038, 6046 closest to the second end SE of the first container 6012 is connected to the second laterally spaced connector 6040, 6048 closest to the third end TE of the second container 6014.

As shown in FIG. 84, the number of connection locations 6514 may further include v) a far-right location 6532 wherein the center FC of the first container 6012 overhangs past the fourth end FFE of the second container 6014. The far-right location may interchangeably referred to as a far-right connection location or a far-right connection configuration. As shown in FIG. 84, the far-right location 6532 may include a connection location wherein the first laterally spaced connector 6038, 6046 closest to the first end FE of the first container 6012 is connected to the second laterally spaced connector 6040, 6048 closest to the fourth end FFE of the second container 6014.

Like in the left location 6516 and in the right location 6520, the plane FP passing through the first center FC of the first container 6012 and the plane SP passing through the second center SC of the second container 6014 are parallel to each other and are spaced apart from each other in both the far-left location 6530 and the far-right location 6532. For example, in the right location 6520 and the far-right location 6532, the plane FP passing through the first center FC of the first container 6012 is to the righthand side of the plane SP passing through the second center SC of the second container 6014. In the left location 6516 and the far-left location 6530, the plane FP passing through the first center FC of the first container 6012 is to the lefthand side of the plane SP passing through the second center SC of the second container 6014.

The far-left location 6530, the left location 6516, the right location 6520, and the far-right location 6532 each include a plurality of connection locations. For example, as described in detail above, in the two exemplary left locations shown in FIGS. 82A and 82B, the center FC of the first container 6012 is located above the lid portion 6030 of the second container 6014 between the third end TE and the center SC of the second container 6014.

In FIGS. 83-84, the first container 6012 may be configured to be selectively connectable on top 6512 of the second container 6014 and on top of the third container 6015. As shown in FIGS. 83-84, the third container 6015 may be configured to be positioned in side-by-side relationship with the second container 6014. The third connection portion 6036 of the third container 6015 may be configured to be connectable with the first connection portion 6034 of the first container 6012 at the same time that the second connection portion 6036 of the second container 6014 may be connected to the first connection portion 6034 of the first container 6012. In some aspects, the third connection portion 6036 of the third container 6015 may have the same configuration and operation as the second connection portion 6036 of the second container 6014. In some aspects, the third container 6015 may be configured to be positioned in side-by-side relationship with the first container 6012, while the second container 6014 may be configured to be selectively connectable on tops of the third container 6015 and the first container 6012. In some aspects, the second container 6014 may be configured to be positioned in side-by-side relationship with the first container 6012, while the third container 6015 may be configured to be selectively connectable on tops of the second container 6014 and the first container 6012.

The first container 6012 may simultaneously be connected to the second container 6014 and the third container 6015, bridging the second and third containers 6014, 6015 in the far-left location and in the far-right location. In some aspects, the first container 6012 may simultaneously be connected to the second container 6014 and the third container 6015, bridging the second and third containers 6014, 6015 in the left location and the right location.

In some aspects, the first container 6012 may simultaneously be connected to the second container 6014 and the third container 6015, bridging the second and third containers 6014, 6015 in the far-right location 6532 and in the left location 6516. For example, in FIG. 84, the first container 6012 may be connected to the second container 6014 in the far-right location 6532, while the first container 6012 may be connected to the third container 6015 in the left location 6516.

In some aspects, the first container 6012 may simultaneously be connected to the second container 6014 and the third container 6015, bridging the second and third containers 6014, 6015 in the far-left location and in the right location. For example, in FIG. 83, the first container 6012 may be connected to the second container 6014 in the far-left location 6530, while the first container 6012 may be connected to the third container 6015 in the right location 6520.

As shown in FIGS. 83-84, the plane passing through the first center FC of the first container 6012, the plane passing through the second center SC of the second container 6014, and the plane passing through the third center TC of the third container 6015 are parallel to each other and are spaced apart from each other. These planes are perpendicular to the longitudinal axes of the first container 6012, the second container 6014, and the third container 6015.

The first container 6012 may further comprise a lock actuator. The row 6508 of first lock members 6046 may include at least one movable lock member 6046, selectively movable by the actuator between a locked position and an unlocked position. The at least one movable lock member 6046 is configured to prevent separation of the first and second containers 6012, 6014 in the locked position. The at least one movable lock member 6046 is configured to prevent separation of the first container 6012 from both the third and second containers 6014, 6015 in the locked position. The actuator described herein as the lock assembly is described in further detail below.

As shown in FIG. 78, the row 6504 of first laterally spaced connectors 6038 skips at least one first laterally spaced connector 6038. The connectors 603812, 603822 positioned closest to the center FC of the first container 6012 may be spaced apart from each other at two times the first connector spacing 6502.

In the above discussions, the connectors 6040 and the lock members 6048 may be disposed on (a front and a rear) on the top/lid of the container. In some aspects, the connectors 6040 and lock members 6048 may be disposed on any two sides of the four sides on the top of the container. As shown in FIG. 77, a row of connectors 6040_{M} and the lock members 6048_{M} may be disposed may be disposed in the middle (e.g., between the front and the rear or between any two opposite sides) of the container. These connectors 6040_{M} and lock members 6048_{M} disposed in the middle of the container may be interchangeably referred to as middle connectors and the middle lock members, respectively. The middle connectors 6040_{M} and the middle lock members 6048_{M} are configured for connecting and locking smaller containers (e.g., see containers 1015, 1017 as shown in FIGS. 29 and 30). That is, two containers may be provided where one container may be configured to mate along middle of the other container.

The container may include a row of the middle connectors 6040_{M} and a row of the middle lock members 6048_{M}. As shown in FIG. 77, the row of the middle lock members 6048_{M} may be disposed to face the row of connectors 6040, and the row of the middle connectors 6040_{M} may be disposed to face the row of lock members 6048. In some aspects, the row of the middle lock members 6048_{M} may be disposed to face the row of lock members 6048, and the row of the middle connectors 6040_{M} may be disposed to face the row of connectors 6040. The middle connectors 6040_{M} and the middle lock members 6048_{M} may have the same configuration (e.g., shape, size, etc.) and operation as the connectors 6040 and the lock members 6048 disposed on the front or the rear of the lid/top of the container.

Referring to FIG. 78, a gap BG is disposed between the lock members 6046 and the connectors 6038 on the bottom of the container. The gap between the lock members 6046 and the connectors 6038 on the bottom of the (e.g., top) container is provided so as to clear the middle connectors 6040_{M} and middle lock members 6048_{M} on the lid/top of another (e.g., bottom) container.

As shown FIGS. 54-56, the gap may be a smaller (longitudinally extending) opening BG′ that is disposed on the bottom of the container and is shaped and configured to receive the middle connectors 6040_{M} and middle lock members 6048_{M} on the lid/top of another (e.g., bottom) container.

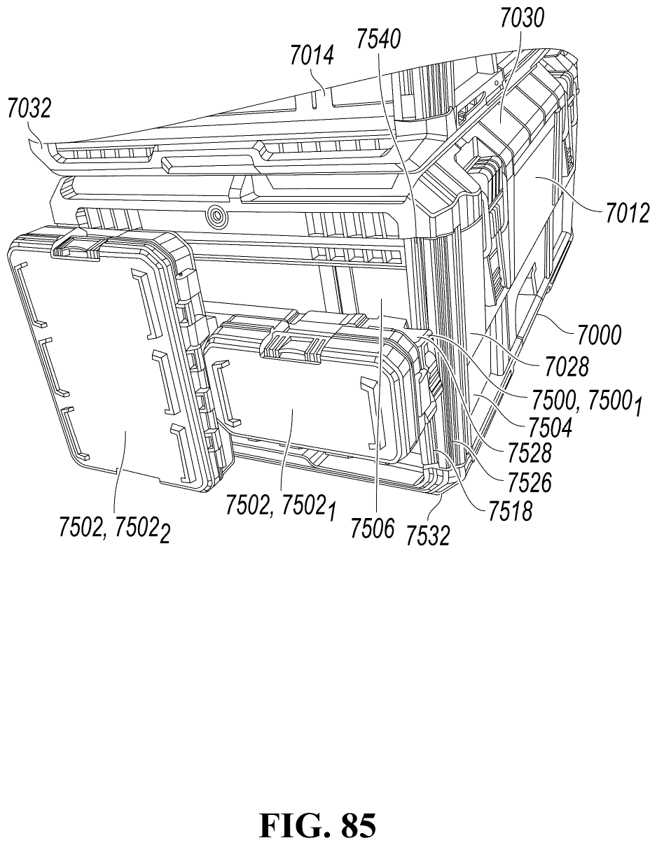

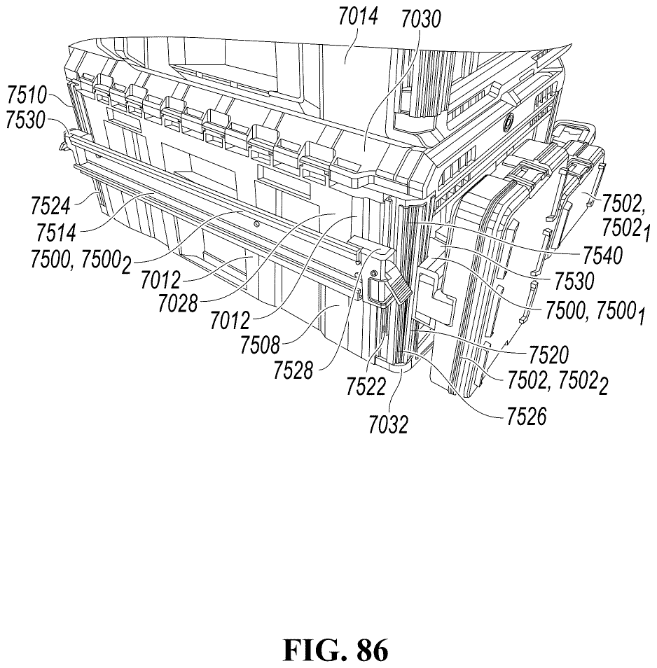

FIGS. 85-86 show perspective views of a storage system 7000 in accordance with the systems described herein. The container system 7000 may interchangeably referred to as a stackable container system or a container system.

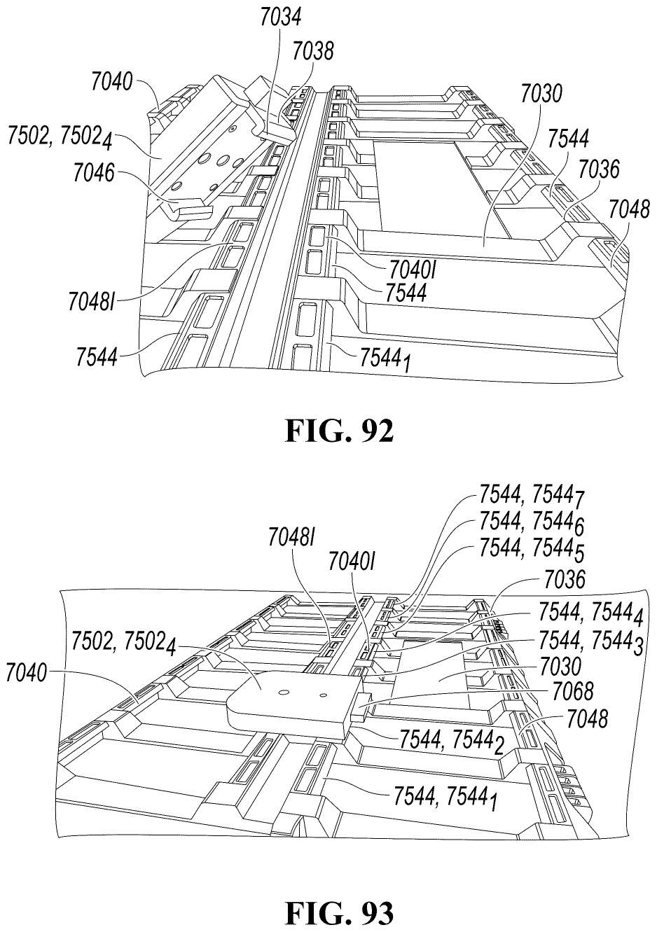

The storage system 7000 may include a container 7012, a crossrail 7500, and an accessory 7502. The container 7012 comprises four sides 7504, 7506, 7508, and 7510, a top 7030, and a bottom 7032. The opposing sides 7504 and 7508 may form the front and the rear sides of the container 7012, while the opposidng sides 7506 and 7510 may form the left and the right sides of the container 7012. The top 7030 may have at least one connector portion 7036 (as shown in FIGS. 92-94).

The crossrail 7500 may be connected to the container 7012. The crossrail 7500 may be releasably or removably connected to the container 7012. As shown in FIGS. 85-86, the crossrail 7500 may extend alongside one 7506 or 7508 of the sides 7504, 7506, 7508, and 7510, and the crossrail 7500 may be in spaced relation to the one 7506 or 7508 of the sides 7504, 7506, 7508, and 7510.

The accessory 7502 may have a releasable connector 7512. The releasable connector 7512 may be configured to releasably connect to the at least one connector portion 7036 (e.g., on the top 7030 of the container 7012), and/or to releasably connect to the crossrail 7500 along a continuous connecting region 7514 along the crossrail 7500, to enable the accessory 7502 to be positioned in infinite increments along the crossrail 7500.

The crossrail 7500 may be the first crossrail 7500, 75001. The storage system 7000 may further include a second crossrail 7500, 75002 that is connected to the container 7012, which extends alongside one 7508 of the sides 7504, 7506, 7508, and 7510. The second crossrail 7500, 7500₂ may be in spaced relation to said one 7508 of the sides 7504, 7506, 7508, and 7510. The crossrails 7500, 7500₁ and 7500, 7500₂ may be releasably or removably connected to the container 7012.

The second crossrail 7500, 75002 may be longer than the (first) crossrail 7500, 7500₁. The first crossrail 7500, 7500₁ may be shorter than the second crossrail 7500, 7500₂. The second crossrail 7500, 7500₂ may have the same length as the (first) crossrail 7500, 7500₁. The second crossrail 7500, 7500₂ may be shorter than the (first) crossrail 7500, 7500₁. The first crossrail 7500, 7500₁ may be longer than the second crossrail 7500, 7500₂.

FIG. 85 shows the crossrail 7500, 7500₁ being connected to the left side 7506 of the container 7012. FIG. 86 shows two crossrails 7500, 7500₁, and 7500, 7500₂ being connected to the left side 7506 and the rear side 7508 (that is opposite to the front side 7504) of the container 7012, respectively. The number of crossrails 7500 that can be connected to the container 7012 may vary and may depend on the application. Each side 7504, 7506, 7508, and 7510 of the container 7012 may accommodate one or more crossrails 7500 depending on the height/depth of the container 7012. For example, each side 7506, 7508, and 7510 of the container 7012 may accommodate two crossrails 7500 thereon. In this case, the two crossrails 7500 may be connected to be spaced apart from each other on the corresponding side 7506, 7508, and 7510 of the container 7012.

The crossrails 7500 may be connected to three sides (e.g., the left side 7506, the rear side 7508, and the right side 7510) of the container 7012. The crossrails 7500 may be connected to two sides (e.g., the left side 7506 and the right side 7510, or the rear side 7508 and one of the left side 7506 and the right side 7510) of the container 7012. The crossrail 7500 may be connected to the front side 7504 of the container 7012. In some aspects, the crossrail 7500 may not be connected to the front side 7504 of the container 7012.

The second crossrail 7500, 7500₂ may extend along one 7508 of the sides 7504, 7506, 7508, and 7510 adjacent to the one 7508 of the sides 7504, 7506, 7508, and 7510 which the (first) crossrail 7500, 7500₁ extends along. In some aspects, the second crossrail 7500, 7500₂ may extend along one 7510 of the sides 7504, 7506, 7508, and 7510 opposing to the one 7506 of the sides 7504, 7506, 7508, and 7510 which the (first) crossrail 7500, 7500₁ extends along.

The storage system 7000 may include a plurality of stackable containers 7012, 7014 including at least a first container 7012 and a second container 7014. The second container 7014 may be releasably connectable on the top 7030 of the first container 7012. The first container 7012 may also be releasably connectable on top 7030 of the second container 7014.

Each container 7012, 7014 comprises a container portion 7028 and the lid portion 7030. The lid portion 7030 may interchangeably be referred to as the top. In some aspects, the bottom 7032 of the container portion 7028 includes a first connection portion 7034. Referring to FIGS. 92-93, the lid portion 7030 of one of the containers 7012, 7014 has the second connection portion 7036 that is (e.g., releasably) connectable with the first connection portion 7034 of the other of the containers 7012, 7014. The first and second connection portions 7034, 7036 may include a first connector 7038 on the first connection portion 7034 and a second connector 7040 on the second connection portion 7036. The first and second connection portions 7034, 7036 may further have mutually engageable lock elements 7046, 7048. The lock elements 7046, 7048 include a first lock element 7046 on the first connection portion 7034 and a second lock element 7048 on the second connection portion 7036. The first connection portion 7034, the first connector(s) 7038, and the first lock element(s) 7046 of one of the containers 7012, 7014 and the second connection portion 7036, the second connector(s) 7040 and the second lock element(s) 7048 of the other of the containers 7012, 7014 are all described above. Accordingly, like components are not described further below. The first lock element 7046 or the second lock element 7048 may include a movable lock member. The movable lock member may be configured to be movable between a locked configuration and a released configuration.

The second connection portion 7036 may further include an inner second connector 7040I and an inner second lock element 7048I disposed between the second connector 7040 and the second lock element 7048.

Referring to FIGS. 92-93, the top 7030 of the container 7012 may include a plurality of connector portions 7036, 7040, 7040I, 7048I, 7048. Each connector portion 7036, 7040, 7040I, 7048I, 7048 may provide a discrete connection location 7544. Discrete connection locations 7544₁-7544₇ are shown in FIGS. 92 and 93 for the inner second connectors 7040I. Although not labeled, there may be discrete connection locations for each of the inner lock members 7048I, the lock members 7048, and the second connectors 7040. The releasable connector 7034 of the accessory 7502 may be configured to releasably connect to each connector portion 7036, 7040, 7040I, 7048I, 7048. The top 7030 of the container 7012 may have at least five connector portions. For example, there may be at least five second connectors 7040, at least five inner second connectors 7040I, at least five second lock elements 7048, and at least five inner second lock elements 7048I disposed on the top 7030 of the container 7012. The top 7030 of the container 7012 may have seven connector portions. In another embodiment, there may be at least five second connectors 7040 and at least five second lock elements 7048 disposed on the top 7030 of the container 7012.

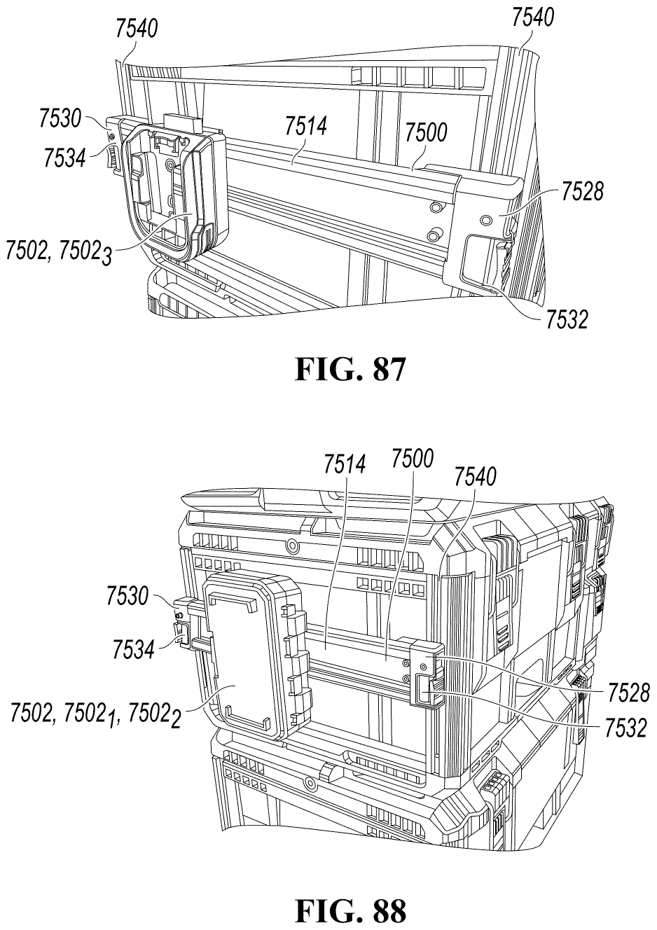

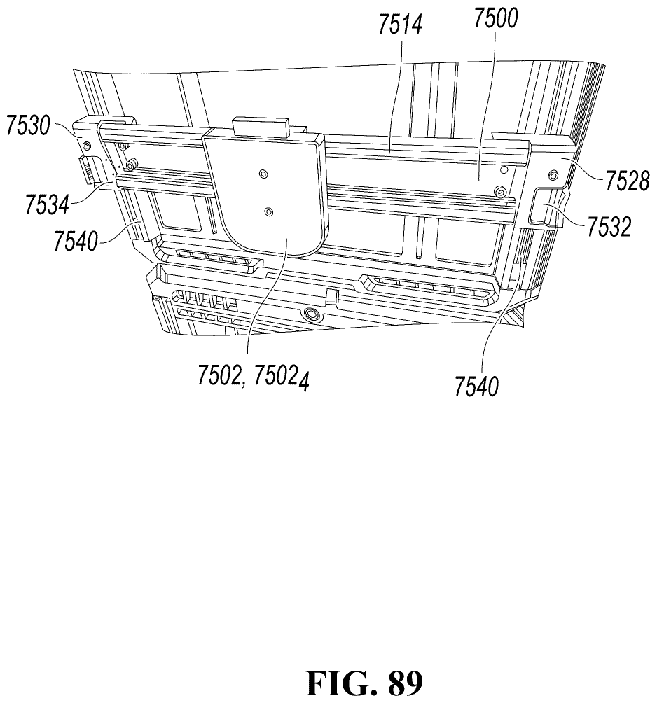

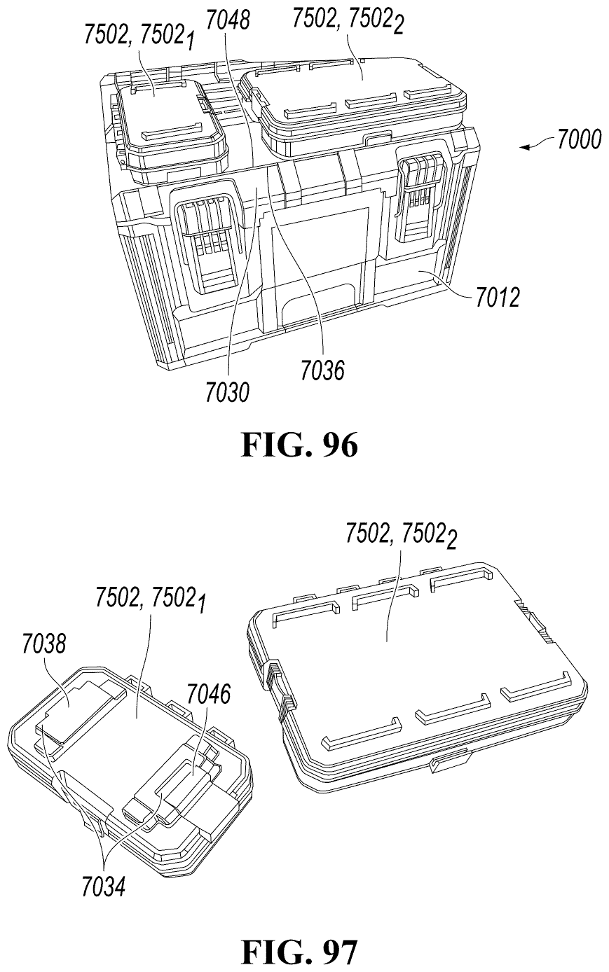

The top 7030 of the container 7012 may be configured to simultaneously connect to i) the bottom 7032 of the second container 7014 and ii) the accessory 7502. In some aspects, the second container 7014 and the accessory 7502 may be connected to the top 7030 of the container 7012 at different connection locations. For example, referring to FIG. 96, one of the two containers 7502₁, 7502₂ may be removed and replaced with the accessory 7502₃ shown in FIG. 87 or 7502₄ shown in FIG. 89 such that the accessory 7502₃ or 7502₄ is connected to the top 7030 of the container 7012, while the other of the two containers 7502₁, 7502₂ remains connected to the top 7030 of the container 7012.

Referring to FIGS. 85-86, the one 7506 (left side) of the sides 7504, 7506, 7508, and 7510 of the container 7012 includes two vertical rails 7518, 7520. The one 7508 (rear side) of the sides 7504, 7506, 7508, and 7510 of the container 7012 includes two vertical rails 7522, 7524. The crossrail 7500 may be configured to connect to the container 7012 by releasably connecting to each of the two vertical rails (e.g., 7518 and 7520 on the left side 7506 or 7522 and 7524 on the rear side 7508). The crossrail 7500 may extend between the two vertical rails (e.g., 7518 and 7520 on the left side 7506 or 7522 and 7524 on the rear side 7508). In some aspects, a first rail may include one or both of the vertical rails 7518 and 7521, and a second rail may include one or both of the vertical rails 7522 and 7524. Each rail may have multiple channels extending therethrough to provide versatile mounting options for the crossrail 7500.

Each of the four sides 7504, 7506, 7508, and 7510 of the container 7012 may include at least two vertical rails (e.g., 7518, 7520 on the left side 7506 or 7522, 7524 on the rear side 7508). The two vertical rails of the front side 7504 and the right side 7510 of the container 7012 are not shown in Figures. The container 7012 may include at least eight vertical rails (i.e., two vertical rails for each of the sides 7504, 7506, 7508, and 7510 of the container 7012). Each vertical rail may include one or more crossrail receiving portions 7543 that define channels extending therethrough. In some aspects, each vertical rail (e.g., integral rail including rails 7518 and 7521) may include two crossrail receiving portions 7543, positioned perpendicular to one another. The perpendicular orientation of the channels relative to one another provides additional mounting flexibility for accessories and crossrails, such that each channel can be arranged to received croassrails/bars on adjacent sides of the container.

The vertical rails may be separately formed (e.g., metal, plastic, composite, or other materials) and may be connected to the sides 7504, 7506, 7508, and 7510 of the containers 7012. The (adjacent) vertical rails 7520 and 7522 may be integrally formed (with a transition (edge) portion 7526 therebetween), may be disposed between the left side 7506 and the rear side 7508 of the container 7012, and may be connected to the left side 7506 and the rear side 7508 of the container 7012. Each vertical rail may be disposed in the same plane as the corresponding side of the container 7012. For example, two vertical rails 7518, 7520 on the left side 7506 of the container 7012 may be disposed in the same plane as the left side 7506 of the container 7012. The two vertical rails 7522, 7524 on the rear side 7508 of the container 7012 may be disposed in the same plane as the rear side 7508 of the container 7012. The vertical rails may extend the same height as the sides 7504, 7506, 7508, and 7510 of the container 7012. Each vertical rail may include crossrail receiving portion 7543. The crossrail receiving portion 7543 may include a guide or a channel configuration 7543. The rails may be positioned along corner edges of the housing, with a first corner edge between adjacent sides and a second corner edge between other adjacent sides, providing structural support and mounting locations for crossrails.

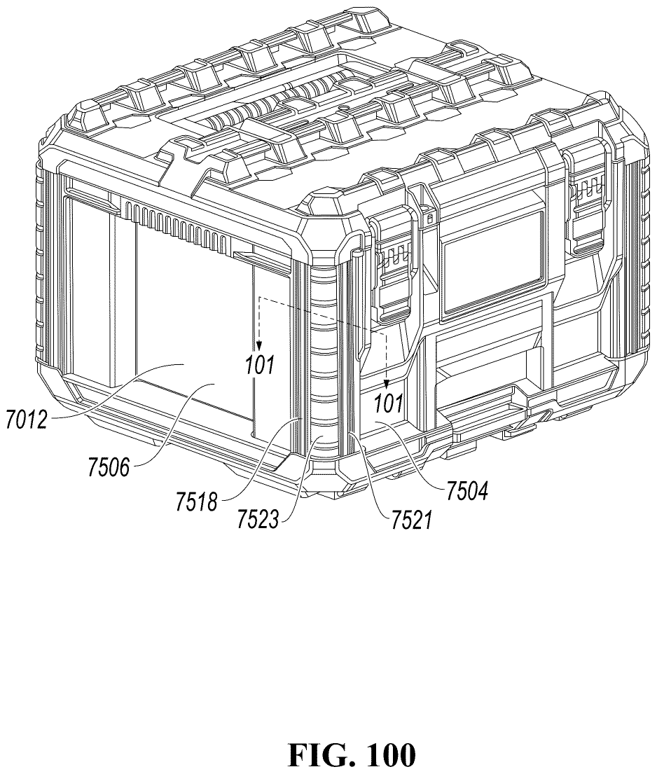

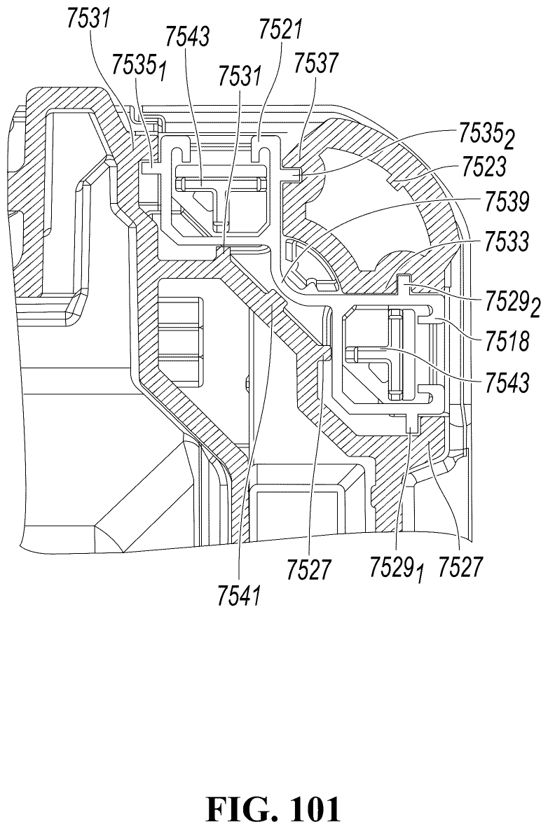

FIGS. 100 and 101 show two (adjacent) vertical rails 7518 and 7521 that may be integrally formed (with a transition (edge) portion 7523 therebetween). The two (adjacent) vertical rails 7518 and 7521 may be disposed between the front side 7504 and the right side 7506 of the container 7012. The transition (edge) portion 7523 may be referred to as a bumper. The vertical rail 7518 may be connected to/supported by the right side 7506 of the container 7012 via connection portion 7527 (disposed on the right side 7506 of the container) and connection portion 7529₁ (disposed on the vertical rail 7518). The vertical rail 7518 may be connected to the transition (edge) portion 7523 via connection portion 7533 (disposed on the transition (edge) portion 7523) and connection portion 7529₂ (disposed on the vertical rail 7518). The vertical rail 7521 may be connected to/supported by the front side 7504 of the container 7012 via connection portion 7531 (disposed on the front side 7504 of the container) and connection portion 7535₁ (disposed on the vertical rail 7521). The vertical rail 7521 may be connected to the transition (edge) portion 7523 via connection portion 7537 (disposed on the transition (edge) portion 7523) and connection portion 7535₂ (disposed on the vertical rail 7521). The connection portions 7531, 7535₁, 7535₂, 7537, 75291, 7529₂, 7527, and 7533 may have other shapes and configurations than those shown in FIGS. 100 and 101 as long as they provide connections between their associated members. The vertical rails 7518 and 7521 may be connected to each other via portion 7539. The portion 7539 may be supported by connection portion 7541. The connection portions 7527, 7531 and 7541 may be integrally formed on body/walls of the container 7012. Each vertical rail 7518, 7521 includes a crossrail receiving portion 7543 that defines a channel extending therethrough. In some aspects, the channels may have access openings positioned adjacent to the top surface of the container 7012, near the lid 7030, to allow vertical insertion of crossrail components. For example, as seen in FIG. 101, the access opening can be defined by the crossrail receiving portion 7543. In some aspects, when the lid 7030 is in the open position, the crossrail receiving portion 7543 (access opening) can be vertically accessible, to allow for the crossrails/bars described herein to be slid into the receiving channels vertically for mating.

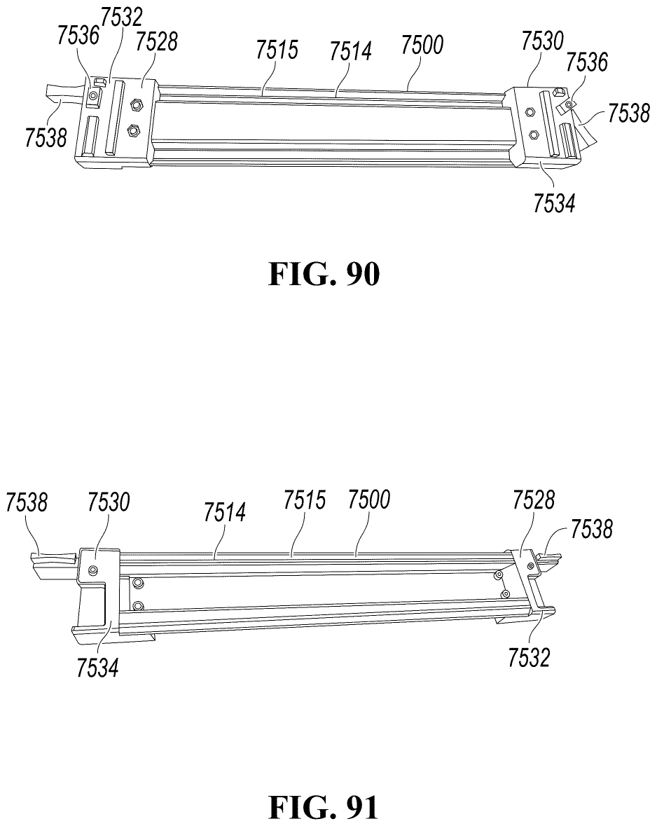

FIG. 90 shows an exemplary crossrail 7500 that includes two releasable connectors 7528, 7530 that are configured to releasably connect to the crossrail 7500 to one side 7504, 7506, 7508, and 7510 of the container 7012. The releasable connector 7528 is shown in an unlocked position and releasable connector 7530 is shown in a locked position in FIG. 90. FIG. 90 shows the rear view of the crossrail 7500, while FIG. 91 shows the front view of the crossrail 7500 of FIG. 90. The releasable connectors 7528, 7530 of the crossrail 7500 are shown in their unlocked positions in FIG. 91. The crossrail 7500 functions as a bar that is removably mated to and extends between a first rail and a second rail of the container 7012 (e.g., between the vertical rail 7522 and the vertical rail 7524). The crossrail 7500 includes first and second cleats in the form of vertical rail engaging portions 7536 positioned at opposed ends thereof to facilitate the mating functionalities described herein. In some aspects, when the lid 7030 is in a closed position, the lid prevents access to the openings, thereby preventing insertion or removal of crossrail components and providing security for mounted accessories.

The crossrail 7500 may include a body 7515 disposed between two releasable connectors 7528, 7530. The body 7515 of the crossrail 7500 may include the continuous connecting region 7514. The body 7515 of the crossrail 7500 may be made of a metal material. The body 7515 of the crossrail 7500 may be made of a plastic material, a composite material, or any other material as would be appreciated by a person of ordinary skill in the art. The body 7515 of the crossrail 7500 may be shaped and configured to engage with the connector 7038 and the lock element 7046 disposed on the accessory/container 7502 so as to enable releasable connection of the accessory/container 7502 on the body 7515 of the crossrail 7500. The crossrail 7500 is configured to be mated to the first and second rails through two distinct processes: a first process where the first and second cleats (vertical rail engaging portions 7536) are static during mating by sliding vertically into the channels through access openings, and a second process where the first and second cleats are pivotally moveable relative to the crossrail 7500 during mating through actuation of the locks 7538, as described below. Additionally, in some aspects, the bar/crossrail 7500 may be removably mated between the first rail and the second rail by laterally placing the first cleat and the second cleat into the first and second channels, respectively, and pivoting the first and second cleats, by actuation of the locks 7538, to lock the bar in a mated position on the first rail and the second rail.

The two releasable connectors 7528, 7530 of the crossrail 7500 may be disposed on end portions 7532, 7534 of the crossrail 7500. Each releasable connector 7528, 7530 of the crossrail 7500 may include a vertical rail engaging portion 7536 that is shaped and configured to engage with and configured to be movable along the corresponding vertical rail to a desired position/location and a lock 7538 that is configured to lock the vertical rail engaging portion 7536 with respect to the corresponding vertical rail at the desired position/location. The crossrail receiving portion 7540 (as shown in FIG. 85) of the vertical rail may be shaped and configured to receive the vertical rail engaging portion 7536 of the crossrail therein and to allow the vertical rail engaging portion 7536 of the crossrail to be movable therein to the desired position/location. The vertical rail engaging portions 7536 function as cleats that can be inserted into the channels of the first and second rails. In the first process, the cleats remain static and are slidably inserted into the channels through access openings adjacent to the top surface of the container. In the second process, the cleats are pivotally moveable through actuation of the locks 7538 to secure the crossrail in position.

One of the vertical rail engaging portion 7536 of the crossrail and the crossrail receiving portion 7540 of the vertical rail may be a male member and the other of the vertical rail engaging portion 7536 of the crossrail and the crossrail receiving portion 7540 of the vertical rail may be a female member. One of the vertical rail engaging portion 7536 of the crossrail and the crossrail receiving portion 7540 of the vertical rail may be configured and shaped to have a male shaped configuration and the other of the vertical rail engaging portion 7536 of the crossrail and the crossrail receiving portion 7540 of the vertical rail may be configured and shaped to have a female shaped configuration.

The lock 7538 may be disposed on the crossrail. The lock 7538 may be configured to apply a force, urging the male member into engagement with the female member to lock the male member in position with respect to the female member in that position. The lock 7538 may be movable to a release position in which the lock 7538 frees the male member so that the male member may then movably engage with the female member. In some aspects, the lock 7538 may be disposed on the vertical rail. The releasable connector between the crossrail and the vertical rail may have other shaped configurations as would be appreciated by a person of ordinary skill in the art. The lock 7538 enables the second process of mating, where pivotal movement of the cleats (vertical rail engaging portions 7536) is controlled to secure the crossrail 7500 within the channels of the rails. The dual mating processes provide flexibility in how the crossrail can be installed and removed, with the lid 7030 controlling access to ensure secure mounting when closed.

FIG. 87 shows a first type of accessory 7502, 7502₃ (e.g., charger) releasably connected to the first crossrail 7500, 7500₁ that is releasably connected to the first side 7506 of the container 7012.

FIG. 88 shows a second type of accessory (or small container) 7502, 7502₁, 7502₂ releasably connected to the first crossrail 7500, 7500₁ that is releasably connected to the first side 7506 of the container 7012. FIGS. 85-86 show two accessories (e.g., small containers) 7502, 7502₁ and 7502, 7502₂ releasably connected to the first crossrail 7500, 7500₁ that is releasably connected to the first side 7506 of the container 7012. FIG. 86 also shows the second crossrail 7500, 7500₂ that is being releasably connected to the second side 7508 of the container 7012.

FIG. 89 shows a third type of accessory 7502, 7502₄ releasably connected to the first crossrail 7500, 7500₁ that is releasably connected to the first side 7506 of the container 7012. FIG. 95 shows a fourth type of accessory 7502, 7502₅ releasably connected to the first crossrail 7500, 7500₁ that is releasably connected to the first side 7506 of the container 7012.

The accessory 7502 may interchangeably be referred to as utility or item. The accessory 7502 may include, but not limited to, light, radio, fan, charger, cup, flashlight, thermos, etc. In some aspects, the accessory 7502 may include, but not limited to, tools, charger/charging devices, power storage devices, other construction equipment, other jobsite equipment, etc.

FIG. 92 shows the third accessory (shown in FIG. 89) 7502, 7502₄ being releasably connected, using a releasable connector 7034, to at least one connector portion 7036 of the top 7030 of the container 7012 and at a first connection location 7544, 7544₂. FIG. 93 shows the third accessory (shown in FIG. 89) 7502, 7502₄ releasably connected to the at least one connector portion 7036 of the top 7030 of the container 7012 and at the first connection location 7544.

The releasable connector 7034 of the accessory 7502, 7502₄ may include the (first) connector 7038 and the (first) lock element 7046. The lock element 7046 of the releasable connector 7034 of the accessory 7502, 7502₄ and the lock element 7048I of the top 7030 of the container 7012 may be configured to be mutually engageable with each other. The lock element 7046 may include a movable lock member. The lock element 7048I may include movable lock member. The movable lock member is movable between a locked configuration and a released configuration. The releasable connector 7034 functions as a connection assembly that includes a first cleat and a second cleat, collectively referred to as the first connection portion 7034. The first cleat, which is moveable relative to the accessory, corresponds to the lock element 7046 that is actuated via the user actuatable member 7068. The second cleat corresponds to the connector 7038 portion of the connection assembly, as discussed in greater detail below.

The releasable connector 7034 of the accessory 7502, 7502₄ may also include a user actuatable member 7068 that is configured to be actuated by a user. The user actuatable member 7068 may be interchangeably referred as a handle or a lever. The releasable connector 7034 of the accessory 7502, 7502₄ may be configured to be movable between (a) a lock position in which the lock element 7046 is configured to lockingly engage with the locking element 7048I and (b) a release position in which the locking element 7046 disengages from the locking element 7048I so as to release the accessory 7502, 7502₄ from the container 7012. The bias member/spring, as described elsewhere herein, may be configured to bias the releasable connector 7034 between its lock position and its release position.

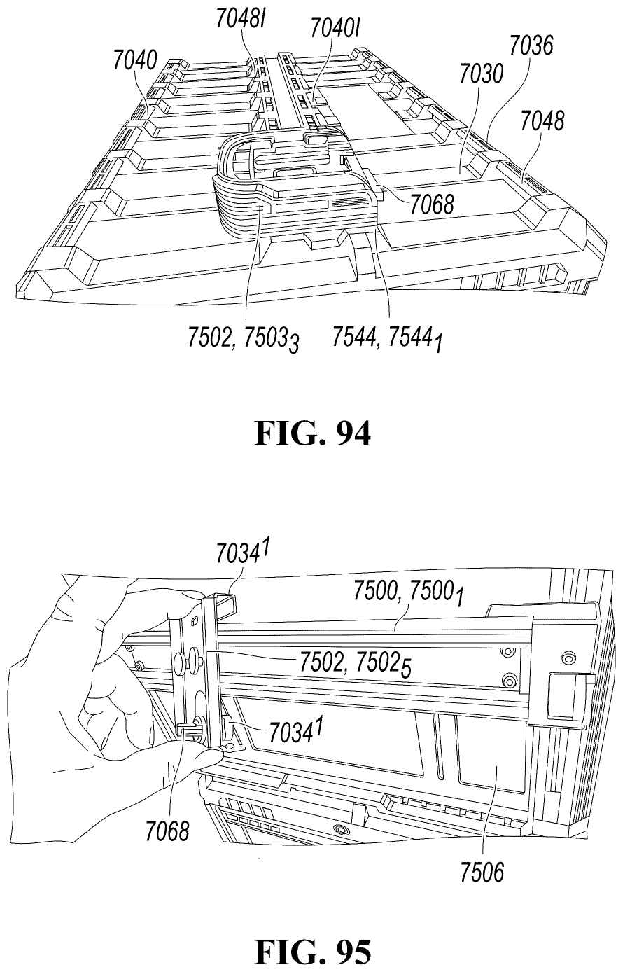

FIG. 94 shows the first accessory 7502, 7502₃ (e.g., charger) (shown in FIG. 87) releasably connected to the at least one connector portion 7036, 7040I, 7048I of the top 7030 of the container 7012 and at a second connection location 7544, 7544₁. The second connection location 7544, 7544₁ is different from the first connection location 7544, 7544₂ shown in FIG. 93.

FIG. 95 shows the fourth accessory 7502, 7502₅ being releasably connected to the crossrail 7500 that is releasably connected to the container 7012. The fourth accessory 7502, 7502₅ may include a releasable connector 7034′, in accordance with the systems described herein, that is configured to releasably connect the fourth accessory 7502, 7502₅ to the crossrail 7500, 7500₁. The releasable connector 7034′ may include a rotatable/twistable/pivotable user actuatable member 7068′ (instead of a spring biased releasable connector as described elsewhere herein) that is configured to move the releasable connector 7034′ between the locked and the released/unlocked positions.

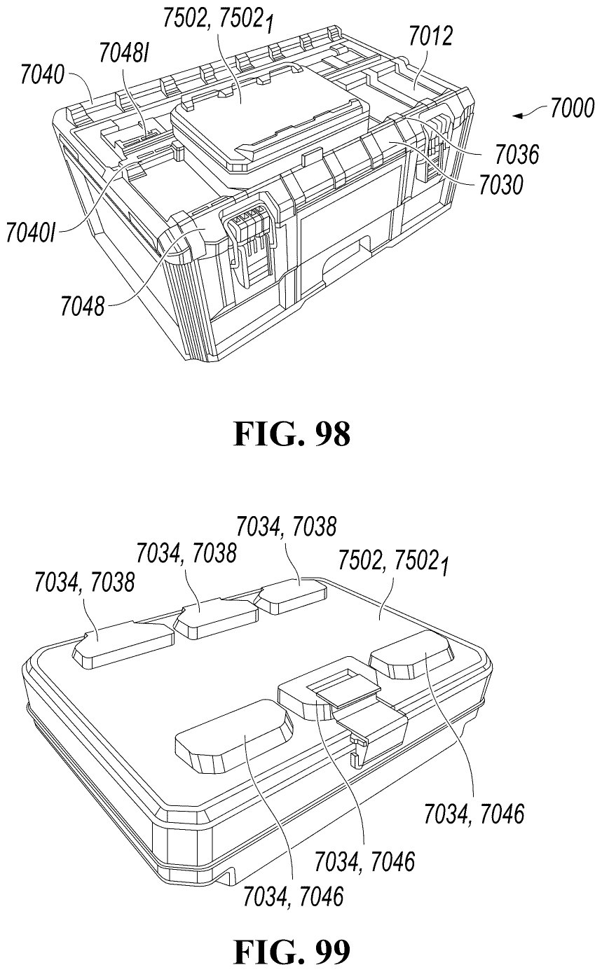

The movable cleat/lock 7046 of the accessory 7502 may be configured to selectively engage with both the crossrail 7500 and the at least one connector portion 7036, 7048I of the top 7030 of the container 7012. Engagement of the movable lock 7046 with either the crossrail 7500 or the at least one connector portion 7036, 7048I may prevent the release of the accessory 7502 from the respective crossrail 7500 or at least one connector portion 7036, 7048I of the top 7030 of the container 7012. For example, in some aspects, the accessory connection assembly, including a first cleat (e.g., movable lock 7046) and a second cleat (e.g., connector 7038), allow for the accessory to selectively mate in multiple orientations: a first orientation where the accessory connects to pockets of the first plurality of pockets (e.g., between connector portions 7036 and 7040I) as shown in FIGS. 96 and 98, a second orientation where the accessory connects to one or more pockets of both the first and second plurality of pockets (e.g., straddling between connector portions 7040I and 7048I) as shown in FIGS. 93-94, and a third orientation where the accessory connects to the channel of the bar (crossrail 7500) as shown in FIGS. 87-89.

FIG. 96 shows a perspective view of the container system 7000. Two accessories/small containers 7502, 7502₁and 7502, 7502₂ are releasably connected to the at least one connector portion 7036 of the top 7030 of the (larger) container 7012. This configuration demonstrates the first orientation where accessories mate to pockets of the first plurality of pockets in the top wall. The accessories include connection assemblies with first and second cleats positioned at opposite ends, where the first cleat (lock element 7046) is moveable relative to the accessory via the user actuatable member 7068, and the second cleat corresponds to the connector 7038.

As discussed in detail above, the (second) connector portion 7036 may include the second connector 7040 and the second lock element 7048. The connector portion 7036 may also include the inner second connector 7040I and the inner second lock element 7048I disposed between the second connector 7040 and the second lock element 7048. In FIG. 96, the two accessories/containers 7502, 7502₁ and 7502, 7502₂ are disposed between and releasably connected to the second lock element 7048 and the inner second connector 7040I. In some aspects, the two accessories/containers 7502, 7502₁ and 7502, 7502₂ may be disposed between and releasably connected to the second connector 7040 and the inner second lock element 7048I. The multi-orientation connectivity is enabled by the consistent connector design between the container top and the removable bar, where both the top wall connector portions and the bar's continuous connecting region 7514 provide compatible mating surfaces for the accessory connection assemblies.

FIG. 97 shows a bottom view of the left-side accessory/container 7502, 7502₁ of FIG. 96 and a top view of the right-side accessory/container 7502, 7502₂ of FIG. 96. The releasable connector or (first) connection portion 7034 of the accessory/container 750₂, 7502₁ may be configured to releasably connect to either at least one connector portion 7036, 7040, 7040I, 7048I, 7048 of the container 7012 as shown in FIG. 96 or to the crossrail 7500, 7500₁ connected to the container 7012 as shown in FIGS. 85-86. The versatile connection assembly design enables the accessory to selectively connect in different the various orientations discussed above. The accessory may further include a projection extending outward from the accessory opposite the first cleat, configured to selectively engage with an accessory housing to connect additional components to the accessory.

The releasable connector 7034 of the accessory/container 7502, 7502₁ may include the (first) connector 7038 and the (first) lock element 7046. The lock element 7046 and the lock element 7048 or 7048I may be configured to be mutually engageable with each other. The lock element 7046 may include a movable lock member. The lock elements 7048, 7048I may include movable lock members. The movable lock member is movable between a locked configuration and a released configuration.

FIG. 98 shows a perspective view of the container system 7000. The accessory/small container 7502, 7502₁ may be releasably connected to the at least one connector portion 7036 of the larger container 7012. FIG. 99 shows a bottom view of the accessory/container 7502, 7502₁ of FIG. 98. The releasable connector 7034 of the accessory/container 7502, 7502₁ may be configured to releasably connect to either at least one connector portion 7036, 7040, 7040I, 7048I, 7048 of the top 7030 of the container 7012 as shown in FIG. 99 or to the crossrail 7500, 7500₁ that is connected to the container 7012 as shown in FIGS. 85-86. FIG. 99 shows the central movable lock member 7046. The comprehensive container bar system improves the connective modularity of the containers described herein, enabling accessories to connect in multiple orientations through the consistent connector design shared between the container top and the removable bar, providing maximum flexibility for accessory placement and configuration.

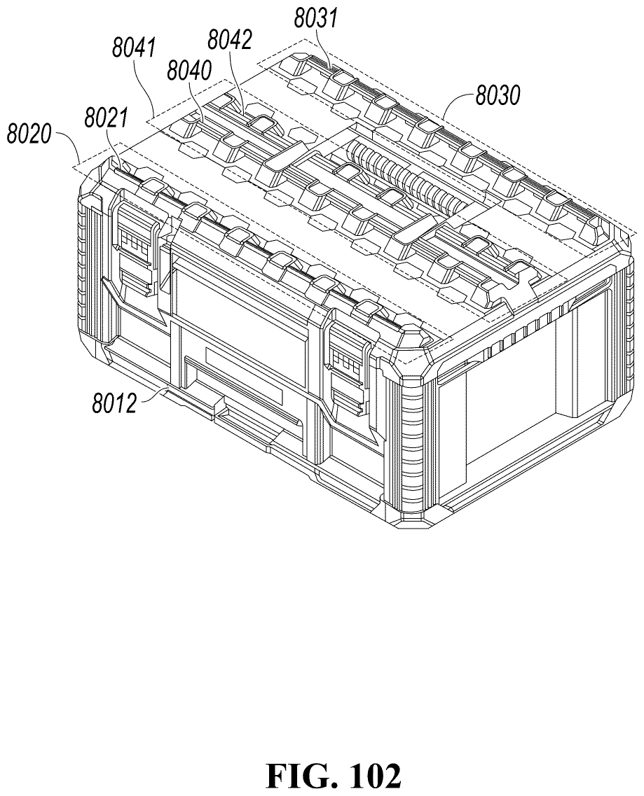

FIG. 102 shows a container 8012. In some aspects, the container 8012 can include similar components to the containers described above, accordingly like components are not described. As shown in FIG. 102, the container 8012 can include a top surface, a first plurality of pockets 8020 positioned proximate to a first edge of the top surface, a second plurality of pockets 8030 positioned proximate to a second edge of the top surface, and a third plurality of pockets 8040 positioned on the top surface at a location between the first plurality of pockets 8020 and the second plurality of pockets 8030. In some aspects, the third plurality of pockets 8040 can include a first set of pockets each having an opening 8041 facing a corresponding opening 8021 of the first plurality of pockets 8020, and a second set of pockets each having an opening 8042 facing a corresponding opening 8031 of the second plurality of pockets 8030.

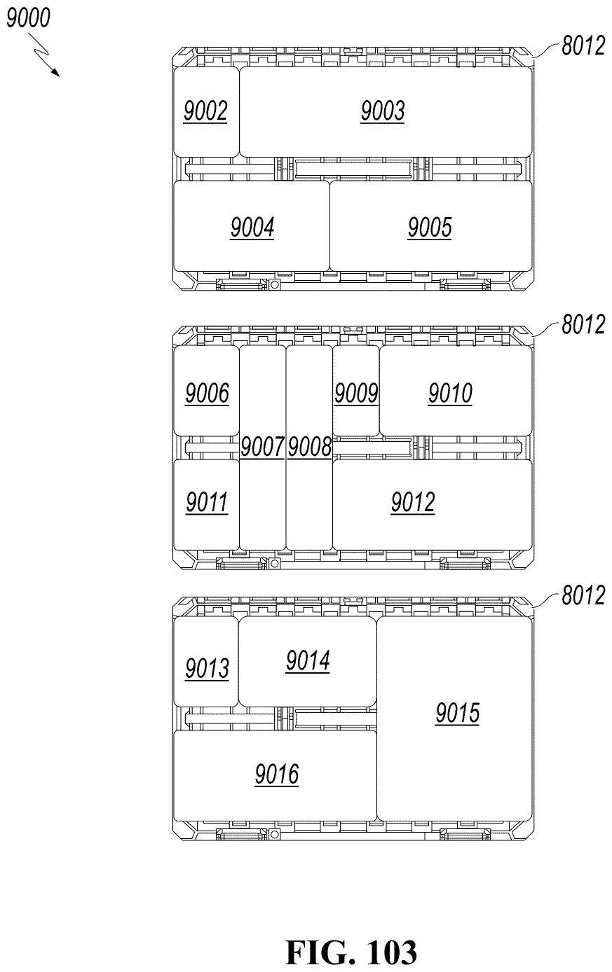

FIG. 103 illustrates various top views of a container system 9000, showing a plurality of stacking configurations for a plurality of containers 9002-9015 of the system 9000 on a top surface of the container 8012 of FIG. 102. In some aspects, each container 9002-9015 of the container system 9000 can include top and bottom mating elements (e.g., cleats and pockets) which can interact with one another to releasably mate the containers similarly to the mating of the containers described above, accordingly like components are not described. Additionally, while the heights of the containers are not shown in FIG. 103, it is appreciated that the heights of the containers 9002-9015 can similar or can vary in height. As shown in FIG. 103, the cleat and pocket arrangements of the containers described herein (e.g., containers 9002-9015) allow for various containers to be mounted to one another in a wide variety of stacking configurations. While it is not shown in FIG. 103, it is also realized that additional containers could be stacked on top of one or more of the containers 9002-9015, creating a third layer of containers. Each configuration of the plurality of configurations shown in FIG. 103 include releasably secure connections between cleats of each of the containers 9002-9015 and either i) between one or more of the first plurality of pockets 8020 and one or more of the second plurality of pockets 8030, ii) between one or more of the first plurality of pockets 8020 and one or more of the third plurality of pockets 8040 (e.g., the pockets having the openings 8041 facing the first plurality of pockets 8020), or iii) between one or more of the second plurality of pockets 8030 and one or more of the third plurality of pockets 8040 (e.g., the pockets having the openings 8042 facing the second plurality of pockets 8030).

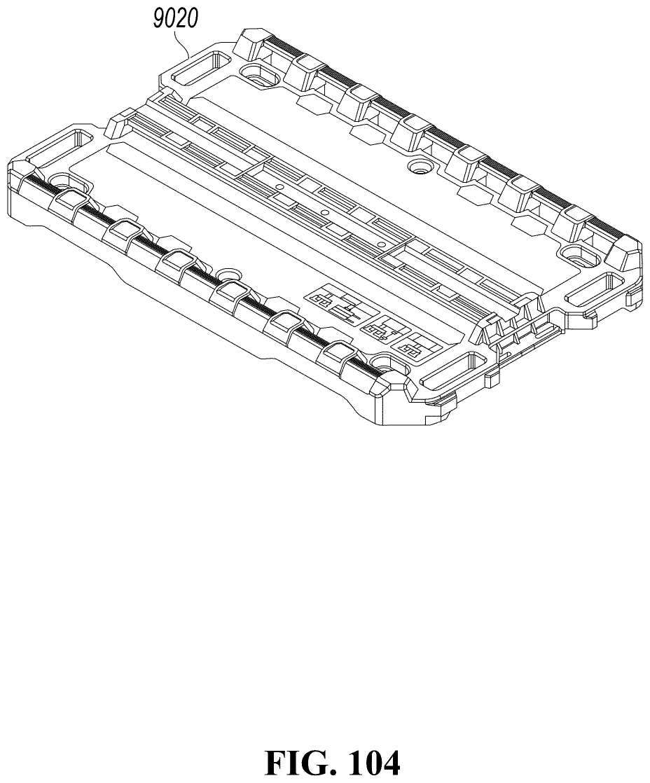

FIG. 104 shows an adapter or mount 9020 which can be used with the systems described herein. In some aspects, it may be desirable to securely attach containers or other portable structures described herein to a floor or a wall. For example, it may be desirable to secure the containers described herein to the bed of a truck so that they do not slide around while driving, or to a wall of a garage to make more efficient use of the floor space in the garage. Accordingly, in some aspects, the adapter/mount 9020 can be provided, which can include similar features to the to the container 8012 described above, accordingly like components/features are not described. Specifically, the adapter/mount 9020 can also include a top surface, a first plurality of pockets positioned proximate to a first edge of the top surface, a second plurality of pockets positioned proximate to a second edge of the top surface, and a third plurality of pockets positioned on the top surface at a location between the first plurality of pockets and the second plurality of pockets. Similar to the container 8012, containers of the container systems described herein (e.g., containers 8012 and 9002-9015) may be securely mounted to the top surface of the adapter/mount 9020 in a wide variety of stacking configurations as shown and described above in reference to FIG. 103.

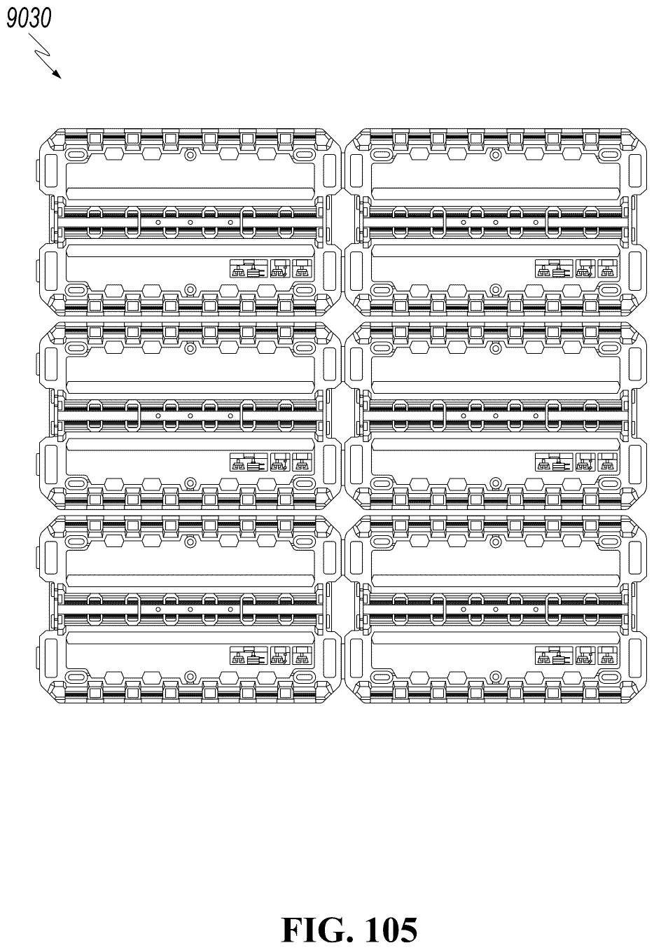

FIG. 105 is a top elevation view of an array 9030 of a plurality of the adapters/mounts 9020 of FIG. 104. In some aspects, a plurality of the adapters/mounts 9020 can be placed together on a floor (e.g., in the bed of a truck) or on a wall (e.g., a wall of a garage) to provide a larger modular connection surface to securely couple containers to, as described above.

The values/ranges noted above detailed description are exemplary. In some aspects, the values/ranges are up to 10 percent greater than or up to 10 percent less than the value described above. In some aspects, the values/ranges are up to 5 percent greater than or up to 5 percent less than the value described above.

Example aspects have been provided so that this disclosure will be thorough, and to fully convey the scope to those who are skilled in the art. Numerous specific details are set forth such as examples of specific components, devices, and methods, to provide a thorough understanding of the systems described herein. It will be apparent to those skilled in the art that specific details need not be employed, that example aspects may be embodied in many different forms and that neither should be construed to limit the scope of the disclosure. In some example aspects, well-known processes, well-known device structures, and well-known technologies are not described in detail.

The terminology used herein is for the purpose of describing particular example aspects only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by one of ordinary skill in the art in the context of the various elements, components, regions, layers and/or sections being described.

Numerous modifications may be made to the exemplary implementations described above. These and other implementations are within the scope of this application.

1.-74. (canceled)

75. A system, comprising:
a first structure having a first plurality walls defining a first volume, the first plurality of walls including a top wall and a bottom wall opposite the top wall, the first structure including a first plurality of connecting features positioned along the top wall, and a second plurality of connecting features positioned along the bottom wall; and
a second structure having a second plurality walls defining a second volume that is less than the first volume, the second plurality of walls including a top wall and a bottom wall opposite the top wall, the second structure including a third plurality of connecting features positioned along a top wall, and a fourth plurality of connecting features positioned along a bottom wall;
wherein the fourth plurality of connecting features are configured such that second structure can be releasably mounted to the top wall of the first structure by engaging the fourth plurality of connecting features with the first plurality of connecting features; and
wherein the second plurality of connecting features are configured such that they are incapable of engaging with the third plurality of connecting features to prevent the first structure from being mounted to the top wall of the second structure.

76. The system of claim 75, further comprising a third structure having a plurality walls defining a third volume that is less than the first volume, the third plurality of walls including a top wall and a bottom wall opposite the top wall, the third structure including a fifth plurality of connecting features positioned along a top wall, and a sixth plurality of connecting features positioned along a bottom wall;
wherein the fourth plurality of connecting features are configured such that second structure can be releasably mounted to the top wall of the third structure by engaging the fourth plurality of connecting features with the fifth plurality of connecting features;
wherein the sixth plurality of connecting features are configured such that third structure can be releasably mounted to the top wall of the first structure by engaging the sixth plurality of connecting features with the first plurality of connecting features;
wherein the sixth plurality of connecting features are configured such that third structure can be releasably mounted to the top wall of the second structure by engaging the sixth plurality of connecting features with the third plurality of connecting features; and
wherein the second plurality of connecting features are configured such that they are incapable of engaging with the fifth plurality of connecting features to prevent the first structure from being mounted to the top wall of the third structure.

77. The system of claim 75, wherein the first plurality of connecting features are a first plurality of pockets, and the third plurality of connecting features are a second plurality of pockets.

78. The system of claim 77, wherein the second plurality of connecting features are a first plurality of cleats, and the fourth plurality of connecting features are a second plurality of cleats.

79. The system of claim 75, wherein the first plurality of pockets are smaller than the second plurality of pockets.

80. The system of claim 79, wherein the first plurality of cleats are larger than the second plurality of pockets, preventing the first plurality of cleats from being positioned within the second plurality of pockets.

81. The system of claim 75, wherein the second plurality of connecting features includes a first cleat positioned on a first side of the first structure, and a second cleat positioned on a second side of the first structure, opposite the first side.

82. The system of claim 81, wherein at least one of the first cleat and the second cleat are moveable relative to the first structure.

83. The system of claim 81, wherein the second cleat is rigidly connected to the first structure.

84.-122. (canceled)

123. A container system, comprising:
a plurality of containers including at least a first container, a second container, and a third container, the second and third container each configured to releasably connect on top of the first container, the first and third container each configured to releasably connect on top of the second container.
the first and second containers each comprising a bottom portion and a top portion, the bottom portion of the first container having a first bottom connection portion with a first bottom connector, the top portion of the first container having a first top connection portion with a first top connector, the bottom portion of the second container having a second bottom connection portion with a second bottom connector, the top portion of the second container having a second top connection portion with a second top connector,
the first container being selectively connectable to the second container in at least two mating configurations i) wherein the first bottom connector is matingly connected to the second top connector, and ii) wherein the second bottom connector is matingly connected to the first top connector,
the third container comprising a top portion having a third top connector and a bottom portion having a third bottom connector, the third container being selectively connectable to i) the first container wherein the third bottom connector is connected to the first top connector in a mating configuration, and ii) the second container wherein the third bottom connector is connected to the second top connector in a mating configuration,
wherein the first bottom connector and third top connector have a non-mating configuration preventing the first bottom connector from being connected to the third top connector

124. The container system of claim 123, wherein the first bottom connector comprises a first bottom tooth with a first thickness,
wherein the third connector comprises a gap distance,
wherein the gap distance is configured to be less than the first thickness of the first bottom tooth to prevent connection between the third top connector and the first bottom connector.

125. The container system of claim 124, wherein the first top connector further comprises a first top tooth having a second thickness, the third bottom connector comprises a second gap distance, and
wherein the second gap distance is configured to be equal to or greater than the second thickness of the first top tooth to allow connection of the third bottom connector and the first top connector.

126. The container system of claim 123, wherein the first bottom connection portion and second bottom connection portion each further comprise a movable lock member, and
wherein the movable lock member is movable between a locked configuration and a released configuration with respect to either i) the first top connection portion of the first container or ii) the second top connection portion of the second container.

127. The container system of claim 123, wherein the third bottom connection portion further comprises a movable lock member, and
wherein the movable lock member is movable between a locked configuration and a released configuration with respect to the first top connection portion of the first container or the second top connection portion of the second container.

128. The container system of claim 123, further comprising a fourth container, the fourth container comprising a top portion having a fourth top connector and a bottom portion having a fourth bottom connector, the fourth container being selectively connectable to i) the first container wherein the fourth bottom connector is connected to the first top connector in a mating configuration, ii) the second container wherein the fourth bottom connector is connected to the second top connector in a mating configuration, and iii) the third container wherein the fourth bottom connector is connected to the third top connector in a mating configuration.

129.-201. (canceled)
